(19) United States
(12) Patent Application Publication
(10) Pub. No.: US 2023/0342166 A1
(43) Pub. Date: Oct. 26, 2023

(54) SYSTEM, METHOD, AND APPARATUS FOR PUBLICATION AND EXTERNAL INTERFACING FOR A UNIFIED DOCUMENT SURFACE

(71) Applicant: Coda Project, Inc., Mountain View, CA (US)

(72) Inventors: Alexander W. DeNeui, Sandpoint, ID (US); Glenn Jaume, San Francisco, CA (US); Hariharan Sivaramakrishnan, Bellevue, WA (US); Helena G. Jaramillo, Syracuse, NY (US); John Z. Li, San Francisco, CA (US); Jonathan L. Goldman, San Francisco, CA (US); Martin Charles, Austin, TX (US); W. Michael Varney, Truckee, CA (US); Timothy Andrew James, Seattle, WA (US); Adam Ginzberg, San Francisco, CA (US); Nathan Penner, Redmond, WA (US); Evan Brooks, San Francisco, CA (US); Michael Hewitt, Moscow, ID (US); Punit Shah, San Francisco, CA (US); Patrick Barry, San Francisco, CA (US); Huayang Guo, Fremont, CA (US); Jason Peter Stowe, Seattle, WA (US); Christopher Leland Eck, Sammamish, WA (US); Alicia Salvino, Philadelphia, PA (US); Alan Fang, New York, NY (US); Spencer Chang, San Francisco, CA (US); Elizabeth Huang, Great Falls, VA (US); Oleg Vaskevich, San Francisco, CA (US)

(21) Appl. No.: 18/216,069

(22) Filed: Jun. 29, 2023

Related U.S. Application Data
(63) Continuation-in-part of application No. 17/679,006, filed on Feb. 23, 2022.
Application No. 17/679,006 is a continuation-in-part of application No. 15/499,882, filed on Apr. 27, 2017.
(60) Provisional application No. 63/152,541, filed on Feb. 23, 2021.
(60) Provisional application No. 63/230,398, filed on Aug. 6, 2021.
(60) Provisional application No. 63/225,835, filed on Jul. 26, 2021.
(60) Provisional application No. 62/328,469, filed on Apr. 27, 2016.
(60) Provisional application No. 62/485,908, filed on Apr. 15, 2017.

(51) Int. Cl. G06F 9/451; G06F 3/0486; G06F 21/62

(52) U.S. Cl. CPC G06F 9/451; G06F 3/0486; G06F 21/6218

(57) ABSTRACT

Systems and methods include a document serving circuit structured to access a document data, the document data comprising data for a unified document surface, and to provide at least a portion of the document data to a client serving circuit. The client serving circuit is structured to implement a unified document surface interface in response to the at least a portion of the document data, implement an extension creation interface, and to provide a pack implementation value to the document serving circuit in response to user interactions with the extension creation interface. The document serving circuit is further structured to determine a pack definition value in response to the pack implementation value.

### CLAIM TO PRIORITY

This application is a continuation-in-part of: U.S. patent application Ser. No. 17/679,006, filed on Feb. 23, 2022, now published on Aug. 25, 2022 as US 2022/0269851 A1, and entitled “SYSTEM, METHOD, AND APPARATUS FOR PUBLICATION AND EXTERNAL INTERFACING FORA UNIFIED DOCUMENT SURFACE”.

U.S. patent application Ser. No. 17/679,006 claims the benefit of and priority to U.S. Provisional Patent Application No. 63/152,541, filed on Feb. 23, 2021, entitled “SYSTEM, METHOD, AND APPARATUS FOR PUBLICATION AND EXTERNAL INTERFACING FOR A UNIFIED DOCUMENT SURFACE”; U.S. Provisional patent application No. 63/230,398, filed on Aug. 6, 2021, entitled “SNAPSHOT SHARDING”; and U.S. Provisional patent application No. 63/225,835, filed on Jul. 26, 2021, entitled “UNIFIED DOCUMENT SURFACE PACKS”.

This application is also a continuation-in-part of: U.S. patent application Ser. No. 15/499,882, filed on Apr. 27, 2017, now published on Nov. 2, 2017 as US 2017/0315967 A1, and entitled “Conditional Formatting”.

U.S. patent application Ser. No. 15/499,882 claims the benefit of priority to U.S. Provisional patent application No. 62/328,469, filed on Apr. 27, 2016, entitled “UNIFIED COLLABORATIVE DIGITAL PLATFORM”, and U.S. Provisional Patent Application No. 62/485,908, filed Apr. 15, 2017, entitled “UNIFIED COLLABORATIVE DIGITAL PLATFORM”.

Each of the foregoing patent applications is incorporated herein by reference in their entirety for all purposes.

### BACKGROUND

Previously known systems for document creation and collaboration of documents suffer from a number of drawbacks. For example, users of previously known systems have difficulty sharing and finding useful documents created by other users in a secure environment. In another example, previously known systems have limited extension capability, and/or extension capability that requires users to be experts in extension tools, and where shared documents having extensions introduce risks that are difficult to resolve, and result in many users and organizations that simply block or do not utilize extensions to the main document creation system. In another example, previously known systems require users to install significant applications to operate the document creation system, and further create multiple copies of large files on individual devices, or cause users to experience significant delays to access and edit large documents, resulting in difficulty implementing a collaborative workflow. Additionally, dedicated applications for many previously known systems require different versions for different client device types, resulting in conflicting document issues such as formatting, and requiring maintenance of a large number of applications and versions of those applications for administrators of entities having a large user base. In another example, previously known systems operate a number of document creation applications, each tailored to specific types of content, with mixed content documents requiring sophisticated interfacing protocols to get the mixed content to function, and limited capability for certain types of content within a given document creation application.

### SUMMARY

Embodiments herein include systems and methods to provide for operation of a document creation, sharing, and collaboration system that can function across a large number of client device types, seamlessly for different device types, and with capability tailored for particular devices. Embodiments herein support convenient sharing of documents to selected users. Embodiments herein support creation of powerful extensions for the document creation system that are accessible to users having a moderate level of expertise in coding and computing environments. Embodiments herein support convenient sharing of extensions to selected users. Embodiments herein support the creation and utilization of extensions in a protected environment, making extensions convenient to create and utilize with low risk to the user systems. Embodiments herein support convenient discovery of useful documents and extensions, and provide a convenient platform for resource exchange to support creators of useful documents and extensions.

An embodiment of the present disclosure includes a method, comprising: communicating a first operation log from a first computing device to a second computing device and a third computing device, the first operation log comprising at least one first sequential operation defining operations to create a first document; receiving a change value for the first operation log from the second computing device, the change value comprising at least one sequential operation defining operations to create a second document including changes relative to the first operation log; receiving a second change value for the first operation log from the third computing device, the second change value comprising at least one sequential operation defining operations to create a third document including changes relative to the first operation log; communicating the second change value to the second computing device; and receiving an updated change value from the second computing device, the updated change value comprising a conflicts resolving change value between the change value and the second change value.

An embodiment of the present disclosure includes an apparatus, comprising: an application configuration circuit structured to interpret at least one of: a user noun selection, a user verb selection, or a user context selection; the application configuration circuit further structured to determine an application configuration value in response to a source data value, and further in response to the at least one of: the user noun selection, the user verb selection, or the user context selection; the application configuration circuit further structured to determine the application configuration value such that the application is responsive to a target user device resource value; and an application publication circuit structured to publish an application in response to the application configuration value.

An embodiment of the present disclosure includes an apparatus, comprising: an application configuration circuit structured to interpret at least one of: a user noun selection, a user verb selection, or a user context selection; the application configuration circuit further structured to determine an application configuration value in response to a source data value, and further in response to the at least one of: the user noun selection, the user verb selection, or the user context selection; wherein the source data value comprises at least one data object selected from the data objects consisting of a graph, a chart, an image, a video file, an audio file, a media file, video content, audio content, and media content; and an application publication circuit structured to publish an application in response to the application configuration value.

An embodiment of the present disclosure includes a system, comprising: a document server communicatively coupled to a computing device; a document comprising an operation log, wherein the operation log comprises at least one first sequential operation defining operations to create data values of the document; a document object model, wherein the document object model comprises an object definition corresponding to each of a plurality of objects in the document; wherein the document is at least partially positioned on at least one of the document server and the computing device; wherein the at least one client computing device comprises a formula engine, wherein the formula engine is structured to determine a calculation definition in response to the user formula value and the document object model; wherein the client computing device comprises; a unified document surface application circuit structured to interpret a user formula value and to update the data values of the document in response to the user formula value; a user display circuit structured to provide a first view in response to the updated data values of the document; a visualization tool (VT) circuit structured to determine a visualization element (VE) in response to the updated data values of the document, and further in response to at least one of: a user visualization selection or a user context value; and wherein the user display circuit is further structured to provide a second view in response to the VE and updated data values of the document.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 is a schematic depiction of a system for implementing an extension capability for a unified document surface operating system.

FIG. 2 is a depiction of an example pack gallery.

FIG. 3 is a schematic depiction of a workflow for operating the formula snippet.

FIG. 4 is a schematic depiction of a sharding circuit.

FIG. 5 is a schematic flow diagram of a procedure for generating shards.

FIG. 6 is a schematic flow diagram of a procedure for transmitting shards.

FIG. 7 is a schematic flow diagram of a procedure for prioritizing shards.

FIG. 8 is a schematic depiction of a system for group collaboration.

FIG. 9 is a schematic depiction of a system with a share environment.

FIG. 10 is a schematic depiction of a system with for implementing forms capability.

FIG. 11 is a schematic flow diagram of a procedure for implementing a pack.

FIG. 12 is a schematic flow diagram of a procedure for installing a pack.

FIG. 13 is a schematic flow diagram of a procedure for publishing a pack.

FIG. 14 is a schematic flow diagram of a procedure for installing a pack.

FIG. 15 is a schematic diagram of a system for pack implementation.

FIG. 16 is a schematic diagram of a system for pack implementation.

FIG. 17 is a schematic diagram of a pack.

FIG. 18 is a schematic diagram of a system for pack execution.

FIG. 19 is a schematic diagram of a system for pack execution.

FIG. 20 is a schematic diagram of a system for pack publishing.

FIG. 21 is a schematic diagram of a system for pack publishing.

FIG. 22 is a schematic diagram of a controller for providing granular shard support.

FIG. 23 is a schematic diagram of an example of multiple shard groups.

FIG. 24 is a schematic diagram of a controller for providing publication support for a unified document surface.

FIG. 25 is a schematic depiction of an example document publication value.

FIG. 26 is a schematic depiction of an example document publication definition.

FIG. 27 is a schematic depiction of an example target display description.

FIG. 28 is a schematic diagram of an example system for document serving.

FIG. 29 is a schematic diagram of an example of certain considerations for determining a pre-render command.

FIG. 30 is a schematic diagram of an example unified document surface platform.

FIG. 31 is a schematic diagram of an example controller for use with a unified document surface.

FIG. 32 is a schematic diagram of aspects of an example unified document surface platform.

FIG. 33 is a schematic diagram of aspects of an example unified document surface platform.

FIG. 34 is a schematic depiction of a number of shards.

FIG. 35 is a schematic depiction of example shard strategy descriptions.

FIG. 36 is a schematic depiction of example aspects of a form.

FIG. 37 is a schematic depiction of example aspects of a table.

FIG. 38 is a schematic depiction of an example document list.

FIG. 39 is a schematic depiction of an example document description card is illustrated.

FIG. 40 is a schematic depiction of an example table having a canvas.

FIG. 41 is a schematic depiction of an example canvas embedded in a table.

FIG. 42 is a schematic depiction of an example document surface.

FIG. 43 is a schematic depiction of an example document with a collapse interface.

FIG. 44 is a schematic depiction of aspects of an example collapse interface.

FIG. 45A is a schematic flow diagram of a procedure for document sharding.

FIG. 45B is a schematic flow diagram of a procedure for document sharding.

FIG. 46 is a schematic flow diagram of a procedure for document sharding.

FIG. 47 is a schematic flow diagram of a procedure for implementing a document surface interface with shards.

FIG. 48 is a schematic flow diagram of a procedure for publishing documents.

FIG. 49 is a schematic flow diagram of a procedure for publishing documents.

FIG. 50 is a schematic flow diagram of a procedure for publishing documents.

FIG. 51 is a schematic flow diagram of a procedure for publishing documents.

FIG. 52 is a schematic flow diagram of a procedure for determining a document list.

FIG. 53 is a schematic flow diagram of a procedure for providing a gallery.

FIG. 54 is a schematic flow diagram of a procedure for providing forms.

FIG. 55 is a schematic flow diagram of a procedure for providing forms.

FIG. 56 is a schematic flow diagram of a procedure for using forms.

FIG. 57 is a schematic flow diagram of a procedure for generating shards.

FIG. 58A is a schematic flow diagram of a procedure for updating document data.

FIG. 58B is a schematic flow diagram of a procedure for updating document data.

FIG. 59 is a schematic flow diagram of a procedure for document display.

FIG. 60 is a schematic flow diagram of a procedure for document display.

FIG. 61 is a schematic flow diagram of a procedure for configuring rendering.

FIG. 62 is a schematic flow diagram of a procedure for configuring rendering.

FIG. 63 is a schematic flow diagram of a procedure for document rendering.

FIG. 64A is a schematic flow diagram of a procedure for document rendering.

FIG. 64B is a schematic flow diagram of a procedure for document rendering

FIG. 65 is a schematic flow diagram of a procedure for document rendering.

FIG. 66 is a schematic depiction of a system for working with an operation log.

FIG. 67 is a schematic flow diagram of a procedure for communicating a change value.

FIG. 68 is schematic flow diagram of a procedure for updating a change value.

FIG. 69 is a schematic flow diagram of a procedure for receiving an updated change value.

FIG. 70 is a schematic flow diagram of a procedure for communicating a change value.

FIG. 71 is a schematic flow diagram of a procedure for providing a snapshot.

FIG. 72 is a schematic flow diagram of an alternate procedure for providing a snapshot.

FIG. 73 is a schematic depiction of a system for providing a data view.

FIG. 74 is a schematic illustration of a data depiction.

FIG. 75 is a schematic flow diagram of a procedure for updating a source data value.

FIG. 76 is a schematic depiction of another embodiment of a system for providing a visualization.

FIG. 77 is a schematic depiction of another embodiment of a visualization tool circuit.

FIG. 78 is a schematic flow diagram of another embodiment of a procedure for providing a view.

FIG. 79 is schematic depiction of a system for providing an application.

FIG. 80 is a schematic depiction of a system for operating an API.

FIG. 81 is a schematic depiction of a system for updating an operation log.

FIG. 82 is a schematic depiction of a system for accessing environmental variables.

FIG. 83 is a schematic depiction of a system for updating an operation log.

FIG. 84 is a schematic depiction of a system for operating a formula engine.

FIG. 85 is a schematic depiction of a system for accessing environmental variables.

FIG. 86 is a schematic data illustration.

FIG. 87 is a schematic data illustration.

FIG. 88 is a schematic data illustration.

FIG. 89 is a schematic data illustration.

FIG. 90 is a schematic data illustration.

FIG. 91 is a schematic depiction of a system for accessing data.

FIG. 92 is a schematic data illustration.

FIG. 93 is a schematic data illustration.

### DETAILED DESCRIPTION

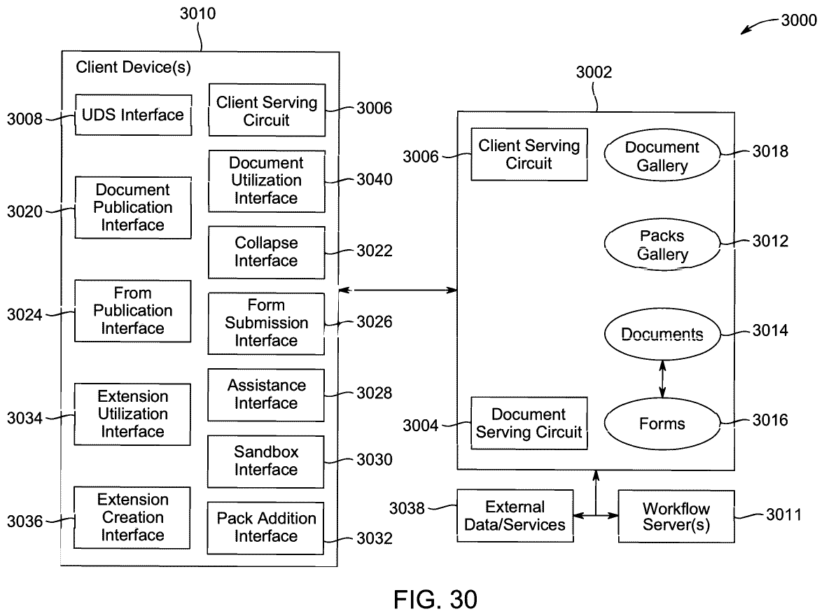

Referencing FIG. 30, an example UDS platform 3000 is schematically depicted. The example UDS platform 3000 is configured to, without limitation, allow users to: prepare documents 3014 that each comprise a unified document surface (UDS); collaborate on documents; publish documents to a selected scope (e.g., a document gallery 3018 of the UDS platform 3000, fully public publication such as a URL that is exposed to search engines or other internet navigation services, publish to a workspace, publish to selected users, etc.); provide scheduled access to published documents in whole or part, and according to numerous criteria; create capable extensions to the UDS interface 3008, including extensions with arbitrary coding capability with managed risks to keep users, client devices, and the UDS platform 3000 secure; publish extensions to a selected scope (e.g., a packs gallery 3012 of the UDS platform 3000); and/or create forms 3016 to solicit data entry from anyone, whether a user of the UDS platform 3000 or otherwise, and to integrate submitted data into a document. The example of FIG. 30 is a non-limiting and schematic depiction, showing an example arrangement of components of the UDS platform 3000, and client devices 3010 accessing the UDS platform 3000.

The example UDS platform 3000 includes a document serving circuit 3004 that coordinates data flows between the client device(s) 3010 and stored document 3014 data, and coordinates support for calculations related to the UDS platform 3000. Example calculations related to the UDS platform 3000 include calculations to execute formulas and/or code (e.g., embodied in packs or otherwise) within documents 3014, operate authorization interfaces (e.g., logins to the UDS platform 3000, access to external data and/or services, and/or access for users to published documents, packs, etc.), to maintain documents in a collaborative environment (e.g., developing dependency graphs and/or invalidation graphs, to perform conflict resolution, to generate snapshots and/or implement sharding strategies, to expose API interfaces to the UDS platform 3000, to exercise API interfaces with external services and/or external data providers, etc.), and/or to determine which sharding strategies should be supported and/or utilized, etc. In the example of FIG. 30, the document serving circuit 3004 may outsource calculations to one or more workflow servers 3011, which may be affiliated with the UDS platform 3000 and/or external (e.g., utilizing a third party computing resource, such as Amazon Web Services, Microsoft Azure, etc.), and which may include the utilization of virtual machines and/or on demand allocated computing resources (e.g., a “serverless computing” implementation). In certain embodiments, the utilization of workflow servers 3011 allows for execution of arbitrary code, published documents having external data and/or external service access, and the like, to be performed while minimizing the risk of malicious code damaging a client device and/or the UDS platform 3000, accidental exposure of unintended data (e.g., by being provided within source code and/or cached memory that might be accessible to a sophisticated user where code execution, external data access, and/or API interactions are performed from the client device).

The example UDS platform 3000 includes a client serving circuit 3006 that implements communications between the UDS platform 3000 and client device(s) 3010, and may be distributed between the UDS platform 3000 and the client device 3010, or positioned on one or the other. In certain embodiments, the user interacts with the UDS platform 3000 using a client device 3010 of any type, primarily interacting with a UDS interface 3008 that provides menus, document rendering, formula entry, publication, and any other functionality as set forth throughout the present disclosure. In certain embodiments, the UDS interface 3008, and/or any other interfaces implemented on the client device 3010, may be implemented as a dedicated application (e.g., an application installed on the client device), as a web portal, and/or as an in-browser application (e.g., utilizing JavaScript or another implementing programming language). In certain embodiments, the UDS interface 3008, and/or other interfaces, may be installed as a part of interactions to access the UDS platform 3000, and/or may additionally or alternatively be installed on a more persistent basis, stored in a cache of the client device 3010, or the like. In certain embodiments, the interfaces may be provided as a shard upon accessing the UDS platform 3000, in a manner similar to document shards and other shards described throughout the present disclosure. In certain embodiments, certain interfaces may be provided in separate shards, which may be delivered to the client device 3010 upon initial access, during low usage periods while the user is interacting with one or more interfaces, and/or as needed (e.g., loading an extension utilization interface 3034 in response to the user accessing a pack creation interface within the UDS interface 3008).

The example client device 3010 depicts three primary types of interfaces positioned thereon, which are divided into three types for clarity of the present description, but the types of interfaces are not limiting. Additionally or alternatively, the interfaces depicted are depicted individually for clarity of the description, but the interfaces may be combined in whole or part. For example, the document publication interface 3020 may be contained within the UDS interface 3008. The example client device 3010 depicts document related interfaces, such as the UDS interface 3008 implementing primary document access and control, a document utilization interface 3040 allowing users to access and utilize published documents, a document publication interface 3020 allowing users to publish documents, and a collapse interface 3022 that allows the user to controllably collapse document elements such as a table, a canvas, a section, or the like, and/or to control collapsing operations for other users of a document. The example client device 3010 depicts form related interfaces, such as a form publication interface 3024 allowing users to create and publish forms that accept data from other users, including users that do not utilize the UDS platform 3000, and a form submission interface 3026 allowing users to access forms and submit data using the form, where the data can be stored into a selected document (e.g., as a row of a table of a document). The form submission interface 3026, in certain embodiments, may be provided independently of other interfaces on the client device 3010, for example allowing form submissions by users that do not access and/or are not familiar with (or possibly even aware of) the UDS platform 3000. The example client device 3010 depicts extension (or pack) related interfaces, such as an extension utilization interface 3034 allowing users to incorporate and/or utilize packs within their own documents; an extension creation interface 3036 allowing users to create sophisticated extensions that do not require extensive coding capability, but that support full coding capability in selected languages and/or within any language (depending upon the configuration of the UDS platform 3000); a pack addition interface 3032 allowing users to browse a pack gallery 3012 to find packs that implement desired functionality and/or access selected resources; an assistance interface 3028 that guides users in creating extensions; and/or a sandbox interface 3030 that allows users to test extension aspects, formulas, authorization operations related to a pack, code elements, and/or utilization of external data and/or external services.

The arrangement depicted in FIG. 30 is a non-limiting arrangement illustrating certain aspects of the present disclosure. Any systems, apparatuses, components, devices, circuits, controllers, assemblies, or other elements of the present disclosure may be utilized with all or a portion of the UDS platform 3000 and/or client device 3010, and/or elements of the UDS platform 3000 and/or client device 3010 may be included with, in whole or part, any such systems, apparatuses, components, devices, circuits, assemblies, or other elements of the present disclosure.

The example UDS platform 3000 is scalable, and can function with multiple users (e.g., dozens, hundreds, thousands, and/or millions of users), including users simultaneously working with documents, and/or performing any other operations on the UDS platform 3000. Without limitation to any other aspect of the present disclosure, aspects of the present disclosure may be implemented by any systems, apparatuses, components, devices, circuits, assemblies, procedures, methods, or other elements as set forth in U.S. Pat. No. 10,466,867, entitled “FORMULAS”, filed on 27 Apr. 2017, which issued on 5 Nov. 2019, and which is incorporated herein by reference in the entirety for all purposes.

A unified document surface (UDS), as used herein, should be understood broadly. In certain embodiments, a UDS is a rendering of a document, doclet, and/or portion of a document on a UDS interface, for example as the document is visible to a user of the UDS platform. A UDS includes a capable document surface where a user can seamlessly include tables, figures, pictures, text flows, etc., where each element is fully capable to engage a formula engine and document model as supplied by the UDS platform. The UDS eliminates the need for distinct file types and/or interfacing between different document applications that are utilized by previously known document creation and editing applications. As used herein, a UDS may be a synonym with the underlying document in certain contexts, and/or the UDS may be the surface where a user creates, edits, views, or performs other operations in relation to a document.

A UDS interface, as used herein, should be understood broadly. The UDS interface is the view of the user to the underlying application for creating a UDS, a document, a pack, an extension, or the like. In certain embodiments, other interfaces utilized herein (e.g., reference FIG. 30) may be provided on the UDS interface—for example through menu selections, command lines from formulas that call up other interfaces, or the like. In certain embodiments, one or more other interfaces are provided separately from the UDS interface, for example a sandbox interface and/or an assistance interface for pack and/or extension creation and publication.

A document, as used herein, should be understood broadly. An example document is a corpus of information embodied as a snapshot, a snapshot plus an operation log, and/or among a group of shards. In certain embodiments, the entire corpus of the snapshot, shards, and/or operation log forms the document. In certain embodiments, one or more of these forms the document, and other ones of these are supporting information that may be redundant, where the document does not include the redundant information, and/or where the document is, in a certain sense, “overspecified” by the entire corpus of information, but all of the information is considered to be a part of the document. In certain examples and descriptions set forth herein, a “document” is referenced as accessed by a user, shared with other users, or the like, which may be only a view of the document or portions thereof as provided by the UDS interface, but referenced as a document for clarity of the present description. The set of information that physically embodies the “document”, and the notional logic of which informational aspects are the “document” and/or where the document exists, depends upon the context and conventions of the particular system, which will be understood by one of skill in the art having the benefit of the present disclosure. For example, the set of information that physically embodies the document, and/or the notional logic of where the document exists, may depend upon which elements of the total sum of information are considered to be primary information. Further, when multiple users are editing a document at the same time, multiple operation logs for the document may be created, for example with an operation log for each user. Those operation logs may be considered to provisionally form a part of the document, for example all or a portion of these operation logs may be rejected during de-confliction operations. In certain embodiments, a user may work with a document locally (e.g., where the user does not have connectivity to the UDS platform), where the document exists in a canon version on the server, and in a provisional local version for that user. Upon reconnection to the UDS platform, the local operation log of that user may be incorporated into the document (e.g., by recording on the server side operation log, and/or capturing in a snapshot operation). For some purposes, the local version of the document may be considered to be the “document”, and for other purposes (e.g., if those local changes are never sent to the server, and/or end up being rejected by the server), the local version of the document may be considered to have never been a part of the document. For example, if a snapshot is determined to be inconsistent with a shard—then if disambiguation or conflict resolution operations, for example by the document serving circuit, utilize the snapshot to determine the actual document content, then the snapshot could be considered to be the “document” for that embodiment. By contrast, if disambiguation or conflict resolution operations utilize the shard(s) to determine the actual document content, then the shard(s) could be considered to be the “document” for that embodiment. In certain descriptions, “document” is utilized to reference content that a user would casually consider to be the document, which may be a view of the document as provided on the UDS interface, and which may not include all available content based upon the permissions of that user, preferences of that user, display options of that user, and the like. In certain embodiments, “document data” is referenced herein, where the document data may be considered to be the document for certain purposes. These variations in the usage of document, document data, shard documents, and the like, are utilized for clarity of the present description, which deals with a complex utilization environment where documents are provided in different views to multiple users having multiple purposes and permission schemes, across multiple devices, and which can be changing rapidly due to publication events, collaborative editing by many users, and the like.

A circuit, as used herein, should be understood broadly. In certain embodiments, components having terminology such as a controller, a processor, or the like may be utilized instead of, and/or in conjunction with, a circuit, and accordingly those terms should be understood broadly with similar considerations to those presented with regard to circuits. Circuits, as used herein, include correlated aspects of the system configured to perform selected operations thereof, and can include logic gates, programmable logic circuits, interface devices (e.g., network communication devices and/or connecting hardware), I/O devices (e.g., user input devices such as a mouse, keyboard, touch screen, voice input, displays, etc.), any sensor utilized by the system, any actuator utilized by the system, processors or processing resources, computer readable memory, data stored in computer readable memory, or the like. In certain embodiments, aspects of a circuit may be embodied as instructions stored on a computer readable memory configured such that a processor executing the instructions thereby performs one or more operations of the circuit. In certain embodiments, as will be understood in the context of particular descriptions herein, a circuit includes any one or more of these, and/or is in communication with any one or more of these. The present disclosure depicts each controller, circuit, memory element, data structure, or the like, as a single device for clarity of the present description. A given controller, circuit, memory element, data structure, or the like, may additionally or alternatively be distributed, in whole or part. For example, the client serving circuit 2208 may be present, in whole or part, on any one or more of the controller 2238, a client device 2224, a workflow server 3011 (e.g., reference FIG. 30). In certain embodiments, the client serving circuit 2208 may have a distinct location at different times (e.g., operations with a first client device where the client serving circuit is partially positioned on the first client device during UDS interface operations by the first client device, and operations with a second client device where the client serving circuit is not included in any part on the second client device during UDS interface operations by the second client device—for example where the first client device has greater memory resources than the second client device, where the second client device has greater connectivity resources than the first client device, and/or where the document serving circuit 2206 determines that at least partial inclusion of the client serving circuit on the first client device will improve the first user experience). In another example, the controller 2238 may have elements (e.g., circuits, stored data, etc.) distributed across a number of servers, for example with supporting servers, workflow servers, or the like, performing at least some operations performed by the controller 2238. In certain embodiments, the distribution of a given controller, circuit, or other functional device may be changed at different times or different operating conditions, for example where a substantial calculation performed by the document sharding circuit is offloaded to a workflow server, where calculations supporting the document are sent to a workflow server and/or virtual machine, or the like. The utilization of circuit language emphasizes the coordination of aspects of the circuit to perform described functions.

Certain descriptions herein include an administrator, a document administrator, a caretaker for a UDS platform, or similar terms. The term administrator, as used herein, should be understood broadly. An administrator is any entity having a specified role with respect to the document, the document server, the client device, and/or an organization associated with the document. Non-limiting examples of an administrator include a specified person, a specific login or login type, a person having a specified role (in association to the document server; a client device; a computer system associated with the document server, document, and/or client device; the document; a project associated with the document; and/or a workflow associated with the document), and/or an entity with any of the preceding characteristics. In certain embodiments, an administrator is a person creating the document, creating a new version of an existing document, a person in a position of authority, and/or a person specified to have the administrator role for a given project, period of time, project deliverable, or the like. In certain embodiments, a user may be an administrator for certain operations, document sections, or the like, and not an administrator for other operations, document sections, or the like. In certain embodiments, and administrator is a “super-user.” The described examples of an administrator are non-limiting examples, and any operations or criteria to determine an administrator are contemplated herein.

Certain operations herein are described as being based upon and/or in response to a context, a contextual determination, a contextual indication, and/or determined or interpreted contextually. All of these and similar terms (“context parameters” in the present paragraph) should be understood broadly. Context parameters include, without limitation, a user, a user title, a user role, a user location, user permissions for the document, a time of day, an editing time for the user (e.g. time accessing the document, and/or time actively interacting with the document), whether the user created the document, whether the user is an administrator, the current operations being performed by the user (e.g. providing input, selecting a value, responding to a prompt, dragging a selected object, inserting an object, deleting an object, etc.), the time of day, a calendar date, relations of any of these to outside parameters (e.g. an end-of-month, end-of-year, outside of normal business hours, a change in regulatory jurisdiction due to location, or other determination), a data type being accessed by the user, an object type being accessed by the user, a time since the document has been synchronized or updated, a client device capability (e.g. memory, processor power, operating system, communication bandwidth, and/or currently available resources for any of these), an output type (e.g. screen size, color capability, printer type, available storage, and/or web page availability and configuration), a data source for one or more aspects of the document or document portion currently accessed by the user (e.g. size, age, and/or availability of linked or referenced data), a number and/or characteristics of users currently accessing the document, parameters from the document defined at creation or updated, rules for the document, default parameters for the document, a location within the document being accessed by the user, a total size of the document, a size of the document portion accessed by the user, and/or rules associated with the document (e.g. selected by the user and/or an administrator). As will be understood to one of skill in the art having the benefit of the disclosures herein, certain ones of the illustrative context parameters may be utilized for certain operations, and certain ones of the illustrative context parameters may not be applicable for certain operations. The illustrative context parameters are non-limiting, and further do not limit any descriptions herein utilizing context parameters.

A document view as described herein should be understood broadly. An example document view may be a portion of the document being accessed by the user. In certain embodiments, a document view includes information derived from, calculated from, and/or processed for viewing by the user, and accordingly a document view in certain embodiments is based upon, but is not a part of the document and/or the data element. A data element as described herein, when referencing a portion of the document (for example, a portion of the document communicated from a document server to a client computing device), should be understood broadly. A data element may be information derived from the document, a portion of the document, and/or all of the document. A data element may include data aspects that are not a part of the document, but that are associated with, linked by, and/or referenced by the document. For example, a data element may include aspects of source data that is not present within the document, but is passed from the document server to the client computing device.

An example system is described for implementing an extension capability for a unified document surface operating system. Any one or more aspects of the example system may be utilized with, provided as a part of, and/or incorporated with any systems, operations, and/or procedures herein. Additionally or alternatively, aspects of other systems set forth herein may perform one or more operations of a system for implementing an extension capability, for example with a document server 106 performing one or more operations of a document serving circuit, or other circuits, controllers, processors, or the like as set forth herein.

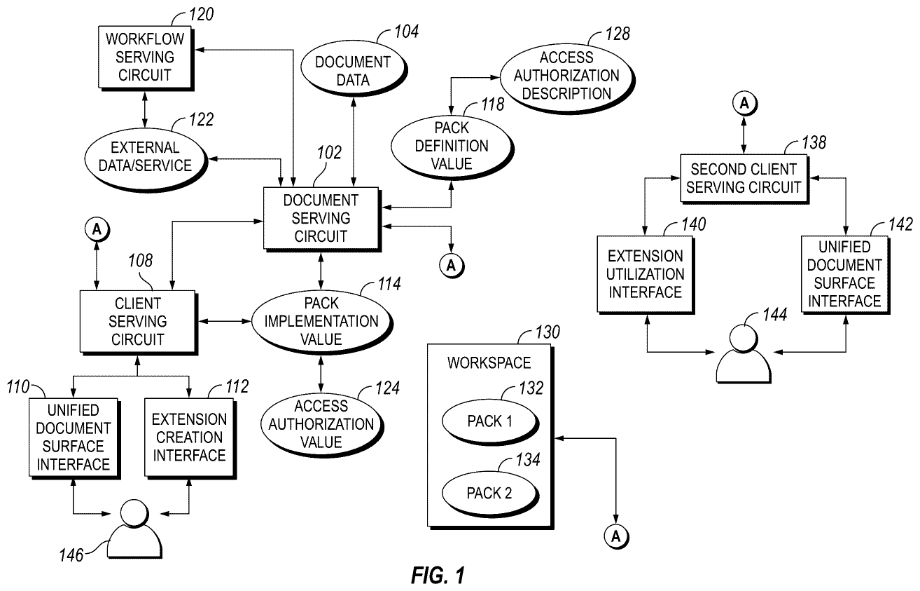

Referencing FIG. 1, an example system includes a document serving circuit 102 that accesses a document data 104. The example document data 104 includes data for a unified document surface, and the document serving circuit 102 provides at least a portion of the document data 104 to a client serving circuit 108. An example client serving circuit 108 implements a unified document surface interface 110 in response to the portion of the document data 104. For example, the document data 104 may be data utilized to create a document (e.g., tables, text flows, graphs, visualizations, formulas, etc.), where the unified document surface interface 110 provides a user 146 with a view of the unified document surface according to the context of the user 146 (e.g., permissions, portions of the document being accessed, preferences selected by the user, aspects defined by an administrator, etc.). The example client serving circuit 108 further implements an extension creation interface 112, and provides a pack implementation value 114 to the document serving circuit 102 in response to user interactions with the extension creation interface 112. An example extension creation interface 112 includes a dedicated interface allowing for a user to rapidly and conveniently produce an extension, for example using a software development kit (SDK), providing for menus, text entry, and other interface elements to utilize code, formulas, text entry, and/or any other aspect of a unified document surface as set forth herein. In certain embodiments, the pack implementation value 114 is converted into a pack definition value 118, by the document serving circuit 102 (and/or by a workflow serving circuit 120, for example as instructed by the document serving circuit 102). The pack definition value 118 provides the resulting aspects to be implemented by a unified document surface (e.g., a document) utilizing the extension created by the user 146. In certain embodiments, the pack definition value 118 may be the same as the pack implementation value 114, for example where elements of the extension may be utilized in a later document without any changes (e.g., a pack or extension including dedicated text, an inline formula operating using a formula engine native to the unified document surface environment, or the like). In certain embodiments, the pack definition value 118 may be determined from the pack implementation value 114, for example including code elements, data, formulas, or the like, that implement the aspects set forth in the pack implementation value 114. In certain embodiments, the pack definition value 118 includes referential information, relative information, automated code (e.g., efficient equivalent code), look-up data, external data, or the like, including references and/or pointers to these that may be stored elsewhere in the system (e.g., in the cloud, accessible to the document serving circuit, stored on the document serving circuit, stored and/or accessible using an external data source and/or external service, or the like).

An example system further includes the pack implementation value 114 including an access authorization value 124, where the pack definition value 118 includes an access authorization description 128. In certain embodiments, the access authorization value 124 includes authorization information to be utilized to implement the extension (or pack 132, 134). For example, the access authorization value 124 may include a username and/or password, for example to access external data 122, an external service 122, or to access protected elements of a document. In certain embodiments, depending upon the data or service utilized, according to selections from the author user, and/or according to permissions of the author user, an author user may implement an extension that allows other customer users 144 (e.g., interacting with a second client serving circuit 138) to utilize the authorization provided by the author user 146. For example, depending upon the permissions, subscription rules, or the like, of an external data or service 122 to be utilized, the author user creating the extension may allow other uses utilizing the extension (e.g., “customer users”) to utilize the authorization of the author user, allowing the customer user to utilize the data or service without entering or having separate authorization information. In certain embodiments, the access authorization value 124 may include identifying information for the external data or service 122, with the customer user having a separate authorization. For example, an external data element may be included in the extension, where customer users 144 would need separate login information to access those portions of the extension. In certain embodiments, the access authorization value 124 may include authorization information, allowing incorporation of the data and/or service 122 into the extension, without further authorization utilized during utilization of the extension or pack—for example where flat data, unlinked data, data at a fixed point in time, and/or periodically updated data, is included with the extension, and where utilization of the extension does not require additional access to the external data 122 or service 122 initially providing the data, at the time of utilizing an extension within a subsequent document. The access authorization description 128 includes the implementing information, including what authorization information is required from customer users, how often data and/or services are required to be updated, how often authorization information is to be updated, and/or other authorization criteria such as temporary and/or introductory access criteria, authorization requirements (e.g., password criteria, two-factor authentication requirements, etc.). In certain embodiments, the access authorization value 124 and the access authorization description 128 may contain the same elements, or may contain distinct elements.

An example document serving circuit 102 further exposes a pack 132 134, for example as constructed from the pack implementation value 114, access authorization description 128, and/or any other data, links, references, formatting, incorporated data, etc. An example operation to expose a pack includes publishing the pack to a selected workspace 130—for example a work group of defined users, within a defined category (e.g., productivity, accounting, legal, document authoring assistance, calendar management, etc.). In certain embodiments, publication of the pack 132, 134 is provided to all users (e.g., all users having access to the unified document surface environment). In certain embodiments, publication of the pack 132, 134 is organized among a number of packs in a gallery or similar implementation, for example to highlight groups of similar packs, packs from selected authors, packs that are popular among customer users, packs listed according to selected categories, or the like. In certain embodiments, publication of a pack includes differential implementation of pack visibility vs. usability (e.g., showing only packs that can be used by a customer user, showing packs that are available but may require a subscription for the pack, installation of additional supporting features, subscription to external data and/or services, etc.).

A pack, an extension, or similar terminology, as utilized herein, should be understood broadly, and includes a functional element created by an author user, and available for incorporation into subsequent documents, such as documents created using a unified document surface environment. Without limitation to any other aspect of the present disclosure, a pack may include any one or more of: flat text flows (e.g., configured text that appears with the pack as entered by the author user); referential text flows (e.g., configured text that appears using contextual information such as a username, current data, path locations, etc.); formulas (e.g., inline formulas native to the unified document surface environment); executable code (e.g., code implemented in any language, such as JavaScript, Python, C++, etc.); tables (e.g., configured and/or formatted tables, and/or criteria to configure selected tables, which configuration may be determined according to aspects of a document using the pack; aspects of a customer user such as permissions, roles, etc.; according to data brought in with the table and/or entered into the table, etc.); action values (e.g., sending of messages, making calendar entries, providing notifications, interacting with a 3^{rd} party service, etc.); formatting operations (e.g., setting conditional formatting for the document or portions thereof; and/or determining formatting relative to best practices and/or defined norms such as entered by the author user and/or provided by a 3^{rd} party service, etc.). Example and non-limiting formulas include one or more of: a unified document surface interface formula; a code based formula; a third party formula; or a column formula. Without limitation to any other aspect of the present disclosure, a pack may be utilized to: implement a document template; provide for a library of useful functions (e.g., math operations, accounting operations, workflow operations such as time entry, data access, project updates, industry-specific calculations and/or operations, etc.); execute complex algorithms or code; access and/or update external data; access and/or integrate external service(s); ensure that selected language is included and/or properly provided in a document (e.g., implementing terms of service, disclaimers, legal language, human resources language, etc.); and/or ensure consistency of appearance of selected elements (e.g., tables, reports, visualizations, etc.). In certain embodiments, a pack may be incorporated into a specific document, for example where a customer user implements the pack for utilization in a second document. In certain embodiments, a pack may be incorporated into a unified document surface interface—for example where a customer user implements a pack to be available within the native unified document surface environment (e.g., creating an enhanced environment for all documents of the customer user, similar to an add-on or extension for the entire document creation and/or editing environment for the customer user). Descriptions herein reference incorporation of a pack into a second document for clarity of the describing embodiments herein, but all embodiments, descriptions, and operations herein should be understood to contemplate incorporation of a pack into a document and/or into a unified document surface interface.

An example system includes a second client serving circuit 138 that accesses the pack 132, 134 (e.g., through interaction of the customer user with the extension utilization interface 140, for example selecting the pack from a selected workspace 130 or other organizing construct for packs available to the customer user), and incorporates at least a portion of the pack 132, 134 into a second document in response to customer user interactions with the extension utilization interface 140. In certain embodiments, the second user 144 accesses the second document utilizing a second UDS interface 142. An example pack 132, 134 may include a number of features that can be selected—for example selection of certain tables, formulas, code elements, data elements, or the like from a menu of options available with the pack and exposed to the customer user via the extension utilization interface. In certain embodiments, incorporation of the pack 132, 134 may include exposing formula libraries, available data, or the like, to the customer user, without direct appearance of pack elements in the document. For example, a pack including a formula library (e.g., selected math functions) may be incorporated in a document by providing the extended formula set (e.g., the formulas available in the formula library) to be available to the customer user. In the example, the pack is incorporated into the document, even if the document content has not changed due to incorporation of the pack (e.g., before the customer user includes a formula from the extended formula set into the document body).

An example system includes the document serving circuit 102 isolating the access authorization description 128, or portions thereof, from the second client serving circuit 138. For example, authorization information may be required for a pack to access a particular element of the pack, such as external data 122, an external service 122, and/or to confirm that the author user has proper permissions to implement aspects of the pack. In certain embodiments, the document serving circuit 102 accesses the particular element of the pack utilizing the access authorization description 128, and inserts the resulting information into the document (and/or into the pack menu, and/or into any other element of the extension utilization interface and/or unified document surface interface implemented by the second client serving circuit), without the authorization information (e.g., usernames, passwords, hash values, tokens, etc.) being communicated to the second client serving circuit 138. In the example, the isolation of the access authorization description 128 prevents either inadvertent or malicious exposure of the authorization information to the customer user 144 (e.g., which could be accessed via memory cache inspection, source code inspection, network communication spying, or the like). Additionally or alternatively, authorization information may be passed to and/or utilized by the second client serving circuit 138 in an encrypted form, and/or may be utilized directly (e.g., for a low risk activity, according to selections made by the author user, according to a role and/or permissions of the customer user, etc.). In certain embodiments, one or more aspects of the access authorization description 128 may be isolated, and other aspects may be communicated to the second client serving circuit 138.

An example pack definition value 118 includes an external data access value. External data may be any type of external data as set forth throughout the present disclosure. Example and non-limiting external data includes one or more of: an authorized data access; a 3^{rd} party data access; an external data value determined at a time of creating the pack implementation value; an external data value determined at a time of determining the pack definition value (e.g., while parsing the pack implementation value); an external data value determined at a time of incorporating the pack into a second document; an external data value provided as live data (e.g., updated continuously, and/or on a short time frame such as hourly, daily, etc.); and/or an external data value provided as selectively updated data (e.g., updated periodically; updated according to specific events such as changes to the document, project milestones, event-driven updates, according to determined changes in the external data, etc.).

An example system supports implementation of an arbitrary code component within the pack implementation value (and/or pack definition value). In certain embodiments, execution of arbitrary code, for example from a code element provided in a coding language that is not native to the unified document surface environment, and/or a code element provided where implementation makes validation and/or security confirmation of the code element prohibitive prior to utilization of the code element impractical, introduces risks to the system (e.g., the document serving circuit and/or the second client serving circuit). In certain embodiments, operations of the document serving circuit protect the system from malicious and/or defective code elements included in a pack, allowing for inclusion of arbitrary code components within a pack while providing for an acceptable risk environment for the system and customer users. An example operation to protect the system includes operating a virtual machine for the code element. In certain embodiments, the virtual machine may be operated on the document serving circuit, and/or sourced externally, for example operating the arbitrary code component on a workflow server and/or cloud server (not shown) separate from the document serving circuit. In certain embodiments, certain operations of the arbitrary code component (e.g., accesses to external information or services, accesses and/or commands to hardware components or devices, and/or system commands such as to the second client serving circuit, to an operating system, and/or any other command that may have an element extending access outside of the native unified document surface environment) may be operated using a virtual machine, where the code component to be performed on the virtual machine could include an individual command of the arbitrary code component, a selected portion of the arbitrary code component, and/or an entirety of the arbitrary code component. In certain embodiments, virtual machine operations may be performed utilizing a serverless compute service (e.g., AWS Lambda, Kubeless, Google Cloud Functions, etc.). In certain embodiments, the outputs of the virtual machine execution are provided to the second client serving circuit after operation of the virtual machine, isolating operations of the arbitrary code component from the second client serving circuit and the native unified document surface environment, and intercepting malicious and/or defective code operations before devices within the native unified document surface environment are affected. In certain embodiments, code components may be operated at the time of creating the pack definition value—for example code components that access external data to be included in the pack. In certain embodiments, code components may be operated at the time of incorporating the pack into a second document—for example when a customer user selects the pack for utilization into the second document. In certain embodiments, code components may be operated at various times during the life cycle of the second document and/or unified document surface interface, for example and without limitation: during periodic updates of external data; during updates and/or installation of the unified document surface interface (e.g., where the customer user installs the unified document surface interface onto a new device, updates the unified document interface, and/or reinstalls the unified document surface interface); and/or while editing the second document. Operations to isolate arbitrary code components may be performed during any operations where the arbitrary code components may be performed.

An example document serving circuit 102 determines whether an update to the pack implementation value includes an incompatibility risk, which may be referenced as a “breaking change” herein. A breaking change, in certain embodiments, may be determined to be present any time that a pack is updated (e.g., where an author user makes any change to a pack, and re-publishes the pack as an updated version). In certain embodiments, the document serving circuit may determine that certain changes are a potential breaking change (e.g., changing a link, reference value, updating the access authorization value, adding a capability or access type that was not present for a previous version, etc.), and that other changes are not a potential breaking change (e.g., changes to flat text data, changes to comments, changes in formatting, etc.). It can be seen that, in certain embodiments, a change may be considered a breaking change for one user, system, or set of priorities (e.g., adding a table column may be considered a breaking change for one system), but may not be considered a breaking change for another user, system, or set of priorities (e.g., adding the table column may not be considered a breaking change for another system). In certain embodiments, aspects of the pack may be utilized to determine whether a breaking change is present (e.g., if calculations are directed to a column, and columns are moved, the movement of the columns may be considered a breaking change).

The example document serving circuit 102 may perform certain operations to manage changes in response to a breaking change (and/or a potentially breaking change). An example document serving circuit provides an incompatibility warning to the client device (e.g., the client serving circuit and/or second client serving circuit), for example letting the author user know that the pack update may break user functionality, and/or letting the customer user know that an update to the pack may break the functionality of the pack. An example document serving circuit provides an update option value to the second client serving circuit accessing a document (and/or using the unified document surface interface) utilizing the pack. In a further example, updates to packs may be pushed (e.g., updates to the pack are enforced) in the nominal case, where an update to the pack that includes a breaking change may be operated to allow the customer user to delay (e.g., for a day, a week, and/or to a selectable time period) updating of the pack, and/or allow the customer user to avoid the update altogether (where applicable, for example where a customer user is allowed to arbitrarily extend an update period and/or continue using an old version of a pack). In certain embodiments, the author user may be able to indicate update behavior, for example allowing or preventing customer users to delay updates and/or use older versions. In certain embodiments, update behavior of packs may be determined in response to role(s) of the applicable user(s), an entity related to the applicable user(s) (e.g., entities having a special relationship to the unified document surface environment, such as subscribers, owners, controller, etc., may have differential permissions), subscription values and/or versions of the unified document surface environment related to user(s), and/or permissions of the user(s) in relation to associated packs, environment(s), and/or documents.

Certain further aspects of extensions and/or packs for a unified document surface environment are described following, any one or more of which may be utilized with and/or incorporated in any systems, circuits, procedures, and/or other aspects set forth throughout the present disclosure.

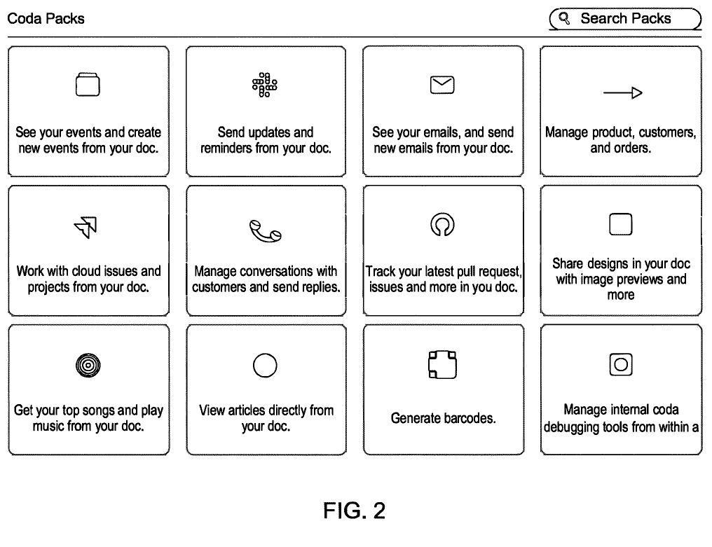

Referencing FIG. 2, an example pack gallery (or a portion thereof) is depicted. The example pack gallery depicts a view of available packs that may be presented to a customer user, including a searching feature that may be used—for example to search pack titles, keywords, descriptions, categories, authors, or the like. The example pack gallery is a non-limiting example. In certain embodiments, selection of a pack (e.g., on the extension utilization interface) may provide further details about a pack, provide installation and/or incorporation options for the pack, or the like.

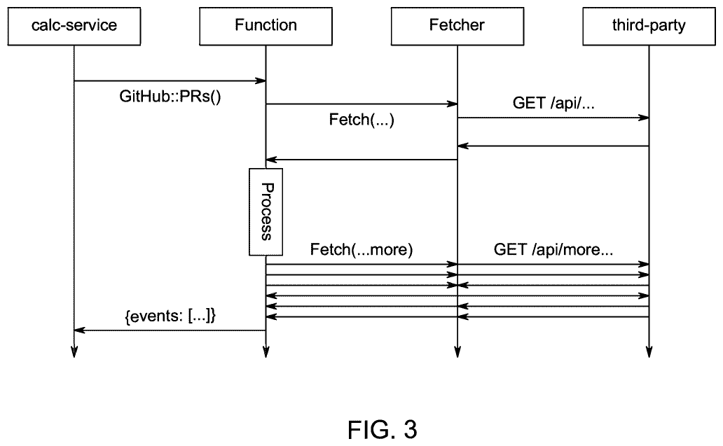

A schematic workflow for operating the formula snippet is depicted in FIG. 3. The example formula snippet includes access to external data using a fetcher component (e.g., operated on the document serving circuit, workflow serving circuit, and/or sourced to a serverless compute service, utilizes metadata related to the time and document, utilizes temporary storage, and isolates authorization credentials from being passed between devices. The example operation of FIG. 3 includes a rate limiting aspect, preserving resources and preventing certain malicious attacks or excessive resource utilization from poorly implemented code, while providing sufficient responsiveness for users (e.g., authors and customers) of the pack.

An example system controls flow of calculations and data, allowing for raw rate limiting, access sequencing control (e.g., FIFO, LIFO, etc.), and/or response to external signals (e.g., response time and/or outage of external data and/or service providers). In certain embodiments, statistical data about calculations and data flows, such as resource utilization, time or event-based graphs, cache utilization (e.g., access counts and/or size), and/or logged fault or error values, are stored and/or able to be accessed—for example by author users (e.g., depending upon authorization), administrators, or the like. In certain embodiments, error values are determined in response to one or more of: incorrect data (e.g., in a table, formula, etc., which may be determined based on specified ranges, calculated outputs, data types, etc.), authorization failure (e.g., expired or bad token, failed access, etc.), a bug in a formula (e.g., overflow, bad output, failed execution, mixed data types, etc.), and/or rate errors (e.g., slow-downs, rate limits, system outages, etc.). In certain embodiments, the extension creation interface provides error information related to a pack, for example categorizing and displaying errors during build and/or execution operations of the pack. In certain embodiments, statistics related to the pack may be made available to the author user, such as a number of installations, utilizations, unique accesses, subscription data, or the like.

An example system provides for a simple implementation to build a pack (e.g., converting the pack implementation value to the pack definition value) and/or to publish a pack (e.g., expose the pack to a workspace). In certain embodiments, the author user can access, visualize, and/or retrieve statistics and/or log data related to previous versions of a pack. In certain embodiments, the author user can revert a pack to a previous version, control the timing of an update, and the like.

An example system allows for sync tables—for example providing a table with a selected schema, retrieving the data for the table, controlling calculations related to the table, and building the table into a unified document surface, including providing the space and layout for the table, imposing editing restrictions, limiting data sizes (e.g., max columns or rows). In certain embodiments, calculation operations for a sync table are performed in a separate workflow—for example workload distribution between servers and/or serverless components—relative to a workflow for other document elements within the unified document surface environment.

An example system supports dynamic sync tables—for example by providing for parameterization of the target (e.g., document location responsive to the pack), and fully dynamic schema for sync tables. Example operations include providing a schema function, a function to determine the name for the target, and/or a function to retrieve a user-visible URL for the sync table.

In embodiments, a snapshot of a document may be a single file. In some applications, a snapshot comprising a single file may be inefficient and/or impractical. For example, for a large document, loading or transferring a snapshot file may take several seconds or even minutes for the whole file to be transferred and/or loaded on a client or user device. In some cases, a delay or a wait of several seconds or minutes for transferring and/or loading a snapshot file may be unacceptable for some users and/or applications.

In some embodiments, a snapshot of a document may be a plurality of files. A snapshot comprising a plurality of files may provide, in some instances and applications, improved performance in loading and/or transferring of snapshots, storage optimization, improved performance (speed, CPU time, memory requirements, and the liked) for updating of snapshots, and the like. For example, a snapshot may include a plurality of files, and the files may be created and/or prioritized. In some cases, user experience for transferring and/or loading snapshot documents may be improved by transferring and/or loading critical elements of the document first. In embodiments, critical elements may be elements that allow or are necessary for the partial rendering of the document, provide for at least a partial view of the data of a document, provide for basic interactivity or navigation of the document, and/or the like.

In embodiments, a snapshot of a document may include a plurality of files wherein each file includes partial information of a snapshot. As used herein, a shard is to be understood as a file that captures partial or incomplete information of a snapshot. The process of generating a plurality of files wherein each file captures partial or incomplete information of a snapshot is referred to herein as sharding of a snapshot. Sharding of a snapshot creates a plurality of shards. In certain embodiments, one or more shards may include information not found within a separate snapshot file, for example: metadata related to the shard (e.g., time stamps; relevant user information; resources that have access to, links to, and/or have accessed the shard (e.g., users, documents, services, devices, etc.); sharding recipes supported by the shard; update times and/or status values for the shard, or the like. In certain embodiments, a snapshot includes separate information that is complete for creation of the document, and each associated shard includes at least a portion of the snapshot. In certain embodiments, a shard includes separate information related to the document, where the snapshot and shards together include complete information for the document, with or without redundancy of any information within the document between the shards and/or the snapshot. In certain embodiments, the snapshot comprises a superset of information present within associated shards of the document. The snapshot may exist as a physical file or stored information, and/or may exist as a logical grouping of information from the associated shards. In certain embodiments, a common shard may be shared between more than one snapshot, for example a shard directed to basic functionality, a shared data set, a template for a document or object for a document, or the like.

In embodiments, sharding may be used to create shards for an existing snapshot file. In some embodiments, sharding may include splitting a file into a plurality of shards. In some embodiments, sharding may include processing, compressing, expanding, dividing, rearranging, and/or transforming elements of a file. Shard may include redundant or duplicate information such that multiple shards may include the same information for a snapshot. In embodiments, sharding may be used to create shards during a snapshot creation process from the operations log. In embodiments, sharding may be used to create new shards from existing shards. In embodiments, sharding may be initiated each time a new snapshot is generated. In some embodiments, sharding may be initiated when a document is requested and/or at specified intervals.

In embodiments, sharding may be performed according to different strategies or sharding recipes. Sharding recipes may specify aspects of each shard, such as how many shards should be generated, the size of each shard, the maximum size of each shard, the minimum size of each shard, elements associated with each shard, and the like. Sharding recipes may specify how to group elements into shards (such as grouping all table elements into one shard, or generating a different shard for each table, etc.), types of data transformations to be performed (binary encoding, compression, etc.), data, and the like. Sharding recipes may include ranking or prioritization for each shard that specify the order the shards may be transmitted or loaded when requested. Sharding recipes may be optimized, iteratively improved, or specific to different applications, device resources (client device and/or server capabilities), network characteristics (speed, cost, latency or network between client and server), document types, size of documents, frequency of access by users, number of users accessing a document, location of the document, and the like. In embodiments, multiple sharding recipes may be applied to one snapshot to generate multiple sets of shards. A shard set from the multiple sets of shards may be selected according to which set is most appropriate for a request.

In one example, sharding may generate a set of shards that includes at least two shards. The two shards may include a schema shard and a data shard. A schema shard may include schema data that may indicate the look and feel of a document and may aspects of the size of a table (number of columns, rows, width, name of table, name of columns, data types, etc.), aspects of the text (font, size, color, etc.), system tables, invalidation graphs, and the like. A data shard may include data that is used to populate the cells of the tables, text, and the like. In some embodiments, a set of shards may include a form shard that includes elements associated with a form of a document.

In another example, sharding may generate a set of shards that includes different shards for different elements of a document. The set of shards may include a canvas shard, table shard, page shard, grid shard, form shard, text shard, metatable shard, people shard, and the like.

In another example, sharding may generate a set of shards that facilitate faster-perceived loading of a document. The set of shards may include a critical shard that includes data necessary to render a user interface of the document. A critical shard may be designated as high priority and may be designated as the first or one of a first shard to be transmitted or loaded when a document is requested to give provide a basic view of a document while other shards are loaded in the background. The set of shards may include a canvas shard and grid or table shards for each page or table in the document. The canvas shard and grid or table shards may be prioritized based on the page or canvas of the document that is requested.

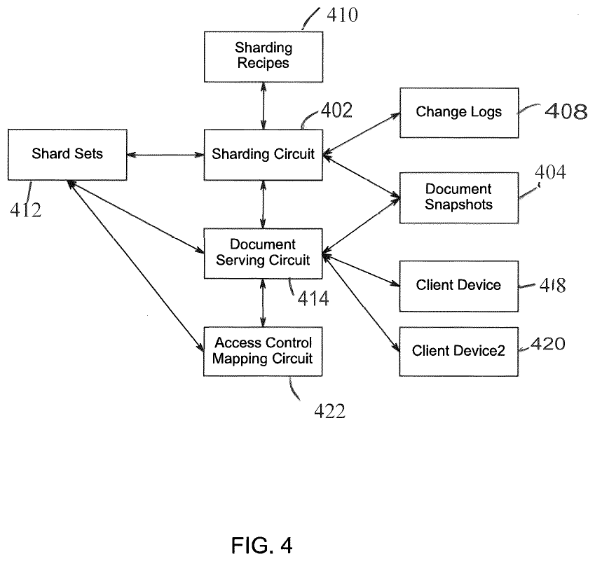

Referencing FIG. 4, an example system includes a sharding circuit 402. The sharding circuit 402 may access one or more document snapshots 404 or document change logs 408 and create shard sets 412 according to sharding recipes 410. In one example, the sharding recipes 410 may indicate when each recipe should be used. In one example, some recipes may be specified to be used with existing document snapshots 404, while other recipes may be specified to be used with change logs 408 of a document. Some recipes may be specified to be used to specific types of documents (such as read-only, editable, sharable, etc.), snapshots, locations of data, client devices, network conditions, document access history, and the like. The sharding circuit 402 may generate one or more shard sets 412. In some cases, not all sharding recipes 410 may be applicable, and only a subset of the recipes may be used for a snapshot 404.

The sharding circuit 402 may be activated in response to new or changed logs 408 and/or document snapshots 404. New elements in change logs 408 and/or updates to document snapshots 404 may trigger the sharding circuit 402 to generate a shard set 412 using one or more sharding recipes 410.

The sharding circuit 402 may be activated in response to a client device 418, 420 requesting a document. The system may include a document serving circuit 414 that may receive document requests from a client device 418, 420. The document serving circuit 414 may determine properties of the document (size, number of elements, etc.), properties of the client device 418, 420 (capabilities, memory, processing power, etc.), network conditions (bandwidth, latency, etc.), and/or the like. The document serving circuit 414 may include logic to determine if a document snapshot 404 should be provided to the client device 418, 420. The document serving circuit 414 may include logic to determine if a shard set 412 should be provided to the client device 418, 420. The document serving circuit 414 may include logic to determine if a shard set 412 may improve the responsiveness or the appearance of responsiveness of the document on the client device based on the capabilities of the device, network conditions, properties/content of the document, etc. The document serving circuit 414 may identify a particular shard set 412 from the shard sets that is most appropriate for the client device 418, 420 based on the capabilities of the device and other factors.

The document serving circuit 414 may determine the prioritization of the shards of a shard set 412 and transmit the shards to the client device 418, 420 according to the prioritization. In some cases, each shard set 412 may be associated with a table or metadata that identifies the prioritization or order for transmitting the shard. In some cases, the prioritization of the shards may be, at least partially, dynamically determined. In one example, the prioritization of the shards may be dynamically determined based on the request from the client device 418, 420. In one example, the prioritization may be determined based on the page or canvas requested by the client device. In response to a request for a specific page or canvas of a document, the document serving circuit 414 may identify critical shards and shards that include data related to the requested page or canvas. The shards that include data related to the requested page or canvas may be transmitted with higher priority (such as before) shards related to non-requested pages.

In another example, the document serving circuit 414 may trigger the sharding circuit 402 to generate a shard set 412. The document serving circuit 414 may provide the sharding circuit 402 aspects and properties of a client device 418, 420 generating a request for a document, and the sharding circuit 402 may generate one or more shard sets 412. In another example, the document serving circuit 414 may monitor requests from multiple clients and may identify access patterns for the documents. Access patterns may include the frequency of requests for certain documents, the locations within the documents that are accessed, the size of data transfers, the number of client devices 418, 420 requesting the documents, and the like.

In embodiments, access patterns may be used by the sharding circuit 402 to determine sharding strategies and/or recipes 410 for sharding. In one example, access patterns may indicate frequent access to one or more tables or canvases of a document and infrequent access to other elements. The sharding circuit 402 may generate a shard that includes the frequently accessed tables and canvases and identify the shard as a high-priority shard. In embodiments, the document serving circuit 414 may identify changes in access patterns and trigger the sharding circuit 402 to generate new shards based on the changes in the access patterns.

In embodiments, document serving circuit 414 may maintain a record of accessed shards and changes in shard to predict shards that may be cached on a client device 418, 420 and do not require retransmission.

The system may further include an access control mapping circuit 422. In some cases, documents may include sensitive information, and some users may be restricted or may not have permission to view or edits one or more parts of a document. In some embodiments, an access control mapping circuit 422 may identify elements of a document that are subject to access restrictions for one or more users. In one instance, sharding of restricted elements may depend on the size of the restricted elements, the location of the size of the restricted elements, the frequency of access of the restricted elements, and the like. For example, if the size of the restricted elements is large, all the restricted elements may be grouped together into one shard. In another example, if the restricted elements cannot be grouped into one shared group of different shards, the document may be created for different users based on their access authorization. In embodiments, the access control mapping circuit 422 may identify users' permissions and identify appropriate shards for the user that include or exclude restricted elements based on the user's permissions.

In embodiments, the system may generate or maintain user-specific shards. The user-specific shards may identify user-specific data, such as document preferences, user scratch data related to personal notes, edits, and the like.

In embodiments, shard sets generated by the sharding circuit 402 corresponding to different sharding recipes 410 may be independent of one another such that shards from one shard set cannot be used with shards from another shard set. In some cases, shards from different shard sets may be interchangeable or may be mixed. For example, one shard set may be generated based on a sharding recipe 410 for course sharding that generates a few large shards. Another shard set may be generated based on a sharding recipe 410 for fine-grained sharding that generates many small shards. In one example, course shards and fine-grained shards may be generated to be interchangeable. For example, one course shard may be equivalent to two or more fine-grained shards, and the shards may be mixed or interchanged based on current network conditions. For example, the loading of shards for one client may begin with the loading of course shards. However, as network conditions change (such as a decrease in network latency), fine-grained shards may be sent to improve performance over the faster network conditions.

In embodiments, shards 412 and sharding recipes 410 may be generated and/or modified via one more graphical user interfaces (GUI). In embodiments, the performance of each shard set, sharding recipe 410 may be tracked and the performance identified in the GUI. Performance may indicate loading or transmission times for specific network conditions or speeds. Performance may include user satisfaction ratings associated with each sharding method. Users may be asked to indicate if they are happy or satisfied with the performance of the document. Ratings from users may be associated with sharding recipes 410.

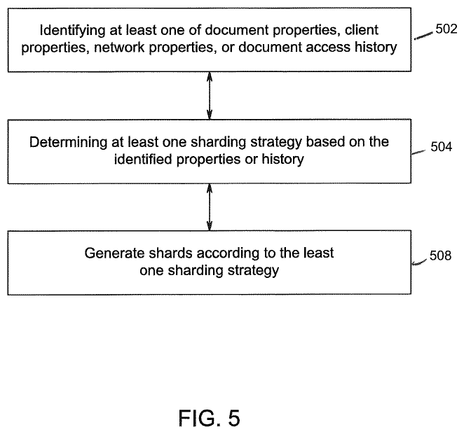

Referencing FIG. 5, an example method for generating shards includes identifying 502 at least one of a document property, client property or capability, network property, and/or document access history. The method may further include determining 504 at least one sharding strategy or recipe based on the identified properties of histories. The strategy may determine aspects of the shards such as the number of shards, size of shards, and the like, and the shards may be generated 508 according to at least one sharding strategy.

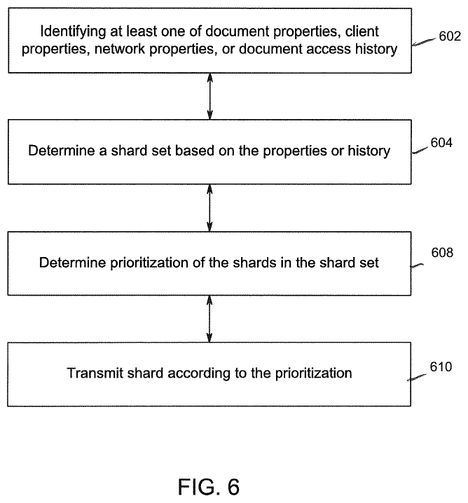

Referencing FIG. 6, an example method for transmitting shards includes identifying 602 at least one of a document property, client property or capability, network property, and/or document access history. A shard set may be identified 604 based on the properties or history. The shards in the shard set may be further prioritized. Prioritization 608 of the shards may be based on an objective such as user satisfaction, minimum time until the first element is rendered, minimum time until the first document is interactive, and the like. The shards may be transmitted 610 according to the prioritization.

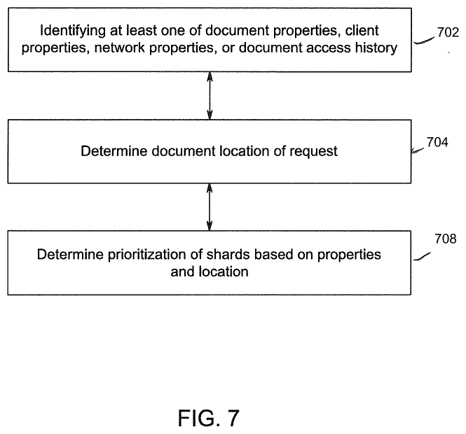

Referencing FIG. 7, an example method for prioritizing shards includes identifying 702 at least one of a document property, client property or capability, network property, and/or document access history. The method may further include determining 704 a location within a document that is requested by a client and determining 708 a prioritization of shards based on the properties and requested location. Prioritization of the shards may be based on an objective such as the minimum time until the first element is rendered, minimum time until the first document is interactive, and the like.

An embodiment of the present disclosure related to systems, procedures, and apparatus for performing operations to publish, organize, and perform group collaboration and review of documents is set forth herein. The system, procedures, and apparatus for publishing, organizing, and performing group collaboration and review of documents may be performed with, and/or incorporated with, in whole or part, any embodiments herein including, without limitation, systems, apparatus, circuits, controllers, devices, and/or procedures for executing a unified document surface, interfacing with external data, performing conditional formatting operations, interfacing with workflow servers, providing selected document access, interfacing with forms associated with a document, and the like.

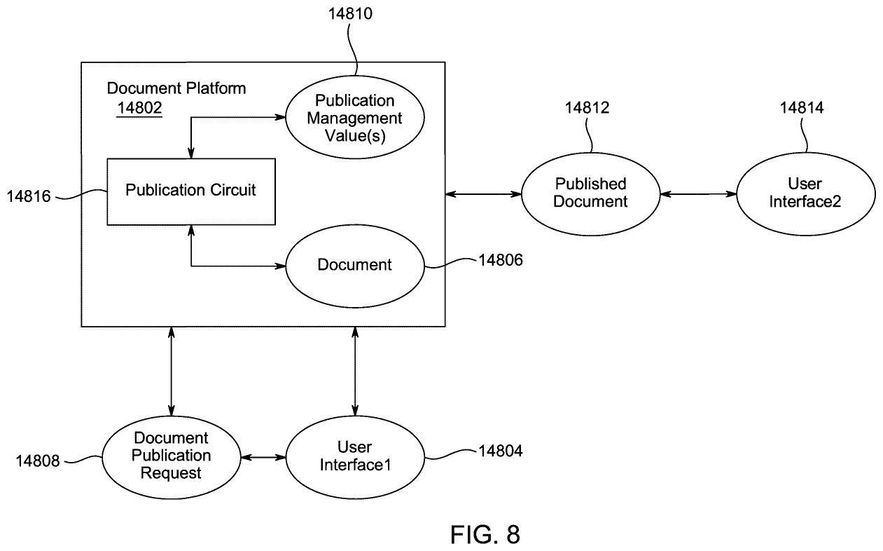

Referencing FIG. 8, an example system includes a document platform 14802, which may include a document server, workflow server, and/or any other computing device as set forth throughout the present disclosure. The example system includes a document 14806, which may be a unified document surface, that is created (in the example) by a first user interacting with a user interface 14804 to create, edit, and/or perform other operations with regard to the document 14806. The example document platform 14802 includes a publication circuit 14816 that performs operations to manage publication of the document 14806. The example publication circuit 14816 interprets a document publication request 14808, and determines publication management value(s) 14810 in response to the document publication request 14808. As will be understood with reference to the present disclosure, the publication management value(s) 14810 may be determined iteratively (e.g., with a number of interactions between the document platform 14802 and the user interface 14804), by providing prompts and/or menus to the user interface 14804, and/or may be defined by the user, for example executing operations to interact with an API of the document platform 14802 or the like. The example of FIG. 8 describes a single published document for clarity of the description, but a given document may have multiple published documents produced therefrom.

In the example of FIG. 8, a second user operating a second user interface 14814 accesses a published document 14812 provided by the publication circuit 14816 based on the document 14806 and the publication management value(s) 14810. The published document 14812 may be the same document (e.g., the second user can access the document directly, potentially with permission and display differences relative to the first user), a version of the document created for publication (e.g., stored separately from the document 14806 and/or created at the time of access by the second user, and which may be linked or unlinked from the document 14806), and/or a portion of the document (e.g., selected page(s), sections, tables, etc.).

The example of FIG. 8 depicting the document platform 14802 and user interfaces 14804, 14814 is an example for purposes of illustration. A given user may interact with the document platform 14802 using any device, and more than one user may interact with the document platform 14802 using a same device. Additionally or alternatively, the document platform 14802 may be a single device or a distributed device, and may be included in whole or part on a user device (e.g., a device executing a user interface).

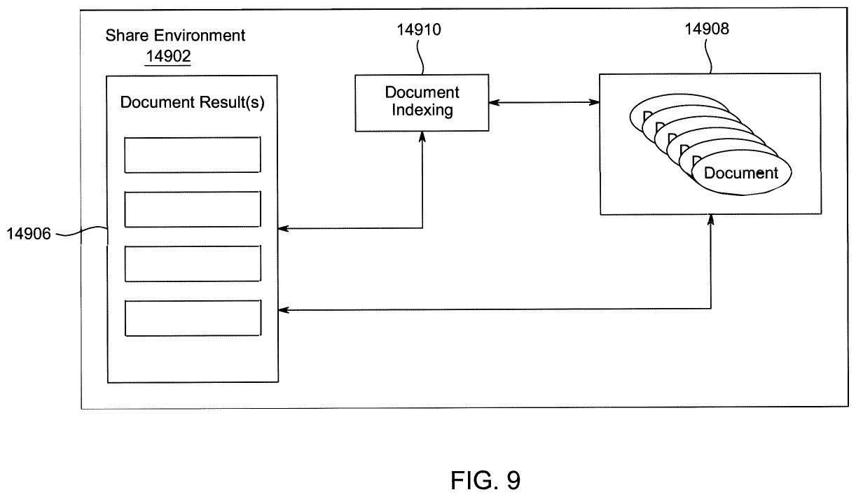

In certain embodiments, the publication management value(s) 14810 include a unique address for the published document 14812, for example a URL that is specific to the published document 14812. In certain embodiments, a document 14806 may be published more than once, for example with separate unique addresses for each publication based on the document. In certain embodiments, the publication circuit 14816 provides a suggested unique address, for example based on a user name of the user providing the document publication request 14808, and/or other values that provide information about the document source (e.g., an entity related to the document, tag or header within the document, etc.) and/or that support uniqueness of the name (e.g., a system time value, managed key list from the document platform 14802, etc.) and/or narrow the span of comparable names to support ease of providing a unique value. In certain embodiments, the publication circuit 14816 allows the user to determine the unique address for the published document 14812, whether providing an initial suggestion to the user or otherwise. After publication, in one example, a second user can access the published document 14812 using the unique address. In certain embodiments, the published document 14812 may be available through a share environment (e.g., reference FIG. 9), a direct address entry, and/or a link. The access of the second user may be subject to authentication and/or limitations as described herein.

An example publication circuit 14816 determines one or more suggested changes to the document, for example providing for margin suggestions, column widths, font selections, spacing selections, or the like, and provide the publication management value(s) 14810 in response to the suggested changes (and/or a user response to the suggested changes). The suggested changes may be applied directly to the document 14806, and/or may be applied only to the published document 14812. In certain embodiments, the publication circuit 14816 provides a user interface allowing the application of the suggested changes (and/or modifications to the suggested changes) to the document 14806 and/or published document 14812. In certain embodiments, suggested changes may be determined from standards (e.g., best practices, formatting and layout defined by experts, utilized by a given set of documents, utilized by exemplary documents and/or highly rated documents, etc.) and/or templates (e.g., defined by an administrator, by the user, by a person having a specified role, associated with a user or entity, etc.), and/or may be configured according to a context related to the published document 14812, such as a type of access of the published document (e.g., a web browser, dedicated proprietary program or viewer, etc.) and/or a type of device for access of the published document (e.g., a mobile device, tablet, laptop, desktop, media device, etc.). In certain embodiments, the published document 14812 may be provided with a different appearance and/or responsive to a different set of suggested changes based on the context related to the published document 14812, for example a context of the second user at a time of accessing the published document 14812.

In certain embodiments, the publication management value(s) 14810 allow for access control of the published document 14812, for example allowing an accessing user to only read the published document (e.g., view access), to edit the published document 14812 (e.g., edit access), and/or to interact with the published document 14812 in a more limited manner (e.g., play access). For example, a user having play access may be able to enter values (e.g., to run scenarios, check data, and/or create a limited local version of the published document) and/or see changes in response to entered values, but the entered values may not be saved back on the document 14806. Access control of the document may be provided for the entire published document, and/or for selected portions (e.g., a table, executable object, text flow, chart, etc.) of the document. The user can provide a single access type (e.g., all accessing users have a same set of permissions), and/or provide variable access types according to a list of users, user roles, entities associated with a user, and/or a user access type (e.g., users logged in to the document platform 14802 have a first type of access, and users accessing the document without a login, or anonymously, have a second type of access). In certain embodiments, blocked features (e.g., buttons or other executable objects, tables, text flows, charts, etc.) may be hidden from the view of the second user, and/or may be depicted for the view of the second user but not accessible. In certain embodiments, some blocked features may be hidden, and other blocked features may be depicted. In certain embodiments, access may be limited to certain operations, for example a table in the document may have permissions that allow the user to enter data (e.g., add a row) and/or edit existing data, but do not allow operations to add or delete a table, add or delete a column, change formatting, etc.

In certain embodiments, the published document 14812 may be exposed to external resources, entities, servers, controllers, or the like. The exposure of the published document 14812 may be determined by the user, and/or determined according to permissions given to other users (e.g., a fully public document may be exposed fully, where a limited document may not be exposed, exposed to only certain external resources, and/or portions of the document may be exposed where other portions are not). Example and non-limiting external resources include web crawlers, search engines, indexing resources, a share environment, or the like. For example, an operation to expose the published document may include an operation to allow indexing of the document by a search engine company. Another example operation to expose the published document may include an operation to provide the published document to a share environment, and/or to index the document for searching and/or other operations in the share environment.

In certain embodiments, the published document 14812 includes calculated and/or dependent data aspects, for example live values that are calculated based on data within the document 14806 and/or external data. An example publication circuit 14816 performs a pre-rendering operation, which may be stored as a data subset of the published document, providing for rapid access to portions of the published document such as static data values or text, etc. The pre-rendered portion of the published document may be conceptualized as a light content version of the published document that allows the second user to have immediate access to the published document, while hydration or other operations to prepare the full document can be performed separately, for example in parallel while the second user accesses the document. The pre-rendered portion of the document may be refreshed, for example periodically, based on detection of a change in the document, or the like. The pre-rendered portion of the document may include an associated context of the second user and/or can include versions based on the range of supported access types for the published document. Accordingly, the publication circuit 14816 may prepare and/or store multiple versions of pre-rendered portions of the published document.

An example pre-rendered document portion is prepared for a portion of the document, for example a first page, initial access position, a given section, etc. An example pre-rendered document portion is prepared for deeper portions of the document, such as successive pages, additional sections, etc. An example pre-rendered document portion is prepared for deeper portions of the document or related documents, such as linked documents (and/or sections of the document), related documents, or the like.

In certain embodiments, the second user may interact with the published document in a visible manner (e.g., using an identifiable user name), an invisible manner (e.g., anonymous access), and/or a mixed manner (e.g., using a pseudonym, unique identifier that is not visibly linked to the second user, etc.). In certain embodiments, the second user may access the document with freely selected visibility (e.g., anonymous, then identifiable, then anonymous), and/or may access the document with a lower visibility, but once the second user accesses the document in a visible manner the second user cannot revert to a lower visibility access. The visibility of access by second users may be set using the document publication request 14808 and/or by the publication circuit 14816. An example mixed visibility operation includes the second user accessing the published document utilizing a pseudonym (e.g., system generated, and/or editable by the second user).

An example publication circuit 14816 tracks and/or provides analytics, for example to the user interface 14804 and/or to another user (not shown). Without limitation, analytics may include views of the document, edits of the document, copy operations of the document, links to the document, and/or unique counts of these. In certain embodiments, the analytics may include user associations with any one or more of the elements (e.g., which user provided an edit, etc.) In certain embodiments, the analytics include document portion associations (e.g., related sections, tables, etc.) with any one or more of the elements. The example publication circuit 14816 provides at least a portion of the analytics to a selected user (e.g., the first user, or another user), for example as a standard report, summarized information, or the like. The example publication circuit 14816 may provide a more complete version of the analytics, for example the raw data and/or portions thereof, which may be provided as a separate document accessible to the selected user, as a table (e.g., in the document and/or associated with the document) accessible to the selected user, and/or exposed to selected users with an API that provides for accessing the analytics.

Referencing FIG. 9, an example share environment 14902 associated with a corpus of documents 14908 is schematically depicted. In certain embodiments, the corpus of documents 14908 is a related group of documents, such as all documents which a user has access to, all documents related to a particular entity, all documents having a selected metadata value, or the like. In certain embodiments, the corpus of documents 14908 includes published documents 14812 having a given access level (e.g., open to the public, limited to logged in users, etc.), and/or documents associated with the document platform 14802, etc. The example share environment 14902 includes a document results component 14906, which may be provided to a user interface. The example document results component 14906 is provided to selected users (e.g., as determined from the corpus of documents 14908, user preferences, or the like), and may be provided based on default settings and/or user interactions. An example document results component 14906 provides top-ranked documents from the document corpus, which may be determined according to a number of access events for each document, links to each document, and/or user ratings for documents. An example document results component 14906 may additionally or alternatively determine document results in response to search operations, filtering, selections (e.g., selected tags, categories, etc.), and/or other document aspects (e.g., utilizing certain types of formulas, document size, using certain object types such as buttons, charts, pictures, videos, etc.). In certain embodiments, user interactions can search the corpus of documents (e.g., searching for text, titles, authors, etc.), and/or select criteria utilized to rank documents within the corpus of documents (e.g., selecting categories, ranking criteria such as links vs. views, etc.). In certain embodiments, the document results are presented as links, cards (e.g., depicting the title, text or other feature causing a hit on the search, author, a subheading for a portion of the document, analytics related to the document, etc.), and/or previews of a portion of the document. A tag for a document may be a category (e.g., based on a documents content and/or intended purpose), and/or a metadata element allowing for relationship between documents utilizing any selected criteria. In certain embodiments, each document has a single tag that is utilized to determine the document results 14906. In certain embodiments, a document may have multiple tags, ranked tags, and/or weighted tags, for example allowing for a more granular and/or multi-dimensional determination of rankings and/or relationships between documents.

In certain embodiments, the share environment 14902 determines an index 14910 of the corpus of documents, for example to provide for efficient searching of the corpus of documents. The index 14910 may be updated periodically and/or in response to an event (e.g., upon a user request, in response to a change in the corpus of documents of a certain type, in response to a change in top ranked documents of the corpus of documents, etc.). In certain embodiments, the index 14910 may be specific to a user, to a group of users, to a selected corpus or portion thereof, and/or to a selected entity (e.g., for users associated with the entity and/or a corpus of documents associated with the entity).

An embodiment of the present disclosure related to systems, procedures, and apparatus for performing operations to provide selected document access and/or interface with forms associated with a document is set forth herein. The system, procedures, and apparats for performing operations to provide selected document access and/or interface with forms associated with a document may be performed with, and/or incorporated with, in whole or part, any embodiments herein including, without limitation, systems, apparatus, circuits, controllers, devices, and/or procedures for executing a unified document surface, interfacing with external data, performing conditional formatting operations, interfacing with workflow servers, publishing, organizing, performing group collaboration and review of documents, and the like.

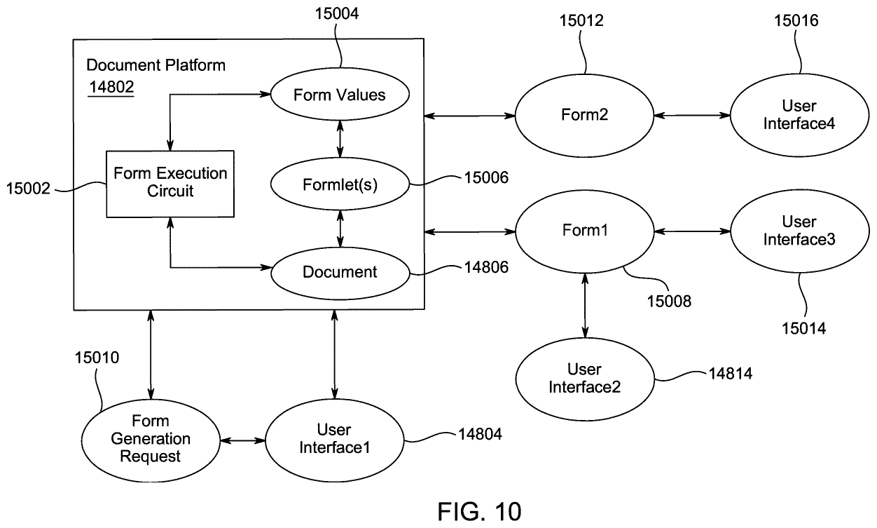

Referencing FIG. 10, an example includes a document platform 14802 having a form execution circuit 15002 that performs operations to provide forms 15008, 15012 relating to a document to user interfaces (e.g., 14814, 15014, 15016). A form, as utilized herein, should be understood broadly, and includes an accessible portion of the document 14806, where the user interface accessing the form does not have direct access to the document 14806. For example, a form may be utilized to collect information from users, to survey or get feedback from users, to allow users to request information, goods, or services, or the like. In certain embodiments, the form execution circuit 15002 exercises a user interface 14804, allowing a user to prepare a form for a document 14806. In certain embodiments, operations to prepare a form are limited to a document author, authorized user, administrator, or the like. In certain embodiments, the user provides a form generation request 15010 to the form execution circuit 15002 to prepare the form. Operations to provide the form generation request 15010 may be iterative, based on menus or prompts, form templates, or the like. In certain embodiments, the form generation request 15010 is captured as form values 15004, which may include the form generation request 15010 or aspects thereof, and/or may be generated in whole or part in response to the form generation request 15010. In certain embodiments, the form execution circuit 15002 prepares a formlet 15006 in response to the form values 15004. After the preparation of the formlet 15006, the form values 15004 may be deleted or retained (e.g., to provide information for the user interface if the user creates a new form, wants to load an old form, etc.). The formlet 15006 includes information from the document 14806 and/or other sources sufficient to prepare a form 15008 upon request by a user. In certain embodiments, the formlet 15006 includes pointers or sufficiently unique identifiers to be able to pull information from the document 14806 when creating a particular instance of a form. In certain embodiments, the formlet 15006 includes data from the document, for example text flows, form headings, table and/or column titles, or the like, and/or may further include table data (e.g., a list of parameters, for example to support a drop down menu to be utilized by a user interface interacting with the form). The selection of utilizing data stored in the formlet 15006 or data accessed from the document 14806 may be made by any criteria, including determinations of a size of the formlet, user experience interacting with the form, the size of the associated data, selections by the user creating the form, workload balancing between a user device and the document platform, or the like. In certain embodiments, a formlet 15006 can be conceptualized as a child document, where the document 14806 is a parent document, and where the child document is configured to provide only selected elements of the document 14806 to users of the form, and to allow for limited and controlled editing of the document 14806, for example in response to a submission of the form, without providing access to the document 14806 to those users. In certain embodiments, the formlet 15006 is not identifiable or usable as a document apart from the existence of the document 14806.

In certain embodiments, a form is present within a document 14806—for example a form in one section of the document may include information from another portion of the document (e.g., text, headers, a table display, etc.), and/or may be utilized to add information to another portion of the document (e.g., data input into the form is entered into a table in another portion of the document). The underlying document 14806 may be visible to the user in whole, for example where a form is utilized for the convenience of the user, not visible to the user (e.g., the form section is the only section visible to the user), or visible to the user in part (e.g., some portions of the document are visible to the user and some are not). In certain embodiments, a form is external to the document 14806, and acts in some ways similarly to a published document 14812 (e.g., reference FIGS. 8-9 and the related descriptions).

In certain embodiments, a form is published to selected users, to a selected corpus of documents, to the public generally (e.g., available to anyone having the address of the form), and/or only to users of a document platform 14802 (e.g., associated with a particular entity, service, server, application, or the like). In certain embodiments, a form may be created, but a user selection can determine whether the form is published or hidden. For example, the user creating the form may remove the form from publication (e.g., interfacing an object responsive to an “accept submissions” toggle or other selection by the user), such as during creation and/or verification of the form, during periods when further data submissions from users of the form are not needed or desired, and/or to edit or update the form, and then place the form into publication (or back into publication) to allow users to utilize the form.

An example form execution circuit 15002 provides a form to a user, accepts a submission of the form from the user (e.g., the user enters selected data and hits a “submit” button or exercises a similar executable object), and performs selected actions in response to the submission. In certain embodiments, the form information is submitted as entries in one or more tables of the document 14806, and/or a target document (e.g., a first document may be utilized to develop and/or generate the form, and a second document is utilized to capture data submitted by the resulting form). The information captured from the form may go beyond the submitted data, for example including user information about the submitting user, time stamps, versions of interface tools (e.g., web browser, proprietary software, etc.) utilized, time spent accessing the form or fields thereof, and/or any other data or metadata associated with the interaction of the user with the form. In certain embodiments, the activities performed in response to the submission, including information captured, is determined by the form execution circuit 15002 in response to the interactions related to the form generation request 15010. An example form execution circuit 15002 performs a rationality check on submissions, for example detecting inadvertently repeated submissions or the like.

An example form execution circuit 15002 operates a form creation tool, where the user creating the form can utilize menus and/or selections to create and/or configure a form. For example, the user may select the document or a portion thereof (e.g., a table, text flow, or the like), and generate a form therefrom. In certain embodiments, the user may select a form from a template of forms to begin creation of the form. In certain embodiments, the form creation tool allows for permission setting (e.g., a user list, login requirement, associated information allowing access to the form, etc.) and/or a publication setting (e.g., scope or visibility of the form, how the form or existence of the form gets communicated to users, etc.) for the form. An example form creation tool creates a unique address for the form, for example including a suggestion and/or allowing the user to edit the suggested address.

In certain embodiments, data fields of the form may be validated data fields, for example where the data field has a selected format, and/or a selected format is supplied after the user enters data into the field. In certain embodiments, a formula engine is provided that allows for complex validation criteria, for example requiring that data fall within selected ranges, a comparison of entered data to other parameters (e.g., time values, external data, minimum or maximum values, expected values, etc.). The example embodiment supports multiple validation criteria for a data field, and the form execution circuit 15002 (e.g., as stored operations in the formlet and/or as a runtime operation by the form execution circuit) to provide a selected validation message, for example when the user enters invalid data, leaves a data field with invalid data present, and/or attempts to submit the form. The validation message may be configured for each data field, for each validation test, as a general indication of which fields are not valid, or the like. In certain embodiments, the lack of data in a given data field may be invalid (e.g., a required data field). In certain embodiments, the validation message is provided by a formula, for example allowing the recitation of the invalid data in the message (e.g., “You entered 145. Please enter a value between 0-99.”), utilization of the user's name, the inclusion of external data, or the like.

An example form creation tool allows for hidden data to be provided in the form—for example to sort a table on a column that is not depicted on the user interface. In certain embodiments, hidden data may be provided for the convenience of the user, but present in the form data such that a sophisticated user (e.g., accessing communications between the user device and the document platform, metadata related to the form, cached information related to the form, etc.) could access the information. In certain embodiments, hidden data may be provided for security purposes—for example hiding the names of persons, data fields present in an underlying table of the document where a displayed column was sourced (e.g., a listing of names on a form generated from a table of the document that also includes salary information), or for any reason where the data is not intended to be accessible to the user. Where the data is not intended to be accessible to the user, the data may be removed (e.g., the table is sorted using the hidden data on the document platform, and then only the redacted table is sent as the form), and/or encrypted in place (e.g., present on the user device, but only as encrypted). In certain embodiments, the form creation tool provides a convenient user interface element to block utilization of certain types of data (e.g., people, health information, financial information, etc.) to prevent inadvertent access of those types of data to a user of the form. In certain embodiments, the form creation tool provides a convenient user interface element to remove hidden data, such as lookup table data (e.g., a column used as a lookup but not intended for display) and/or sorting table data (e.g., a column used to sort data, but not intended for display), to prevent inadvertent access of those columns to a user of the form. In certain embodiments, hidden data can be utilized in providing the form to the user interface, for example hiding some fields from some users (e.g., allowing for a form to provide different fields to different portions of a group—such as an invitation providing distinct selected information to the bridal party vs. the groom party).

An example form creation tool allows for the user to select tables from the document, and/or to filter, search, and/or hide columns from selected tables for utilization in the form. An example form creation tool allows the user to include table data, text flows, charts, or the like as a flat data element (e.g., utilizing data as available at the time of the creation of the form), and/or to utilize active data elements from the document or external data. In certain embodiments, if the user edits the form, then the published form is updated automatically—for example a next user accessing the form will see the update to the form. In certain embodiments, editing of the form is restricted while the form is published, and resumed if the form is withdrawn from publication (e.g., status changed to “not accepting submissions”).

An example form execution circuit 15002 operates the user interface to display form results, for example determined from submission events of the form. In certain embodiments, the form results may be provided as data entries on a table of the document, and/or stored in another document associated with the document and/or the form. An example form execution circuit 15002 provides information such as a view of the data, filtering options for the data, selection options for the data (e.g., time ranges, data entered since a last check, lifetime data entered, etc.), aggregated data, summarized data, statistical descriptions of the data, etc. In certain embodiments, one or more aspects of information captured with the submission may be included with the data, either to be utilized for selection criteria, to summarize and/or process selected portions of the submitted data, to determine data by user, or the like.

The example of FIG. 10 depicts a first form 15008 and a second form 15012. The example forms 15008, 15012 are associated with the same document 14806. In certain embodiments, the forms 15008, 15012 may related to the same or distinct data—for example submissions of the first form 15008 may be added to a first table of the document, and submissions of the second form 15012 may be added to a second table of the document, or the submissions from each form 15008, 15012 may both be applied to a same table of the document (e.g., where the forms 15008, 15012 are created for distinct user types, configured for specific types of user devices, etc.). The submitted data from a form may be provided to any portion of the document (e.g., a table, text flow, section, etc.) and/or may be provided in whole or part to another location (e.g., a separate document).

In embodiments, elements, such as packs, may be used to extend document functionality and integration with other applications, services, and/or programs. A pack may be created to perform calculations, generate unique displays and graphics, manipulate data, query external data sources, and/or the like.

In embodiments, packs may be authored using a packs creation interface that may be part of the unified document surface of a document. Pack authoring may include an interface for specifying one or more of code, scripts, modules, and the like. Packs may be authored in one or more programming languages and may leverage one or more code libraries and functions available for the programming language. Packs may include access to functions and capabilities of a document surface of a document. Packs may be authored using one or more authoring tools and may be authored by writing code, with a drag and drop interface for selecting and arranging code elements, graphical code builders, and the like. Packs may be authored using one more browser based code editors, software developer kits (SDK), integrated development environments (IDE), code editors, and the like. Authoring tools may include one or more of contextual tools to identify, validate, and/or populate code and functions of the pack and may include tool tip functions, side bar help panels, code examples, and the like. A pack may be authored to import data from a source outside of a document and convert the data such that it can be represented and manipulated using formulas, functions, visualizations, and methods available to the document surface.

Authoring tools may include one or more test and debugging tools such as tools for sandbox, command tools to test data connections, authentication management, and the like. Authoring tools may include an option to run a pack in sandbox environment that isolates the pack from deployed documents during testing. In embodiments, authoring tools may include error detection/validation at build time.

An authored pack may be published using one more publishing interface. Publishing a pack may store the pack in a pack repository. The pack repository may be unique to one or more users, may be public to all users, and the like. An author that publishes a pack may select publications options as to the destination, permissions, and the like. A pack may be published to a pack marketplace allowing users to buy, sell, and/or trade packs.

A pack publishing interface may include version tracking and management. Publishing a pack may generate a record of the version, date of publishing, description of the pack and the like. A new version of a published pack may be automatically pushed to users and the pack may be updated to the new version of the pack in a document. In some embodiments, updating of the pack may be configured according to one or more author settings, document settings, user settings, system settings, and the like. The setting may be governed by a hierarchy, permissions, and the like. In one example, author settings may take precedence over user or document settings. In another example, author settings may take precedence over document settings based on the relative permission or status of the author of the pack and the document owner. In one example, settings associated with a higher rated user may take precedence over settings of a lower level user. In embodiments, settings may include one or more of automatic updates (where packs may be updated whenever new versions are available, notifications based updates (new version notifications may be provided to users and new versions are installed based on user selections), grace period updates (users may be given a time period to defer updating to new version after which the update may be installed automatically, developer control updates, and the like. Updates may depend on the type of updates. Security updates may be required while other updates may be deployed as a notification upgrade or a grace period update.

A pack may be installed into a document by associating the pack with the document. An association may be generated by dragging and dropping the pack into a document from a library of packs, from a marketplace of packs, and the like. Associating a pack with a document may initiate a configuration stage for the pack. Configuration may include at least one of defining options for the pack, defining or selecting a behavior of the pack, defining or selecting the appearance of the pack, defining or selecting data connections, defining or selecting account information, and the like.

In embodiments, defining a configuration of a pack may include defining access authorization. In some embodiments, access to the functionality of the pack, data associated with a pack, and the like may be defined by access authorization. Access authorization may be defined for each pack during configuration. Access authorization may indicate users, groups, types of users, and the like that are allowed to access a pack in a document and/or which set of features in the pack are accessible to the users. In some embodiments, pack authorization may be inherited or based on the authorizations associated with the document in which the pack is installed. In some cases, access authorization of a pack may limit the authorization to a subset of the users and/or groups that are associated with the document. A pack that is installed in a document may be configured to evaluate the credentials of a user viewing the document and determine if the user has access authorization to the document. In the case of unauthorized users, a pack may be hidden in the document, inoperable, and/or shown as a placeholder to the user.

In embodiments, the display of the data, visualizations, source of data, and the like associated with a pack may depend on access authorization of the user viewing or accessing the document. In some embodiments, access authorization of a pack may be propagated from the credentials used to access the document. In one example, an installed pack may be configured to access a calendar of a user and provide a summary of appointments in a document. The access authorization of the pack may change based on the user viewing the document and the pack may retrieve and display different data for different users viewing a document in which the pack is installed.

Configuration of a pack may be defined using a graphical user interface and may include graphical elements for making selections (such as text boxes, drop-down menus, calendars, and the like).

Associating a pack with a document may include providing specifications for the inputs and/or outputs to the pack. A pack may take as input one or more data that is in a document or is associated with a document. Providing input data specification may include defining a range of data, location of data, preprocessing steps for data, and the like. Providing output data specification may include selecting a range of output data, selecting post processing steps, and the like.

Packs installed into a document may be executed according to a pack execution configuration. A pack execution configuration may be defined on various levels of hierarchy such as per pack, per user, per document, per workspace, per enterprise, and the like. In some embodiments, the execution configuration may inherit configurations based on a defined hierarchy. In some embodiments, a pack may be configured to execute when a document in which the pack is installed is accessed. In embodiments, a pack may be configured to execute according to the pack execution configuration of the user accessing the document. In some embodiments, a pack may be configured to execute according to user input. A user may initiate execution of a pack by selecting the pack in a document, requesting data from the pack, providing data for the pack, and the like. In some embodiments, a pack may be configured to execute in response to push notifications from external data sources when data in the external source is updated. In some embodiments, a pack may be configured to execute in according to a schedule, timer, number of accesses, the freshness of data, and the like.

In embodiments, packs may execute at a client device used to view a document. In some embodiments, packs may execute server-side. In some cases, parts of a pack may execute on a client and some parts of the pack may execute server-side. Selection of parts of a pack for the location of execution may be in response to properties of elements of the pack such as the author of the elements, types of operations in each element, and the like. For example, elements authored by trusted parties or elements that include formula operations may be enabled to execute on a client device while other operations relating to authentication, accessing external data, and the like may be configured or required to execute server-side.

In one embodiment, packs may be stored and executed server-side. In embodiments, document users may be provided with an option to install a pack into a document from a selection of packs that are stored on a server. An authored pack may be available for installation into a document only once the pack is released by the user and transferred to a server. In some embodiments, elements such as code, logic, input and outputs, and the like of the pack may be evaluated after the pack is transferred to the server and before the pack is available for installation into a document. Evaluation of the pack may include scanning of the code of the pack for malicious code. Evaluation of the pack may include comparing the description of the pack provided by the author with the function of the pack during execution. Packs that are detected to include malicious code or appear to have different functionality to what was described may be flagged by the server and the packs may not be provided for installation.

Packs that are stored on the server may be installed in a document. When needed (such as when a document is accessed by a user) the pack may be triggered for execution on the server. Triggering a pack for execution may include providing, from the document where the pack is installed, input data for the execution of the pack. The server may execute the pack using the input data from the document if any. The server may be configured to transfer data requests from the pack to third-party data sources. The pack may be configured to receive data from third-party sources, perform additional post-processing and/or calculations to generate output data for the document. The server may transfer the output data for display in the document.

The server-side execution environment for executing the packs may include protection against malicious or faulty code and/or malicious adversaries. Protection may include multi-tier protection which may include executing packs in a sandbox environment that is associated with a different account than document data whereby if the account of the sandbox environment was to be compromised, the document data would not be available to the compromised account and server. Multi-tier protection may include implementing the execution environment in a serverless infrastructure that uses cloud-based services. The cloud-based services may distribute execution among many different servers thereby eliminating dedicated servers that may fail or be exploited. Multi-tier protection may a virtual environment implementation for the execution environment. A virtual machine may be used to instantiate a copy of the execution environment that executes the pack. In some embodiments, a separate virtual machine may be instantiated for every pack execution. The server-side execution environment may isolate each pack from one another via one more virtual machine. In embodiments, two or more packs may be designed to interact with one another and may be configured to execute in the same virtual machine.

In embodiments, aspects of the installation and execution of a pack may be recorded and tracked. A pack execution log may include aspects of the operations related to the pack, number of installations of the pack, number of executions, number of executions of the components of the pack, number of data accesses, and the like. The pack execution log may maintain a log of access and executions for each user or identification number associated with a workspace or user. In some cases, pack executions logs may include data related to each pack with respect to the pack author, pack administrator, user, and the like. Pack execution logs may be provided to users for review and may limit the access to a pack (for example, in response to a threshold number of errors associated with a pack).

Services, operations, and/or data for a pack may require user authentication and/or authorization. Formulas in a document or pack may require account information for a user, team, workspace, or the like. Formulas may be invoked with account identifiers. The account identifiers may be provided to a server and the server may use the account identifier to determine secret identifying information for the account identifier (such as cryptographic tokens, login information, etc.). A server may be used to manipulate user credentials and authorization information on behalf of a user thereby ensuring that sensitive credential and authorization information is not exposed on a client device.

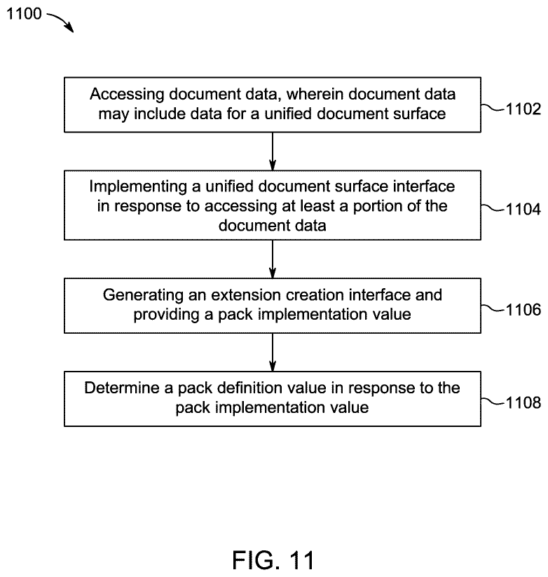

FIG. 11 is a schematic flow diagram of a procedure for implementing a pack. In embodiments, a method 1100 may include accessing document data 1102. The document data may include data for a unified document surface. Accessing document data may include accessing the whole document or at least a portion of the document. The method may further include implementing a unified document surface interface in response to accessing at least a portion of the document data 1104. The method may further include generating an extension creation interface and providing a pack implementation value 1106. The pack implementation value may be provided in response to user interactions with the extension creation interface. In embodiments, the method may include determining a pack definition value in response to the pack implementation value 1108. In embodiments, the pack implementation value may include an access authorization value, and the pack definition value may include an access authorization description. The method may further include exposing a pack to a workspace in response to the pack definition value. A pack may be accessed by other clients or client serving circuits for implementing an extension utilization interface. The method may include incorporating at least a portion of the pack into a second document in response to user interactions with the extension utilization interface. In embodiments, the second document may be associated with the workspace.

In embodiments, the method may include exposing a pack to a workspace in response to the pack definition value. In some cases, the method may include accessing the pack by a second client or a second client-serving circuit, implementing an extension utilization interface, and incorporating at least a portion of the pack into a second document in response to user interactions with the extension utilization interface. In some cases, the second document may be associated with the workspace. In some embodiments, the method may further include isolating the access authorization description from the second client serving circuit. In some cases, the pack may include at least one of a service or an external data value and the access authorization description may include authorization information for access to the at least one of the service or the external data value. In some cases, the pack definition value may include a formula and the formula may include at least one of: a unified document surface interface formula; a code based formula; a third party formula; or a column formula. In some cases, the pack definition value may include an external data access value and the external data access value may include at least one of: an authorized data access; a third party data access; an external data value determined at a time of creating the pack implementation value; or an external data value determined at a time of accessing the pack definition value. In some cases, the pack definition value may include at least one of: a formula; an action; a format; or a table. The extension creation interface may include a software development kit (SDK) layer. The pack implementation value may include an arbitrary code component.

In embodiments, the method may include determining the pack definition value by isolating operations of the arbitrary code component from at least one of the client serving circuit or the document serving circuit. The method may further include determining the pack implementation value by operating a virtual machine to execute the arbitrary code component. The method may further include determining the pack definition value by operating the virtual machine on a workflow serving circuit. In some embodiments, the method may further include creating a dedicated instance of the virtual machine for the arbitrary code component.

In embodiments, the method may include performing, in response to determining an update to the pack implementation value comprises an incompatibility risk, at least one operation selected from the operations consisting of: providing an incompatibility warning value to the client device; providing an update option value to a second client serving circuit accessing a document utilizing a pack exposed to a workspace in response to the pack definition value; or providing an update delay value to a second client serving circuit accessing a document utilizing a pack exposed to a workspace in response to the pack definition value. In some embodiments, the method may further include implementing a sandbox interface as a part of the extension creation interface, and to provide a calculated output value to the client device in response to user interactions with the sandbox interface. In some embodiments, the method may include operating an external data access authorization in response to an access credential supplied by the user to the sandbox interface.

The method may further include storing the access credential in a local hidden file of the client device. The access authorization description may include an authorization type for each one of a service or an external data access of the pack. The method may include requiring authorization information for the service or the external data access from a second user of a second document utilizing the pack in response to the authorization type comprising a user authorization type. The method may further include accessing the service or the external data access using separate credentials from the required authorization information. In embodiments, the method may further include providing access to the service or the external data access to the second user of the second document utilizing the pack in response to the authorization type comprising a system authorization type. The method may include performing a validation of the pack definition value and creating a pack in response to the pack definition value and the validation. The method may include performing a validation of the pack definition value and providing a notification to the extension creation interface in response to the validation indicating a pack error. In some cases, the pack error may include at least one error selected from the errors consisting of: a formula error, an authorization error, or a code operation error. The extension creation interface may include an assistance interface. The assistance interface may include at least one of: a tooltip associated with at least one of: a component of the extension creation interface, a formula command, or a text value; a description value associated with at least one of: a component of the extension creation interface, a formula command, or a text value; or a code example associated with at least one of: a component of the extension creation interface, a formula command, or a text value. The extension creation interface may be configured to limit access to the external data access value to a defined external data component of the extension creation interface.

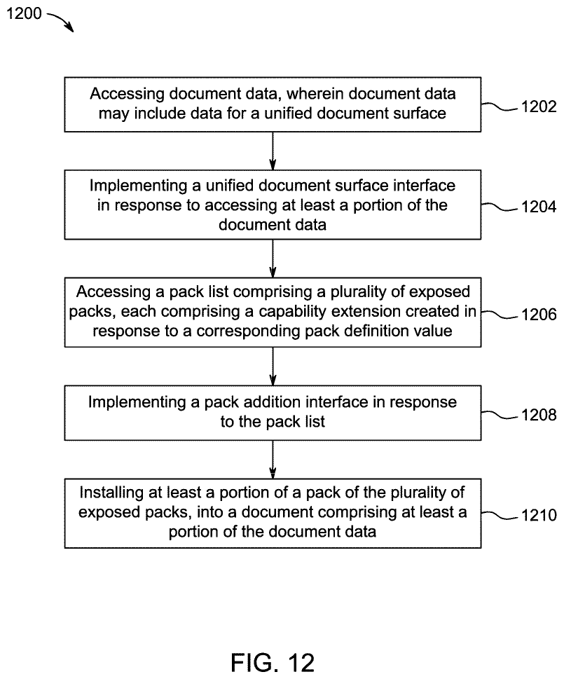

FIG. 12 is a schematic flow diagram of a procedure for installing a pack. In embodiments, a method 1200 may include accessing document data 1202, the document data may include data for a unified document surface. In embodiments, at least a portion of the document data may be provided to a client serving circuit. The method may include implementing a unified document surface interface in response to the at least a portion of the document data 1204. The method may further include accessing a pack list comprising a plurality of exposed packs, each comprising a capability extension created in response to a corresponding pack definition value 1206, implementing a pack addition interface in response to the pack list 1208, and installing at least a portion of a pack of the plurality of exposed packs, into a document comprising at least a portion of the document data, in response to user interactions with the pack addition interface 1210. In embodiments, the user interactions comprise a drag and drop operation of the pack to the document. The pack may include at least one of: a formula; an action; a format; a table; a unified document surface interface formula; a code based formula; a third party formula; a column formula; a text flow; an arbitrary code component; or a template. The pack may include one of a service or an external data access value. The one of the service or the external data access value may include an authorized service or external data access value. The authorized service or external data access value may include a system authorized service or external data access value. In embodiments, the method may further include providing access to the service or external data access value without further authorization operations from a user of the unified document surface interface. The method may include isolating authorization information for the authorized service or external data access value from a client device displaying the document.

In embodiments, the authorized service or external data access value may include a user authorized service or external data access value. The method may include providing access to the service or eternal data access value in response to authorization credentials supplied by a user of the unified document surface interface. The method may further include accessing the authorized service or external data access value using distinct credentials from the authorization credentials supplied by the user of the unified document surface interface. In some embodiments, the method may include commanding execution of operations of the pack on at least one of a separate workflow server or a virtual machine. In embodiments, the corresponding pack definition value may include an update implementation value. In embodiments, the method may include updating the document in response to an update of the pack and the update implementation value. The update implementation value may include at least one value selected from the values consisting of: an immediate update value; a timed update value; or an update notification value.

The method may further include determining an update type value, and to update the document further in response to the update type value. The pack may include a versioned object. In embodiments, the method may include updating the document further in response to a version of the exposed pack and a version of the installed pack in the document. The method may include determining a pack execution log in response to operations of the document using the pack and exposing at least a portion of the pack execution log to an author of the pack. The pack execution log may include at least one log information element selected from: a number of documents having the pack installed; a number of execution events of components of the pack; an execution time of execution events of components of the pack; a number of service or data access events of components of the pack.

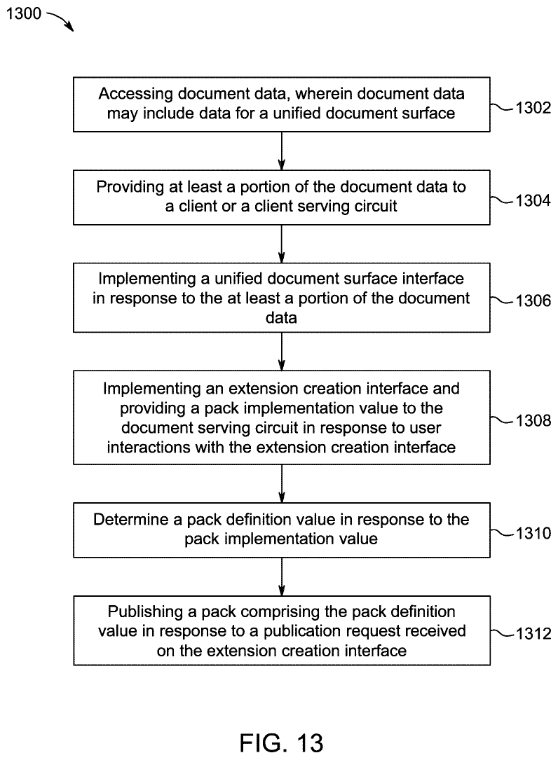

FIG. 13 is a schematic flow diagram of a procedure for publishing a pack. In embodiments, a method 1300 may include accessing a document data 1302. The document data may include data for a unified document surface. The method may include providing at least a portion of the document data to a client or a client serving circuit 1304. The method may include implementing a unified document surface interface in response to the at least a portion of the document data 1306. The method may include implementing an extension creation interface and providing a pack implementation value to the document serving circuit in response to user interactions with the extension creation interface 1308. In embodiments, the method may include determining a pack definition value in response to the pack implementation value 1310 and publishing a pack comprising the pack definition value in response to a publication request received on the extension creation interface 1312. The pack definition value may include a publication scope value. The method may further include and wherein publishing the pack in response to the publication scope value. The publication scope value may include at least one value selected from the values consisting of: a public scope; a workspace scope; a user inclusion scope; or a user exclusion scope. The pack definition value may include a category tag. In embodiments, the method may further include publishing the pack in response to the category tag. The method may include accessing a pack list comprising a plurality of published packs including the pack, and to display selected ones of the pack list to a client device in response to category tags corresponding to each one of the plurality of published packs. In some embodiments, the method may include selecting the ones of the pack list in response to the category tags. The method may further include ordering the selected ones of the pack list in response to the category tags. The pack definition value may include an access cost description. The method may include publishing the pack in response to the access cost description. The access cost description may include at least one of: a subscription cost value; an installation cost value; a trial period value; a pack usage document example value; or a usage based cost value.

The method may include publishing a pack description card in response to the pack definition value. The pack description card may include at least one value selected from the values consisting of: a pack icon; a pack picture; a pack text description; a pack title; a pack author name; a pack author entity; a pack author contact; a utilizing documents list; a pack building block description; or a pack dependency description. The pack definition value may include a unique address for the pack.

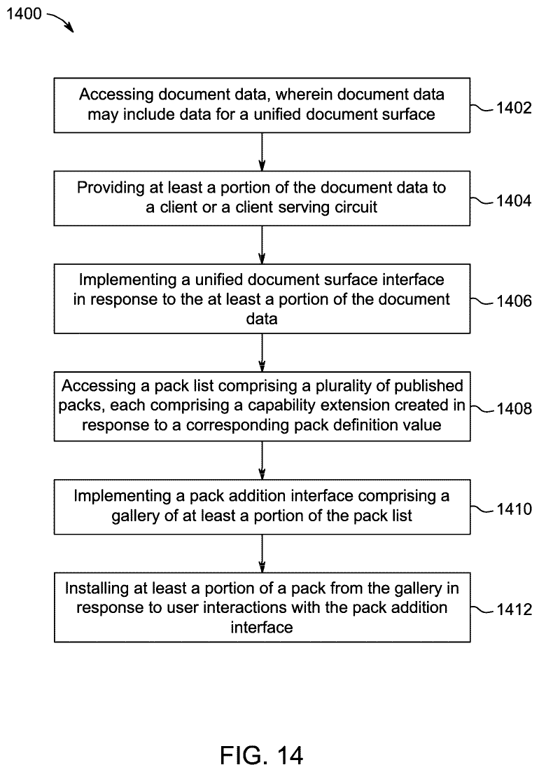

FIG. 14 is a schematic flow diagram of a procedure for installing a pack. In embodiments, a method 1400 may include accessing document data, the document data may include data for a unified document surface 1402. The method may include providing at least a portion of the document data to a client or a client serving circuit 1404. The method may further include implementing a unified document surface interface in response to the at least a portion of the document data 1406 and accessing a pack list comprising a plurality of published packs, each comprising a capability extension created in response to a corresponding pack definition value 1408. The method may further include implementing a pack addition interface comprising a gallery of at least a portion of the pack list 1410 and installing at least a portion of a pack from the gallery in response to user interactions with the pack addition interface 1412. The method may include selecting the gallery from the pack list in response to a publication scope value corresponding to each of the plurality of published packs. The method may include selecting the gallery from the pack list in response to a user search term provided on the pack addition interface. The method may include selecting the gallery from the pack list in response to a category tag corresponding to each of the plurality of published packs. The method may include selecting the gallery from the pack list in response to an installation volume description corresponding to each of the plurality of published packs. The method may include selecting the gallery from the pack list in response to an installation trend value corresponding to each of the plurality of published packs. The method may include selecting the gallery from the pack list in response to an administrative permissions value corresponding to at least one of the plurality of published packs. The administrative permissions value may include at least one value selected from the value consisting of: a cost permissions value; a building block value; a pack inclusion value; a pack exclusion value; or a pack certification value. In embodiments, the method may include providing an administrator notification in response to the user interactions with the pack addition interface and installing the at least a portion of the pack in response to an administrator response authorizing the installation.

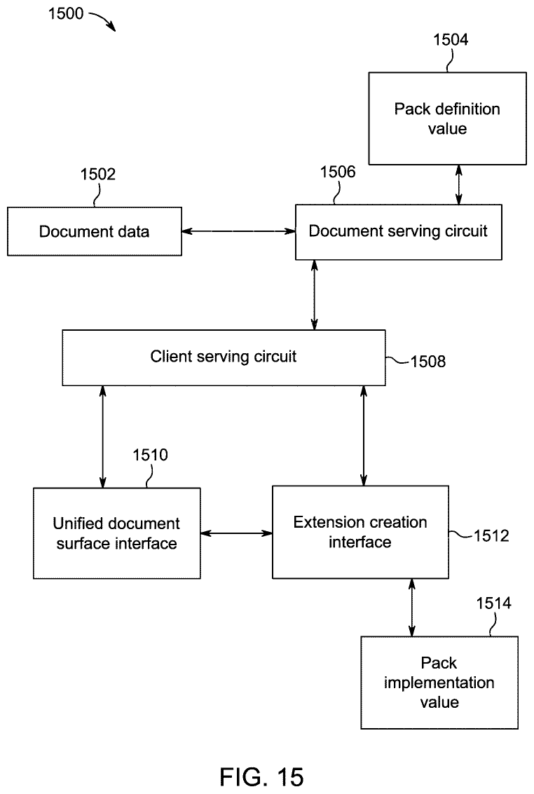

Referencing FIG. 15, an example system 1500 includes a document serving circuit 1506 structured to access a document data 1502. The document data may include data for a unified document surface. The document serving circuit 1506 may provide at least a portion of the document data 1502 to a client serving circuit 1508. The client serving circuit 1508 may be structured to implement a unified document surface interface 1510 in response to the at least a portion of the document data 1502. The client serving circuit 1508 may be further structured to implement an extension creation interface 1512, and to provide a pack implementation value 1514 to the document serving circuit 1506 in response to user interactions with the extension creation interface 1512. In embodiments, the document serving circuit 1506 may be further structured to determine a pack definition value 1504 in response to the pack implementation value 1514. In some embodiments, the pack implementation value 1514 may include an access authorization value and the pack definition value 1504 may include an access authorization description. In embodiments, the document serving circuit 1506 may be further structured to expose a pack to a workspace in response to the pack definition value 1504.

In embodiments, the system may include a plurality of client serving circuits 1508 that may be structured to access the pack, to implement a plurality of extension utilization interfaces 1512, and to incorporate at least a portion of the pack into a plurality of other document in response to user interactions with the extension utilization interface. the second document is associated with the workspace. A document serving circuit 1506 may be further structured to expose a pack to a workspace in response to the pack definition value 1504.

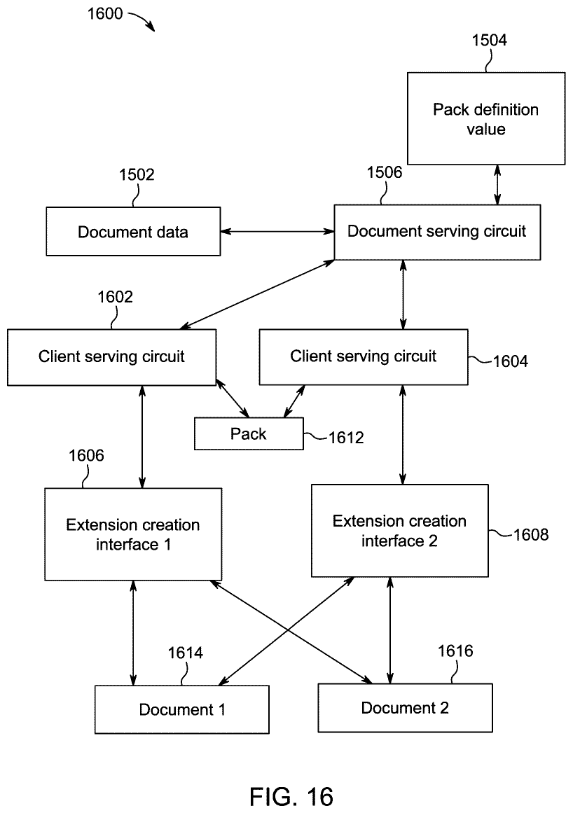

Referencing FIG. 16, an example system 1600 may include a plurality of client serving circuits such as a first client serving circuit 1602 and a second client serving circuit 1604 structured to access a pack 1612. Each client serving circuit 1602, 1604 may be structured to implement an extension utilization interface 1606, 1608, and to incorporate at least a portion of the pack 1612 into a first document 1614 and a second document 1616 in response to user interactions with the extension utilization interface. The documents 1614, 1616 may be associated with the workspace. In embodiments, the document serving circuit 1506 may be further structured to isolate the access authorization description from the second client serving circuit 1604 and the first client serving circuit 1602.

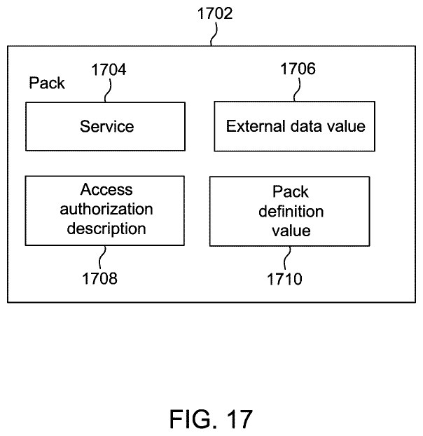

Referencing FIG. 17, an example pack 1702 may include at least one of a service 1704 or an external data value 1706. The pack 1702 may include and wherein the access authorization description 1708 that may include authorization information for access to the at least one of the service 1704 or the external data value 1706. The pack may include a pack definition value 1710 comprises a formula. The formula may include at least one of: a unified document surface interface formula; a code based formula; a third party formula; or a column formula. The pack definition value may include an external data access value. The external data access value may include at least one of: an authorized data access; a third party data access; an external data value determined at a time of creating the pack implementation value; or an external data value determined at a time of accessing the pack definition value. In embodiments, the pack definition value 1710 may include at least one of: a formula; an action; a format; or a table.

In embodiments, the extension creation interface 1512 may include a software development kit (SDK) layer. The pack implementation value may include an arbitrary code component. In embodiments, the document serving circuit 1506 may be structured to determine the pack definition value 1504 by isolating operations of the arbitrary code component from at least one of the client serving circuit 1506 or the document serving circuit 1508. In embodiments, the document serving circuit 1506 may be further structured to determine the pack implementation value 1514 by operating a virtual machine to execute the arbitrary code component. The document serving circuit 1506 may be further structured to determine the pack definition value 1504 by operating the virtual machine on a workflow serving circuit.

In embodiments, the document serving circuit 1506 may be further structured to perform, in response to determining an update to the pack implementation value comprises an incompatibility risk, at least one operation selected from the operations consisting of providing an incompatibility warning value to the client device; providing an update option value to a second client serving circuit accessing a document utilizing a pack exposed to a workspace in response to the pack definition value; or providing an update delay value to a second client serving circuit accessing a document utilizing a pack exposed to a workspace in response to the pack definition value.

The document serving circuit 1506 may be structured to implement a sandbox interface as a part of the extension creation interface 1516, and to provide a calculated output value to the client device in response to user interactions with the sandbox interface. The document serving circuit 1506 may be further structured to operate an external data access authorization in response an access credential supplied by the user to the sandbox interface. The document serving circuit 1506 may be further structured to store the access credential in a local hidden file of the client device. The access authorization description may include an authorization type for each one of a service or an external data access of the pack. The document serving circuit 1506 may be further structured to require authorization information for the service or the external data access from a second user of a second document utilizing the pack in response to the authorization type comprising a user authorization type. The document serving circuit 1506 may be further structured to access the service or the external data access using separate credentials from the required authorization information. The document serving circuit 1506 may be further structured to provide access to the service or the external data access to the second user of the second document utilizing the pack in response to the authorization type comprising a system authorization type.

In embodiments, the document serving circuit 1506 may be further structured to perform a validation of the pack definition value 1504, and to create a pack in response to the pack definition value and the validation. The document serving circuit may be further structured to perform a validation of the pack definition value 1504, and to provide a notification to the extension creation interface 1512 in response to the validation indicating a pack error. The pack error may include at least one error selected from the errors consisting of: a formula error, an authorization error, or a code operation error.

The extension creation interface 1512 may include an assistance interface. The assistance interface further may include at least one of: a tooltip associated with at least one of: a component of the extension creation interface, a formula command, or a text value; a description value associated with at least one of: a component of the extension creation interface, a formula command, or a text value; or a code example associated with at least one of: a component of the extension creation interface, a formula command, or a text value. The extension creation interface 1512 may be configured to limit access to the external data access value to a defined external data component of the extension creation interface 1512.

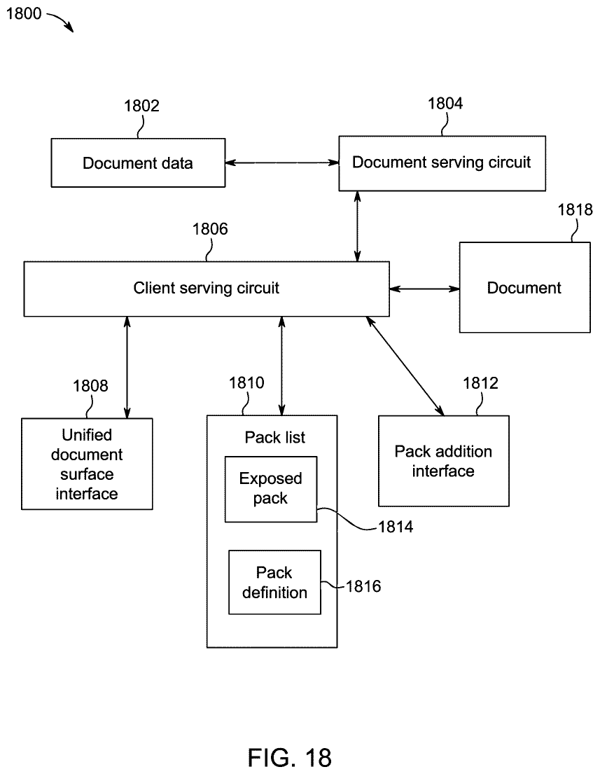

Referencing FIG. 18, an example system 1800 includes a document serving circuit 1804 structured to access a document data 1802. The document data may include data for a unified document surface, and to provide at least a portion of the document data 1802 to a client serving circuit 1806. The client serving circuit 1806 may be structured to: implement a unified document surface interface 1808 in response to the at least a portion of the document data 1802. The client serving circuit 1806 may be further structured to access a pack list 1810, the pack list may include a plurality of exposed packs 1814. Each exposed pack may include a capability extension created in response to a corresponding pack definition value 1816. The client serving circuit 1806 may be further structured to implement a pack addition interface 1812 in response to the pack list 1810 and install at least a portion of a pack of the plurality of exposed packs 1814 into a document 1818. The document 1818 may include at least a portion of the document data 1802, in response to user interactions with the pack addition interface 1812. In embodiments, the user interactions may include a drag and drop operation of the pack to the document 1818.

In embodiments, the pack may include at least one of: a formula; an action; a format; a table; a unified document surface interface formula; a code based formula; a third party formula; a column formula; a text flow; an arbitrary code component; or a template.

The pack may include one of a service or an external data access value. The one of the service or the external data access value may include an authorized service or external data access value. The authorized service or external data access value may include a system authorized service or external data access value. The document serving circuit 1804 may provide access to the service or external data access value without further authorization operations from a user of the unified document surface interface 1808. The document serving circuit 1804 may isolate authorization information for the authorized service or external data access value from a client device displaying the document.

In embodiments, an authorized service or external data access value may include a user authorized service or external data access value. The document serving circuit 1804 may provide access to the service or eternal data access value in response to authorization credentials supplied by a user of the unified document surface interface 1808. The document serving circuit 1804 may access the authorized service or external data access value using distinct credentials from the authorization credentials supplied by the user of the unified document surface interface 1808.

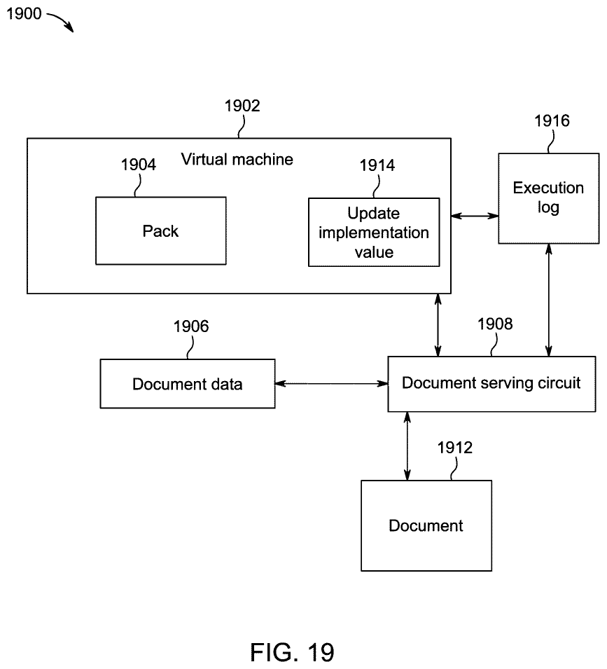

Referencing FIG. 19, an example system 1900 includes a document serving circuit 1908 that may be configured to command execution of operations of the pack 1904 on at least one of a separate workflow server or a virtual machine 1902. A corresponding pack definition value may include an update implementation value 1914. The document serving circuit KJJK908 may update the document 1912 in response to an update of the pack 1904 and the update implementation value. The update implementation value 1914 may include at least one value selected from the values consisting of: an immediate update value; a timed update value; or an update notification value. The document serving circuit may be further structured to determine an update type value, and to update the document further in response to the update type value. In embodiments, the pack 1904 may include a versioned object, and wherein the document serving circuit 1908 may update the document further in response to a version of the exposed pack and a version of the installed pack in the document 1912. The document serving circuit 1908 may further structured to determine a pack execution log 1916 in response to operations of the document 1912 using the pack 1904, and to expose at least a portion of the pack execution log to an author of the pack. The pack execution log 1916 may include at least one log information element selected from: a number of documents having the pack installed; a number of execution events of components of the pack; an execution time of execution events of components of the pack; a number of service or data access events of components of the pack.

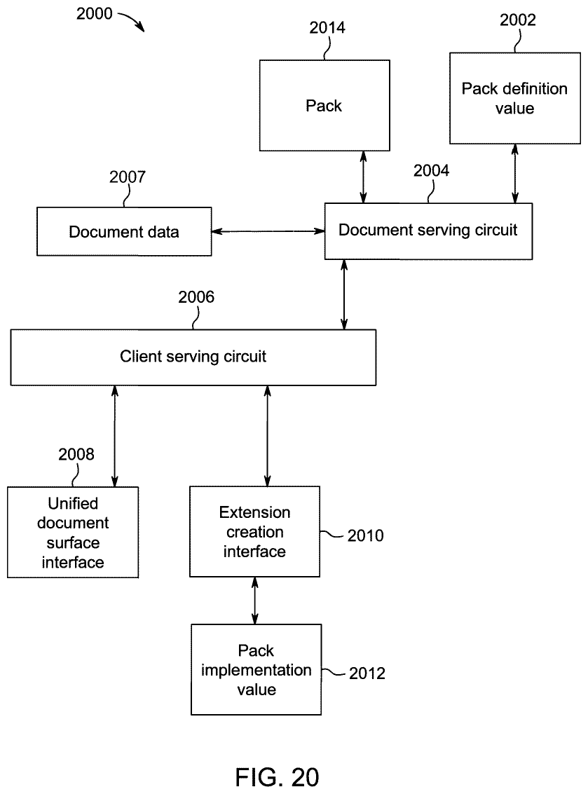

Referencing FIG. 20, an example system 2000 includes a document serving circuit 2004 structured to access a document data 2007, the document data comprising data for a unified document surface. The serving circuit may provide least a portion of the document data to a client serving circuit 2006. The client serving circuit 2006 may be structured to implement a unified document surface interface 2008 in response to the at least a portion of the document data. The client serving circuit 2006 may be further structured to implement an extension creation interface 2010 and to provide a pack implementation value 2012 to the document serving circuit 2004 in response to user interactions with the extension creation interface 2010. The document serving circuit 2004 may be further structured to determine a pack definition value 2002 in response to the pack implementation value 2012. The document serving circuit 2004 may be further structured to publish a pack 2014 comprising the pack definition value 2002 in response to a publication request received on the extension creation interface 2010. The definition value may include a publication scope value. The document serving circuit 2004 may be structured to publish the pack 2014 in response to the publication scope value. The publication scope value may include at least one value selected from the values consisting of: a public scope; a workspace scope; a user inclusion scope; or a user exclusion scope. The pack definition value may include a category tag and the document serving circuit 2004 may be structured to publish the pack in response to the category tag.

In embodiments, the client serving circuit 2006 may be structured to access a pack list comprising a plurality of published packs including the pack, and to display selected ones of the pack list to a client device in response to category tags corresponding to each one of the plurality of published packs. The client serving circuit 2006 may be further structured to select the ones of the pack list in response to the category tags. The client serving circuit may be further structured to order the selected ones of the pack list in response to the category tags.

In embodiments, the pack definition value 2002 may include an access cost description and the document serving circuit 2004 may be structured to publish the pack in response to the access cost description. The access cost description may include at least one of: a subscription cost value; an installation cost value; a trial period value; a pack usage document example value; or a usage based cost value. The document serving circuit may be further structured to publish a pack description card in response to the pack definition value. The pack description card may include at least one value selected from the values consisting of: a pack icon; a pack picture; a pack text description; a pack title; a pack author name; a pack author entity; a pack author contact; a utilizing documents list; a pack building block description; or a pack dependency description. The pack definition value may include a unique address for the pack.

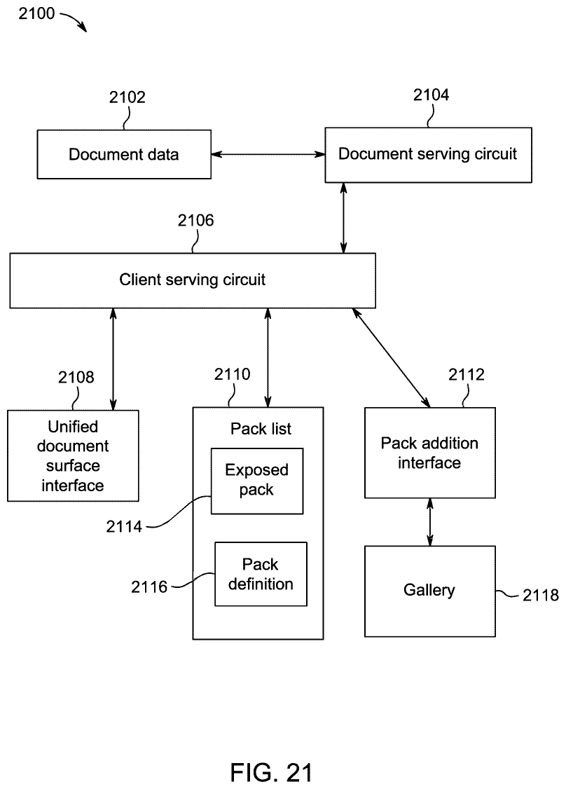

Referencing FIG. 21, an example system 2100 includes a document serving circuit 2104 structured to access a document data 2102, the document data comprising data for a unified document surface. The serving circuit may provide least a portion of the document data to a client serving circuit 2106. The client serving circuit 2106 may be structured to implement a unified document surface interface 2108 in response to the at least a portion of the document data, access a pack list 2110 comprising a plurality of published packs 2114, each comprising a capability extension created in response to a corresponding pack definition value 2116. The client serving circuit 2106 may be structured to implement a pack addition interface 2112 comprising a gallery 2118 of at least a portion of the pack list and install at least a portion of a pack from the gallery 2118 in response to user interactions with the pack addition interface. The client serving circuit 2106 may be further structured to select the gallery 2118 from the pack list 2110 in response to a publication scope value corresponding to each of the plurality of published packs 2114. The client serving circuit may be structured to select the gallery 2118 from the pack list 2110 in response to a user search term provided on the pack addition interface 2112. The client serving circuit may be further structured to select the gallery 2118 from the pack list 2110 in response to a category tag corresponding to each of the plurality of published packs 2114. The client serving circuit may be structured to select the gallery 2118 from the pack list 2110 in response to an installation volume description corresponding to each of the plurality of published packs 2114. The client serving circuit may be further structured to select the gallery 2118 from the pack list 2110 in response to an installation trend value corresponding to each of the plurality of published packs 2114. The client serving circuit 2106 may be further structured to select the gallery 2118 from the pack list 2110 in response to an administrative permissions value corresponding to at least one of the plurality of published packs 2114. The administrative permissions value may include at least one value selected from the value consisting of: a cost permissions value; a building block value; a pack inclusion value; a pack exclusion value; or a pack certification value. The client serving circuit 2106 may be further structured to: provide an administrator notification in response to the user interactions with the pack addition interface; and install the at least a portion of the pack in response to an administrator response authorizing the installation.

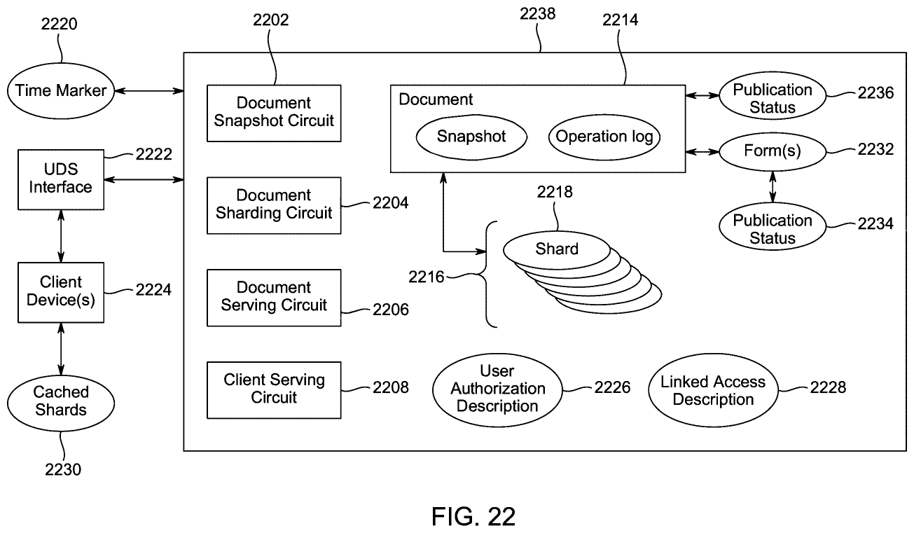

Referencing FIG. 22, an example controller 2238 is depicted for providing granular shard support for a unified document surface (UDS). The example controller 2238 includes a document snapshot circuit 2202 structured to generate a document snapshot 2210 configured to capture a state of a document 2214 at a time marker. The time marker may be an actual time value—for example 12 PM on 1 January 202x, or determined in response to an event indicating a snapshot 2210 is to be taken. For example, the snapshot 2210 may be captured in response to a number of edits made to the document, performed according to a periodic schedule (e.g., daily, weekly, hourly, etc.), performed according to a utilization of the document (e.g., increasing snapshot frequency for a heavily used document to reduce a size of the operations log 2212, decreasing snapshot frequency for a heavily used document to reduce interruption of user editing, etc.), performed in response to selected events (e.g., a command to perform the snapshot 2210 by the document serving circuit 2206, by an administrator, in response to the document being published, and/or in response to a form of the document being published). In certain embodiments, for example where no edits have been performed on the document since a last snapshot event, the document snapshot circuit 2202 may omit creating a new snapshot 2210, where operations to generate the snapshot 2210 are considered to be omitted, or considered to be completed by a confirmation operation that the snapshot 2210 is not needed.

The example controller 2238 further includes a document sharding circuit 2204 that analyzes the document snapshot 2210, and generates a first plurality of shard documents (e.g., shard group 2216 of shards 2218), where the shard group 2216 captures the state of the document at the time marker. The example operation updates the shard group 2216 at the same time as the snapshot 2210, and/or updates the shard group 2216 after the snapshot 2210, using the snapshot 2210 and/or further considering any operations that may be present on the operations log 2212 in the lapsed time since the snapshot 2210 was created. It will be noted that the snapshot 2210 captures the state of the document, for example creating a store of operations that, if performed, would create the document as it existed at the time marker. However, for example where a user is actively editing the document during the operations of the document snapshot circuit 2202 to capture the snapshot 2210, the operations log 2212 may include operations that are not reflected in the snapshot 2210, even at the time the snapshot 2210 is completed. Accordingly, it can be considered that the snapshot 2210 having all operations except those on the operations log 2212 has captured the state of the document, and/or it can be considered that the operations log 2212 is a part of the snapshot 2210. The specific terminology in this regard is not limiting. Further, the shards 2218 may be generated directly from the snapshot 2210, or generated from the snapshot 2210 combined with the operations log 2212. Accordingly, it can be considered that the shard group 2216 having all operations except those on the operations log 2212 has captured the state of the document, and/or it can be considered that the operations log 2212 is a part of the shard group 2216. The description of the shard group 2216 in the example of FIG. 22 is not limiting. For example, the shard group 2216, in certain embodiments, does not fully capture the state of the document, but instead may be configured to support a specific shard scheme. In another example, the shard group 2216 is depicted as separate from the snapshot 2210, but the snapshot 2210 may be embodied as a shard group 2216 instead of as a separate, complete data structure.

The example controller 2238 includes a document serving circuit 2206 structured to access the first plurality of shard documents 2216, and provides at least a subset of the first plurality of shard documents 2216 to a client serving circuit 2208. For example, a shard scheme may indicate that one or more of the shards 2218 should be provided first when a user accesses the document, for example a critical shard and/or a schema shard, with other shards 2218 provided later, or withheld unless and/or until user interactions with the document 2214 indicate that those shards 2218 should also be communicated. The provision of shards 2218 to the client serving circuit 2208, including the rate, order, and/or priority of the shards 2218, will be regulated by the relevant shard scheme, operations of the user on the document 2214, and/or as limited by available system resources such as communication bandwidth, intermediate memory storage, or the like.

The example controller 2238 includes a client serving circuit 2208 that implements a UDS interface 2222 in response to at least a subset of the first plurality of shard document 2216. For example, the UDS interface 2222 may embodied, in whole or part, as an application operating on a client device 2224, which may be a dedicated application (e.g., a proprietary program operating on the client device 2224), a mobile application (e.g., an application on a phone or tablet), as a web portal (e.g., as a terminal-like interface with the client device operating as a client), and/or as an application running within a generalized application (e.g., as executable instructions such as Javascript running in a web browser). The distribution of the support elements to operate the UDS interface 2222 may thus be distributed between the client device 2224 (e.g., the client side) and the controller 2238 (e.g., the server side). The document 2214 is provided as data from the controller 2238 to the UDS interface 2222, and thus the document data is stored on the server, and provided in whole or part (e.g., at least the displayed elements on the UDS interface 2222 must be present on the client device 2224), but the supporting operations to determine user inputs and edits, to display menus, to execute formulas, to provide referencing and/or look-up information, and the like may be distributed between the client device 2224 and the controller 2238, and/or present only on either the client device 2224 or the controller 2238. In certain embodiments, the UDS interface 2222 is the document surface where the user can view and/or edit documents 2214, and further is the surface where interactive elements such as menus, command buttons, formula entries, data fields, and the like can be operated and/or executed by the user.

An example controller 2238 includes the subset of the shard group 2216 being selected based on properties of the document 2214, properties of a client device 2224 displaying the UDS interface 2222 to a user, and/or properties of a communication network (not shown) between the client device 2224 and the document serving circuit 2206. Without limitation to any other aspect of the present disclosure, document properties that may be considered to select a subset of the shard group 2216 include the overall size (e.g., amount of data) within the document, access locations that are typically viewed and/or edited by users within the document, the dependency of portions of the document on other portions of the document (e.g., from referencing data, formula dependencies, etc.). Without limitation to any other aspect of the present disclosure, client device properties that may be considered to select a subset of the shard group 2216 include display characteristics of the client device (e.g., screen size, resolution, color palette, display type, etc.), memory availability of the client device (e.g., buffers, total RAM, cache availability, paged memory availability, etc., which may be limited by the physical memory of the client device, quotas on the client device for the user, and/or constraints imposed by applications and/or an operating system (OS) of the client device), processing resources on the client device, I/O availability of the client device (e.g., mouse, keyboard, touch screen, voice activation, etc.), and/or an access configuration of the client device (e.g., browser type and version, UDS application version, etc.). Without limitation to any other aspect of the present disclosure, communication network properties that may be considered to select a subset of the shard group 2216 include a bandwidth availability of communications, a latency of communications, data rate limitations of communications (e.g., imposed data rates from a service provider, network resource such as a router, etc.), data amount limitations of communications (e.g., data caps).

An example controller 2238 includes the subset of the shard group 2216 being selected based on a history of requests for the document by a user interacting with the UDS interface 2222, or a frequency of requests for the document by the user. For example, if the user accesses certain portions of the document, edits some portions of the document but only views other portions of the document, tends to view the document during certain time periods and tends to edit the document during other time periods, those aspects can be considered in determining which shards 2218 of the shard group 2216 should be provided, and/or in which order they should be provided. In certain embodiments, a history of requests for the document and/or a frequency of requests for the document may be considered according to the client device 2224 (e.g., where a single device such as a retail support device may be utilized by more than one user), and/or according to a related group of users (e.g., users within a workspace, users associated with a particular entity, and/or users subscribing to and/or utilizing a particular document), for example to provide users with a consistent experience, to improve utilization of controller 2238 resources, and/or to improve performance with the document by utilizing information from multiple users—for example where an occasional user receives the benefit of shard generation, grouping, and delivery operations that have been tuned using the experiences of frequent users and/or a pool of users.

An example controller 2238 includes the document serving circuit 2206 providing the subset of the shard group 2216 in an order determined at least in part based on a history of requests for the document by a client device 2224 displaying the UDS interface 2222, or a frequency of requests for the document by the client device 2224. An example document serving circuit 2206 determines the order for providing the subset of the shard group 2216 based on a last accessed location of the document—for example prioritizing a shard for a user that provides the data for the last accessed location of the document by the user, thereby prioritizing information that the user is likely to utilize soon after accessing the document. In certain embodiments, the document serving circuit 2206 determines the order for providing the subset of the shard group 2216 based on the client device 2224 utilized by the user, for example the document serving circuit 2206 may determine that the user is likely to access LOCATION A within the document when using a first device (e.g., a desktop computer), and to access LOCATION B within the document when using a second device (e.g., a mobile phone), thereby providing the shard most likely to improve the user experience based on the user device. In certain embodiments, the document serving circuit 2206 further determines the order of providing shards of the shard group 2216 in response to a statistical analysis of access locations (e.g., determining a frequency of access locations, a change over time of access locations, a number of access locations that cover most access events, with a single purpose-built shard to support these being provided, and/or a group of shards to support these being provided). The statistical analysis may include the user, the client device, and/or associated users or client devices. The statistical analysis may include operations to smooth the sharding provision operations and/or improve the user experience, for example filtering the high access locations (e.g., moving toward a new high access location that is detected incrementally instead of in a single step, in a low-pass filter fashion, and/or moving quickly to a new high access location, for example where the location has changed rapidly and with high confidence, in a high-pass filter fashion), implementing a hysteresis (e.g., to confirm a significant change in access locations has occurred before changing the sharding scheme and/or shard provision order), predicting access locations (e.g., if an access location has been changing over a period of time, for example as a table grows, a project moves to a next phase, etc., where the trajectory for future access locations can be reliably predicted).

An example shard group 2216 includes a schema shard, a critical shard, and/or a data shard. Without limitation to any other aspect of the present disclosure, a schema shard includes display and/or organizing information for a document object, such as a canvas, table, sheet, text flow, or the like. Example schema information includes one or more of: titles and/or headings associated with the object, column names associated with the object, object reference names (e.g., for utilization in a formula language associated with the UDS interface 2222), column widths, row heights, layout information (e.g., margins, spacing, alignment, etc.), and/or referenced objects (e.g., formulas utilized, linked tables or other information, external data and/or services utilized, etc.). In certain embodiments, a schema shard may be provided for the whole document, for a single object (e.g., a canvas or a table), for a group of objects (e.g., a single canvas shard for all canvases), and/or combinations of these. In certain embodiments, the utilization of a schema shard supports pre-rendering of the document (e.g., displaying important information and displaying the document to the user that gives the user a stable sense of how the document, table, canvas, etc. is laid out, and reducing undesirable behavior like shifting of buttons, table locations, or other interface elements after initial display), reduces computing resources required to support the document (e.g., checks for authorization of the user to objects of the document, checking dependencies within the document between document sections, objects, and/or between shards), and/or provides for additional options in developing shard strategies that result in improved performance for the user and/or the controller 2238. Without limitation to any other aspect of the present disclosure, a critical shard includes minimal information about the document to begin the process of rendering the document and orienting the user to the document within the UDS interface 2222. Example critical information includes one or more of: high level document information such as a title, page count, canvas count, permissions required to access the document and/or objects within the document, document sizing information (e.g., width, margins, alignment, etc.). In certain embodiments, the critical shard may include schema information for important document objects, such as canvases, a page one schema (e.g., a schema for the first location within the document that the user will see, and/or that users are likely to access), or the like. In certain embodiments, the critical shard and a schema shard may be the same shard, and/or may include some of the same information. Example data information includes one or more of: text within a text flow, row data for a table, chart depictions and/or chart data, or the like. In certain embodiments, the data shard may additionally or alternatively include the schema information, and/or the data shard may include information associating the data shard with one or more critical shards and/or schema shards. In certain embodiments, the shard group 2216 includes a number of data shards, for example with a data shard for each table, for each canvas, or the like. In certain embodiments, the shard group 2216 includes a data shard with all data for the document. In certain embodiments, the shard group 2216 includes data shards provided to have a consistent size, for example breaking up data for a large table into several data shards, and/or combining data for a number of smaller tables into a single data shard. The example including shard types of a critical shard, schema shard, and/or data shard is non-limiting, and other shard types may be present in addition to, or as an alternative to, the example.

An example document sharding circuit 2204 analyzes the document snapshot and determines a second plurality of shard documents (e.g., a second shard group 2216—not shown independently), where the second shard group 2216 capture at least a portion of the state of the document 2214 at the time marker, where the second plurality of shard documents is different from the first plurality of shard documents. For example, the second shard group 2216 may implement a distinct sharding scheme relative to the first shard group 2216. In certain embodiments, the scope of document coverage of the first shard group and the second shard group may be distinct—for example where the first shard group includes data for a table of the document that is not present in the second shard group. In certain embodiments, even where the scope of document coverage of the first shard group and the second shard group is the same (e.g., where both shard groups include all of the data for the document), the shard groups may be distinct—for example with different distribution of document information between shards, a greater redundancy of document data present in one shard group relative to the other shard group, and/or where the shards of each shard group are provided to the client serving circuit 2208 in a different order or priority for each shard group. An example document serving circuit 2206 accesses both (or all) of the shard groups, and provides at least a subset of the shards from a selected shard group to the client serving circuit 2208. An example document serving circuit 2206 provides at least a subset of shards from the selected shard group based on determined properties of the client device 2224, based on the user, based on an entity of the user, based on an access configuration, and/or based on any considerations set forth throughout the present disclosure, for example in relation to a shard scheme, shard strategy, or shard recipe.

Example and non-limiting shards 2218 for the shard group 2216, for example generated by the document sharding circuit 2204 or the document serving circuit 2206 (e.g., by commanding the document sharding circuit 2204), include one or more of: a shard for each canvas in the document, a shard for each table in the document, a critical shard, a schema shard, a data shard, combinations of these, and/or multiples of one or more of these.

An example document serving circuit 2206 identifies a critical shard, and prioritizes providing the critical shard to the client serving circuit 2208, for example to initiate (and/or expedite) rendering of the document on the client device 2224. An example document serving circuit 2206 identifies cached shard documents on the client device 2224 (and/or on the client serving circuit 2208, for example where at least a portion of the client serving circuit 2208 is positioned on the client device 2224, and/or where the client serving circuit 2208 determines the cached shards 2230 and provides a list of the cached shards 2230 to the document serving circuit 2206).

An example document sharding circuit 2204 generates the shard group 2216 in response to a user authorization description 2226 for the document 2214, for example identifying portions of the document that are not accessible to the user and accordingly do not need shard support for that user, and/or to segregate document portions that require some further authorization (e.g., a login for external data access), which may provide extra time for the client serving circuit 2208 before the relevant document portions would need rendering, even if accessed by the user. An example document sharding circuit 2204 further generates the shard group 2216 in response to a linked access description 2228 for the document 2214, for example a link access from a website, another document accessible to the UDS platform and/or controller 2238, and/or a link access that is determined in response to linking events for users accessing the document (e.g., where a linking source can be determined when a user accesses the document from such links). Example benefits of the shard group 2216 generated in response to a linked access description 2228 allow for operations such as: prioritizing common locations within the document that are likely to be accessed (e.g., due to users exercising the link); creating a dedicated shard for the linked-to portions of the document and/or for related portions (e.g., a table that is visible from the linked-to location, and/or a deep link location in the document, such as another location in the document that is linked to from the original linked-to location determined from the linked access description 2228). In certain embodiments, the number of linking documents, the number of authorized users for a document or relevant portions of the document, and/or the number of link events actually observed may be utilized to determine and generate the shard group 2216.

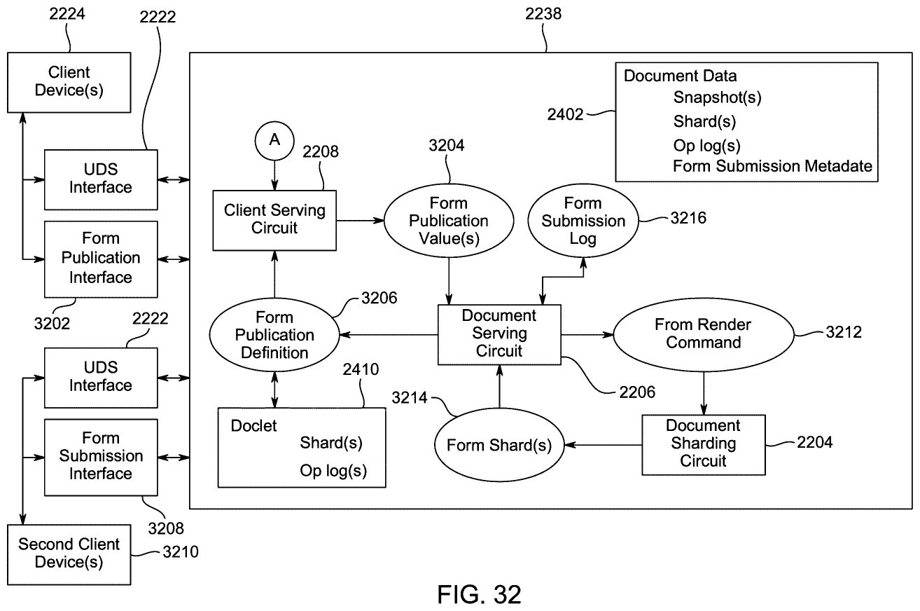

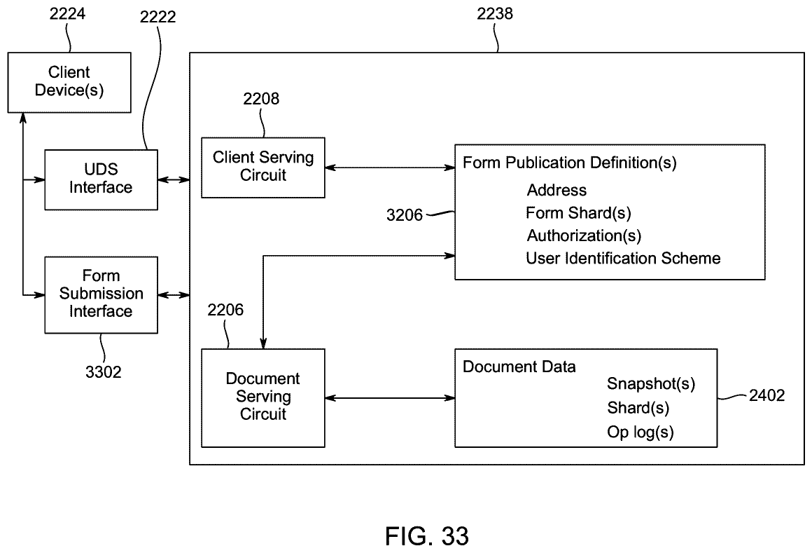

An example document 2214 includes a form 2232 (e.g., reference FIGS. 32-33 and the related descriptions), where the document sharding circuit 2204 generates the shard group 2216 in response to the form 2232—for example ensuring that a shard supporting and/or implementing the form 2232 is present in the shard group 2216, and/or generating a dedicated shard 2218 that supports and/or implements the form. In certain embodiments, the form 2232 may be an inline form, for example appearing within the document on a table, canvas, or other document object, where another user can interact directly with the form 2232 within the document 2214. In certain embodiments, an inline form may be utilized for documents 2214 that are shared internally within a workspace (e.g., where it does not matter if users interacting with the form and/or submitting data on the form have access to the rest of the document 2214), for documents 2214 with strong partial document access control (e.g., where an address to the form directs a user to the document section or object(s) implementing the form, but the remainder of the document 2214 can be protected from viewing and/or editing for those users), and/or where the form 2232 is not published, allowing the user in control of the document 2214 (e.g., the author, and/or an authorized user) to preview the form without creating a published version of the form. In certain embodiments, the form 2232 is a segregated form, for example a form 2232 that is rendered as a standalone object from the document 2214, which may be considered as a separate document, a child document, and/or a subsidiary document. For example, and without limitation to any other aspect of the present disclosure, publication of a form 2232 for the document 2214 may create a separate address (e.g., a URL) dedicated to the form 2232, where a user accessing that separate address can enter data onto the form and submit the form, but does not otherwise see the document 2214 and may not even be aware of the existence of the document 2214. In certain embodiments, the document sharding circuit 2204 generates the shard group 2216 in response to a publication status 2234 of the form 2232, for example creating a dedicated form shard if the form 2232 is published, and/or changing a priority among the shard group 2216 depending upon whether the form is published or unpublished. In certain embodiments, whether a form 2232 is an inline form or a segregated form, the publication status 2234 of the form may be considered a type of linked access description 2228, for example where the publication status 2234 indicates that other users can access and submit the form 2232, the form 2232 becomes a likely landing location within the document 2214 for other users (potentially for many other users, depending upon the scope of publication of the form), providing a lever for efficiency development for shard activity (e.g., shard generation, shard scope, shard priority, and/or distribution of document data among shards) to improve the operations of the controller 2238 (e.g., resource utilization and/or response time) and/or to improve the experience of users of the form 2232, the document 2214, and the UDS platform generally.

A shard, as utilized herein, should be understood broadly. Without limitation to any other aspect of the present disclosure, certain aspects of a shard are described following. In certain descriptions, a shard may be referenced as a shard document or similar terminology. A shard includes a subset of an entire snapshot, where the snapshot provides the information to reproduce a document at a specific time, or at a time marker (e.g., where the time marker is selected to be performed periodically, in response to certain events such as a specific request or command to update the snapshot, and/or in response to edits of the document, access events by users of the document, before document publication, or the like). In certain embodiments, a shard may be created to support a specific object (e.g., a shard supporting an object, such as a table, canvas, text flow, or the like), to support a specific operation (e.g., a shard created to support pre-rendering and/or rapid display of a document, to support certain types of access to the document, such as access by linking documents, access to specific portions of the document, or the like), and/or according to an overall scheme that supports efficient operation of the document, execution of particular features of the document (e.g., support for forms, specific calculation types, and/or dividing up large data sets into manageable elements), and/or overall efficient operation of a platform operating a UDS interface for a large number of users and/or a large corpus of documents.

Each shard is individually a subset of the snapshot, and/or may further include an associated operation log (e.g., to store changes to the document between snapshot events). Each shard may include redundant information with other shards, for example where a first shard captures a table, and a second shard captures a schema for the table (e.g., column counts, column labels and/or reference indicators, size information about the table, rows of the table, and/or columns of the table, etc.). In the example, the first shard and the second shard have redundant information (e.g., the schema information), but the utilization of both shards allows for efficient operation of the document (in terms of utilization of computing resources such as memory, network communications, and/or processing, and/or in terms of user time where the schema shard allows for rapid display of important aspects of the document so the user can begin working with the document before the document is fully populated), while incurring a minimal cost to support these efficiencies. In certain embodiments, shards may be associated in groups to support certain operations related to the document, and/or to create different views of the document available to be used on distinct devices, with distinct users, and/or to support distinct types of operations and/or access related to the document. For example, a group of shards may be created to support user experiences in the context of limited resources, where resource limitations may relate to device hardware (e.g., display sizes and/or types, I/O limitations such as the presence or lack of a keyboard, mouse, or other I/O hardware associated with the device), computing resources (e.g., available memory, connectivity include data rate and/or data caps associated with the device or user), user limitations (e.g., authorization of the user to access or perform certain operations, limited subscriptions to underlying documents, packs, external data or services, etc., that may be utilized by the document), and/or to support inferred or explicit user preferences (e.g., supporting rapid access to certain document features, objects, or locations, prioritizing document responsiveness over resource utilization, or vice versa, etc.).

The utilization of a particular sharding scheme, which may additionally or alternatively be referenced as a group of shards, a shard strategy, or a shard recipe, allows for customized support for users based upon the resource limitations for that user, according to a document experience that is desired by an author of the document and/or a custodian of the UDS interface management (e.g., an operator and/or administrator of the document serving circuit, a controller such as depicted throughout the present disclosure (e.g., controller 2238 of FIG. 22). The sharding scheme includes the shards and sharding logic (e.g., how the document data is divided up and/or supported by shards), the timing to prepare and/or update shards, and/or how the shards are to be delivered to a client device accessing the logic (e.g., the order and timing of shard delivery, which shards are to be delivered every time and which shards may be held until relevant portions of the document are accessed and/or appear likely to be accessed, etc.). In certain embodiments, a distinct sharding scheme may be provided for a first user experience (e.g., the user experience including a user, a particular client device, a particular access configuration, an access location, and/or an access time, etc.), and a second sharding scheme may be provided for a second user experience (e.g., a different user, device, access configuration, access location, and/or access time), where the selection of which sharding scheme is to be utilized for a given user experience may be a part of the overall sharding strategy. In certain embodiments, multiple sharding schemes may be supported at any given time, with appropriate shards created (e.g., by a document sharding circuit) to support all of the sharding schemes contemplated for the document. In certain embodiments, a sharding scheme may be dropped from support (e.g., where user experiences, document characteristics, and/or other factors in the system indicate that a particular sharding scheme is no longer being utilized, is being utilized only at a low frequency, and/or is not providing or no longer providing efficient operations), and/or added for support (e.g., where user experiences, document characteristics, and/or other factors in the system indicate that a new sharding scheme may be indicated, and/or as a part of an iterative improvement process to test sharding schemes for efficiency improvements and/or user experience improvements).

In certain embodiments, a particular group of shards to support a particular sharding scheme may include all document data (e.g., where the group of shards contains all information about the document between the shards), and/or may include a subset of the document data (e.g., where some document data is not within the shards, which may be utilized where the user is not authorized to access certain parts of the document that do not then require support within the group of shards, and/or where the snapshot or shards from a different group of shards can be utilized if the user accesses portions of the document that are not supported within the group of shards). In certain embodiments, at least one shard group may be included that has all of the document data, the snapshot and/or operations log may be kept as the repository of all document data, and/or the entire shard corpus may embody the document data, without any particular group of shards having all of the document data therein. In certain embodiments, certain document data may be provided within multiple shard groups—for example where efficiencies to support the multiple shard groups exceed the cost of storing and managing redundant document data, and/or within multiple independent shards as noted preceding.

In certain embodiments, the snapshot may be embodied as a group of shards, for example a group of shards that define all of the document data (e.g., except operations stored on the operations log), where the snapshot is not stored as a single data element (e.g., a single file or data structure). In certain embodiments, the group of shards embodying the snapshot may not relate to any particular sharding scheme, for example where multiple sharding schemes are present that, between them, include a group of shards having all of the document data, but the group of shards having all of the document data are not associated as a particular sharding scheme. In certain embodiments, a shard may be stored that is not associated with a sharding scheme, for example a shard storing a portion of data for completeness of the snapshot, but where that shard is not utilized in any active sharding scheme. In certain embodiments, for example where the snapshot is embodied as a group of shards, the removal of support for a sharding scheme having a shard that is being utilized as a part of the snapshot, the controller 2238 may preserve the shard when support for the sharding scheme is removed to protect the integrity of the document data. In certain embodiments, the snapshot or another support element for the document, may store a shard management table or other data structure that associates shards to sharding schemes, that notes dependencies between shards (e.g., shard A must be loaded before shard B, for example where shard A includes a table schema and shard B includes data for rows of the table, and/or where shard A includes references or calculations that shard B depends upon), and/or indicates the corpus of shards that embody all of the document data. In certain embodiments, the shard management table or other data structure is updated when sharding schemes are changed, when shard dependencies are changed, and/or when the corpus of shards defining the document data is changed.

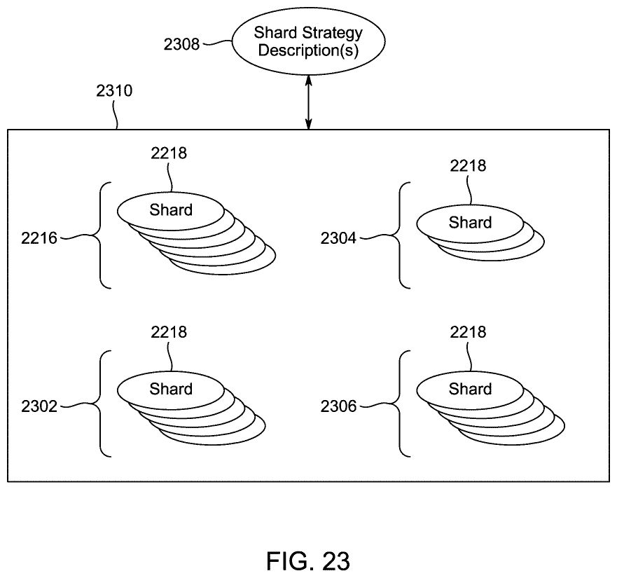

Referencing FIG. 23, an example of multiple shard groups 2216, 2302, 2304, 2306 is schematically depicted. The example group 2310 of shard groups 2216, 2302, 2304, 2306 may be utilized with any system, controller, platform, or circuit as set forth throughout the present disclosure. In the embodiment of FIG. 23, each of the shard groups 2216, 2302, 2304, 2306 is associated with at least one of a number of shard strategy descriptions 2308. In certain embodiments, the shards 2218 of the shard groups 2216, 2302, 2304, 2306 are generated by a document sharding circuit 2204. The shards 2218 within each group may be unique (e.g., shards 2218 between a first group 2216 and a second group 2304 are distinct files or data elements), and/or shards 2218 may be shared between groups. For example, for a document 2214 where a table shard is created for each table, the shard groups 2216, 2302, 2304, 2306 may include one or more of the table shards, which may be references or pointers to the relevant table shards. In certain embodiments, each shard group 2216, 2302, 2304, 2306 supports a different shard strategy, and a given shard group 2216, 2302, 2304, 2306 may support more than one shard strategy (e.g., where two shard strategies—such as “mobile phone shard strategy” and “tablet shard strategy” result in a same grouping and organization of shards). In certain embodiments, two or more of the shard groups 2216, 2302, 2304, 2306 may include the same shards, but have distinct parameters, such as for shard delivery order and/or shard prioritization. In certain embodiments, even where two shard groups 2216, 2302, 2304, 2306 have the same shards 2218 and the same parameters, it may be useful to keep the two separate shard groups 2216, 2302, 2304, 2306. For example, two shard strategies may result in the same shard implementation (e.g., shard mix, shard content, shard delivery, shard prioritization, etc.) for some document types (e.g., small documents, unpublished documents, and/or documents with a low utilization by users), but drive distinct shard implementations for other document types (e.g., large documents, published documents, and/or highly utilized documents). As the document 2214 can evolve over time, for example growing in size, user base, become published (or withdrawn from publication), and/or external documents, web pages, or the like can link to the document 2214 well after the document 2214 is created, embodiments keeping multiple shard strategies and/or shard groups, even with identical resulting implementations during at least certain portions of the document life cycle, may result in more efficient overall implementations of the UDS platform, controller 2238, document serving circuit 2206, document sharding circuit 2204, or the like. In certain embodiments, technically redundant shard groups 2216, 2302, 2304, 2306 and/or sharding strategies may be removed. In certain embodiments, shard strategies and/or shard groups 2216, 2302, 2304, 2306 may be added as indicated throughout the life cycle of the document 2214, and/or as determined according to periodic analysis of sharding strategies and performance, through the operations of iterative improvement operations of the controller 2238, as determined according to criteria related to the document 2214 that may change over time, or the like.

In certain embodiments, the document serving circuit 2206 (and/or the document sharding circuit 2204) selects one of the shard strategy descriptions 2308, and provides selected shards from the shard group 2216 (and/or from a corresponding group of shards 2216, 2302, 2304,2306 for that strategy) to the client serving circuit 2208 in response to the selected shard strategy description 2308. In certain embodiments, the document sharding circuit 2204 generates shards 2218 to support a selected shard strategy description 2308, and/or generates shards 2218 to support multiple, or all, of the shard strategy description(s) 2308. Accordingly, where multiple shard strategy descriptions 2308 are available, they may not all be supported all of the time, for example allowing unused shard strategy descriptions to be unsupported, only supporting a primary shard strategy description, and/or only supporting a few targeted shard strategy descriptions. In certain embodiments, the number of supported shard strategy descriptions 2308 can be adjusted according to the document 2214, events related to the document 2214 (e.g., slow response times, a publication event, a document size threshold, a subscribed or accessing user threshold, etc.).

In certain embodiments, the document serving circuit 2206 (and/or the document sharding circuit 2204) selects one of the shard strategy descriptions 2308 in response to a size of the document, a last accessed location of the document (e.g., for a user, a client device, a recent user, etc.), and/or a selected location of the document (e.g., determined from usage, data density in the document, linking access to the document, landing pages and/or a “page one” for the document, etc.). Accordingly, it can be seen that the supported shard strategy descriptions 2308, and/or the implemented shard strategy descriptions 2308, can be adjusted in real time, and can be tailored to the specific user, specific client device, and/or specific access configuration of the user. In certain embodiments, the document serving circuit 2206 (and/or the document sharding circuit 2204) selects a shard strategy description 2308 in response to a characteristic of a client device 2224 displaying the UDS interface 2222, for example allowing for the selection of a specific strategy that best fits the particular device, including resources available, I/O for the device, and/or resources of the device. In certain embodiments, the document serving circuit 2206 (and/or the document sharding circuit 2204) selects a shard strategy description 2308 in response to one or more of: a user authorization description 2226 for the document 2214, a linked access description 2228 for the document 2214, and/or a publication status of the document (publication status 2236) and/or of a form (publication status 2234).

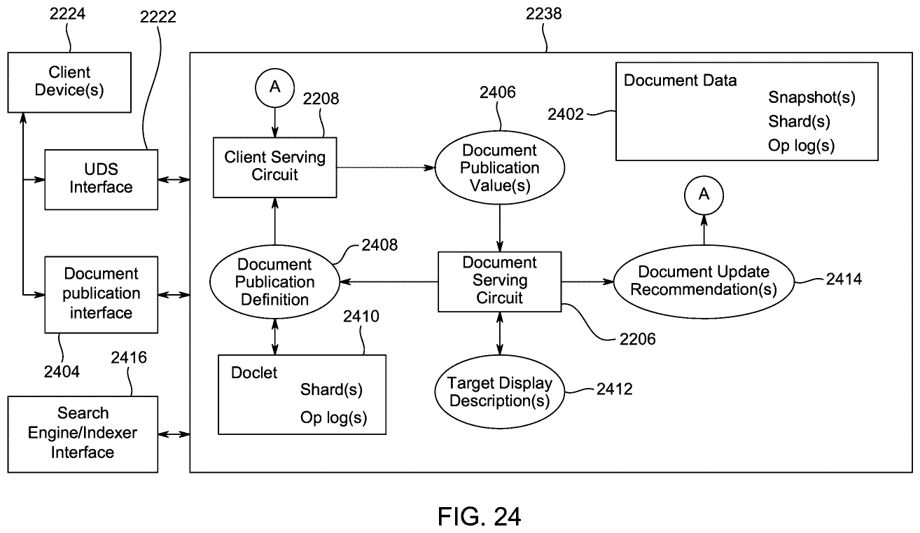

Referencing FIG. 24, an example controller 2238 is depicted for providing publication support for a unified document surface (UDS). The example controller 2238 includes a document serving circuit 2206 that accesses a document data 2402, which may include snapshot(s), operation log(s), shard(s), and/or other data that, together, defines a document that is accessed by users on a UDS interface 2222 for reading, editing, performing calculations, managing workflows, providing notifications to users, and/or for collaborative editing among a group of users. The example document serving circuit 2206 provides at least a portion of the document data 2402 to a client serving circuit 2208, where the client serving circuit 2208 implements a UDS interface 2222 in response to the provided document data 2402. The example client serving circuit 2208 implements a document publication interface 2404, which may be an overlay onto the UDS interface 2222, an inherent feature of the UDS interface 2222 that is available in relevant circumstances (e.g., through a menu selection, publication button, or other interface that is available when the user is able to publish the document, for example if the user has sufficient permissions, a compliant version of a UDS implementing application, etc.), and/or may be a separate interface from the UDS interface 2222 (e.g., appearing in a separate window). The example client serving circuit 2208 provides a document publication value 2406 in response to user interactions with the document publication interface 2404. Example user interactions with the document publication interface 2404 include option selections (e.g., a publication scope, permissions to access the published document, permissions to edit the published document, selections related to data sharing from a main document that is being published, etc.) and/or data entry values (e.g., a title, description, category tag, accessing address, author information, etc.). In certain embodiments, user interactions with the document publication interface 2404 may include allowing the user to import pictures, identify portions of the document that may be of interest to other operations set forth throughout the present disclosure, and the like. In certain embodiments, the document publication interface 2404 includes a publication execution control, for example a toggle switch (e.g., indicating “published” or “not published”), a button or other control to execute publication, or the like.

In the example, the document publication value 2406 captures relevant information from the user for the publication, including information provided through the user interactions, and which may include default information (e.g., for settings that the user did not specify), automatically generated information (e.g., category tags, external data access implementation for the published document, authorization implementations for the published document, etc.).

The example document serving circuit 2206 determines a document publication definition 2408 in response to the document publication value 2406. In certain embodiments, depending upon the format of the document publication value(s) 2406 and processing of user interactions with the document publication interface 2404 by the client serving circuit 2208, the document publication definition 2408 may be identical to the document publication value 2406, and/or the document publication value 2406 may be used as the document publication definition 2408. In certain embodiments, the document publication value 2406 captures one or more elements of the raw inputs of the user interactions, and the document publication definition 2408 is utilized to implement those elements into actionable code elements for execution of the document publication. The example document publication definition 2408 defines a doclet 2410 determined in response to the document data 2402 and the document publication value 2406. In the example of FIG. 24, a doclet 2410 is an embodiment of the document defined by the document data 2402 for publication, which may not be identical to the main document. For example, the doclet 2410 may have omitted portions of the document, have distinct permissions for access and/or editing (e.g., for the entire document, and/or for portions, objects, or sections thereof), and the like. Accordingly, in certain embodiments, for example where publication of the document merely provides full access to the main document for all purposes, the content of the doclet 2410 and the main document may be the same, and the actual data stored may be identical (e.g., the same data at the same memory locations). In certain embodiments, the doclet 2410 is a distinct, dependent document from the main document, where edits to the main document are reflected in the doclet 2410, and where edits in the doclet 2410 may be unavailable, ignored, and/or may be reflected in the main document, depending upon the permissions applied by the author user (e.g., the user that controls the main document and executed the publication) and/or available to accessing users. In certain embodiments, the doclet 2410 may have a separate shard group and/or operation log relative to the main document. In certain embodiments, the doclet 2410 may share one or more shards and/or operation log with the main document. The term doclet 2410 is used herein for clarity of the description, to reference the as-published document embodied in the document data 2402, but all implementations of the doclet 2410, including where the doclet 2410 and the main document are a same document (and/or effectively a same document), are contemplated herein.

The example document serving circuit 2206 publishes the doclet 2410 in response to a publication request received on the document publication interface 2404 (e.g., an in-line formula command, a publication control and/or button, and/or a setting such as a toggle switch indicating a publication status). Operations to publish the doclet 2410 include, without limitation, making the doclet 2410 available for access to users (e.g., by entering a URL for the doclet 2410), exposing the doclet 2410 to a selected gallery (e.g., a gallery created for a workspace, a gallery created for public access on a website, and/or a gallery created through the UDS platform that is accessed by and/or operated by the controller 2238).

In certain embodiments, the document publication definition 2408 includes a unique address to access the doclet 2410. An example unique address is a URL generated that is specific to the doclet 2410, which may be edited or selected by the publishing user. Any type of address is contemplated herein, for example a unique address on a network (e.g., where the publication is to a workspace or other group of users having access to the network). In certain embodiments, the document publication value 2406 includes at least a portion of the document data 2402 to be included in the doclet 2410, for example with selected tables, text flows, canvases, or other objects selected. In certain embodiments, the doclet 2410 includes all of the document data 2402.

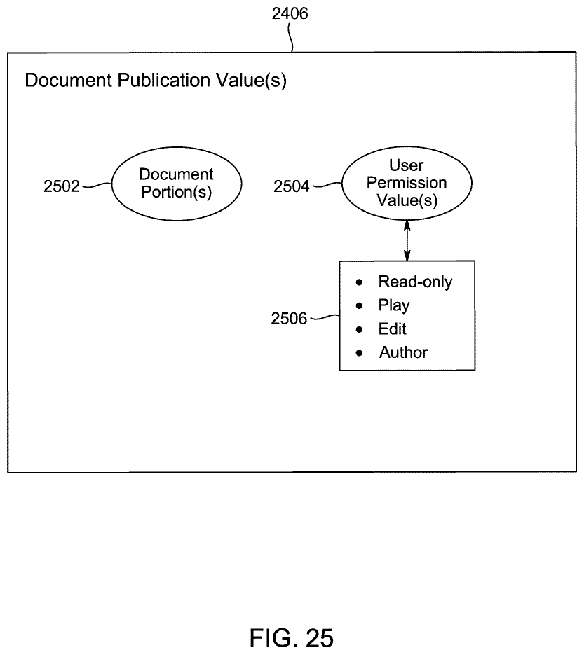

Referencing FIG. 25, an example document publication value 2406 includes a user permissions value 2504, for example defining what operations are available to users of the doclet 2410. The user permissions value 2504 may be specific to users (e.g., a first user has more permissions than a second user), and/or may be specific to portions of the doclet 2410 (e.g., opening a first table up for viewing, but allowing editing for a second table). Additionally or alternatively, the user permissions value 2504 may further include device-specific permissions (e.g., changing access based on a device used to access the document), location specific permissions (e.g., changing access based on a location of the user and/or a client device), and/or other permissions such as subscription permissions (e.g., allowing subscribed users a distinct access from other users), UDS platform permissions (e.g., a user have one version of an interfacing application for the UDS platform having distinct access from another user having a different version—for example to control document access for features of the doclet 2410 that may not be supported in all versions of the interfacing application).

Example and non-limiting access permissions 2506 include read-only access (e.g., allowing the user to view or read the doclet 2410 or relevant portions thereof), play access (e.g., allowing the user to edit the doclet 2410 in a non-persistent manner, for example that is not stored on a doclet 2410 shard or operation log, and not visible to other users), edit access (e.g., allowing the user to make selected edits, such as adding a row to a table, editing selected text flows, etc., but limiting other edit types such as the addition of objects, formulas, tables, and/or editing columns of a table that is present), and/or author access (e.g., allowing author-like editing, such as the addition or deletion of tables, columns, etc., but which may be unlimited, or somewhat limited, for example not allowing edits to protected areas, metadata, disallowing access to analytics or author log information related to the document, etc.). The described permissions 2506 are non-limiting examples to illustrate aspects of the present disclosure.

Referencing FIG. 25, an example user permissions value 2504 includes selective limitations for user interactions with the doclet 2410 based on a user characteristic, such as a user subscription value (e.g., whether the user has paid for specific types of access), a user role (e.g., administrator, super-user, etc.), and/or a user entity (e.g., a user employed at a specific company, that is a member of a specific group, etc.). In certain embodiments, the document publication value 2406 includes a document portion 2502, for example identifying portions of the document (defined by the document data 2402) that are relevant to the publication, such as portions that will be accessible, portions that have associated permissions, and the like.

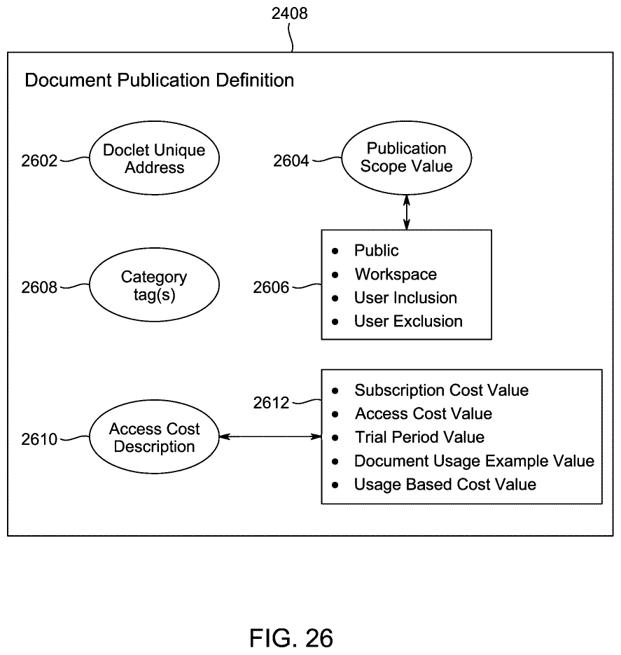

Referencing FIG. 26, an example document publication definition 2408 includes a publication scope value 2604, for example defining a scope of exposure for the doclet 2410 as published. Example and non-limiting publication scope values 2604 include: a public scope (e.g., the document will be visible and/or accessible to all users of the UDS platform, and/or positioned in publicly available location such as a URL accessible to anyone); a workspace scope (e.g., the document will be visible and/or accessible to a group of related users, for example all users associated with a particular entity, all users associated with a particular department, all users having a specific job title, etc., where the group of related users is a “workspace”); a user inclusion scope (e.g., a list of users that can see and/or access the document); and/or a user exclusion scope (e.g., a list of users that cannot see and/or access the document, regardless of the other scope of the document, at least for user access events under the control of the UDS platform or other implementing platform for the doclet 2410).

An example document publication definition 2408 includes a category tag 2608. In certain embodiments, the category tag 2608 is utilized to find published documents (e.g., allowing a user to search and/or filter documents according to a category tag of the document), provided on a document description (e.g., a document description card and/or description associated with the doclet 2410, for example allowing a user to determine the relevance of the doclet 2410 to what they are looking for), and/or utilized to group relevant documents (e.g., ranking “productivity” documents separately from a global ranking of documents). In certain embodiments, the category tag 2608 may be entered by the publishing user, selected from a list by the publishing user (e.g., to enforce consistent terminology for category tags), and/or applied automatically by the document serving circuit 2206 (e.g., determined at the time of creating the document publication definition 2408, and/or updated periodically). In certain embodiments, category tags may be automatically determined by keyword classification of the document, by category tags of similar documents (e.g., other documents having the same author user, documents using similar terminology, similar title words, and/or similar headings within the document). In certain embodiments, category tags may be applied and/or adjusted by a caretaker of the UDS platform, applied or adjusted in response to user feedback (e.g., through an interface for accessing published documents by users of the doclet 2410). In certain embodiments, category tags may be periodically (e.g., once per month) or episodically (e.g., when a new version of the doclet 2410 is published, in response to edits on the doclet 2410, and/or based on subscriptions of users that are out of sync with the category tags of the doclet 2410, for example where subscribers of the doclet 2410 overwhelmingly subscribe to other documents having different category tags, which may indicate that the category tag for the doclet 2410 may not be informative). In certain embodiments, the document publication definition 2408 includes a single category tag 2608, more than one category tag 2608, and/or weighted category tags (e.g., a primary and multiple secondaries, numerically weighted category tags, and/or categorically weighted category tags).

An example client serving circuit 2208 accesses a document list including a number of published doclets (e.g., all doclets in a gallery implemented by the UDS platform, all doclets associated with a workspace, and/or all doclets available to the user), and displays selected ones of the document list to the client device. An example client serving circuit 2208 selects documents for display based on the category tags 2608, and/or orders the selected ones of the document list based on the category tags 2608.

An example document publication definition 2408 includes an access cost description 2610, for example setting criteria for a cost to access the published doclet 2410. Example access cost descriptions 2610 include members 2612 such as a subscription cost value (e.g., defining a periodic cost for access), an access cost value (e.g., a one-time cost to purchase access), a trial period value (e.g., a period of time where access can be reduced cost or free), a document usage example value (e.g., usage examples of the document, or other documents using the document, that may be made available for a reduced cost, free, for a limited time, and/or with limited functionality, for example to allow users to evaluate the fit of the document to their intended need), and/or a usage based cost value (e.g., a cost per user, a cost per access, a cost per execution event—for example to allow for modeling scenarios using the document, etc.). In certain embodiments, the usage based cost value may include a cost function, for example a per-user cost that can scale or otherwise change based on the number of users. In certain embodiments, access to the document and/or access costs can be controlled at a group level, for example with an administrator of a workspace providing and/or purchasing access to the doclet 2410 for the entire group.

An example document serving circuit 2206 performs a document style check in response to the document publication value 2406. In response to the document style check determining that a change to the doclet 2410 is recommended, the client serving circuit 2208 provides a document update recommendation to the document publication interface 2404. For example, the document serving circuit 2206 may check whether the document follows a best practice (e.g., formatting, header information, chart types, etc., which may be determined from similar popular documents, defined best practices by an entity or administrator associated with the publishing user, and/or defined best practices by a caretaker of the UDS platform), requirements for the document (e.g., disclaimers, word usage, formatting, etc., that may be defined in any manner similar to the best practices), column width or organization values, screen width and/or organization values, and/or types of access provided (e.g., when it appears that sensitive document areas are editable and/or visible, which may be implemented on particular types of formulas, data elements such as personally identifiable information, or the like). In certain embodiments, the document update recommendation may include any one or more of: flagging identified areas without a specific recommendation; making a display size recommendation; making a usage recommendation (e.g., suggesting to hide or protect certain areas of the document); making a formula recommendation (e.g., flagging certain formulas and/or suggesting more robust alternatives); language recommendations (e.g., avoiding or utilizing jargon or specific keywords, and/or adjusting the language literacy level); and/or context-related recommendations (e.g., a setting incongruous with other documents published by the user, public access to a document labeled “confidential”, a cost collision such as a free document that utilizes an expensive pack, external data, or external service, etc.).

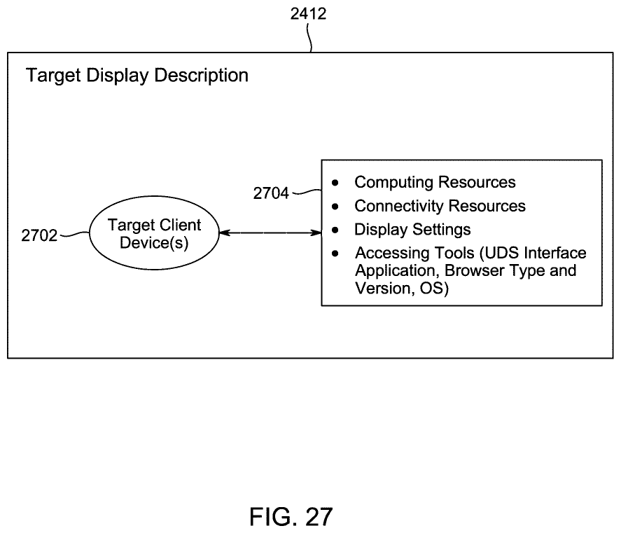

An example document serving circuit 2206 performs the document style check in response to a target display description 2412. Referencing FIG. 27, an example target display description 2412 includes one or more target client devices 2702, with associated resources 2704, such as computing resources, connectivity resources, display settings, and/or accessing tools (e.g., a UDS interface application, a browser type, an operating system, and/or versions of these). In certain embodiments, the target display description 2412 may be entered by the publishing user (e.g., to ensure compatibility and/or a good document experience with the selected devices), included as a default list by a caretaker of the UDS platform, and/or defined by an administrator associated with the user. The utilization of the target client devices 2702 allows the document serving circuit 2206 to ensure compatibility and/or a good document experience with a range of client devices, including the implementing applications to access documents on the UDS platform. In certain embodiments, some formulas or other operations may be incompatible with certain operating systems, browsers, applications, and/or versions of these (including at least newly released versions and/or older versions). In certain embodiments, the document serving circuit 2206 flags aspects of the doclet 2410 that are potentially issues, and/or suggests adjustments to the doclet 2410 that result in similar looking document and/or similar functionality.

An example document serving circuit 2206 performs a document prominence check in response to the document publication value 2406, where the client serving circuit 2208 provides a document update recommendation to the document publication interface 2404 in response to the document prominence check indicating that aspects of the doclet 2410 may detract from the doclet 2410 being listed as high as it could be within a gallery, search engine results, or the like. Example operations of the document serving circuit 2206 to perform the document prominence check include, without limitation: keyword selection; document terminology selection; usage a headers in-document; and/or usage of standardized HTML representations for the document (e.g., header terminology and/or arrangement). In certain embodiments, the document update recommendation can include one or more of: recommended category tags, recommended word changes, recommended header changes, and/or recommended chart types or other visualization types. In certain embodiments, the document serving circuit 2206 may include best practices or other expert defined sources, comparisons to other documents that are ranked highly in a gallery and/or search engine results, or the like.

An example document serving circuit 2206 exposes the doclet 2410 to a search engine and/or an indexer (e.g., Google) in response to the publication request. In certain embodiments, the search engine and/or indexer may operate within the scope of a UDS platform (e.g., dedicated to a corpus of documents associated with the UDS platform), and/or external to the UDS platform (e.g., generally available to the internet).

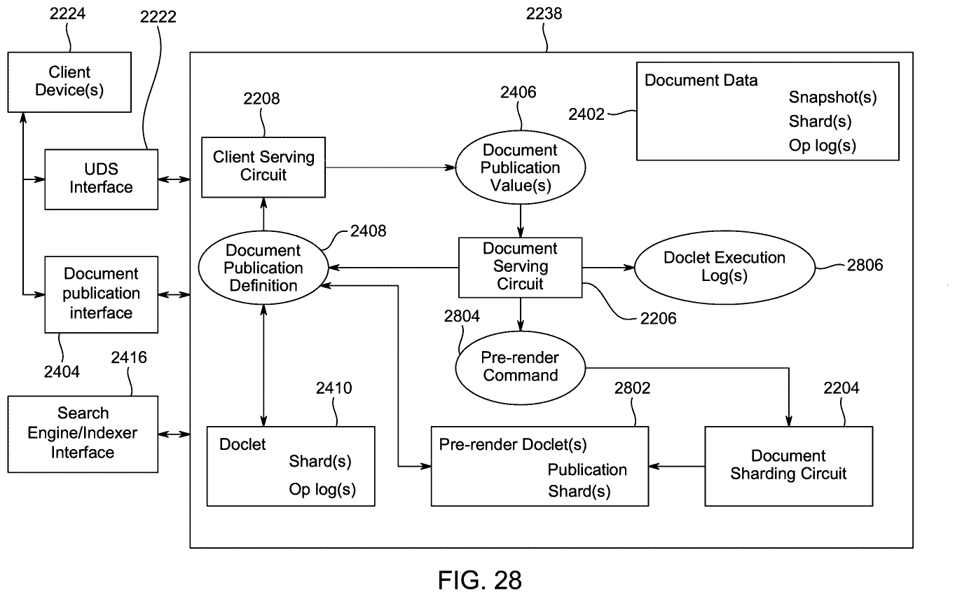

Referencing FIG. 28, an example document serving circuit 2206 prepares at least one pre-render doclet 2802 in response to the publication request. In certain embodiments, the document serving circuit 2206 prepares the pre-render doclet(s) by providing a pre-render command 2804 to a document sharding circuit 2204, where the document sharding circuit 2204 generates at least one publication shard in response to the pre-render command 2804. The example publication shard captures a state of at least a selected portion of the doclet 2410. Descriptions throughout the present disclosure to prepare shards that support rapid document rendering and access for users are applicable to the publication shard. An example client serving circuit 2208 provides the publication shard(s) to a second document publication interface accessing the doclet 2410 (e.g., a second user accessing the published document using a gallery, address link, search engine return result, etc.), and in certain embodiments provides the publication shard before providing one or more other shards of the doclet 2410—for example to allow for rapid rendering and/or access to the user accessing the published document.

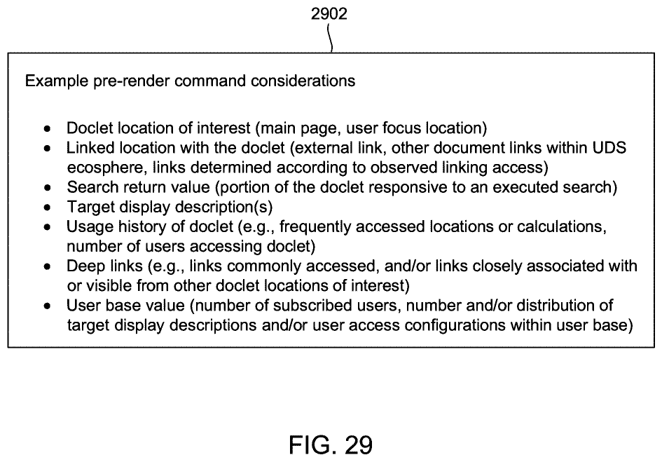

Without limitation to any other aspect of the present disclosure, certain considerations to prepare the publication shard include one or more of: a selected location within the doclet; a linked location within the doclet; a search return value identifying a location within the doclet (e.g., search terms that tend to surface the doclet within a gallery or search engine, which may be highlighted within the gallery or search engine results, making the user more likely to access those sections of the doclet); a usage history of users interacting with the doclet; an initial view of the doclet (e.g., a default position of the doclet based on access from a gallery, etc.); a deep link of the doclet (e.g., a linked or referenced location within the doclet that is accessible by a link or reference within, or in close proximity to, any other identified location for the doclet); a user base value for the doclet; a number of users having a selected access (e.g., read-only, play, edit, etc.) to the doclet; a number of user access configurations for users having access to the doclet (e.g., a high percentage of phone users for the doclet, etc.); and/or a distribution of user access configurations for users having access to the doclet. An example document serving circuit 2206 monitors parameters utilized to determine the publication shard, such as a user base value, and updates the publication shard(s) in response to the monitored values. For example, if user access operations change the relevant locations within the doclet, the distribution of user access configurations, and/or the total number of user changes, the document serving circuit 2206 may command an update to the publication shard(s) to support continued efficient operations of the doclet 2410. Without limitation to any other aspect of the present disclosure, a non-limiting example of certain considerations 2902 to determine the pre-render command 2804 is depicted at FIG. 29.

An example document serving circuit 2206 interprets a doclet access value for the doclet 2410, and performs a document credit action in response to the doclet access value. In certain embodiments, the doclet access value determines a number of users subscribing to, accessing, utilizing, or otherwise interfacing with the doclet 2410, and/or determines one or more of these according to a user type (e.g., new users, users having published documents, etc.). In certain embodiments, the document credit action includes one or more of: providing a credit to an account of the user on a UDS platform, featuring a document of the user, sending a congratulatory message to the user, or the like. In certain embodiments, credited activities for the doclet access value include one or more of: achieving a threshold number of accessing, editing, and/or subscribing users; bringing new users into the UDS platform by access to the doclet 2410; and/or receiving positive reviews or similar feedback from other users of a UDS platform.

An example document serving circuit 2206 determines a doclet execution log in response to operations of users accessing the doclet 2410, and exposes at least a portion of the doclet execution log to an author of the document data (e.g., the publishing user). In certain embodiments, the doclet execution log and/or aspects thereof may be exposed to other users, such as a caretaker of the UDS platform, an administrator associated with the user, and/or subscribing users of the doclet 2410. Example and non-limiting information in the doclet execution log includes one or more of: a number of documents referencing the doclet; a number of execution events of components of the doclet (e.g., certain formulas, external data access events, external service access events; editing of text flows; and/or execution of buttons or control objects); an execution time of execution events of components of the doclet; a number of users accessing the doclet; a number of users editing the doclet; an interface time of users with the doclet; a number of users performing non-persistent editing of the doclet (e.g., “play” access); a user description of users accessing the doclet (e.g., user identifiers, a distribution of access configurations, location of users, etc.); an accessing source of users accessing the doclet (e.g., a gallery, search engine, external link, and/or search terms, category tags, or other aspects of these related to the access event); and/or a display description of users accessing the doclet (e.g., display size, resolution, available color palette, etc.).

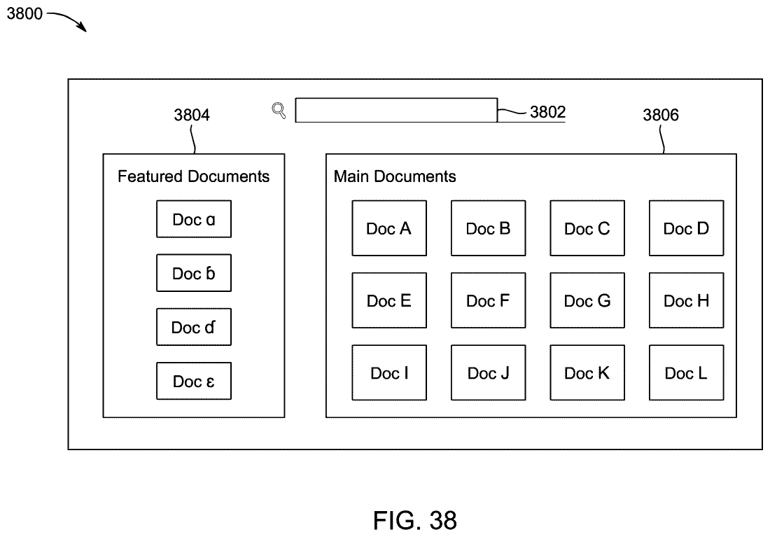

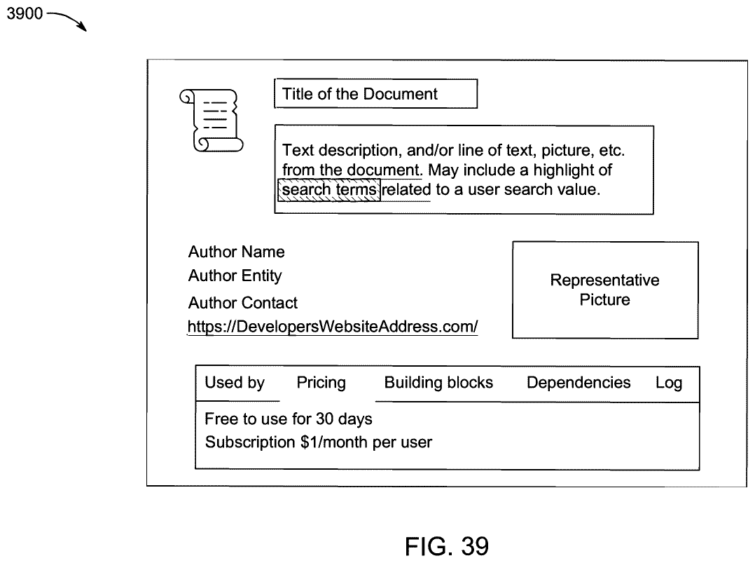

An example document serving circuit 2206 publishes a document description card 3900 in response to the document publication definition. For example, referencing FIG. 39, an example document description card is illustrated. The example document description card includes: a document icon (e.g., the scroll in the upper left, where the user can select or import any desired icon); a title of the document; a text description and/or resulting text from a gallery and/or search engine that caused the document description card to be displayed; author information for the document (e.g., author name, related entity, contact information, and/or a website for the author and/or an entity of the author); a document picture (e.g., a picture from the document, and/or any picture selected by the author that may enhance understanding of the goal of the document); a utilizing document list (e.g., other documents that link to and/or utilize the doclet in whole or part); a utilizing packs list (e.g., packs that utilize the doclet, for example by linking to the doclet and/or calling the doclet through an interface); a document building block description (e.g., formulas, packs, and/or external data or services utilized by the document, for example to help users find doclets of interest based on the building blocks, and/or to determine if they have sufficient access to the building blocks of the doclet to make utilization of the doclet worthwhile); a document dependency description (e.g., formulas, packs, browsers, access configurations, system requirements, and/or other information that can help the user ensure they will have full use of the doclet); and/or a document pricing description. In the example of FIG. 39, some aspects of the document description card 3900 are accessible through a menu interface (e.g., “Used by”, “Pricing”, etc., where the illustration of FIG. 39 shows “Pricing” currently selected). The actual layout and context of the document description card 3900 is non-limiting, and any information considered useful by the author, other users, and/or a caretaker of the UDS platform may be provided on the document description card 3900. In certain embodiments, the content of the document description card 3900 may be adjusted according to the context—for example display in a featured document list may vary from display in a main document list (e.g., reference FIG. 38), and display after a specific user focus (e.g., clicking the document description card 3900 when displayed on a list) may be varied further. In the example of FIG. 39, a “Log” option is depicted on the document description card 3900, which may be present only in certain circumstances (e.g., to the author user, an administrator, a caretaker of the UDS platform, subscribing users, etc.). In addition to the Log option varying in availability by user, the content of the Log option may additionally or alternatively be varied by user. Any one or more of the depicted aspects of the document description card 3900 may be omitted or adjusted, and/or other elements throughout the present disclosure that may be of value to a user determining whether a doclet is useful for that user may be included on the document description card 3900.

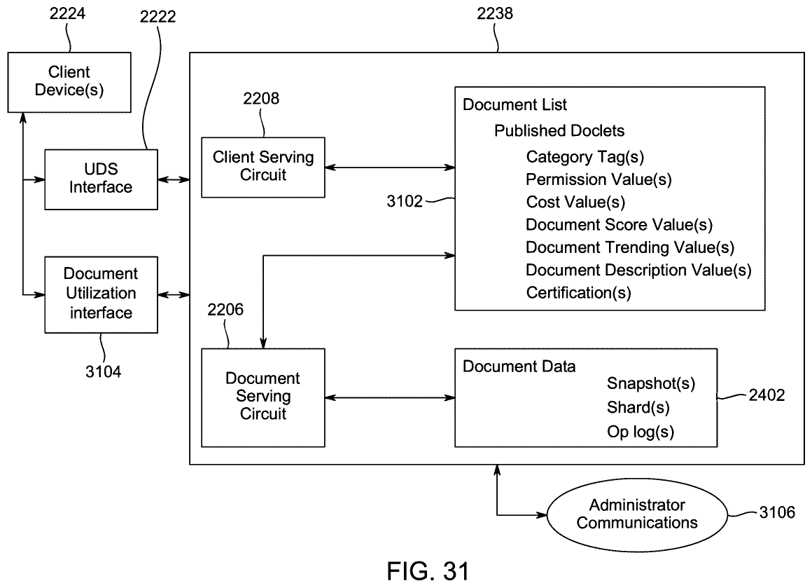

Referencing FIG. 31, an example controller 2238 includes a client serving circuit 2208 that implements a UDS interface 2222, accesses a document list 3102 including a number of published doclets, that implements a document utilization interface 3104 including a gallery of at least a portion of the document list 3102. The example client serving circuit 2208 provides selected access to a selected doclet from the gallery in response to user interactions with the document utilization interface 3104. In certain embodiments, the client serving circuit 2208 interprets a user category tag (e.g., as text entered by the user and/or as a selection by the user from a list of category tags), and determines the at least a portion of the document list 3102 in response to the user category tag, and further in response to doclet category tags for each of the published doclets. In certain embodiments, the at least a portion of the document list 3102 includes only doclets having the category tag, having a similar category tag (e.g., alternate spellings, similar meanings, etc.), and/or doclets that have sufficient relevancy to the user (e.g., according to prior user documents accessed, similarity to documents the user has created or accessed, and/or having a match to other elements of a user search beyond the category tag, such as a word search term) despite lacking the category tag match. An example client serving circuit 2208 interprets a user search value (e.g., text entered on the document utilization interface, and/or suggested text selected by the user from a suggested value or list), and determines the at least a portion of the document list 3102 in response to the user search value.

An example client serving circuit 2208 determines the document list in response to a permissions value corresponding to the user, for example filtering a corpus of doclets that are potentially available to doclets that the user has permission to see, permission to access, permission to edit, and/or where the user may not have permissions but could potentially get permissions (e.g., through approval of an administrator related to the user, and/or by purchasing access to a given doclet). In certain embodiments, the permissions value may correspond to related permissions, for example permissions for the user related to building blocks of the doclet (e.g., a pack utilized by the doclet, an external service or external data accessed by the doclet, and/or a subscription level with the UDS platform 3000 required to utilize certain formulas and/or other elements of the doclet). In certain embodiments, permissions based operations of the client serving circuit 2208 include selecting the at least a portion of the document list 3102 in response to the permissions value corresponding to the user—for example instead of, or in addition to, the filtering of the corpus of doclets. For example, filtering operations of the corpus of doclets may be more permissive (e.g., only filtering doclets where the user could not readily get permission to fully utilize the doclet), and operations to select the at least a portion of the document list 3102 may be more stringent, performed according to user preferences, and/or performed as a part of an ordering and/or scoring scheme to determine the portion of the document list 3102 (e.g., scoring a doclet with permissions issues for the user relatively lower, but not excluding them from consideration).

An example client serving circuit 2208 further determines the at least a portion of the document list 3102 in response to a document score value for each of the doclets from the document list 3102. In certain embodiments, the document score value may be determined in response to a match of an aspect of the doclet to a user search value, a similarity of the doclet other doclets the user has accessed and/or documents the user has created, according to a trending value for each doclet (e.g., recent usage history, subscription history, editing history, etc.), and/or according to a fit of the category tag(s) of each doclet with a user category tag. As noted preceding, a cost to the user to access the doclet (e.g., including a cost of the doclet, and/or an incremental cost to the user to obtain building blocks within the doclet) may be utilized to determine the document score value(s). In certain embodiments, the document score value(s) may be utilized to filter the document list 3102, to select the at least a portion of the document list 3102, to sort the selected doclets (e.g., for positioning depictions of the doclet on the document utilization interface 3104, to determine how prominently to display the doclet, and/or to determine what information to present about the doclet—for example emphasizing information tending to improve or degrade the document score value, which may allow the user to more readily determine whether the doclet is, or is not, likely to be of interest), and/or to order the selected doclets for display on the document utilization interface 3104. In certain embodiments, operations of the client serving circuit 2208 to sort and/or order doclets on the document utilization interface 3104 may be performed in response to the doclet category tag. In certain embodiments, the client serving circuit 2208 interprets a user preference value in response to user interactions with the document utilization interface 3104, and performs operations in response to the user preference value, including operations such as: determining the document score value(s), sorting the selected doclets, and/or ordering the selected doclets. For example, the user preference value may indicate that some criteria (e.g., presence or absence of building blocks, search term matching, category tag matching, pricing information, and/or permissions information) are more important than other criteria, are dispositive (e.g., determinations should be made solely on the dispositive criteria), and/or should not be considered (e.g., an indication to ignore pricing considerations and find the best doclets without such considerations).

Referencing FIG. 38, an example document gallery 3800, for example for display on the document utilization interface 3104, is schematically depicted. The example document gallery 3800 depicts a featured document section 3804, for example depicting doclets that are highly relevant (e.g., a very close or perfect match to one or more criteria, such as a word search term), top trending doclets within a selected scope (e.g., doclets of a certain category tag, doclets within a workspace, and/or doclets within the entire scope of the UDS platform), top all-time doclets within a selected scope (e.g., based on user accesses, ratings, revenue, editing events, formula operations, or the like), and/or doclets having a highly significant match with user preference values. The example document gallery 3800 further includes a main documents section depicting selected doclets from the document list 3102, for example sorted and ordered according to operations described in relation to FIG. 31. The example documents gallery 3800 includes a user search interface 3802, for example allowing the user to enter search values. The example documents gallery 3800 is a schematic depiction illustrating certain aspects of the present disclosure. The depicted aspects may be omitted or replaced, and/or may include additional elements such as a category tag selection interface, a building blocks selection interface, a user preference value interface, or the like. In certain embodiments, one or more of these interfaces may be available within the user search interface as depicted, for example as previews, lists, or autocompletion options presented in response to the user focus being positioned at the user search interface 3802. In certain embodiments, the doclets on the documents gallery 3800 may be depicted with a document description card as set forth throughout the present disclosure, including as depicted in FIG. 39 and the related description. In certain embodiments, doclets in distinct sections, for example the feature documents section 3804 relative to the main document section 3806, may utilize distinct document description cards. In certain embodiments, doclets within a section may utilize distinct document description cards, for example where doclets listed earlier, and/or having a higher scoring value or the like, may have a more complete version of a document description card relative to doclets listed later and/or having a lower scoring value.

In certain embodiments, operations to filter the document list 3102, to select the at least a portion of the document list 3102, to determine document score value(s), to sort and/or order doclets on the documents gallery 3800, may be performed utilizing any of the information described in relation to the document description card(s). Additionally or alternatively, user preference values may be received in relation to any of the information described in relation to the document description card(s), and/or utilized in filtering, scoring, sorting, and/or ordering operations.

In certain embodiments, an example client serving circuit 2208 performs operations to filter the documents list 3102, to select the portion of the documents list 3102, and/or to display a doclet on the documents gallery 3800 in response to an administrative permissions value corresponding to the user and/or one or more of the published doclets. For example, an administrative permissions value may include a cost permissions value (e.g., limiting the user to access only doclets meeting the cost permissions value), a building block value (e.g., preventing the user from accessing documents having certain building blocks, such as certain packs, formulas, external data utilization, and/or external service utilization), a document inclusion value (e.g., the administrative permissions value indicates certain doclets as approved, regardless of other criteria), a document exclusion value (e.g., the administrative permissions value indicates certain doclets as unavailable, regardless of the other criteria), and/or a document certification value (e.g., the administrative permissions value requires a certification, for example by a caretaker of the UDS platform, by an entity associated with the user and/or administrator providing the administrative permissions value, and/or by a third party service, where the certification can relate to any aspect, including for example whether documents utilize acceptable language and/or formatting, are secure and/or free from malicious code, etc.). In certain embodiments, the client serving circuit 2208 provides an administrator notification in response to the user interactions with the document utilization interface 3104 (e.g., an operation to request access to a doclet), and to provide the selected access to the selected doclet in response to an administrator response authorizing access to the selected doclet. For example, an administrator associated with the user may mark one or more doclets (or all doclets) as requiring approval, where the administrator notification is provided in response to a relevant user requesting and/or attempting access to one of the marked doclets.

An example document serving circuit 2206 accesses a document data 2402 corresponding to the selected doclet (e.g., selected in response to user interactions with the document utilization interface 3104), and to provide at least a portion of the document data 2402 to the client serving circuit 2208. The example client serving circuit 2208 implements the UDS interface 2222 in response to the provided portion of the document data 2402, thereby providing selected access to the selected doclet. In certain embodiments, selected access is according to relevant permissions of the user for the doclet (e.g., read-only, play, and/or edit permissions, applicable to portions of the document, and otherwise as described throughout the present disclosure).

Without limitation to any other aspect of the present disclosure, operations described in relation to publication and/or access to doclets, for example as set forth in FIGS. 22, 28, 31, 38, 39, the related descriptions, and otherwise as set forth herein, and including at least doclet filtering, selection, sorting, ordering, gallery display, user preference implementation, and/or permissions implementation, are also applicable to operations herein in relation to packs and extensions, for example as set forth in FIGS. 11-21 and the related descriptions.

Referencing FIG. 32, an example controller 2238 is depicted supporting operations for a user to create, publish, and/or submit forms related to a document on a UDS platform. The example controller 2238 includes a document serving circuit 2206 that accesses a document data 2402, the document data 2402 comprising data for a unified document surface, and to provide at least a portion of the document data 2402 to a client serving circuit 2208. The example client serving circuit 2208 implements a UDS interface 2222 in response to the at least a portion of the document data 2402, for example allowing the user to create and/or edit a document from which other operations of the controller 2238 allow the creation and publication of a form. The example client serving circuit 2208 implements a form publication interface 3202, and provides a form publication value 3204 in response to interactions of a first user with the form publication interface 3202. The example document serving circuit 2206 further determines a form publication definition 3206 in response to the form publication value 3204, the form publication definition 3206 defining a form determined in response to the document data 2402 and the form publication value 3204, where the form publication definition 3206 includes an accessing address for the form (e.g., a unique URL that accesses the form). The example client serving circuit 2208 further implements a form submission interface 3208 in response to the form, and to interactions of a second user (e.g., using a second client device 3210) with the form submission interface 3208. The example document serving circuit 2206 further updates the document data 2402 in response to the interactions of the second user with the form submission interface 3208. An example operation of the controller 2238 includes the first user creating the form using the form publication interface 3202, and the second user submitting the form using a submission interface 3208, where the information submitted from the form is placed into the document, for example by adding a row to a table of the document with the submitted information, and/or including metadata related to the form submission (e.g., an identification of the submitting user, etc.).

An example client serving circuit 2208 implements the form submission interface 3208 in response to determining the second user is an authorized user. For example, operations of the first user with the form publication interface 3202 can define authorized users for the form, for example limiting extraneous submissions by users that get access to the unique address for the form. In certain embodiments, defined authorized users may be a selected list of users (e.g., authorized users are on the list), a selected list of not authorized users (e.g., users on the list are not authorized), user criteria for authorization (e.g., users associated with a particular entity, users associated with a particular workspace, users having a specified criteria such as subscribers to a particular doclet, to a particular pack, or the like).

An example form publication value 3204 includes a submission state allowing implementation of the form submission interface 3208, or a second hidden state that does not allow implementation of the form submission interface 3208. For example, the submission state of the form publication value 3204 provides for “publication” of the form. The submission state of the form publication value 3204 may be implemented in any manner, for example as a toggle switch indicating the form is active for accepting submissions or inactive preventing submissions.

An example client serving circuit 2208 implements the form publication interface 3202 to selectively provide, or hide, hidden lookup data to a client device operating the form submission interface (e.g., the second client device 3210). For example, data within a form and/or in the document that is a parent to the form may utilize lookup data (e.g., to sort information on the form, to provide a relevant value to the user on the form, to group information for the form, and/or to utilize in a validation formula for the form, or the like). Because the form is provided to the client device without the full document data 2402, implementation of the form may rely upon other data in the document that is not intended for display on the form. However, if the hidden lookup data is provided with the form data (e.g., the form shard 3214), then a sophisticated user may pull the hidden data, for example from implementing source code for rendering the form, and/or from a memory cache of the second client device 3210. In certain instances, the hidden lookup data is merely not interesting for the form, and access to the hidden lookup data by the submitting user is not detrimental. In certain embodiments, the hidden lookup data may be data that should not be accessible, for example with personally identifiable information (e.g., age, contact numbers, address, etc.), and/or otherwise sensitive data (e.g., employment status, salary, etc.). In certain embodiments, the form publication interface 3202 is implemented to make it convenient for the user creating the form to prevent transfer of such data to the second client device 3210, for example with a simple toggle switch or other highly visible selection to prevent transfer of the data, and/or where the selection to hide such data is implemented by default, requiring active input from the form creation user to allow such data to pass to the second client device 3210. In certain embodiments, the form submission interface 3208 is capable to operate properly without such data, for example by constructing a form shard 3214 for the second user at the time of requesting access to the form, populating the dependent information for the form from the document data 2402 at the time of the access. In certain embodiments, hidden lookup data may be avoided by creating an indexed table having the information of interest, for example by pre-sorting the table using the hidden fields, which may be appended to the document data 2402 and/or deleted after the publication of the form.

An example client serving circuit 2208 implements the form publication interface 3202 to selectively provide, or hide, sensitive information from the second client device 3210 or inclusion on the form at build time in the form publication interface 3202. For example, a selection available to the user creating the form may be made available that prevents the includes of sensitive information within the form. Sensitive information can be defined by the user, by an administrator associated with the user, and/or by a caretaker of the UDS platform. In certain embodiments, sensitive information can be auto detected by the client serving circuit 2208 implementing the form publication interface 3202, for example information that is often personally identifiable information (e.g., names, contact information, birth dates, addresses, health information, etc.). In certain embodiments, the selection to allow or disallow sensitive information is provided to disallow such information by default, reducing the chance that a user inadvertently includes such information on the form or within hidden data that may be accessible to a sophisticated user accessing the form submission interface 3208.

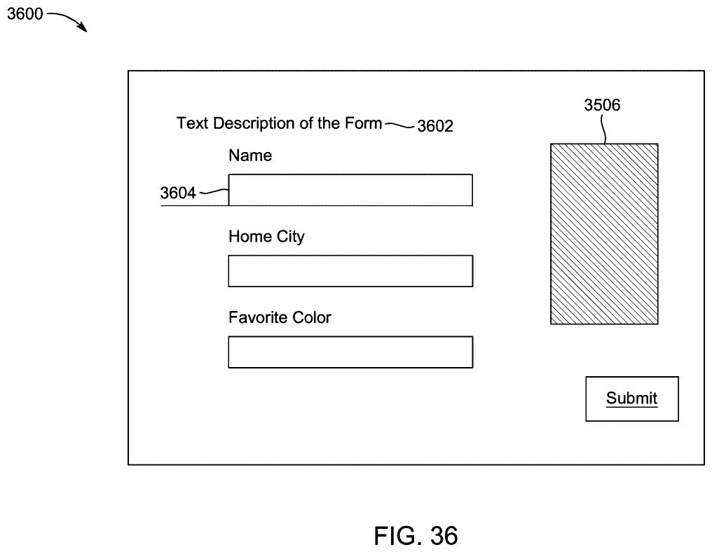

Referencing FIG. 36, an example form 3600 is depicted to illustrate certain aspects of the present disclosure. The example form 3600 includes a text description 3602, for example providing instructions for completing the form 3600, information about how the form 3600 will be used, and/or any other information desired by the form creator. The text description 3602 may be linked to and/or associated with a text flow or text field in the main document, and/or may be created specifically for the form 3600 with interactions of the form publication interface 3202. The utilization of linked text from the main document allows for the form 3600 language to be updated live, while the utilization of dedicated text for the form 3600 reduces connections between the form 3600 and the main document, with attendant risks (e.g., inadvertently changing or deleting the form text). In certain embodiments, the UDS interface 2222 operating on the main document provides a warning and/or notification to the user that edited text is associated with a form 3600.

An example client serving circuit 2208 implements a validation formula associated with data field(s) 3604 of the form 3600. For example, the validation formula may include a verification that the data is within specified ranges, that a date provided is sensible (e.g., before the day of submitting the form for past dates, after the day of submitting the form for future looking dates, etc.). In certain embodiments, the form publication interface 3202 supports the full formula engine for the UDS platform 3000, allowing for highly complex validation formulas, and/or formulas with multiple logical criteria for verification. In certain embodiments, the form submission interface 3202 provides a valid data notification in response to the validation formula and further in response to a data entry interaction (e.g., the submitting user entering data into a text field 3604) and/or in response to the form submission action (e.g., the second user hitting the SUBMIT button as in FIG. 36, or whatever action from the submitting user is supported to request the form submission). In certain embodiments, the valid data notification may be provided in a support text flow 3606, as a tooltip, and/or in a pop-up window. The valid data notification may include an indication that the text field 3604 data is not valid, a description of why the data is not valid, and/or a description of the validation criteria for the field. In certain embodiments, the validation check is performed when the data is entered (e.g., once the user focus leaves the respective text field) and/or when the form submission is requested. In certain embodiments, the support text flow 3606 may be updated with validation information for the user when the user focus is on the text field 3604, for example providing validation support before the user tries to submit invalid data.

An example document serving circuit 2206 provides a form render command 3212 to a document sharding circuit 2204, for example in response to a creation event for the form, and/or in response to a publication event for the form. The example document sharding circuit 2204 generates at least one form shard 3214 capturing a state of the form, and where the client serving circuit 2208 implements the form submission interface 3208 by providing the form shard(s) 3214 to the second client device 3210 operating the form submission interface 3208.

An example document serving circuit 2206 updates the document data 2402 in response to the form submission, placing text (or other information) from the data field(s) 3604 into a table of the document data 2402, and/or storing form submission metadata. Example and non-limiting form submission metadata may be any data of interest related to the form submission, including at least one or more data elements such as: a second user identifier, a form access time stamp, or a form submission time stamp. In certain embodiments, the second user identifier may be an anonymous submission (e.g., a random key, IP address, or other identifier is utilized that does not identify the submitter, and/or no identifier is utilized), a pseudonymous submission (e.g., allowing the second user to enter a nickname, and/or applying a random name to the submission), and/or a identifier (e.g., a username for the second user that is unique, related to the login of the second user with the UDS platform, and/or another unique identifier for the second user such as an email address). In certain embodiments, the form creation user can specify whether submissions are allowed to be anonymous, pseudonymous, or require unique identification. An example form publication value 3204 includes a user identification scheme, for example specifying the identification to be utilized with form submissions.

An example document serving circuit 2206 determines a form submission log 3216 in response to submission activity related to the form, and/or operations of users accessing the form. Example and non-limiting form submission log information includes log information elements such as: a number of form submission events, a data description of submitted data fields of the form (e.g., a listing of values, highest values, lowest values, averages, etc.), an error description for error events occurring during the implementing of the form publication interface (e.g., errors or suspect values that occur during the creation of the form), and/or an error description for error events occurring during the implementing of the form submission interface (e.g., invocations of validation data notifications, submissions with blank data, submission attempts that are not successful and/or a determination of why they failed, etc.). An example document serving circuit 2206 exposes at least a portion of the submission log to the user creating the form, for example allowing the creating user to track analytics related to the form, to determine improvements for the form, etc. In certain embodiments, the document serving circuit 2206 exposes at least a portion of the submission log to other users, for example to an administrator associated with the user creating the form, a caretaker for the UDS platform, or the like. The error log to other users, such as the caretaker for the UDS platform, allows for improvement to the form publication interface 3202, and/or improves support functions for users creating forms.

Referencing FIG. 33, an example controller 2238 includes a client serving circuit 2208 that interprets a submitting user access to a form address (e.g., accessing a unique URL for a form 3600), interprets a form shard(s) (e.g., form shard 3214 and/or as a part of the form publication definition 3206) in response to the submitting user access, implements a form submission interface 3302 in response to the at least one form shard (e.g., providing the form shard(s) to the client device 2224, thereby creating the form submission interface 3302 accessible to the user), and interprets a submission event of the form in response to interactions of the submitting user with the form submission interface 3302. The example controller 2238 includes a document serving circuit 2206 that updates a document data 2402 for a UDS in response to the submission event—for example appending data from the form submission to a table of a main document for the form. An example client serving circuit 2208 further interprets a form publication value 3204 associated with the form, and implements the form submission interface 3302 further in response to the form publication value 3204—for example determining that a creating user has instructed that the form be published. An example client serving circuit 2208 further interprets a user authorization value associated with the submitting user, and implements the form submission interface further in response to the user authorization value—for example determining that the second user is an authorized submitter for the form, and/or determining that the second user is not a prohibited submitter for the form.

Referencing FIG. 34, an example depiction of a number of shards is provided. The shards depicted in FIG. 34 provide illustrative examples of shards that may be created to support a shard group 2216, and/or to support various shard strategies and/or shard recipes. The example of FIG. 34 includes a canvas shard 3402, which may capture a canvas schema and/or canvas data. In certain embodiments, a canvas shard 3402 is generated for each canvas of a document. The example of FIG. 34 includes a table shard 3404, which may capture a table schema and/or table data. In certain embodiments, a table shard 3404 is generated for each table of the document. The example of FIG. 34 includes a critical shard 3406, which may capture essential data to support rapid rendering of the document upon access by a user. The example of FIG. 34 includes a schema shard 3408, which may capture schema elements for objects of interest in the document, for objects related to an initial document position for the user (e.g., a page one position, a linked position, a commonly experienced initial position for users, etc.), for all objects of a selected type in the document (e.g., canvases, tables, etc.), and/or for all objects in the document. The example of FIG. 34 includes a form shard 3410, which may include at least one form shard for each form associated with (e.g., for segregated forms) and/or included within (e.g., for inline forms) of the document. The example of FIG. 34 includes a dedicated shard 3412, which may be a shard dedicated to any aspect of the document to support a selected shard strategy, for example a shard dedicated to support certain frequently used portions of the document, to support specific objects of interest (e.g., a table, a visualization element, a chart, etc.). The example of FIG. 34 includes a partial document shard 3414, which may be a shard configured to support an embodiment of the document as a partial document, for example a partial document related to a published portion of the document, a partial document related to permitted access to a portion of the document for selected users, an abbreviated version of the document created for particular circumstances or users (e.g., a frequently presented portion of the document, a portion of the document created for limited capability devices such as mobile devices, documents to be used as local copies when connectivity is not available for a client device, etc.). The example of FIG. 34 includes a data shard 3416, which may be a shard configured to store data for the document, including for example table data, text flow data, or the like. The utilization of a data shard 3416 alleviates some of the burden on other shards, supporting rapid rendering of the document upon user access to the document. In certain embodiments, a data shard 3416 may be created for a particular object, such as a single table, a text flow, a canvas, or the like. In certain embodiments, multiple data shards 3416 may be utilized to support a large data element, such as a very large table, and/or a data shard 3416 may be utilized to support a number of data elements, such as a number of tables, canvases, or the like.

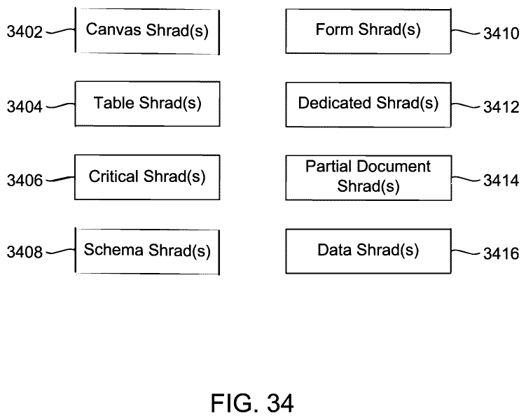

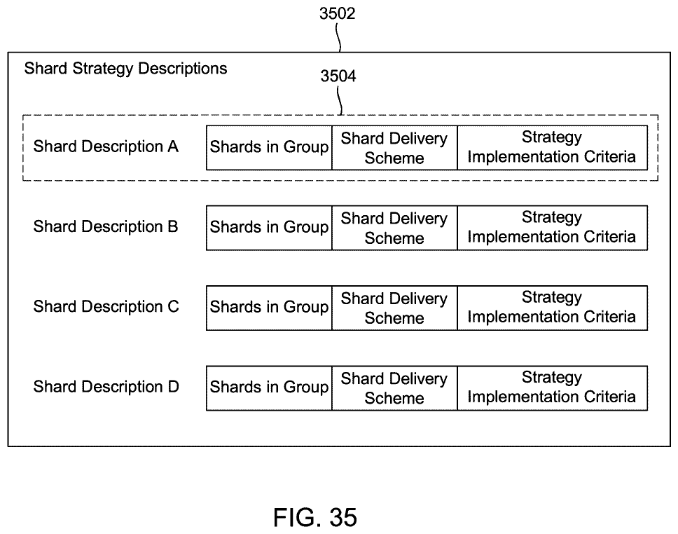

Referencing FIG. 35, a number of shard strategy descriptions 3502 are schematically depicted. In the example of FIG. 35, a single shard strategy 3504 includes a shard strategy identifier (e.g., for tracking, storing, and/or manipulating individual shard strategies), the shards 2218 in a shard group 2216 associated with the shard strategy, a shard delivery scheme associated with the shard strategy, and/or shard implementation criteria associated with the shard strategy. In the example of FIG. 35, the shard delivery scheme defines which shards are to be passed to a client device accessing the document, including an order and/or a priority among the shards. In certain embodiments, shard delivery may be adjusted in response to operations on the document, for example where the user accesses a portion of the document earlier than expected and/or that is out of phase with the purpose of the shard strategy. For example, if the shard strategy is configured around a prediction that the user accesses the document initially at location A within the document, and the user immediately accesses the document at location B after accessing the document, the client serving circuit 2208 may adjust the actual shard delivery relative to the specified shard delivery scheme. In the example of FIG. 35, the strategy implementation criteria defines parameters to determine the circumstances under which the shard strategy is to be implemented. For example, the strategy implementation data may define client device information, user characteristics (e.g., permissions related to the document, document usage history values, etc.).

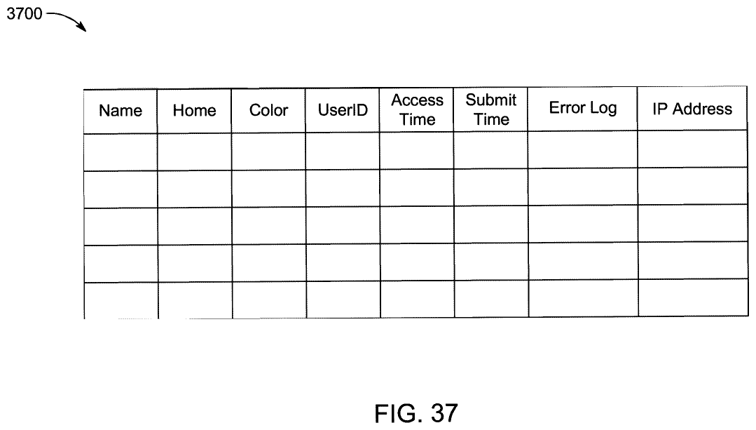

Referencing FIG. 37, an example table 3700 to support a form 3600 is schematically depicted. The example table 3700 may be present within a main document associated with the form 3600, and additionally or alternatively may be utilized to create the form 3600. The example table 3700 of FIG. 37 is consistent with the form 3600 of FIG. 36, where the USERID, Access Time, Submit time, Error log, and IP Address columns capture metadata related to submission events of the form 3600, and where the NAME, HOME, and COLOR columns capture the submitted data from the fields 3604 of the form 3600.

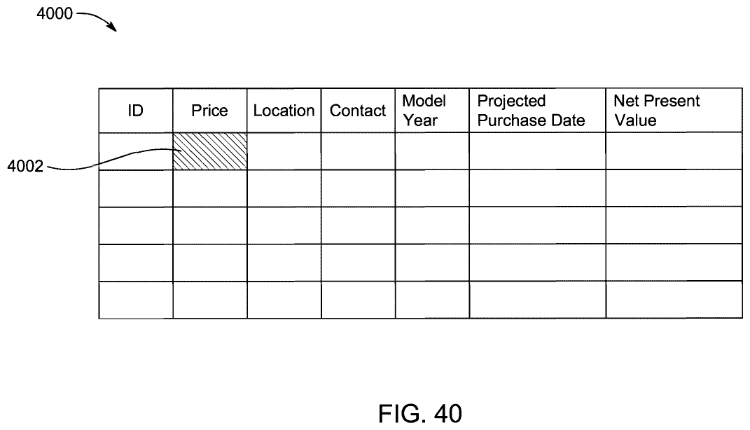

Referencing FIG. 40, an example table 4000 is schematically depicted having a canvas 4002 embedded within a table 4000 of a document. In certain embodiments, any object may be embedded within a table 4000, allowing for nested depictions of data within a table 4000, convenient organization of data within the document, and illustrating the flexibility of the unified document surface implementation of documents of the UDS platform. In certain embodiments, objects such as charts, visualizations, text flows, or the like may be embedded within a table, allowing for associations between those embedded object and data within other columns of the table by row. Additionally, a canvas can support a full rendering of multiple document elements, such as text flows, tables, visualization elements, charts, and the like, providing for a contained universe of document elements within a cell of a table. In certain embodiments, a column formula can be implemented for a column of the table 4000, which may be applied to the canvas 4002 within the document. For example, a column formula can operate on every row within a column of the table, without having to be repeated and/or have cell references to each row. In the example, a column formula applied to the canvas can make global changes to the entire canvas with a single formula entry—for example applying conditional formatting to the entire canvas and/or selected elements of the canvas (e.g., to a table within the canvas, to a text flow, or the like). In certain embodiments, a column formula applied to the canvas can make changes to a single object or element of the canvas—for example each canvas may represent a large data element such as a report (e.g., where the column of the canvases represents instances of the report over a period of time, across a number of departments, etc.), an invoice, a parts list, recipes, etc. In the example, a column formula can reconfigure a single element of every canvas with a single formula entry, for example updating invoices to reflect exchange rate changes, adjust recipes from English units to metric units, change map coordinate systems, etc.

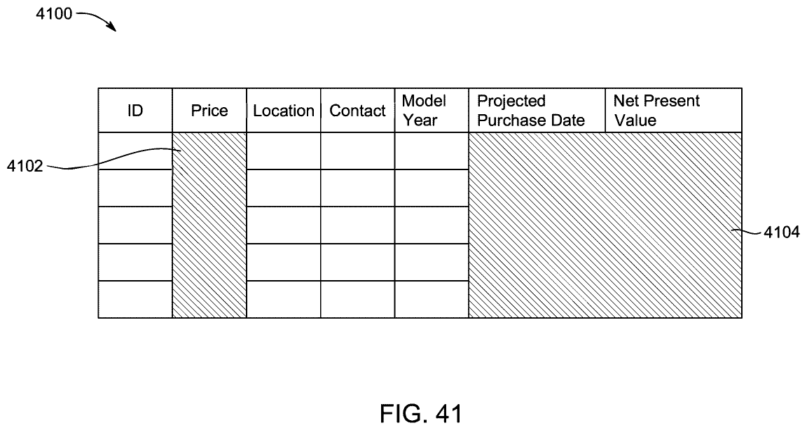

Referencing FIG. 41, an example canvas 4102 is embedded in a table 4100, where the canvas 4102 embodies a column of the table 4100. The example of FIG. 41 additionally includes a second canvas 4104 that embodies two columns of the table, and is a vertically split canvas. The examples of FIGS. 40 and 41 are non-limiting examples, and illustrate aspects of the present disclosure such as embedded objects in a table, including a canvas, and embodiments where a canvas is vertically split allowing for side-by-side construction of extensive document elements, each of which may be a complex document surface having a number of objects therein, with a mixed variety of object elements. In certain embodiments, a document sharding circuit 2204 may generate shards to support the table 4000 and/or embedded canvases within the table 4000, which may include a schema shard for the table, a schema shard for the embedded canvas, and/or data shards for the table and/or embedded canvas.

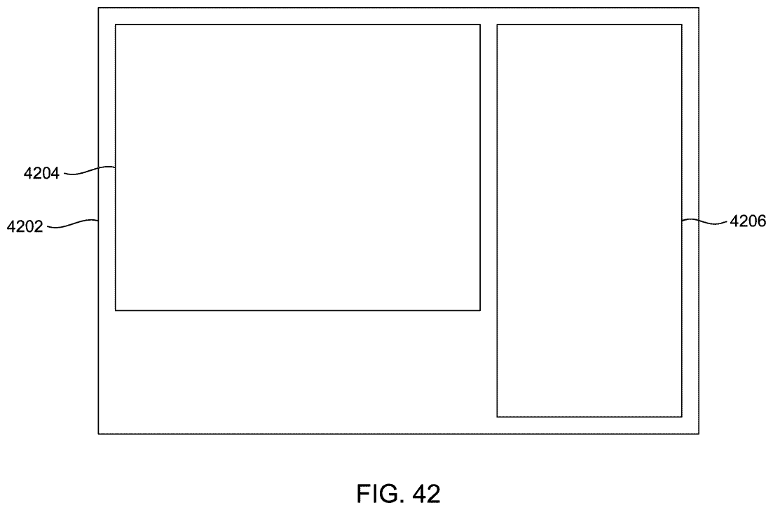

Referencing FIG. 42, an example document surface 4202 includes a first canvas 4204 and a second canvas 4206, where the canvases 4204, 4206 share a vertical extent—for example, the canvases 4204, 4206 are positioned at least partially side-by-side, or the canvases 4204, 4206 are vertically split. The provision for canvas arrangement such as those presented with regard to FIG. 42 allow for ease of creation of documents configured for rendering on selected devices, and for creation of complex arrangements of visual elements, text flows, or the like while remaining readily accessible to casual users of the UDS platform. In certain embodiments, for example with reference to FIGS. 40-42, operations of the client serving circuit 2208 implementing the UDS interface 2222 allow for user selection across multiple sections of the document in a single selection operation. For example, a mouse drag operation in a document represented by FIG. 42 allows for selection of a text flow between both canvases 4204, 4206 in a single operation, allowing the user to perform simple operations to edit the document, even while complex arrangements of the document are implemented. In another example, referencing FIG. 41, a selection operation, such as a mouse drag operation, can select multiple embedded canvases in a single operation. Additionally or alternatively, a selection operation on a surface such as that depicted in FIG. 40 can select text or objects within multiple canvases in a single operation—for example where the “Price” column is a column of canvases (in the example, only a single embedded canvas is depicted), a single selection operation (e.g., a mouse drag) can select multiple canvases, select text and or objects within a canvas, which selection can flow out to the table and/or to adjacent canvases (e.g., a mouse drag with another indicator, such as holding a particular key, and/or toggling a selection setting on the UDS interface 2222), and/or a single selection operation (e.g., a mouse drag with another indicator, such as holding a distinct key, and/or adjusting the selection setting on the UDS interface 2222) can select parallel information among a number of canvases—for example selection of a first paragraph of the first embedded canvas can simultaneously select a first paragraph of each embedded canvas, and/or a first paragraph of each embedded canvas that is engaged by the user focus during the single selection operation. The described examples are illustrative and non-limiting.

In certain embodiments, selection operations that cross document sections or zones include operations that cross canvas boundaries, text flow boundaries, table boundaries, visualization element boundaries, chart boundaries, graph boundaries, linked external data boundaries, and/or preview text boundaries.

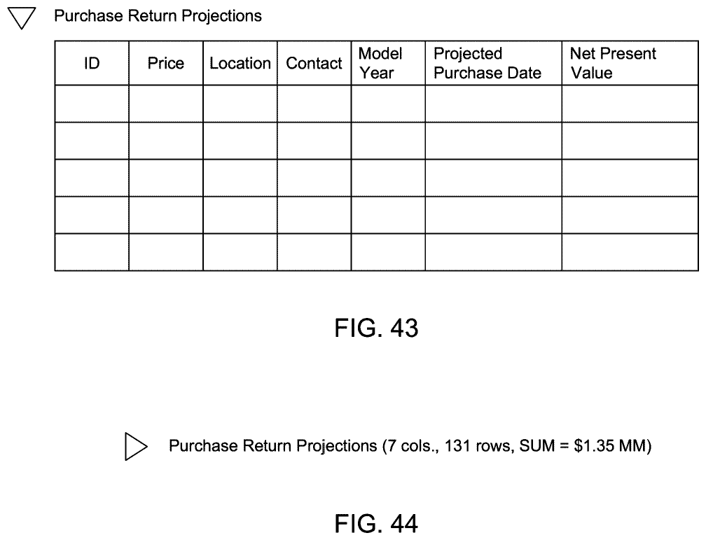

Referencing FIG. 43, an example document surface is depicted, having a collapse interface (e.g., triangle in the upper left corner) provided thereon. An example client serving circuit 2208 hides a document section (e.g., the table of FIG. 43) in response to a user interaction with the collapse interface. In certain embodiments, a collapse interface may be provided on the UDS interface 2222 for each selected feature (e.g., each canvas, each table, each chart, each image, etc.), where the collapse interface is utilized to show or hide the associated section. In certain embodiments, the user can insert a collapse interface for any selected object, and/or associated with any selection by the user, including for selections that cross section boundaries of the document. In certain embodiments, the collapse interface includes a permissions value associated therewith, allowing the user to hide document objects, selections, and/or sections, while optionally preventing other users from exercising the collapse interface to show (or hide) the objects, selections, and/or sections. In certain embodiments, the document sharding circuit 2204 creates one or more shards 2216 associated with the collapsed section, for example allowing the client serving circuit 2208 to display or hide the section of the document associated with the collapse interface, and prevent data of the section of the document associated with the collapse interface from being passed to a client device (e.g., which may allow a sophisticated user to obtain the related data, for example from a memory cache). In certain embodiments, the collapse interface may be shown or omitted for other users and/or in published doclets—for example allowing the document author to collapse sections without another user seeing that the collapse has occurred. In certain embodiments, the collapsed section may be completely hidden, the collapse interface may continue to be shown, perhaps modified such as depicted in FIG. 44, and/or the collapsed section may be replaced with selected data, such as a title, line of text from the collapsed section, summary information for the collapsed section, etc. In the example of FIG. 44, the collapse interface is depicted in a collapsed position (e.g., the collapse interface is turned), and the table of FIG. 43 has been replaced by a title line, combined with some table schema information and a sum of a column of the table. The depicted information for the collapsed section, the visibility of the collapse interface to other uses, and/or the securement of the collapse interface for non-author users are all selectable or configurable by the user, and may be distinct for each collapse interface, document object, and/or document selection. In certain embodiments, the client serving circuit 2208 provides a tool tip on the document surface, for example in response to a user focus positioned at the collapse interface. Example tool tip content includes one or more of: a descriptive line item for the collapsed section, a preview of the collapsed section, a representative data value for the collapsed section (e.g., a first value, last value, sum, average, highest value, lowest value, etc.), and/or an administrative notification value (e.g., an indication that the user does not have permission to exercise the collapsed section, a description of the collapsed section such as a schema, building blocks used in the collapsed section, a word count of the collapsed section, etc.). In certain embodiments, the collapse interface exists in the document model for formula access, with example properties such as display type, permissions associated, the state of the collapse interface (e.g., collapsed or expanded), an associated object reference and/or selection reference, display information (e.g., when collapsed and/or in a tooltip), and/or a persistence value (e.g., allowing the collapse interface to maintain its position after the user exits the document). In certain embodiments, the client serving circuit 2208 stores user interactions with the collapse interface as user operations with the UDS interface 2222 (e.g., to store the collapse state in an operations log, snapshot, and/or a shard, allowing for persistent interaction).

An example document serving circuit 2206 accesses a document data 2402, the document data 2402 including data for a UDS, and provides at least a portion of the document data to a client serving circuit 2208. The example client serving circuit 2208 implements a UDS interface 2222 in response to the at least a portion of the document data 2402, the client serving circuit 2208 further interpreting a user operation including a table creation operation and/or a table linking operation (e.g., creating a linked table to another table in the document, another table in a different document associated with the UDS platform 3000, and/or a table linked to an external table and/or external data), and interprets an access configuration value corresponding to a user performing the user operation. The example document serving circuit 2206 further configures rendering of a created table on the UDS in response to the access configuration value, and where the created table is created in response to the user operation. An example access configuration value include a client device description and/or a platform for the UDS interface 2222 (e.g., a UDS interface version, a browser type and/or version, a UDS platform subscription level, etc.). Example operations of the document serving circuit 2206 to configure the rendering of the created table include one or more of: selecting column width values; selecting column name values; selecting a schema for the table; selecting table navigation control options; selecting a text and/or background color scheme for the table; selected cell delineation elements for the table; selecting row height values for the table; selecting a number of columns to be visible; and/or selecting a number of rows to be visible. In certain embodiments, the document serving circuit 2206 fetches schema information and/or building block information about the linked table to configure the rendering, for example before populating the linked table with data. An example document serving circuit 2206 configures the rendering of the created table based on one or more of: an estimated readability for the access configuration value; an estimated performance response for the access configuration value; an estimated navigability for the access configuration value; and/or a compatibility determined in response to the access configuration value.

An example document serving circuit 2206 configures rendering of a UDS in response to an access configuration value, for example rendering the UDS as one of a centered view (e.g., displayed content is centered horizontally on the UDS) and/or a wide view (e.g., displayed content is rendered to fill the horizontal space of the UDS, for example including provision for margins and/or variability for text, table, and/or images thereon). In certain embodiments, the document serving circuit 2206 configures the rendering of the UDS in response to a display width indicated by the access configuration value, a mapped relationship between an aspect of the access configuration value and a selected rendering scheme (e.g., converting views to be compatible with a browser, adjusting objects to supported objects, etc.), and/or in response to an aesthetic index value. Example and non-limiting aesthetic index values may be determined from one or more of: a white space value resulting from each rendering configuration (e.g., ensuring that white space is provided within selected ranges); a text flow spatial ratio resulting from each rendering value (e.g., a ratio between a width and height of displayed text, for example for a paragraph, text flow, etc.); a table aspect ratio resulting from each rendering value (e.g., a table width to height ratio); a text kerning result corresponding to each rendering value (e.g., considering the spacing between letters resulting from the rendering scheme, for example to avoid stretched letter spacing); and/or a selection history of users having a related access configuration value and related geometric document data to the unified document surface (e.g., determining common operations for display schemes, including spacing, margins, justification values, etc., for documents having a similar geometric appearance such as text flow lengths, table sizes, picture sizes, etc.). In certain embodiments, the rendering may be updated, for example as the user edits the document, adding or removing text, tables, table rows or columns, or edits to other objects. In certain embodiments, the configured rendering may be applied to canvases, tables, text flows, or the like. In certain embodiments, the rendering scheme selected may be determined independently for distinct document objects, document sections, or the like.

An example document serving circuit 2206 provides a number of rendering options to a user performing an operation including a link insertion. In certain embodiments, the rendering options are provided without interrupting the operations of the user. For example, a user may be entering a formula that links to a table, text flow, or other object, where the rendering options are provided as a floating tool tip in the proximity of the user focus, without blocking the data being entered by the user, and/or data immediately preceding the data being entered by the user. In certain embodiments, options may be presented with a thumbnail or other brief depiction of the resulting look of the linked object based on each rendering scheme. In certain embodiments, the document serving circuit 2206 configures the rendering scheme for the linked object in response to a user selection of one of the options, which may include setting schema information for the linked object, seamlessly adjusting the formula and/or related code for the linked object based on the rendering scheme, or the like. Example and non-limiting rendering options include one or more of: a table insertion option, a visual element insertion option, or a link description option. An example client serving circuit 2208 interprets an access configuration value corresponding to the user, and the document serving circuit 2206 provides the rendering options in response to the access configuration value. Example and non-limiting rendering options include one or more of: a table schema option, a table insertion option, a visual element insertion option, a link description option, a centered view option, and/or a wide view option.

An example client serving circuit 2208 interprets a location value for a user associated with the UDS, and the document serving circuit 2206 performs a location based operation in response to the location value for the user. Example and non-limiting location based operations include one or more of: selecting a shard strategy description in response to the location value (e.g., selecting a shard strategy based on performance indicators for the location, for example where the location may indicate that the user has limited and/or intermediate connectivity, and/or where the location indicates that certain type of information, such as sensitive information, confidential information, health information, etc. should be not available to the client device); utilizing the location value as an input parameter to a formula of the UDS, and/or commanding execution of a formula using the location value; determining a snapshot time marker in response to the location value (e.g., performing an opportunistic snapshot when the user location indicates that the user may not be interacting significantly with the document for a period, performing a snapshot in response to a location indicator indicating that the user is potentially going to be traveling, etc.); sending a notification to the user in response to the location value, and further in response to a second user accessing a published document associated with one of the UDS (e.g., a document) and/or the user (e.g., notifying the user that a second user is accessing the document, for example where the location value indicates that the user may not have access to the UDS platform); and/or sending a notification to the user in response to the location value and further in response to a second user submitting a form associated with the UDS. The notification value may include a factual notification (e.g., user XYZ has edited the document), and/or a content notification (e.g., user XYZ has added three rows to table PDQ; and/or user XYZ has submitted a form, and 13 users have now submitted the form). The content notification can include user counts, document edit locations, updated formula information (e.g., sums, averages, model output values, etc.). An example location based operation includes an operation to select and automated rendering operation for an object of the UDS in response to the location value (e.g., where the location value indicates the user may have limited connectivity, a limited capability device, be positioned in a low light environment, be positioned in a bright light environment, etc.).

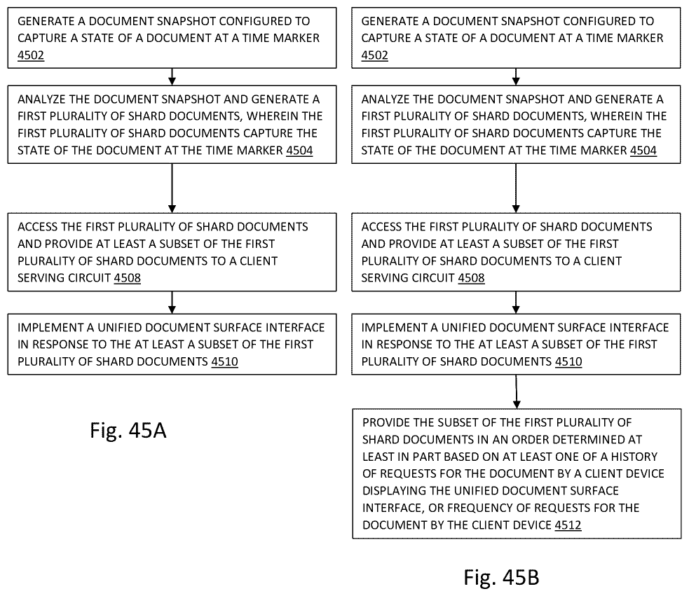

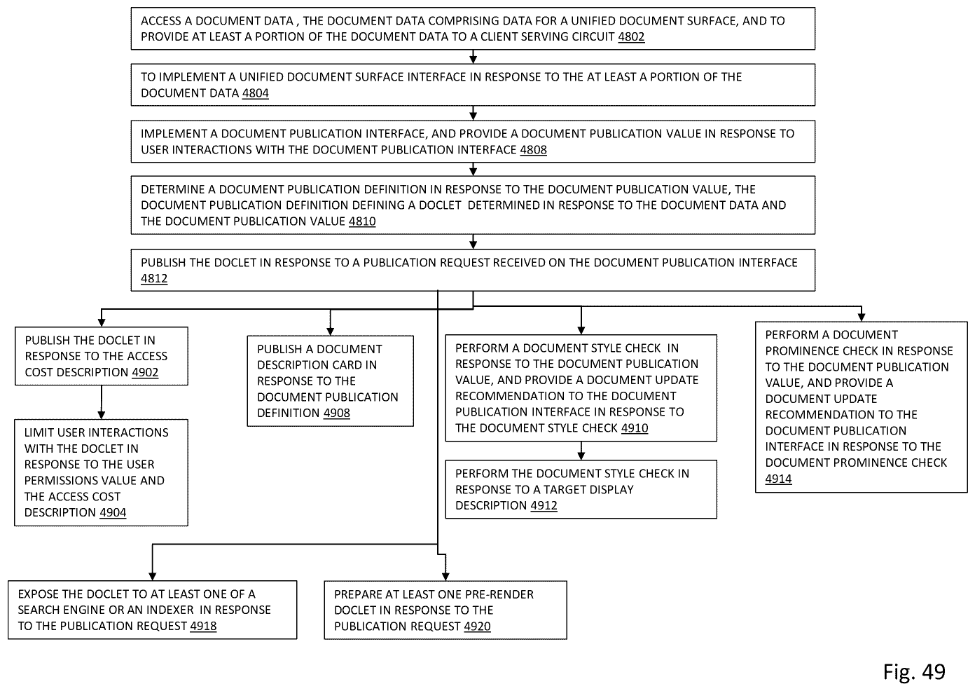

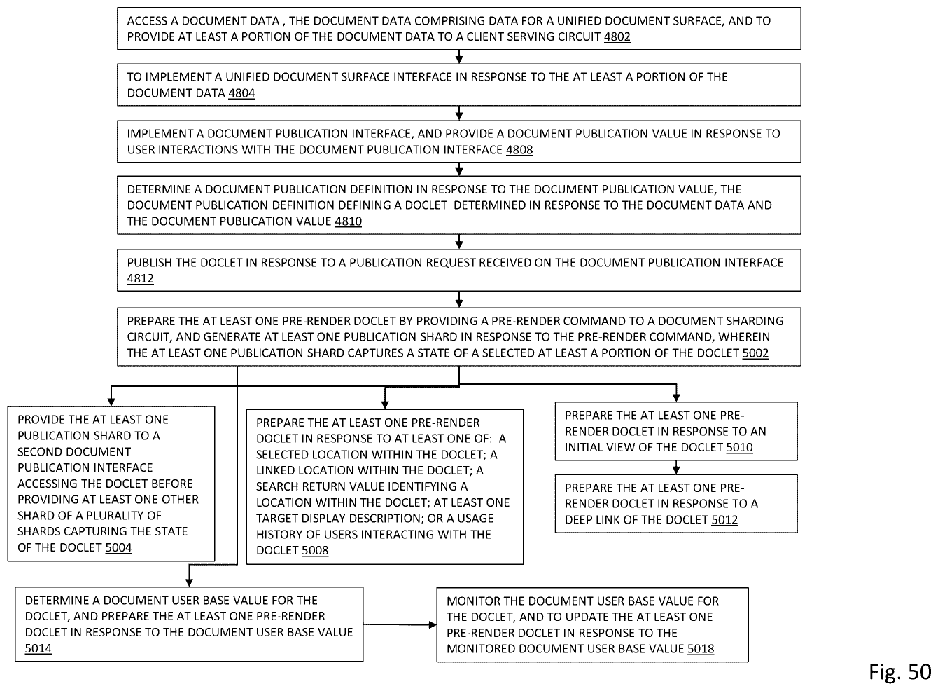

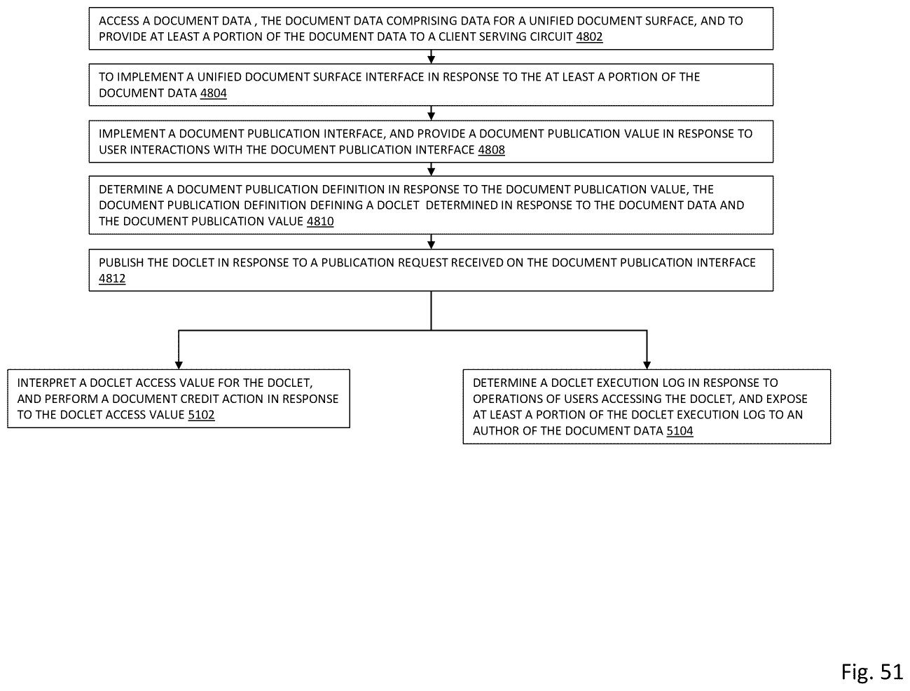

FIGS. 45A-65 are schematic flow diagrams of procedures according to embodiments.

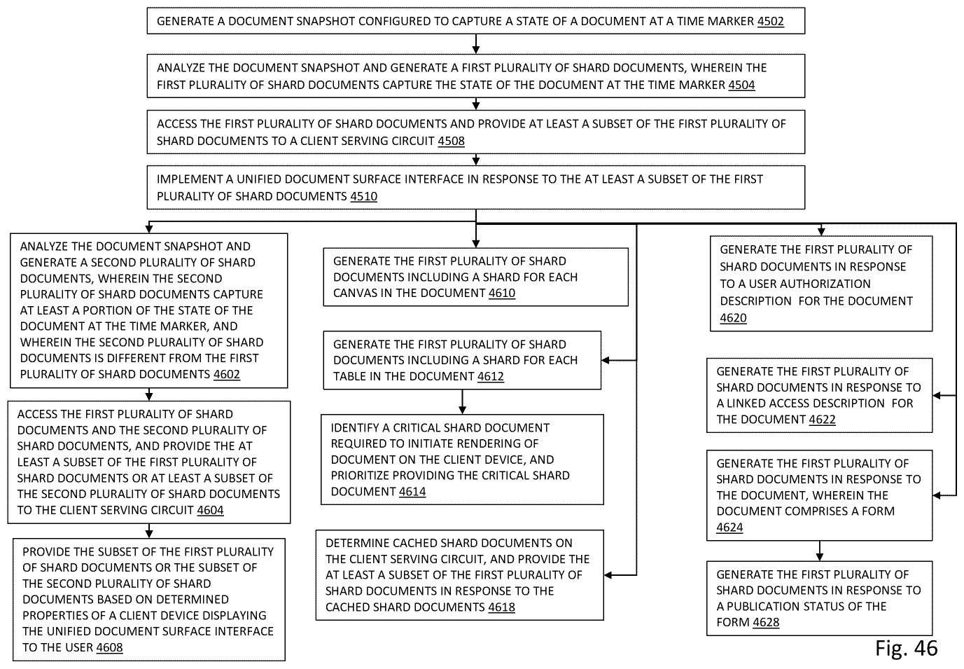

An example method shown in FIGS. 45A-FIG. 46 may include generating a document snapshot configured to capture a state of a document at a time marker 4502; analyzing the document snapshot and generating a first plurality of shard documents, wherein the first plurality of shard documents capture the state of the document at the time marker 4504; accessing the first plurality of shard documents and providing at least a subset of the first plurality of shard documents 4508; and implementing a unified document surface interface in response to the at least a subset of the first plurality of shard documents 4510.

Certain further aspects of the example method are described following, any one or more of which may be present in certain embodiments. The subset of the first plurality of shard documents may be selected based on at least one of properties of the document, properties of a client device displaying the unified document surface interface to a user, or properties of a communication network between the client device and a document serving circuit. The subset of the first plurality of shard documents may be selected based on at least one of a history of requests for the document by a user interacting with the unified document surface interface, or a frequency of requests for the document by the user interacting with the unified document surface interface. The method may further include providing the subset of the first plurality of shard documents in an order determined at least in part based on at least one of a history of requests for the document by a client device displaying the unified document surface interface, or frequency of requests for the document by the client device (FIG. 45B, 4512). The order may be determined to prioritize shards related to a last accessed location of the document. The order may be determined to prioritize smaller shards. The method may further include identifying a critical shard document required to initiate rendering of document on the client device, and prioritizing providing the critical shard document 4614. The first plurality of shard documents include at least one of a schema shard, a critical shard, or a data shard. The number of shard documents generated may be based on a size of the document. The method may further include analyzing the document snapshot and generate a second plurality of shard documents, wherein the second plurality of shard documents capture at least a portion of the state of the document at the time marker, and wherein the second plurality of shard documents may be different from the first plurality of shard documents 4602. The method may further include accessing the first plurality of shard documents and the second plurality of shard documents, and providing the at least a subset of the first plurality of shard documents or at least a subset of the second plurality of shard documents 4604. The method may further include providing the subset of the first plurality of shard documents or the subset of the second plurality of shard documents based on determined properties of a client device displaying the unified document surface interface to the user 4608. The first plurality of shard documents include redundant information in at least a subset of the shard documents. The method may further include generating the first plurality of shard documents including a shard for each canvas in the document 4610. The method may further include generating the first plurality of shard documents including a shard for each table in the document 4612. The method may further include determining cached shard documents, and providing the at least a subset of the first plurality of shard documents in response to the cached shard documents 4618. The method may further include generating the first plurality of shard documents in response to a user authorization description for the document 4620. The method may further include generating the first plurality of shard documents in response to a linked access description for the document 4622. The document may include a form, and wherein the method may further include generating the first plurality of shard documents in response to the form 4624. The form may include one of an inline form or a segregated form. The method may further include generating the first plurality of shard documents in response to a publication status of the form 4628.

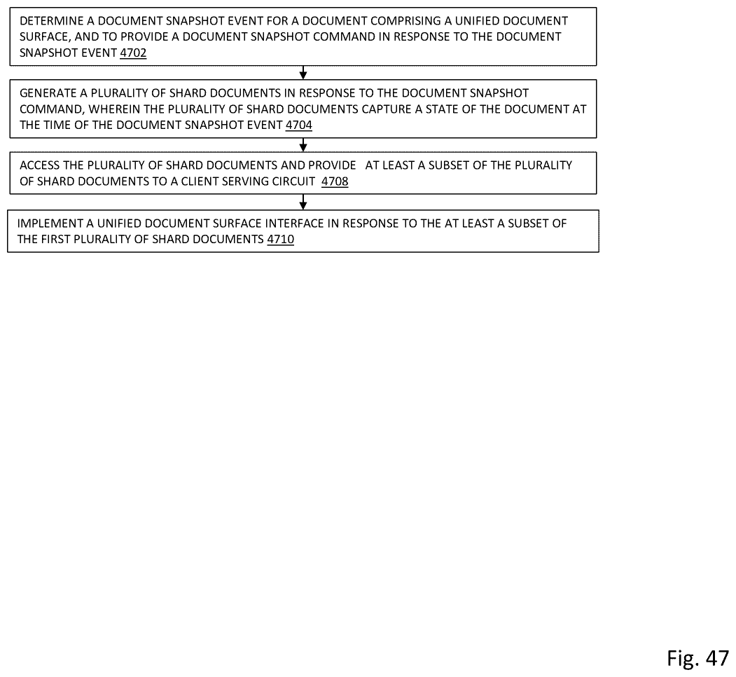

An example method shown in FIG. 47 may include determining a document snapshot event for a document including a unified document surface, and providing a document snapshot command in response to the document snapshot event 4702; generating a plurality of shard documents in response to the document snapshot command, wherein the plurality of shard documents capture a state of the document at the time of the document snapshot event 4704; accessing the plurality of shard documents and provide at least a subset of the plurality of shard documents 4708; and implementing a unified document surface interface in response to the at least a subset of the first plurality of shard documents 4710.

Certain further aspects of the example method are described following, any one or more of which may be present in certain embodiments. The method may further include using a plurality of shard strategy descriptions, each shard strategy description including at least a subset of the plurality of shard documents. The method may further include providing the at least a subset of the plurality of shard documents in response to a selected one of the plurality of shard strategy descriptions. The method may further include generating the plurality of shard documents in response to a selected one of the plurality of shard strategy descriptions. The method may further include generating the plurality of shard documents in response to each of the plurality of shard strategy descriptions. The method may further include determining supported ones of the plurality of shard strategy descriptions, and generating the plurality of shard documents in response to the supported ones of the plurality of shard strategy descriptions. The method may further include selecting one of the plurality of shard strategy descriptions in response to a size of the document. The method may further include selecting one of the plurality of shard strategy descriptions in response to a last accessed location of the document. The method may further include selecting one of the plurality of shard strategy descriptions in response to a selected location of the document. The method may further include selecting one of the plurality of shard strategy descriptions in response to a characteristic of a client device displaying the unified document surface interface to a user. The method may further include selecting one of the plurality of shard strategy descriptions in response to a user authorization description for the document. The method may further include selecting one of the plurality of shard strategy descriptions in response to a linked access description for the document. The method may further include selecting one of the plurality of shard strategy descriptions in response to a publication status for the document. The plurality of shard documents may include a canvas shard document for each canvas of the document. Each canvas shard document may include a schema corresponding to each canvas. The plurality of shard documents may include a table shard document for each table of the document. Each table shard document may include a schema corresponding to each table. The plurality of shard documents include a form shard document for each form of the document. The plurality of shard documents include a form shard document for each published form of the document.

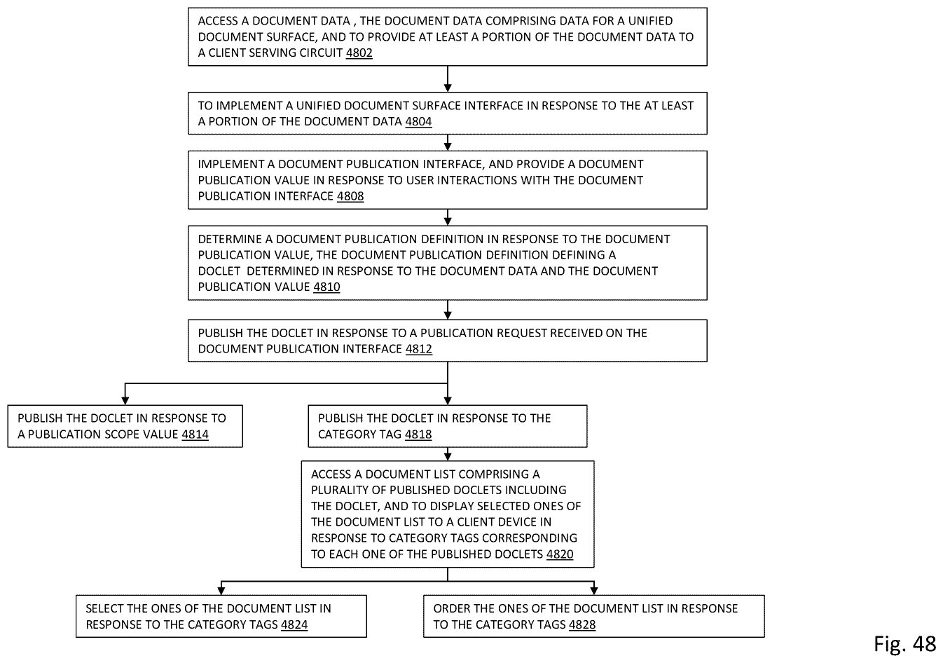

An example method shown in FIGS. 48-51 may include accessing a document data, the document data including data for a unified document surface, and providing at least a portion of the document data 4802; implementing a unified document surface interface in response to the at least a portion of the document data 4804; implementing a document publication interface, and providing a document publication value in response to user interactions with the document publication interface 4808; wherein the method may further include: determining a document publication definition in response to the document publication value, the document publication definition defining a doclet determined in response to the document data and the document publication value 4810; and publishing the doclet in response to a publication request received on the document publication interface 4812.

Certain further aspects of the example method are described following, any one or more of which may be present in certain embodiments. The document publication definition may include a unique address to access the doclet. The document publication value may include at least a portion of the document data to be included in the doclet. The document publication value may include a user permissions value, and wherein the method may further include limiting user interactions with the doclet in response to the user permissions value. The user permissions value selectively limits user interaction with the doclet to read-only access. The user permissions value selectively limits user interaction with the doclet to play access, wherein play access may include non-persistent editing access. The user permissions value selectively limits user interaction with the doclet to edit access, wherein edit access may include persistent editing access. Edit access limits user interaction for selected editing operations. The user permissions value selectively limits user interaction with the doclet to author access, wherein author access may include persistent and unlimited editing access. The user permissions value selectively limits user interaction with the doclet in response to a user characteristic. The user permissions value selectively limits user interaction with the doclet in response to a location within a document defined by the document data. The document publication definition may include a publication scope value, and wherein the method may further include publishing the doclet in response to the publication scope value 4814. The publication scope value may include at least one value selected from the values consisting of: a public scope; a workspace scope; a user inclusion scope; or a user exclusion scope. The document publication definition may include a category tag, and wherein the method may further include publishing the doclet in response to the category tag 4818. The method may further include accessing a document list including a plurality of published doclets including the doclet, and displaying selected ones of the document list to a client device in response to category tags corresponding to each one of the published doclets 4820. The method may further include selecting the ones of the document list in response to the category tags 4824. The method may further include ordering the ones of the document list in response to the category tags 4828. The document publication definition may include an access cost description, and wherein the method may further include publishing the doclet in response to the access cost description 4902. The access cost description may include at least one of: a subscription cost value; a document access cost value; a trial period value; a document usage example value; or a usage based cost value. The method may further include: wherein the document publication value may include a user permissions value; and limiting user interactions with the doclet in response to the user permissions value and the access cost description 4904. The method may further include publishing a document description card in response to the document publication definition 4908. The document description card may include at least one value selected from the values consisting of: a document icon; a document picture; a document text description; a document title; a document author name; a document author entity; a document author contact; a utilizing documents list; a utilizing packs list; a document building block description; or a document dependency description. The method may further include performing a document style check in response to the document publication value, and providing a document update recommendation to the document publication interface in response to the document style check 4910. The method may further include performing the document style check in response to a target display description 4912. The target display description may include at least one of: computing resources available for a target client device; connectivity resources available for a target client device; display settings available for a target client device; or accessing tools for a target client device. The method may further include performing a document prominence check in response to the document publication value, and providing a document update recommendation to the document publication interface in response to the document prominence check 4914. The method may further include exposing the doclet to at least one of a search engine or an indexer in response to the publication request 4918. The method may further include preparing at least one pre-render doclet in response to the publication request 4920. The method may further include preparing the at least one pre-render doclet by providing a pre-render command, and generating at least one publication shard in response to the pre-render command, wherein the at least one publication shard captures a state of a selected at least a portion of the doclet 5002. The method may further include providing the at least one publication shard to a second document publication interface accessing the doclet before providing at least one other shard of a plurality of shards capturing the state of the doclet 5004. The method may further include preparing the at least one pre-render doclet in response to at least one of: a selected location within the doclet; a linked location within the doclet; a search return value identifying a location within the doclet; at least one target display description; or a usage history of users interacting with the doclet 5008. The method may further include preparing the at least one pre-render doclet in response to an initial view of the doclet 5010. The method may further include preparing the at least one pre-render doclet in response to a deep link of the doclet 5012. The method may further include determining a document user base value for the doclet, and preparing the at least one pre-render doclet in response to the document user base value 5014. The document user base value may include at least one value selected from the values consisting of: a number of users having access to the doclet; a number of users having a selected access type to the doclet; a number of user access configurations for users having access to the doclet; or a distribution of user access configurations for users having access to the doclet. The method may further include monitoring the document user base value for the doclet, and updating the at least one pre-render doclet in response to the monitored document user base value 5018. The method may further include interpreting a doclet access value for the doclet, and performing a document credit action in response to the doclet access value 5102. The method may further include determining a doclet execution log in response to operations of users accessing the doclet, and exposing at least a portion of the doclet execution log to an author of the document data 5104. The doclet execution log may include at least one log information element selected from: a number of documents referencing the doclet; a number of execution events of components of the doclet; an execution time of execution events of components of the doclet; a number of service or data access events of components of the doclet; a number of users accessing the doclet; a number of users editing the doclet; a number of users performing non-persistent editing of the doclet; a user description of users accessing the doclet; an accessing source of users accessing the doclet; or a display description of users accessing the doclet.

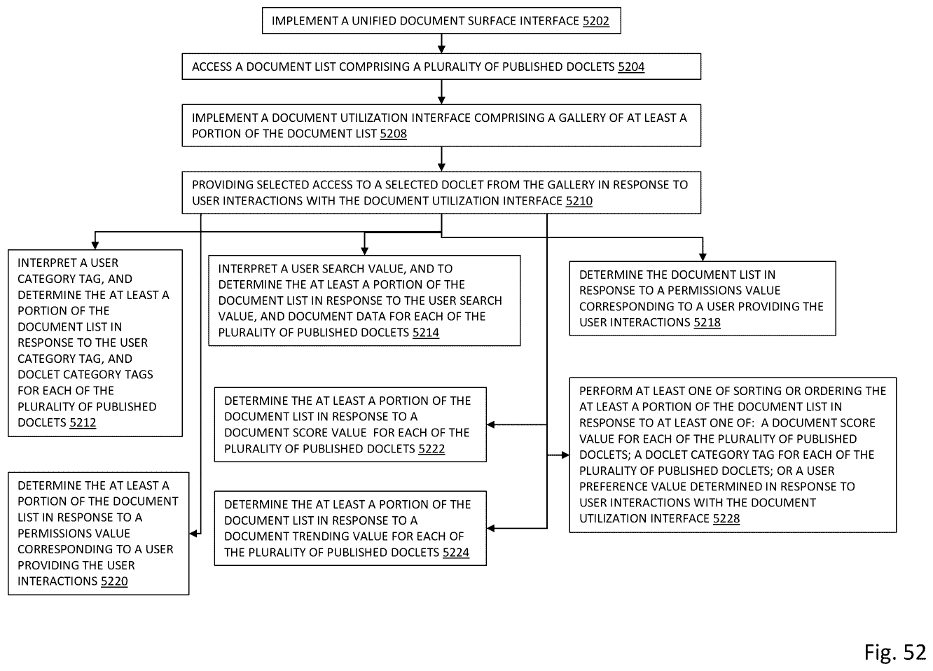

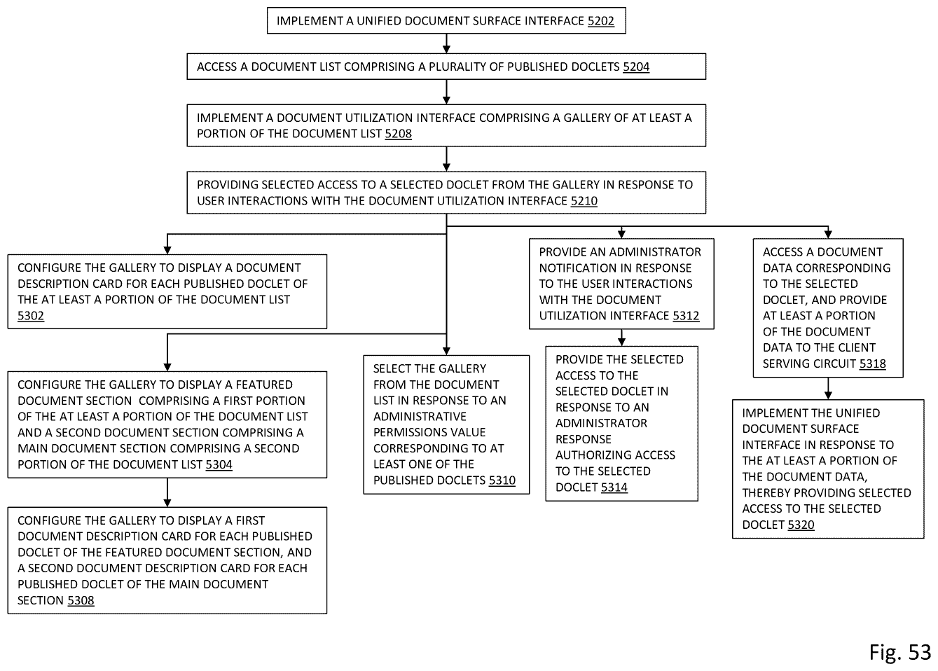

An example method shown in FIGS. 52-53 may include implementing a unified document surface interface 5202; accessing a document list including a plurality of published doclets 5204; implementing a document utilization interface including a gallery of at least a portion of the document list 5208; and providing selected access to a selected doclet from the gallery in response to user interactions with the document utilization interface 5210.

Certain further aspects of the example method are described following, any one or more of which may be present in certain embodiments. The method may further include interpreting a user category tag, and determining the at least a portion of the document list in response to the user category tag, and doclet category tags for each of the plurality of published doclets 5212. The method may further include interpreting a user search value, and determining the at least a portion of the document list in response to the user search value, and document data for each of the plurality of published doclets 5214. The method may further include determining the document list in response to a permissions value corresponding to a user providing the user interactions 5218. The method may further include determining the at least a portion of the document list in response to a permissions value corresponding to a user providing the user interactions 5220. The method may further include determining the at least a portion of the document list in response to a document score value for each of the plurality of published doclets 5222. The method may further include determining the at least a portion of the document list in response to a document trending value for each of the plurality of published doclets 5224. The method may further include performing at least one of sorting or ordering the at least a portion of the document list in response to at least one of: a document score value for each of the plurality of published doclets; a doclet category tag for each of the plurality of published doclets; or a user preference value determined in response to user interactions with the document utilization interface 5228. The method may further include configuring the gallery to display a document description card for each published doclet of the at least a portion of the document list 5302. Each document description card may include at least one value selected from the values consisting of: a document icon; a document picture; a document text description; a document title; a document author name; a document author entity; a document author contact; a utilizing documents list; a utilizing packs list; a document building block description; or a document dependency description. The method may further include configuring the gallery to display a featured document section including a first portion of the at least a portion of the document list and a second document section including a main document section including a second portion of the document list 5304. The method may further include configuring the gallery to display a first document description card for each published doclet of the featured document section, and a second document description card for each published doclet of the main document section 5308. The document utilization interface may include a search interface portion and a document results portion. The method may further include selecting the gallery from the document list in response to an administrative permissions value corresponding to at least one of the published doclets 5310. The administrative permissions value may include at least one value selected from the values consisting of: a cost permissions value; a building block value; a document inclusion value; a document exclusion value; or a document certification value. The method may further include: providing an administrator notification in response to the user interactions with the document utilization interface 5312; and providing the selected access to the selected doclet in response to an administrator response authorizing access to the selected doclet 5314. The method may further include accessing a document data corresponding to the selected doclet, and providing at least a portion of the document data 5318; and implementing the unified document surface interface in response to the at least a portion of the document data, thereby providing selected access to the selected doclet 5320. The at least a portion of the document data may include a plurality of document shards, including at least one publication shard, wherein the plurality of document shards capture a state of the selected doclet, and wherein the at least one publication shard captures a state of a selected at least a portion of the selected doclet. The method may further include providing the at least one publication shard to a client device accessing the doclet before providing at least one other shard of the plurality of document shards. The selected access to the selected doclet may include read-only access to at least a portion of the selected doclet. The selected access to the selected doclet may include play access to at least a portion of the selected doclet, wherein play access may include non-persistent editing access. The selected access to the selected doclet may include edit access, wherein edit access may include persistent editing access. The selected access to the selected doclet may include author access, wherein author access may include persistent and unlimited editing access.

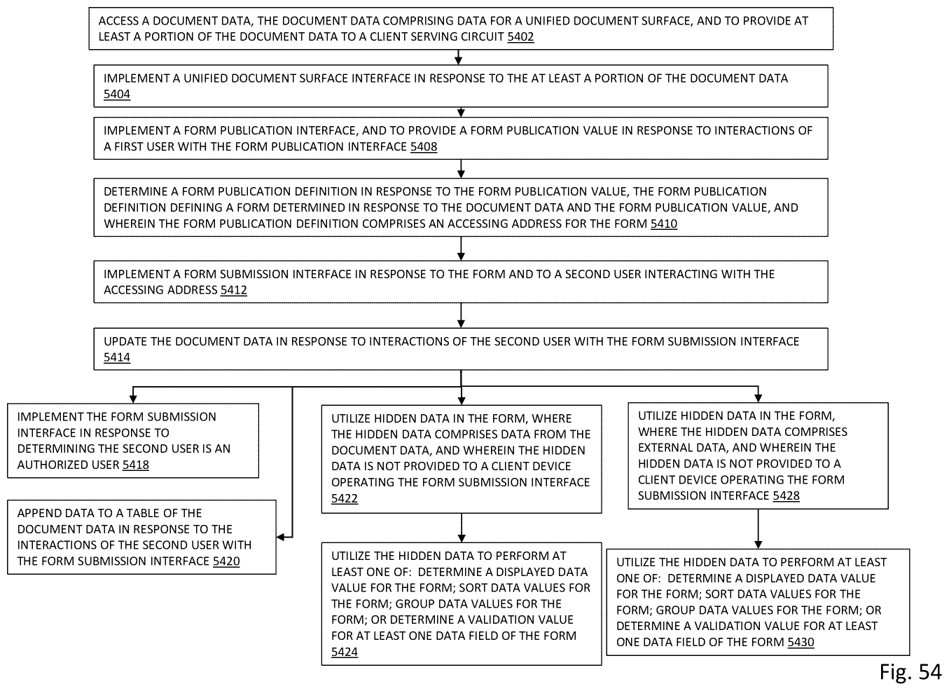

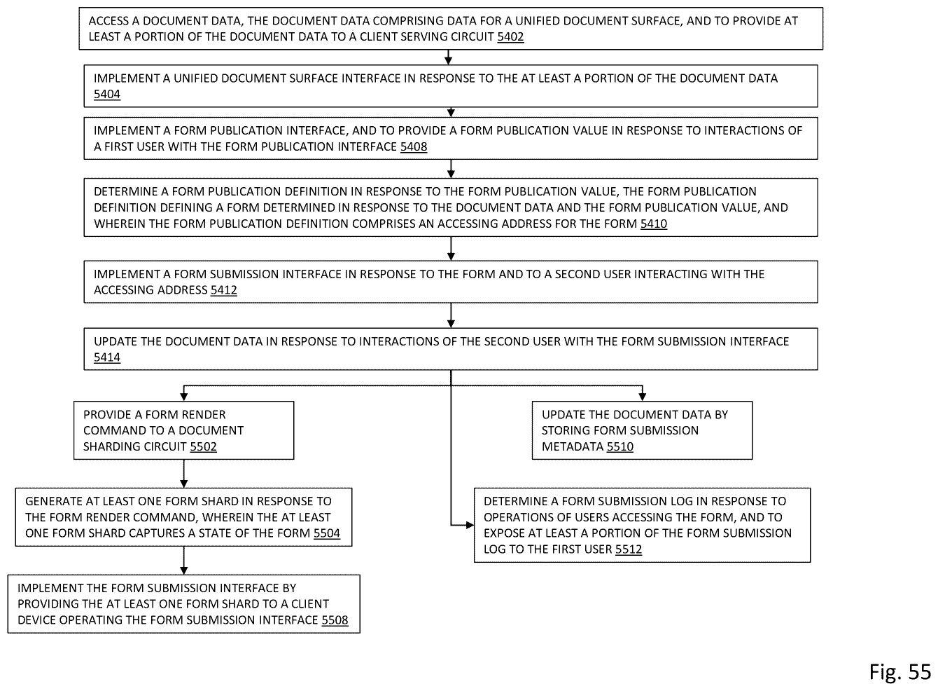

An example method shown in FIGS. 54-55 may include accessing a document data, the document data including data for a unified document surface, and providing at least a portion of the document data 5402; implementing a unified document surface interface in response to the at least a portion of the document data 5404; implementing a form publication interface, and providing a form publication value in response to interactions of a first user with the form publication interface 5408; determining a form publication definition in response to the form publication value, the form publication definition defining a form determined in response to the document data and the form publication value, wherein the form publication definition may include an accessing address for the form 5410; implementing a form submission interface in response to the form and to a second user interacting with the accessing address 5412; and updating the document data in response to interactions of the second user with the form submission interface 5414.

Certain further aspects of the example method are described following, any one or more of which may be present in certain embodiments. The method may further include implementing the form submission interface in response to determining the second user is an authorized user 5418. The form publication value may include one of a submission state allowing implementation of the form submission interface, or a second hidden state that does not allow implementation of the form submission interface. The form publication interface allows the first user to selectively provide hidden lookup data to a client device operating the form submission interface. The form publication interface allows the first user to selectively provide sensitive information to a client device operating the form submission interface. The method may further include appending data to a table of the document data in response to the interactions of the second user with the form submission interface 5420. The form may include a text description and at least one data field. The form may further include a validation formula associated with the at least one data field. The form submission interface provides a valid data notification in response to the validation formula, and further in response to at least one of a data entry interaction with the at least one data field, or a form submission action. The method may further include utilizing hidden data in the form, where the hidden data may include data from the document data, and wherein the hidden data may be not provided to a client device operating the form submission interface 5422. The method may further include utilizing the hidden data to perform at least one of: determine a displayed data value for the form; sort data values for the form; group data values for the form; or determine a validation value for at least one data field of the form 5424. The method may further include utilizing the hidden data to perform at least one of: determine a displayed data value for the form; sort data values for the form; group data values for the form; or determine a validation value for at least one data field of the form 5430. The method may further include utilizing hidden data in the form, where the hidden data may include external data, and wherein the hidden data may be not provided to a client device operating the form submission interface 5428. The method may further include providing a form render command 5502; generating at least one form shard in response to the form render command, wherein the at least one form shard captures a state of the form 5504; and implementing the form submission interface by providing the at least one form shard to a client device operating the form submission interface 5508. The method may further include updating the document data by storing form submission metadata 5510. The form submission metadata may further include at least one data element selected from the data elements consisting of: a second user identifier; a form access time stamp; or a form submission time stamp. The method may further include determining a form submission log in response to operations of users accessing the form, and exposing at least a portion of the form submission log to the first user 5512. The form submission log may include at least one log information element selected from: a number of form submission events; a data description of submitted data fields of the form; a user listing of users that have submitted the form; an error description for error events occurring during the implementing of the form publication interface; or an error description for error events occurring during the implementing of the form submission interface. The form publication definition may include a user identification scheme.

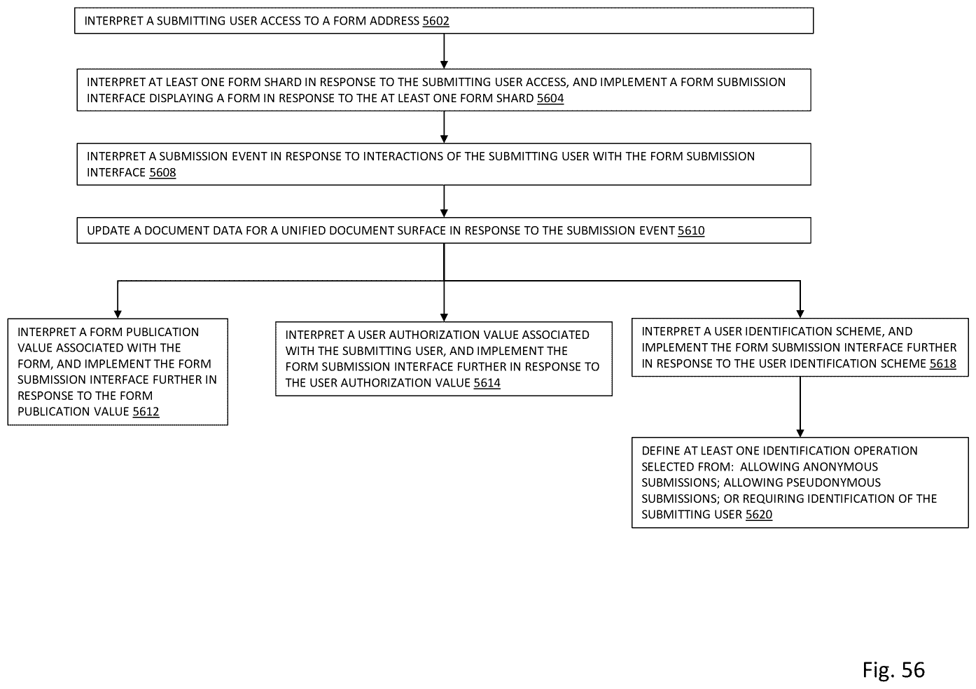

An example method shown in FIG. 56 may include interpreting a submitting user access to a form address 5602; interpreting at least one form shard in response to the submitting user access, and implementing a form submission interface displaying a form in response to the at least one form shard 5604; interpreting a submission event in response to interactions of the submitting user with the form submission interface 5608; and updating a document data for a unified document surface in response to the submission event 5610.

Certain further aspects of the example method are described following, any one or more of which may be present in certain embodiments. The method may further include interpreting a form publication value associated with the form, and implementing the form submission interface further in response to the form publication value 5612. The method may further include interpreting a user authorization value associated with the submitting user, and implementing the form submission interface further in response to the user authorization value 5614. The form may include a text description and at least one data field. The form may further include a validation formula associated with the at least one data field. The form submission interface provides a valid data notification in response to the validation formula, and further in response to at least one of a data entry interaction with the at least one data field, or the form submission event. The method may further include interpreting a user identification scheme, and implementing the form submission interface further in response to the user identification scheme 5618. The user identification scheme may define at least one identification operation selected from: allowing anonymous submissions; allowing pseudonymous submissions; or requiring identification of the submitting user 5620.

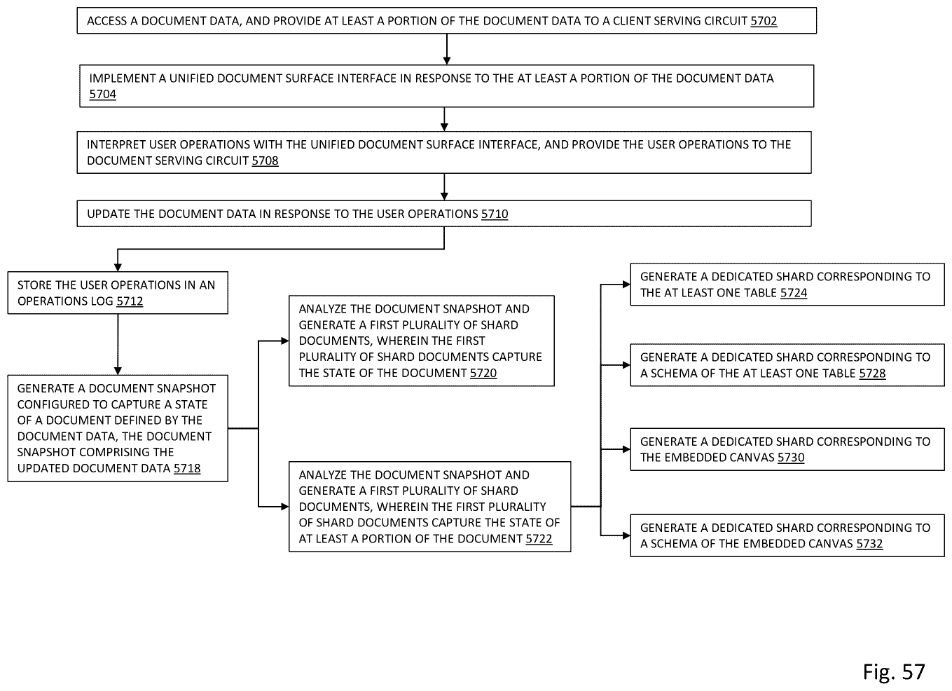

An example method shown in FIG. 57 may include accessing a document data, the document data including data for a unified document surface, and providing at least a portion of the document data 5702; wherein the document data may further include at least one table having an embedded canvas; implementing a unified document surface interface in response to the at least a portion of the document data 5704; interpreting user operations with the unified document surface interface, and providing the user operations 5708; and updating the document data in response to the user operations 5710.

Certain further aspects of the example method are described following, any one or more of which may be present in certain embodiments. The method may further include storing the user operations in an operations log 5712. The method may further include generating a document snapshot configured to capture a state of a document defined by the document data, the document snapshot including the updated document data 5718. The method may further include analyzing the document snapshot and generating a first plurality of shard documents, wherein the first plurality of shard documents capture the state of the document 5720. The method may further include analyzing the document snapshot and generating a first plurality of shard documents, wherein the first plurality of shard documents capture the state of at least a portion of the document 5722. The method may further include generating a dedicated shard corresponding to the at least one table 5724. The method may further include generating a dedicated shard corresponding to a schema of the at least one table 5728. The method may further include generating a dedicated shard corresponding to the embedded canvas 5730. The method may further include generating a dedicated shard corresponding to a schema of the embedded canvas 5732. The embedded canvas may include a column of the at least one table. The embedded canvas may include a plurality of columns of the at least one table. The embedded canvas may include at least two objects selected from the objects consisting of: a text flow, a table, a visualization element, a chart, a graph, linked external data, or a preview.

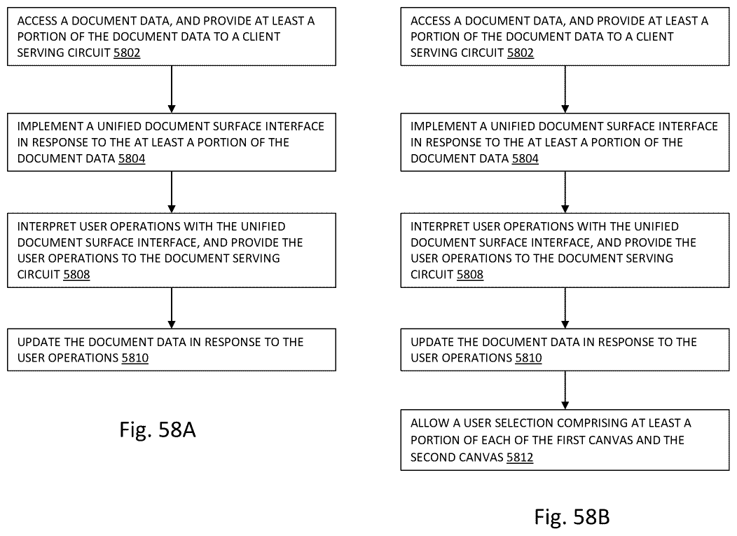

An example method shown in FIGS. 58A-58B may include accessing a document data, the document data including data for a unified document surface, and providing at least a portion of the document data 5802; wherein the document data may further include at least one canvas defining a document section, and having at least two objects selected from the object consisting of: a text flow, a table, a visualization element, a chart, a graph, linked external data, or a preview; implementing a unified document surface interface in response to the at least a portion of the document data 5804; interpreting user operations with the unified document surface interface, and providing the user operations 5808; and updating the document data in response to the user operations 5810.

Certain further aspects of the example method are described following, any one or more of which may be present in certain embodiments. The method may further include the canvas having a vertical split. The canvas may include a first vertical extent, the document data further including a second canvas having a second vertical extent, and wherein the first vertical extent at least partially overlaps the second vertical extent. The method may further include providing a second canvas, and allowing a user selection including at least a portion of each of the first canvas and the second canvas 5812.

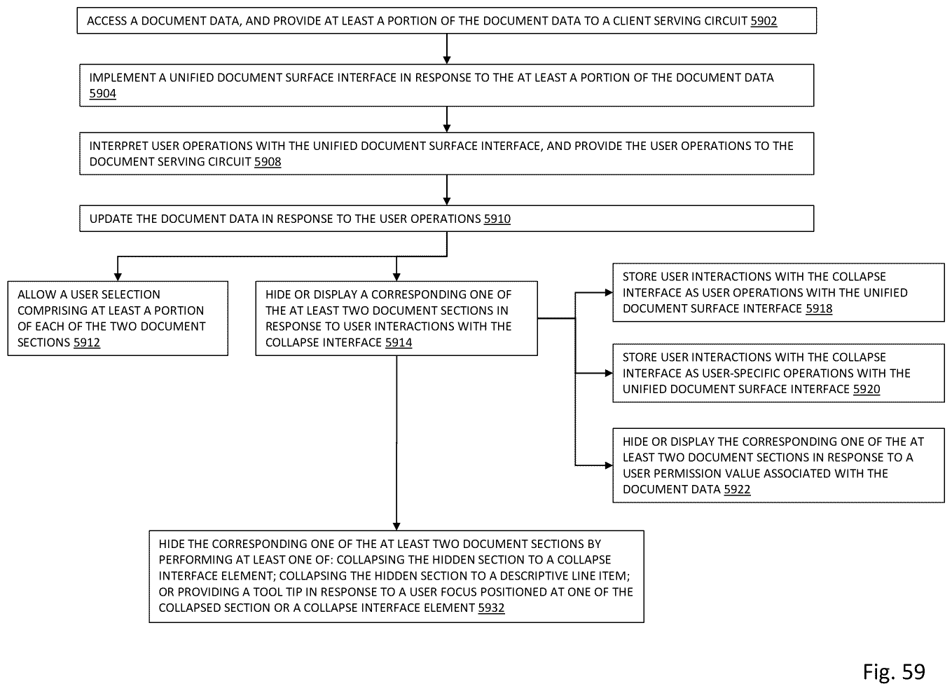

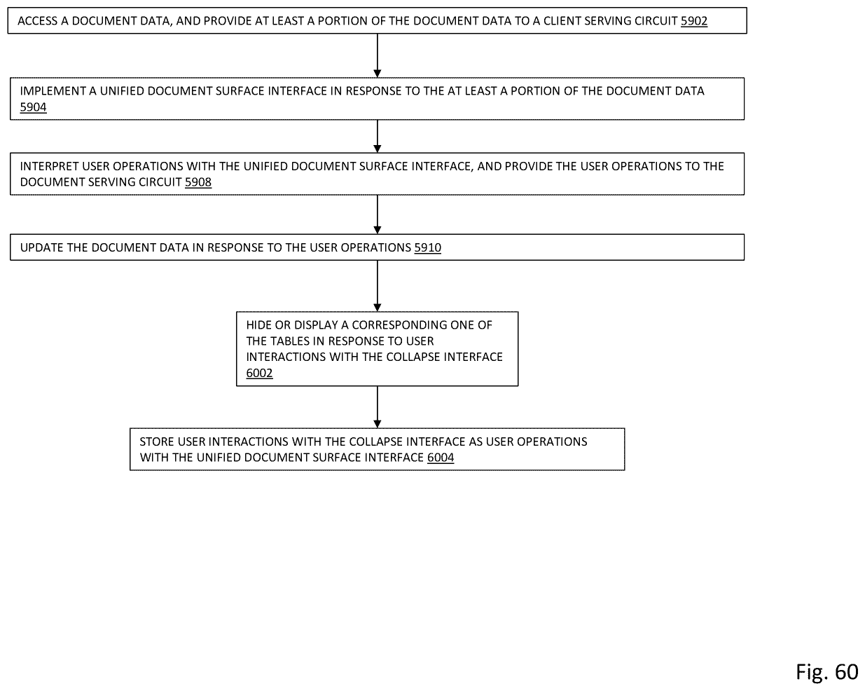

An example method shown in FIGS. 59-60 may include accessing a document data, the document data including data for a unified document surface, and providing at least a portion of the document data 5902; wherein the document data may further include at least two document sections, each document section having at least one object selected from the object consisting of: a canvas, a text flow, a table, a visualization element, a chart, a graph, linked external data, or a preview; implementing a unified document surface interface in response to the at least a portion of the document data 5904; interpreting user operations with the unified document surface interface, and providing the user operations 5908; and updating the document data in response to the user operations 5910.

Certain further aspects of the example method are described following, any one or more of which may be present in certain embodiments. The method may further include allowing a user selection including at least a portion of each of the two document sections 5912. The user selection may include at least a portion of a text flow and at least a portion of a table. The user selection may include at least a portion of a text flow, and at least a portion of at least one of: a text flow, a table, a visualization element, a chart, a graph, linked external data, or a preview. Each of the at least two document sections may include a collapse interface, wherein the method may further include hiding or displaying a corresponding one of the at least two document sections in response to user interactions with the collapse interface 5914. The method may further include storing user interactions with the collapse interface as user operations with the unified document surface interface 5918. The method may further include storing user interactions with the collapse interface as user-specific operations with the unified document surface interface 5920. The method may further include hiding or displaying the corresponding one of the at least two document sections in response to a user permission value associated with the document data 5922. The method may further include hiding the corresponding one of the at least two document sections by performing at least one of: collapsing the hidden section to a collapse interface element; collapsing the hidden section to a descriptive line item; or providing a tool tip in response to a user focus positioned at one of the collapsed section or a collapse interface element 5932, wherein the tool tip may include at least one of: a descriptive line item for the collapsed section, a preview of the collapsed section, a representative data value for the collapsed section, or an administrative notification value. Each of the at least two document sections include a table having a collapse interface, wherein the method may further include hiding or display a corresponding one of the tables in response to user interactions with the collapse interface 6002. The method may further include storing user interactions with the collapse interface as user operations with the unified document surface interface 6004.

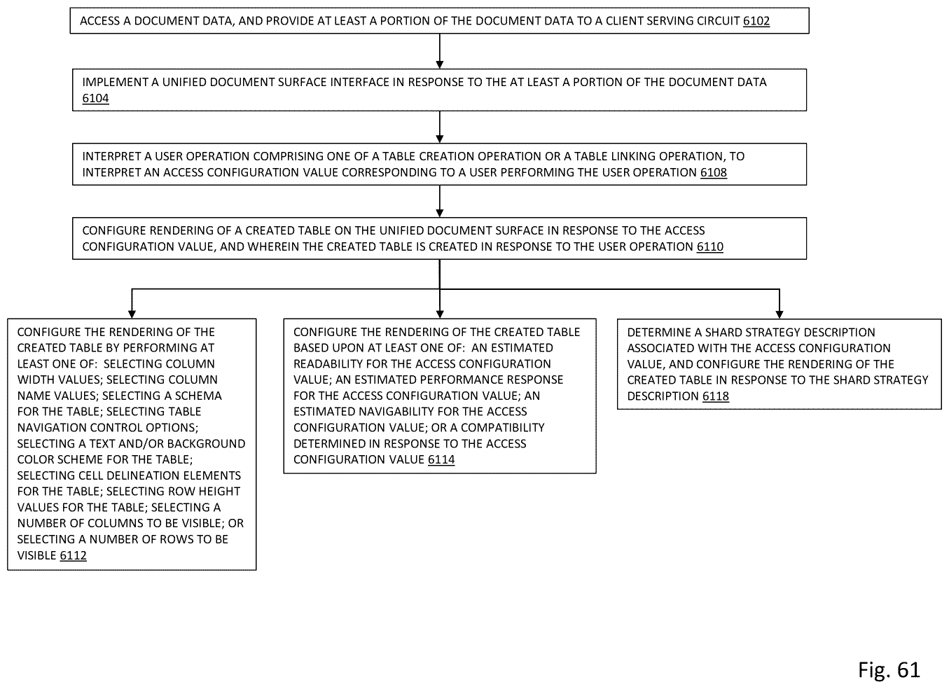

An example method shown in FIG. 61 may include accessing a document data, the document data including data for a unified document surface, and providing at least a portion of the document data 6102; implementing a unified document surface interface in response to the at least a portion of the document data 6104; interpreting a user operation including one of a table creation operation or a table linking operation, to interpret an access configuration value corresponding to a user performing the user operation 6108; and configuring rendering of a created table on the unified document surface in response to the access configuration value, wherein the created table may be created in response to the user operation 6110.

Certain further aspects of the example method are described following, any one or more of which may be present in certain embodiments. The access configuration value may include a client device description. The access configuration value may include a platform for the unified document surface interface. The method may further include configuring the rendering of the created table by performing at least one of: selecting column width values; selecting column name values; selecting a schema for the table; selecting table navigation control options; selecting a text and/or background color scheme for the table; selecting cell delineation elements for the table; selecting row height values for the table; selecting a number of columns to be visible; or selecting a number of rows to be visible 6112. The method may further include configuring the rendering of the created table based upon at least one of: an estimated readability for the access configuration value; an estimated performance response for the access configuration value; an estimated navigability for the access configuration value; or a compatibility determined in response to the access configuration value 6114. The method may further include determining a shard strategy description associated with the access configuration value, and configuring the rendering of the created table in response to the shard strategy description 6118.

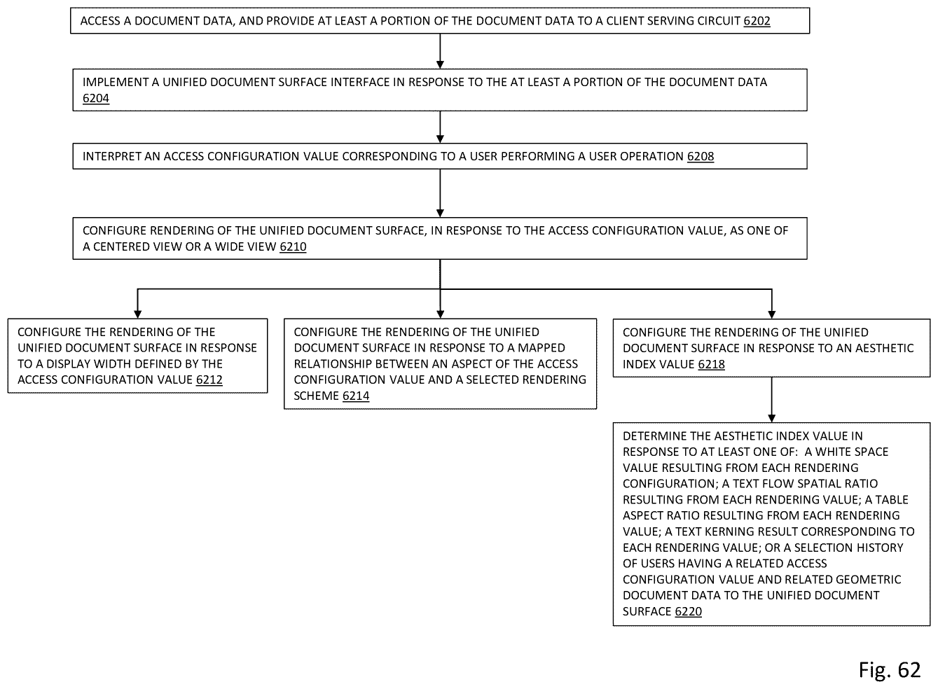

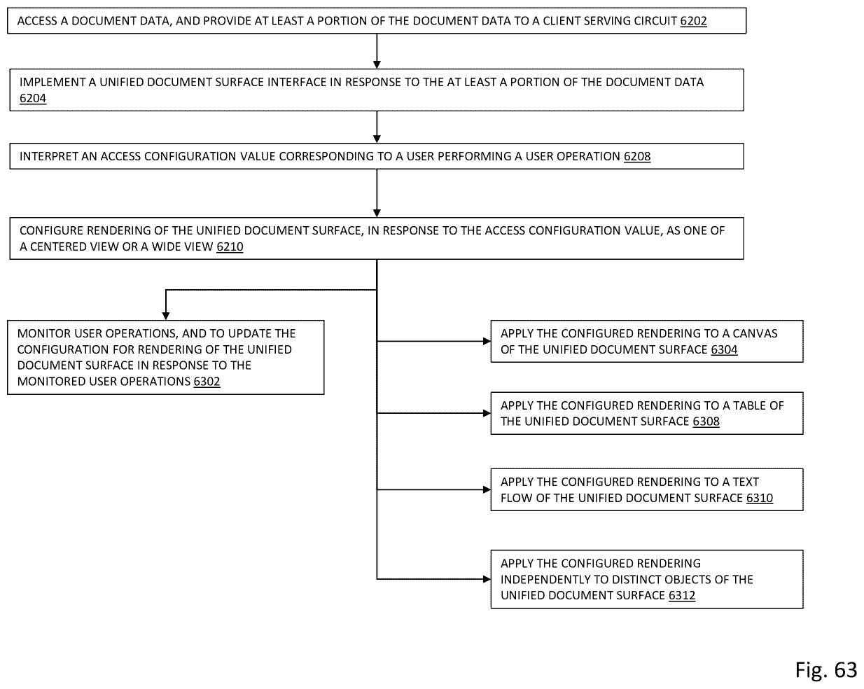

An example method shown in FIGS. 62-63 may include accessing a document data, the document data including data for a unified document surface, and providing at least a portion of the document data 6202; implementing a unified document surface interface in response to the at least a portion of the document data 6204; interpreting an access configuration value corresponding to a user performing a user operation 6208; and configuring rendering of the unified document surface, in response to the access configuration value, as one of a centered view or a wide view 6210.

Certain further aspects of the example method are described following, any one or more of which may be present in certain embodiments. The method may further include configuring the rendering of the unified document surface in response to a display width defined by the access configuration value 6212. The method may further include configuring the rendering of the unified document surface in response to a mapped relationship between an aspect of the access configuration value and a selected rendering scheme 6214. The method may further include configuring the rendering of the unified document surface in response to an aesthetic index value 6218. The aesthetic index value may be determined in response to at least one of: a white space value resulting from each rendering configuration; a text flow spatial ratio resulting from each rendering value; a table aspect ratio resulting from each rendering value; a text kerning result corresponding to each rendering value; or a selection history of users having a related access configuration value and related geometric document data to the unified document surface 6220. The method may further include monitoring user operations, and updating the configuration for rendering of the unified document surface in response to the monitored user operations 6302. The configured rendering may be applied to a canvas of the unified document surface 6304. The configured rendering may be applied to a table of the unified document surface 6308. The configured rendering may be applied to a text flow of the unified document surface 6310. The configured rendering may be applied independently to distinct objects of the unified document surface 6312.

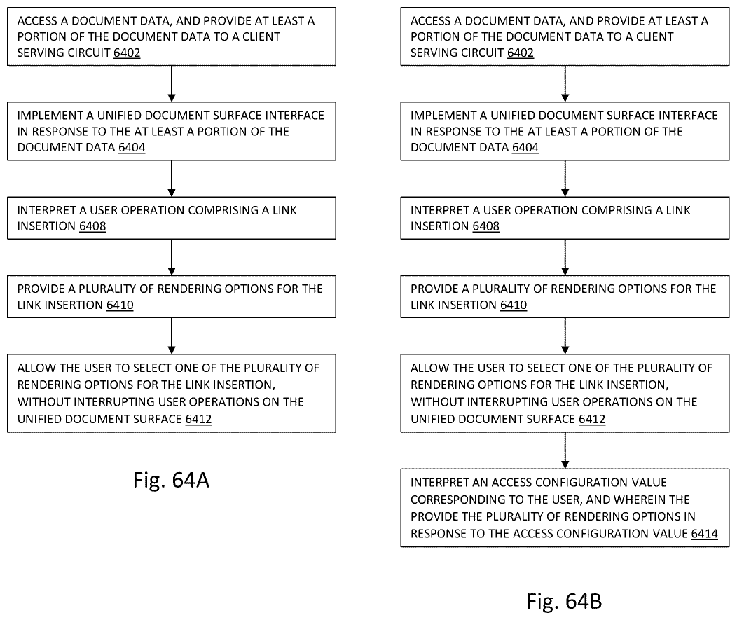

An example method shown in FIGS. 64A-64B may include accessing a document data, the document data including data for a unified document surface, and providing at least a portion of the document data 6402; implementing a unified document surface interface in response to the at least a portion of the document data 6404; interpreting a user operation including a link insertion 6408; providing a plurality of rendering options for the link insertion 6410; and allowing the user to select one of the plurality of rendering options for the link insertion, without interrupting user operations on the unified document surface 6412.

Certain further aspects of the example method are described following, any one or more of which may be present in certain embodiments. The plurality of rendering options include at least one option selected from the options consisting of: a table insertion option, a visual element insertion option, or a link description option. The method may further include interpreting an access configuration value corresponding to the user, and providing the plurality of rendering options in response to the access configuration value 6414. The plurality of rendering options include at least one option selected from the options consisting of: a table schema option, a table insertion option, a visual element insertion option, a link description option, a centered view option, or a wide view option.

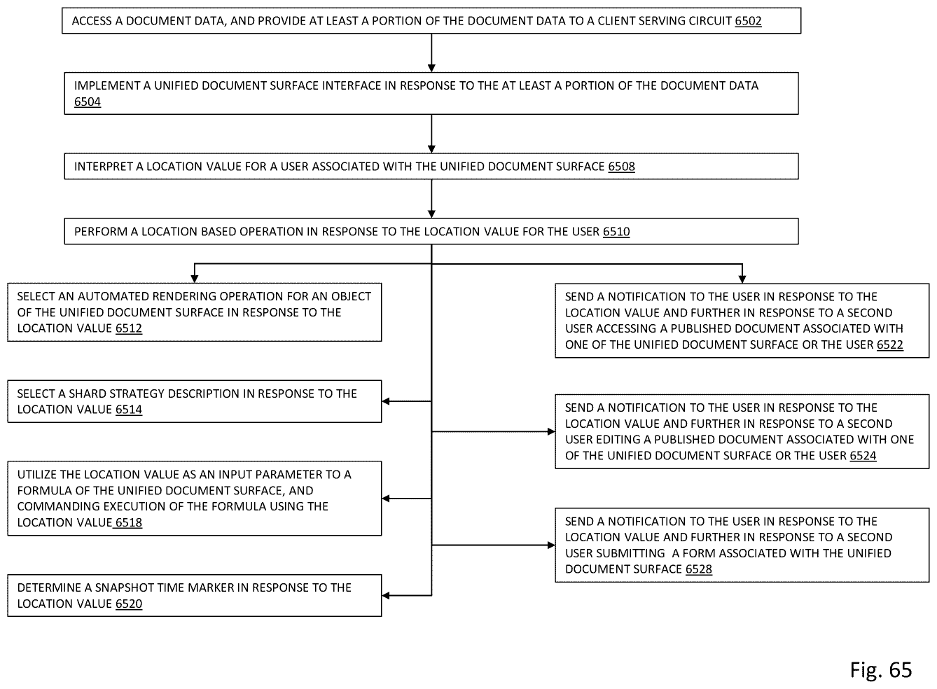

An example method shown in FIG. 65 may include accessing a document data, the document data including data for a unified document surface, and providing at least a portion of the document data 6502; implementing a unified document surface interface in response to the at least a portion of the document data 6504; interpreting a location value for a user associated with the unified document surface 6508; and performing a location based operation in response to the location value for the user 6510.

Certain further aspects of the example method are described following, any one or more of which may be present in certain embodiments. The location based operation may include selecting an automated rendering operation for an object of the unified document surface in response to the location value 6512. The location based operation may include selecting a shard strategy description in response to the location value 6514. The location based operation may include utilizing the location value as an input parameter to a formula of the unified document surface, and commanding execution of the formula using the location value 6518. The location based operation may include determining a snapshot time marker in response to the location value 6520. The location based operation may include sending a notification to the user in response to the location value and further in response to a second user accessing a published document associated with one of the unified document surface or the user 6522. The location based operation may include sending a notification to the user in response to the location value and further in response to a second user editing a published document associated with one of the unified document surface or the user 6524. The location based operation may include sending a notification to the user in response to the location value and further in response to a second user submitting a form associated with the unified document surface 6528.

Certain operations herein are described as being based upon and/or in response to a context, a contextual determination, a contextual indication, and/or determined or interpreted contextually. All of these and similar terms (“context parameters” in the present paragraph) should be understood broadly. Context parameters include, without limitation, a user, a user title, a user role, a user location, user permissions for the document, a time of day, an editing time for the user (e.g. time accessing the document, and/or time actively interacting with the document), whether the user created the document, whether the user is an administrator, the current operations being performed by the user (e.g. providing input, selecting a value, responding to a prompt, dragging a selected object, inserting an object, deleting an object, etc.), the time of day, a calendar date, relations of any of these to outside parameters (e.g. an end-of-month, end-of-year, outside of normal business hours, a change in regulatory jurisdiction due to location, or other determination), a data type being accessed by the user, an object type being accessed by the user, a time since the document has been synchronized or updated, a client device capability (e.g. memory, processor power, operating system, communication bandwidth, and/or currently available resources for any of these), an output type (e.g. screen size, color capability, printer type, available storage, and/or web page availability and configuration), a data source for one or more aspects of the document or document portion currently accessed by the user (e.g. size, age, and/or availability of linked or referenced data), a number and/or characteristics of users currently accessing the document, parameters from the document defined at creation or updated, rules for the document, default parameters for the document, a location within the document being accessed by the user, a total size of the document, a size of the document portion accessed by the user, and/or rules associated with the document (e.g. selected by the user and/or an administrator). As will be understood to one of skill in the art having the benefit of the disclosures herein, certain ones of the illustrative context parameters may be utilized for certain operations, and certain ones of the illustrative context parameters may not be applicable for certain operations. The illustrative context parameters are non-limiting, and further do not limit any descriptions herein utilizing context parameters.

The present disclosure includes a number of descriptions including a document. A document, as utilized herein, should be understood broadly. Without limitation to any other descriptions of a document herein, a document includes a reference-able collection of data structured for presentation, editing, reading, printing, sharing, and/or any other type of access, input, and/or output by a user. A document may be present in a single location (e.g. on a document server) and accessible by one or more users, either on a device including the document server, or on one or more separate devices in communication with the document server. Additionally or alternatively, the document may be distributed across multiple devices, for example with portions of the document stored in multiple places. An example document includes data which is referenced or linked, and in certain embodiments the document includes the references or links to the data, and in certain additional or alternate embodiments the document includes all or a portion of the referenced and/or linked data.

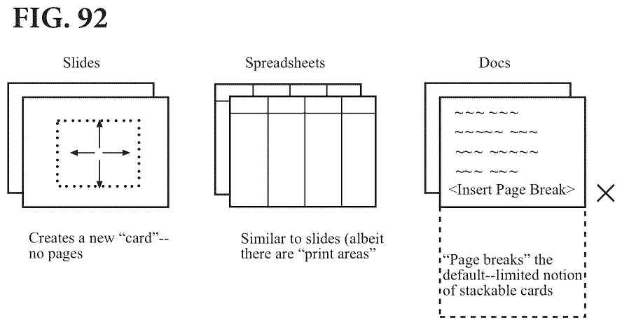

In embodiments, the unified document surface may allow pagination. Referring to FIG. 92, examples of pagination are provided for slides and spreadsheets. Pagination may be included, for example, to illustrate to the user segmented portions of the document for publishing, printing, and/or other output. In certain embodiments, pagination may be included for reference purposes (e.g. to provide an object reference for access through formulas or other linking mechanisms, or to identify document portions for communications that occur outside of the context of the document), for organizational purposes, and/or to apply conditional formatting to selected portions of the document. Pagination may be inserted by user selection, according to rules, and/or according to contextual assessments. In certain embodiments, pagination may be applied to only certain flows of the document (e.g. presentation pages, text, figures set on a page, etc.). In certain embodiments, pagination is unique within a given document scope (e.g. within a canvas and/or within a sheet). Additionally or alternatively, pagination is unique throughout the document (e.g. a document cannot contain two “page 17” member), and/or pagination is not unique at all (e.g. two alternative annual reports of pages 1-50 may be present in the same document, canvas, and/or sheet without any conflict). The use an implementation of pagination is illustrative and non-limiting. Any other type of document segmentation and/or organization (e.g. sections, stories, flows, breaks, etc.) is similarly contemplated herein, and similarly illustrative and non-limiting. Although the example FIG. 92 depicts a bounded canvas, additionally or alternatively a canvas may be unbounded, resizable, or the like.

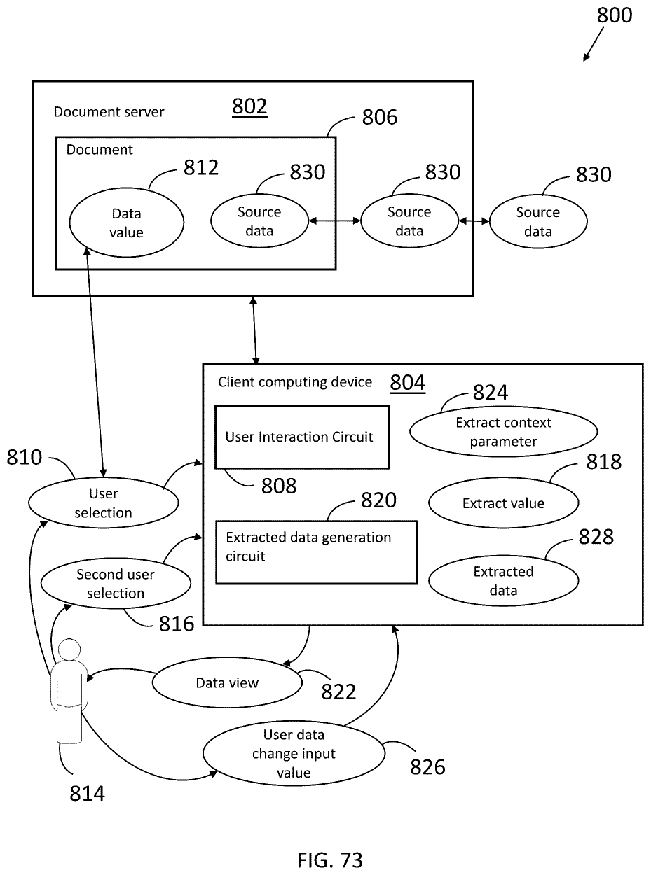

An example system (e.g., system 800 described in the portion referencing FIG. 73, or any system described throughout the present disclosure) provides viewing and/or editing options to a client device in an API, where the client device accesses the API. The utilization of an API allows for support of multiple devices and device types by moving aspects of application operation into the API layer (e.g., to a document server and/or a second client device interfacing with the presently used client device by the user). Accordingly, the client device utilized by the user is responsible for fewer processing operations to support the application, such as view rendering logic. An example system includes an application API that serves responses based on the current view (e.g., the sort, filter, and/or other selections of the user accessing the document thereby limiting the content of the document that must be rendered to provide full, consistent document access to the user; and/or the specific portion of the document visible to the user), rather than making multiple data API calls per asset type (e.g., account information request; list of recent documents request, etc.). The movement of application content into an application API (or other similar organizations of processing content) is selectable, with certain types of operations provided on the API layer, and other types of operations left on the client device. Further, the movement of application content into an application API may be selectable, and/or configured according to a client device type and/or client device resource availability.

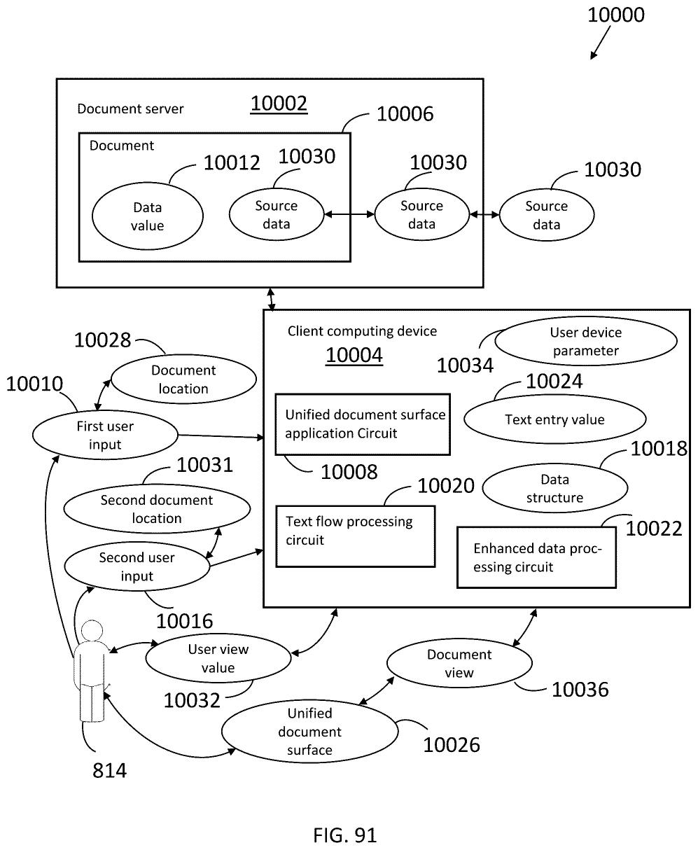

Referencing FIG. 91, a system 10000 includes a first computing device communicatively coupled to a second computing device 10004, where the first computing device includes a document server 10002 that communicates a data value 10012 to the second computing device 10004, such as a client computer device 10004, where the data value 10012 includes at least a portion of a document 10006, and/or includes links, references, and/or imported data from one or more source data 10030 elements. The example second computing device 10004 includes a unified document surface application circuit 10008 that interprets a first user input 10010 including a text flow entry, and interprets a second user input 10016 including an in-line data access entry and/or a table-based calculation entry. The example client computing device 10004 includes a text flow processing circuit 10020 that positions a text entry value 10024 on a unified document surface 10026 in response to the first user input 10010, and an enhanced data processing circuit 10022 that creates at least one data structure 10018 in response to the one of the in-line data access entry and the table-based calculation entry, and positions the data structure 10018 on the unified document surface 10026. Accordingly, the system 10000 provides for a unified document surface 10026 that is not a single purpose surface, and that has access to a full range of spreadsheet, calculation, database, and other tools within a single application.

In certain embodiments, the unified document surface application circuit further interprets a document location 10028 corresponding to the first user input 10010, and the text flow processing circuit 10020 further positions the text entry value 10024 on the unified document surface 10026 in response to the document location 10028. Additionally or alternatively, the unified document surface application circuit further interprets a second document location 10031 corresponding to the second user input 10016, and the enhanced data processing circuit 10022 further positions the data structure 10018 on the unified document surface 10026 in response to the second document location 10031.

An example document location 10028 and second document location 10031 are within a same section of the unified document surface 10026. For example, the text entry value 10024 and data structure 10018 may be positioned on a same canvas, same page, same grid, same sheet, within a document object (e.g., a table, graph, visualization element, etc.), within a same document section, or the like, without the user 814 creating document breaks or sections to accommodate utilization of disparate object types within the unified document surface 10026. In certain embodiments, one of the document location 10028 and the second document location 10031 is included within the other of the document location 10028 and the second document location 10031—for example where the document locations 10028, 10031 include one object embedded within another object. An example system 10000 includes the document location 10028 being a constrained portion of the unified document surface 10026 (e.g. operating on the constrained model) and the second document location 10031 being an unconstrained portion of the unified document surface 10026.

An example unified document surface application circuit 10008 further interprets a user view value 10032, and provides a document view 10036 in response to the user view value 10032. An example user view value 10032 includes a tab selection, a slide selection, and/or a tiled window. Additionally or alternatively, a user view value 10032 includes a user designation, a user authorization, a user device parameter, a filter value, a sorting value, a priority value, a document role value, a text view, a data view, a metadata view, a formula view, and a predetermined view selection. Accordingly, the client unified document surface application circuit 10008 can configure the view of the unified document surface 10026 for the user in response to the user designation (e.g., a role, title, selection by the user, etc.) and/or authorization of the user (e.g. hiding certain portions of the unified document surface 10026 based on the user designation). Additionally or alternatively, the user can determine how to sort, filter, and/or prioritize displayed information on the unified document surface 10026. Additionally or alternatively, the user can determine to view document data, metadata (e.g., tags, styles, editing history, time stamps, object reference names, etc.), formulas as entered (e.g., as opposed to results), the user can set up a view of the unified document surface 10026 for later convenient access, and/or the user can select from a predetermined view or list of views (e.g., set up by an administrator, according to rules in a template, and/or default view selections).

An example unified document surface application circuit 10008 further interprets a user device parameter 10034, and provides a document view 10036 in response to the user device parameter 10034. Example and non-limiting user device parameters 10034 include a user device screen size, a user device input type, a user device resource parameter (e.g., memory of any type, processing capability, communication bandwidth, and/or availability of portions of these for operations with the unified document surface 10026), and/or a user device communication value (e.g., availability and/or capacity of a user device to communicate with the client computing device 10004, with the document server 10002, and/or between the client computing device 10004 and the document server 10002). Accordingly, the unified document surface application circuit 10008 can configure the document view 10036 tailored to the user 814 and the current hardware context of the user 814. A procedure includes an operation to interpret a first user input including a text flow entry, and/or to interpret a second user input including one of an in-line data access entry and a table-based calculation entry. The procedure further includes an operation to position a text entry value on a unified document surface in response to the first user input, and an operation to create a data structure in response to the one of the in-line data access entry and the table-based calculation entry, and to position the data structure on the unified document surface.

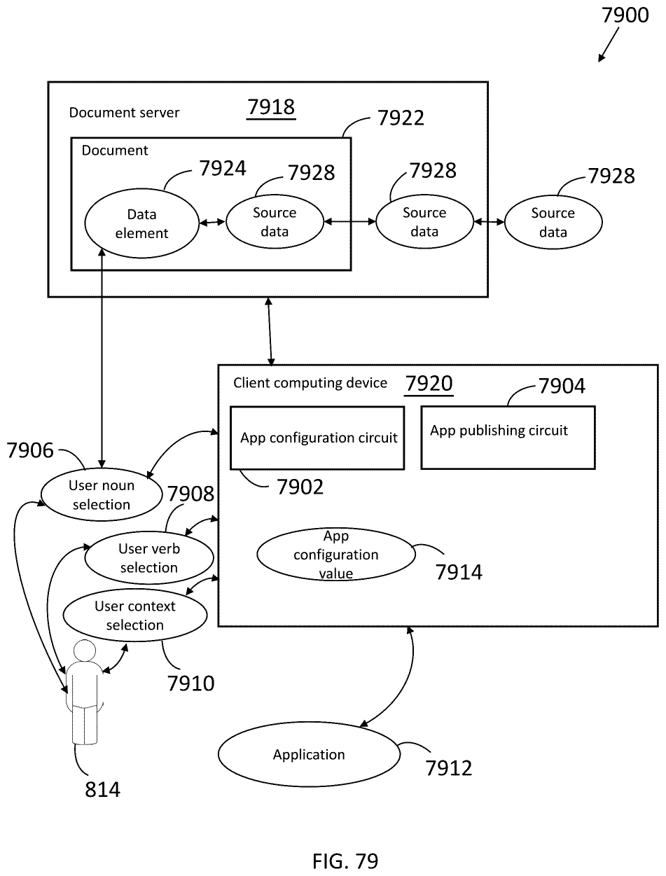

Referencing FIG. 79, a system 7900 includes a client computing device 7920 that comprises an application configuration circuit 7902 that interprets a user noun selection 7906, a user verb selection 7908, and a user context selection 7910, and determines an application configuration value 7914 in response to the document 7922 on the document server 7918, data element 7924, and/or the source data 7928, and further in response to the user noun selection 7906, user verb selection 7908, and/or the user context selection 7910. The description of user 814 interactions with the application configuration circuit 7902 as the user noun selection 7906, user verb selection 7908, and/or the user context selection 7910 provides a convenient context for clarity of description. However, any user 814 inputs consistent with the description herein are contemplated herein, and user 814 interactions with the application configuration circuit 7902 and/or the client computing device 7920 are likewise contemplated herein.

The example user noun selection 7906 includes data from the data element 7924, the document 7922, and/or the source data 7928 for inclusion in, and/or referencing and/or linking with, an application 7912 published by the application publishing circuit 7904 of the client computing device 7920. In certain embodiments, included data from the user noun selection 7906 may be included as linked data, flat data (e.g. data physically stored as application data), referenced data, and/or values calculated from, determined from, and/or visualizations of (e.g. in accordance with any VE 7616a—see the description referencing FIGS. 76-78) any such data. For example, a user 814 may direct that a prose description from the document 7922 is utilized in the user noun selection 7906, and such prose description may be utilized directly in the application 7912, a bulleted list from the prose description (e.g. as a VE 7616a) may be utilized in the application 7912, and/or information determined in response to the prose description and/or a bulleted list may be utilized in the application 7912. For example, and without limitation, a prose description may include a repair sequence for a device (e.g. changing the alternator in a car), and the user 814 may indicate the prose description with the repair sequence in the user noun selection 7906. An example application configuration circuit 7902 includes determining a VE 7616a with a list of parts for the repair, and information included in the application 7912 includes a “card” with a list of parts and nearby stores (e.g. referenced in the source data 7928) based on the application user's location where the parts can be purchased. An example includes a “card” for each store, for example sorted by the lowest cost, least number of stops required to get all of the parts, or other selected criteria by the user 814 or the application user (not shown).

The example system 7900 further includes a user verb selection 7908. In the example, the user verb selection 7908 includes operations defined to be available to the application 7912 and/or the application user. For example, the user verb selection 7908 may define which databases from the document 7922, the data element 7924, and/or the source data 7928 should be utilized by the application 7912. Additionally or alternatively, the user verb selection 7908 defines access for the application user, such as read, write, and/or output access to data available to the application 7912. In certain embodiments, data in the application 7912 may be linked to the data element 7924, the document 7922, and/or the source data 7928, for example providing live updates (or selective updates) to data in the application 7912. Additionally or alternatively, the user verb selection 7908 may allow for updates to the data to be written back from the application 7912—for example allowing the application user to change certain data and send the updates back to the data element 7924, the document 7922, and/or the source data 7928. An example includes a field sales document 7922, wherein the application user enters sales data which is reflected in the document 7922 after entry by the application user. In certain embodiments, the user 814 provides the user noun selection 7906, and may further provide user context selection 7910 such as the target application user for the application 7912, and the application configuration circuit 7902 suggests appropriate values for the user verb selection 7908 in response to the user noun selection 7906 and/or the user context selection 7910. An example application configuration circuit 7902 provides a selection of values for the user verb selection 7908 in response to rules regarding the target application user, user verb selection 7908 values that have been utilized by previous users 814, and/or values from a table in the document 7922 or elsewhere in the system 7900 defining suggested user verb selections 7908 associated with various user context selections 7910 and/or data associated with the user noun selection 7906.

In certain embodiments, the user context selection 7910 includes information that is not within the document 7922, the data element 7924, and/or source data 7928, such as header information for the application, display screens, user agreements, and/or any other data that the user 814 wants to make available in the application but is not present within the document 7922, the data element 7924, and/or source data 7928. Additionally or alternatively, the user context selection 7910 can include information about the application 7912 or application user that the user 814 wants considered during the operations of the application 7912, such as but not limited to the location of the application user, the demographics of the application user, the jurisdiction where the application user is located, and the like. Additionally or alternatively, the user context selection 7910 can include information such as the target operating systems and/or devices for the application 7912 (e.g. Android, Apple OS, and/or Windows).

The example application configuration circuit 7902 determines an application configuration value 7914 in response to the document 7922, data element 7924, and/or the source data 7928, and further in response to the user noun selection 7906, user verb selection 7908, and/or the user context selection 7910. For example, the application configuration circuit 7902 determines what programmatic elements (e.g. SQL and/or javascript) need to be prepared to implement the application 7912, which data elements need to be included in the application data and/or available for access in real time, and further determines the response of the application 7912 to anomalies—for example the response of the application 7912 to linked data fields where communication from a device operating the application 7912 may not be available.

An example system 7900 includes an application publishing circuit 7904 that publishes the application 7912 in response to the application configuration value 7914. An example application publishing circuit 7904 prepares the application file for upload to the appropriate system (e.g. the Apple Store, to a proprietary server for in-house devices or applications as a specific service, etc.). The application configuration circuit 7902 prepares the application executing code, utilizing either pseudo-code operational descriptions generated by the application configuration circuit 7902 and/or incorporating actual code generated by the application configuration circuit 7902. The application configuration circuit 7902 prepares the application 7912 for operation with the target operating system(s), and uploads the application 7912 for later download and use by a device operating the application 7912.

It can be seen that the system 7900 provides for a highly configurable application 7912 leveraging the data, visualization, and referencing capabilities of various system disclosed herein working with a document 7922, a data element 7924, and/or source data 7928. The system 7900 provides for an application 7912 that can be easily configured to work with a document 7922, and/or to provide a useful function to an application user leveraging easy access to the document 7922, the data element 7924, and/or the source data 7928. The user 814 can configure the application 7912 to have live data available as the document 7922, data element 7924, and/or source data 7928 are updated, to require that updates require a new version of the application 7912, and/or combinations of these for varying data elements of the user noun selection 7906. The highly capable and flexible application 7912 from the system 7900 does not require that a user 814 have a sophisticated understanding of database interactions, and can readily work with a flexible document surface without regard to linking different document application types to develop data interaction capabilities. Additionally or alternatively, any controls, visualizations, continuous selections, and/or discrete selections described herein are readily incorporated, and/or modified for inclusion, into an application 7912. In certain embodiments, a target application user may include the user 814, and/or other persons directly interacting with the document 7922 through a client computing device 7920, to readily create a thin client application to provide for remote, controlled, or easy access to the document 7922 and/or selected portions of the document 7922 for editing, reading, publishing, keeping updated on changes to the selected portions, and the like.

An example application 7912 includes a user verb selection 7908 that allows the application user to publish the document 7922 and/or portions thereof as a web page. In certain embodiments, the application 7912 allows the application user to create, request, or receive a permanent URL for the web page. In certain embodiments, a document 7922 and/or portions thereof are published directly to a web page without the use of an application 7912. In certain embodiments, the selected portions of the document 7922 are visible in the application 7912 and/or on the web page, without the editing or interacting features of systems in the present disclosure, and without seeing the construction elements of the document 7922 such as settings for controls, continuous selections, discrete selections, and/or object names or references. An example application 7912 includes an export of recipes from a document 7922, and new visitors can treat it as an application for navigating a recipe book and/or adding their own recipes. In certain embodiments, recipes added by application users are captured in the document 7922, which may be in a separate location from originally published recipes, or in any other location specified by the user 814, such as with the user verb selection 7908. Example and non-limiting embodiments include the document 7922 and/or selected portions thereof published as a document (e.g., as the application 7912) that is operable on a television, such as a smart television, a streaming device, such as Apple TV, a smart watch, and/or a tablet, with configurable access to the document 7922 and/or read-only access to the published portions of the document 7922.

In certain embodiments, the system 7900 provides capability to publish an application 7912 that provides an application user with access to the document 7922 and/or selected portions of the document 7922. The example published application 7912 is a self-contained version of the document, including any or all of the content and/or data in the document 7922. An example published application 7912 is operable “offline” (e.g., without communication access to the document server 7918, and/or with intermittent access to the document server 7918). An example published application 7912 is configured for selected performance on target devices for the application 7912, for example to limit resource utilization (e.g., memory usage, processor usage, and/or communication bandwidth) where target device resources are limited (e.g., a smart phone, tablet, smart device, and/or other “thin client” device). An example includes determining a target device resource value, such as: memory (such as RAM, storage, external storage, etc.), processing power (such processing speed, cores, available threading, etc.), and/or communication capability (such as bandwidth, speed, latency, availability, etc.). The determination of the target device resource value includes detecting resources on an actual device, entry of resource specifications by the user, data lookup of resource information for specified devices, a device type (e.g., a mobile phone and/or tablet), and/or utilizing a technical profile or requirements information to determine device resource levels to be supported by the application 7912.

Operations to determine the application configuration value 7914, and accordingly modulate resource utilization of the application 7912, include at least: inclusion of only a portion of data in the document 7922 and/or a portion of the document 7922; inclusion of flat for one or more data elements in the document 7922 (e.g., replacing referenced or linked data with flat data; replacing calculated values and/or formulas with result data having calculations pre-completed; reducing one or more configurable/selectable aspects of the document 7922 with fixed values and/or values having a limited selection set; adjusting an update rate of linked or referenced data; adjusting an update rate of calculated values and/or formulas; and/or adjusting a resolution of images, charts, graphs, and/or other visualization elements in the document 7922). The term “flat data” includes data stored in-line in the application 7912 and/or on device storage of the target application device, that is not linked (e.g. dependent upon a parent or source data set) or referenced (e.g. calculated at run-time, and/or looked up from another location in the document and/or source data). In certain embodiments, the application 7912 includes a self-contained format which is executable on a target operating system and/or which is executable in a target operating environment (e.g. an .exe file, an archive file instead of referenced or linked data, calculated values.

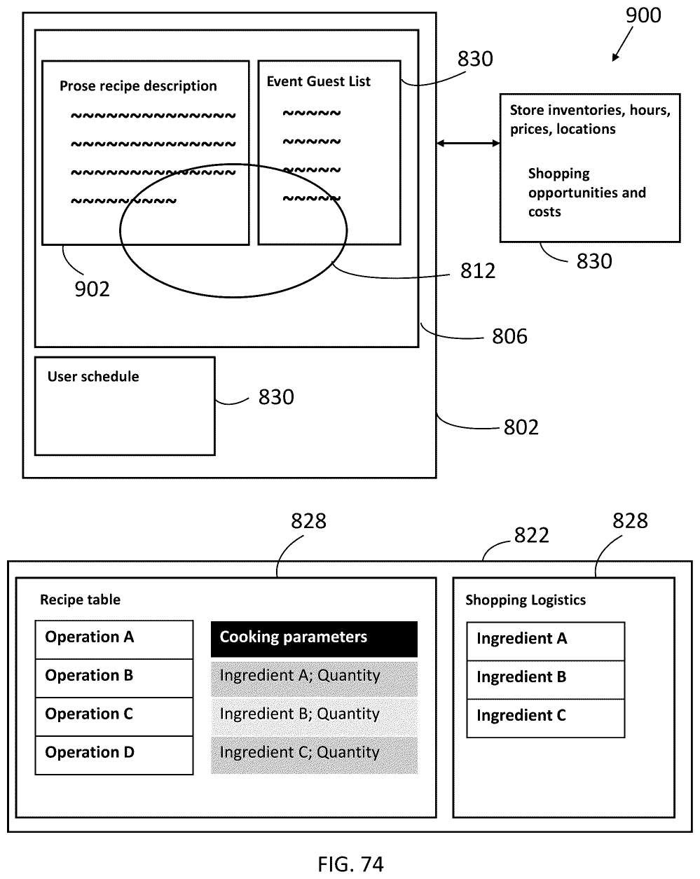

Referencing FIG. 73, an example system 800 includes a document server 802 communicatively coupled to a client computing device 804. Certain further aspects of the example document server 802 and/or the client computing device 804 are described following in the disclosure referencing FIG. 74.

An example system 800 includes the document server 802 that communicates at least a portion of a document 806 to the client computing device 804. A document 806, as used herein, references a collection of data related together for purposes of display, reading, editing, viewing, playback, printing, organizing, collaborating, and/or communicating with the related collection of data. In certain embodiments, a document may reference the data as displayed (e.g. a view of the collection of data related that is presentable to a user on a screen, printed page, and/or any other type of user-focused realization of the related collection of data or a portion thereof), as stored in non-transient memory, a collection of operations which, if executed, render a display consistent with the document, portions of a larger related collection of data present on a given device (e.g. a parent document on a server, where a portion of the parent document present on a client computing device is the “document”) and/or other similar constructions or organizations of data and information. A document or portions thereof may be present in multiple locations.

The example system 800 includes a client computing device 804 having a number of circuits constructed to functionally perform operations of the client computing device 804. An example client computing device 804 includes a user interaction circuit 808 that interprets a user selection 810, where the user selection 810 includes at least one data value 812, where the document 806 includes the data value(s) 812. The client computing device 804 may include one or more computers, but the present disclosure contemplates the computing device as component or group of components that perform the functions of the client computing device 804. Example and non-limiting structures to perform operations of the client computing device 804, including structures of any associated circuits, include one or more user input devices (e.g. mouse, keyboard, touch screen, audio input) and/or communications received from one or more user input devices, storage and/or access to at least a portion of the document 806 (e.g. a displayed portion to the user 814, a stored aspect of the document 806 in a memory location and/or access to a stored aspect of the document 806 through a communication network), processors for executing instructions stored in a non-transient memory location, memory devices storing the document 806, portions of the document 806, and/or the instructions, a display device, a network infrastructure, a cloud storage and/or computing infrastructure, and/or communications to a display device where the display device is responsive to the communications and displays selected portions of the document 806, interface components (e.g. a graphical-user interface, menus, commands, and selections) which may be graphical or hardware-based.

In certain embodiments, a document server 802 may not be present, and/or the document server 802 or portions thereof may be present on a same hardware device as the client computing device 804 and/or portions of the client computing device 804. The user 814 may interact directly with the client computing device 804, and/or may be in communication with the client computing device 804.

Example and non-limiting user selections 810 include one or more of: a user-entered keyword, at least one data value selected by the user 814, a tag value selected by the user 814 (e.g. a style tag or an arbitrary tag), and/or determining a selected range value in response to the user selection 810. Certain non-limiting examples of user selections 810 are illustrated, but the user selection 810 should be understood broadly to include any operation by the user 814 to indicate source data 830, contextual information, information of interest, and/or any other type of information indicating a type of data the user 814 is selecting for extraction of related, re-organized, and/or structured data. An example user selection 810 includes the entry of a word—for example “quarterly”, “cost”, “available”, “measure”, any other type of information, including arbitrary character strings, and/or wild cards. An example user selection 810 includes a tag value selected and/or entered by the user 814—for example a value that indicates information with appropriate related headings, metadata, column titles, row titles, or other information indicated by a tag. In certain embodiments, a tag indicates portions of a document automatically tagged by the application as a document is prepared, such as paragraph types, tables, figures, graphs, referenced information, linked information, and/or data types. In certain embodiments, a tag indicates portions of a document tagged by a user 814, either manually, as part of user defined rules, and/or as part of a user defined template. An example user selection 810 includes at least one data value selected by the user 814, such as a selected word or range of words, a heading, a specific data value (e.g. a name, word, number, or object), a selected range of data (e.g. a table, a column, row, and/or element of a figure such as a bar, pie slice, and/or data series). In certain embodiments, the user selects a value and the user interaction circuit 808 determines the user selection 810 based on the user selected value. For example, a user 814 may select only a portion of a value, or related value, and the user interaction circuit 808 determines a user selection 810 based on the portion or related value. In certain embodiments, the user selects a linked data value (e.g. underlying source data 830 is in a different document (on the document server 802, the client computing device 804, or elsewhere), a portion of the document not present on the client computing device 804, and/or externally sourced data such as from a website, database, and/or cloud storage). In certain embodiments, the user selects a data reference value, such as a value where the underlying source data 830 is present elsewhere (in the document or otherwise), and is not locally stored, or is only stored for responsiveness purposes but the source location is considered the originator of the data (at least for the purposes of the data reference value—the source location may be another reference). In certain embodiments, the user selects a data record, for example an entire file or set of data that is referenced only by title, identifier, and/or unique key.

In certain embodiments, the user interaction circuit 808 determines the user selection 810 from the user selected value using such operations as, without limitation: using an entire word where the user has selected only a portion of the word; selecting an entire table, row, or column where the user 814 has selected only a portion of the table, row, or column; selecting an entire document section (e.g. a paragraph, a tagged region, related tables, figures, or other data) where the user 814 has selected only a portion of the document section; selecting related data where the context indicates the related data is likely to be desired (e.g. the user 814 selects an aggregated data value and the user interaction circuit 808 selects additionally or alternatively the underlying data forming the aggregated value); selecting additional or alternative data according to rules specified by the user 814 (e.g. always take a whole table, take only the columns from cells selected, and/or always get referenced data as well); selecting additional or alternative data according to rules specified by a document template (e.g. a “quarterly reports” document template has one set of selection rules, a “personnel file” document template has a different set of rules, and a “recruit candidate” document template has another set of rules); selecting additional or alternative data according to device resources associated with the user 814 (e.g. user 814 has limited local memory, limited network access, and/or limited processing power, and making appropriate selection decisions to conserve the appropriate resources); selecting additional or alternative data according to rules defined by an administrator; selecting additional or alternative data according to rules defined by a document creator, and/or selecting additional or alternative data according to past operations by the user 814 (e.g. user 814 has always added certain types of data to an extract operation after selecting similar data previously, user 814 has been operating in a selected portion of the document indicating the type of information likely to be of interest to the user, and/or the user 814 has removed certain types of data from an extract operation after selecting similar data previously).

In certain embodiments, the user interaction circuit 808 provides the data value of the user selection 810 as an inferred data value. Example and non-limiting operations to provide the data value of the user selection 810 as an inferred value include: determining the inferred data value in response to: a document type value (e.g. report, draft, publication, personnel file, white paper); determining the inferred data value in response to a document location value (e.g. on the document server 802, on the client computing device 804, in a cloud storage (not shown), or over a mobile network); determining the inferred data value in response to a predefined data association value such as a template data association value or a user selected data association value; determining the inferred data value in response to a prior user operation; prompting a user with a number of data association values (an example implementing GUI may include such prompts as: “Did you mean to select: 1 [KEEP MY SELECTION]; 2 [TABLE A]; 3 [COLUMN B]; 4 [DOCUMENT SECTION C]; 5 [PARAGRAPH D]; 6 [STYLE TYPE E]; OR 7 [OTHER]), and determining the inferred data value according to the prompt response; and/or determining the inferred data value in response to a priority value associated with each of a number of related data values, for example the current context such as date, network responsiveness, user role or title, user history, etc., indicates that monthly revenue is higher priority than quarterly revenue when the aggregated annual revenue value is selected by the user 814 for extract operations.

The example client computing device 804 further includes the user interaction circuit 808 interpreting a second user selection 816 including an extract value 818. Example and non-limiting extract values 818 include a document extract location value (e.g. a position in the document 806 to place the extracted data 828 from extract operations), and/or an extracted data 828 type value (e.g. provide extracted data 828 as a table, figure, bulleted list, aggregated data (e.g. a pivot table), a formatted display of extracted data 828, and/or a list of extracted data 828. In certain embodiments, the user interaction circuit 808 determines the extract value 818 in response to the context of user operations (including at least any context descriptions provided throughout the present disclosure), in response to a user input (including a prompted user input), in response to rules (e.g. user entered, template based, document creator based, and/or administrator entered), in response to a type of the selected data from the user selection 810, and/or in response to historical operations of the user or other users on the document. In certain embodiments, the extract value 818 includes a location to place extracted data 828, a type of data display for the extracted data 828, a status of the extracted data 828 after extraction (e.g. linked data, referenced data, and/or flat data), and/or a formatting of the extracted data 828 for display. An example system 800 includes the user interaction circuit 808 utilizing or confirming (e.g. via a prompt to the user 814) that a current editing location within the document 806 (e.g. a cursor location) is the document extract location value, and/or otherwise allowing the user 814 to enter an extract location value via one or more second user selections 816, and determining the portions of the extract value 818 indicating the type of extracted data, and/or the formatting and display parameters of the extracted data, through any of the operations described herein, and/or through one or more prompts to the user 814, whereby the user 814 provides one or more second user selections 816 to facilitate a data extraction with the desired parameters.

In certain embodiments, the client computing device 804 includes an extracted data generation circuit 820 that creates a data view 822 in response to the user selection 810 and/or the extract value 818, for example pulling referenced or linked data, sorting through the user selection 810 for intended data (e.g. ignoring null values, calculating or updating values, indexing or sorting data, and/or pulling relevant data from an entire selection of data such as keywords, keywords with associated data, and/or specific data columns). In certain embodiments, extracted data 828 is pulled, at least in part, from source data 830. The example system 800 includes source data 830 positioned within the document 806 (e.g. within the document but not within the data value 812), positioned on the document server 802 but outside the document 806, and/or external to the document server 802—for example data provided by a third party access such as an API interfacing with an external data source (not shown), data stored on another client computing device (not shown), and/or data stored on a network and/or cloud server. In certain embodiments, all of the data in the extracted data 828 is within the data value 812. Any portion, all, or none of the extracted data 828 may be taken from source data 830, positioned anywhere with communication to the client computing device 804.

In certain embodiments, the data view 822 includes all of the data contemplated for the extracted data 828, and is positioned at the specified location. In certain embodiments, the data view 822 includes relevant portions of the extracted data 828 for display to the user 814, where other portions of the extracted data 828 are prepared in the data view 822 when accessed by the user 814, over time to limit resource consumption (e.g. over a slow network), and/or in display portions to enable limiting utilization of resources (e.g. memory). Example and non-limiting operations of the extracted data generation circuit 820 include creating a table of extracted data 828, creating a formatted display of extracted data 828, creating a structured data view of extracted data 828, creating an aggregated view of extracted data 828, and/or creating a list of extracted data 828. In certain embodiments, the source data 830 is unstructured data. Unstructured data, as used herein, should be understood broadly, and includes any data that is not structured according to the data view 822, that is not sorted, indexed, and/or aggregated, that is not structured for an intended purpose of the user 814, and/or that is structured for a different purpose than that of the user 814 or for the data view 822. It can be seen that a given element of data may be structured for one purpose, but unstructured for a different purpose. It can be further seen that a given element of data may be unstructured, and after operations of the extracted data generation circuit 820 the element of data may be structured (e.g. confirmed that it is configured for the intended purpose and/or according to the data view 822), even if no alteration (including formatting, presentation to a display, sort order, indexing, and/or aggregating) occurs to the data in the process of making the data structured.

Non-limiting examples of the extracted data generation circuit 820 creating a structured data view of extracted data 828 include: compiling relevant elements of a prose description into a structured view (e.g. pulling ingredients from a description for a recipe or shopping list), changing a data structure from data structured for one purpose to data structured for a different purpose (e.g. pulling resume information into a personnel file template; pulling web based information into a structured template; pulling information from an annual report into a table of relevant financial information; reconfiguring table columns into a desired format including re-ordering and/or removing columns; restructuring a bulleted list of information into a table based format; summarizing and/or aggregating granular data into selected categories; combinations of these; and/or reversals of these). In certain embodiments, extracted data 828 includes data that corresponds to the user selection 810, linked data that is determined (e.g. looked up, referenced, and/or imported) in response to the user selection 810, and/or referenced data that is determined in response to the user selection 810. In certain embodiments, the extracted data generation circuit 820 additionally and/or alternatively determines an extraction context parameter 824, and creates the data view 822 further in response to the extraction context parameter 824. Non-limiting examples of determining the extraction context parameter 824 include: interpreting a user interaction history with the document (e.g. the user has expressed interest in revenues, old records, personnel information, events occurring on Tuesdays, certain data types within the document, and/or certain sections of the document); interpreting a user context selection (e.g. the user has indicated financial reports are due, the user is using a limited resource device, the user has indicated an access time limit for the document, an access time limit for the document is apparent from the system 800 status, other users are accessing portions of the document, and/or a regulatory deadline of a specific type is approaching); determining the extraction context parameter in response to a document type value, a document location value, a prior user operation, a template data association value (e.g. the template indicates certain data types are associated), and/or a user selected data association value (e.g. the user indicates, potentially in response to a prompt, that certain data types are associated).

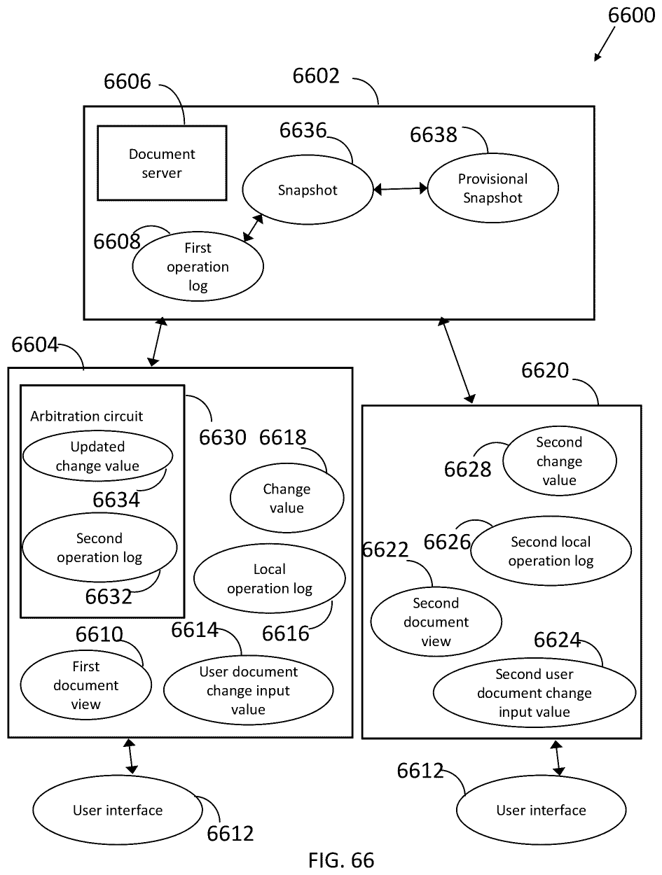

An example user interaction circuit 808 interprets a user data change input value 826. An example user data change input value 826 includes a change to the displayed portion of the data view (e.g. the user enters data, requests a search, and/or performs another interaction with the document). The example user interaction circuit 808 updates a source data 830 including the data value from the user selection 810 in response to the user data change input value 826. For example, the extracted data 828 may be linked or referenced data, where the source data 830 is located elsewhere in the document 806, on the document server 802, in a cloud or networked storage location, and/or includes external data such as a database and/or website. Previously known systems prevent linked, referenced, or other non-sourced data from updating the underlying source data 830. Previously known operations include blocking changes to linked data, breaking the link upon editing linked data, or providing a warning to a user that the linked data is not editable. In certain embodiments, the user interaction circuit 808 updates the source data 830 in response to an update of the linked data, and/or updates the source data 830 without breaking the link. In certain embodiments, the user interaction circuit 808 updates the source data 830 in response to a type of the data (e.g. blocking changes to certain data such as a personnel related data field), in response to an authorization level, title, and/or role of the user 814, in response to a location of the source data 830 (e.g. allowing updates within the document 806 but not externally), in response to a protected status of the source data 830 (which may be user-selectable or not, and may be local to the user 814 or global to the document 806), in response to a conflict resolution with other users of the document (e.g. reference operations of the system 6600 disclosed referencing FIGS. 66-72), and/or according to any other data management principles implemented by the system 800.

In certain embodiments, multiple rules are present for determining the data value 812 from the user selection 810, for determining the extraction value 818, and/or for determining the extract context parameter 824. An example system 800 includes applying all mutually compatible rules, applying the rules in a manner where the greatest number of rules can be applied and excluding the least number of rules, applying the rules in a priority determined by the rule maker (e.g. title or role, current user v. a past user, and/or administrator status), and/or applying the rules in manner determined by the type of information (e.g. rules for human resources, personnel, legal, and/or inclusion of personally identifiable information or health information may get priority). Any other rule conflict management scheme understood in the art is contemplated herein.

Referencing FIG. 74, a schematic illustration 900 of an example data view 822 created in response to a user selection 810 is depicted. The illustration 900 includes a document 806 having a prose recipe description 902 (e.g. a paragraph form description of a recipe for making a food item) and an event guest list. The event guest list is depicted as source data 830 in the illustration 900—for example the event guest list may be present in one portion of the document 806, and the prose recipe description 902 present in another portion of the document 806. The illustration 900 depicts a data value 812—for example portions of the prose recipe description 902 and event guest list selected according to a user selection 810. In the example, the data value 812 is a partial selection of each of the prose recipe description 902 and the event guest list to illustrate certain aspects of the present disclosure, however the data value 812 may fully include one or more of the prose recipe description 902 and the event guest list, and/or the prose recipe description 902 and the event guest list may be indicated in a manner other than as illustrated. The illustration 900 further includes a user schedule, depicted as source data 830 that is present on the document server 802 but not within the document 806, although accessed source data 830 may be located anywhere that is operationally accessible to the client computing device 804 as described herein. The illustration 900 further depicts store information (“Store inventories, hours, prices, locations”), depicted as external source data 830 relative to the document server 802. In the illustration 900, the client computing device 804 (not shown), through operations such as those described with reference to the system 800, has created a data view 822 in response to the user selection 810 (realized as the data value 812). The client computing device 804 has further determined a recipe table (e.g. a list of cooking operations determined from the prose recipe description 902, and/or cooking parameters such as times, temperatures, and ingredients) and a shopping logistics (e.g. times to shop at which stores, and the ingredients list to be purchased). It will be recognized that the illustration 900 depicts the data view 822 showing structured data in a manner uniquely useful to the user 814. In the illustration 900, the system 800 brings together the user schedule, event information, and planned food items together with external data such as store inventories, hours, and locations, and presented the data for the user to obtain the items needed for the event, to prepare the food items, and to integrate shopping with the schedule of the user. In certain embodiments, the user 814 may have entered a selection—for example “plan an event”—that enabled the client computing device 804 to determine that selection of a portion of the prose recipe description 902 was intended to bring the entire prose recipe description 902 into consideration for generating the data view 822. In certain embodiments, the context of the extraction operations in the illustration 900 further enabled the client computing device 804 to reach out to the user schedule and/or store information, even where such data is not present in or explicitly referenced in the document 806. In certain embodiments, the client computing device 804 may output the data view 822 in a manner accessible to the user 814, and/or may add the data view 822 to the document 806. In certain embodiments, the client computing device 804 adds the data view 822 to the document 806, creates a separate document (not shown) that includes the data view 822, and/or provides the data view as a tooltip (e.g. the user 814 hovers over a document 806 portion in a given context, and the client computing device 804 generates a data view 822 for temporary display, and/or allows the user 814 to confirm and generate the data view 822 into a new document or incorporate the data view 822 into a currently existing document 806.

Operations such as performed by the system 800 and depicted in the illustration 900 allow for rapid and convenient generation of user-oriented data extraction. Example and non-limiting applications include generation of a business card or profile document that pulls information from a number of data sources into a convenient and selected data display template, that rapidly creates structured information from a user 814 based on source data 830 and/or document elements that are unstructured and/or not structured for the purpose desired by the user 814, and allows the user 814 to update source data 830 using the structured data in the data view 822 directly, without having to go to the source data 830. The user 814 is thereby able to consider data in a selected context, avoid the specific formatting and input nuances of the source data 830, and have rapidly usable output for a selected purpose.

Non-limiting examples of a data view 822 include a structured representation of data, selected data fields, template form titles (e.g. table row and/or column titles, field names, category titles, boilerplate information, company or entity names, copyright notices, confidentiality notices, and the like), and/or information developed from data in an aggregated, filtered, sorted, parsed, and/or other processed format. Example and non-limiting operations of an extracted data generation circuit 820 to provide a data view 822 include providing a pop-up separate view of the data view 822, a downloadable separate view of the data view 822, a tool tip data view 822 that appears in response to a user indication of a value of the document 806 (e.g. highlighting, selecting, or hovering a selection cursor on and/or over a name, word, term, date, data field), where the tool tip data view 822 includes a structured data view 822 such as a “card” having contextual information about the user indicated value. As used herein, a card includes, without limitation, a discrete display of data elements, which may be provided within a box or bounded shape, and/or which may be provided within a data view 822 having an area configured for display in response to a selected size and/or shape, and/or in response to a user screen size for the client computing device 804, and/or another device used by the user to access the data view 822 (e.g. a tablet, smart phone, laptop, desktop, and/or a smart device having access to the client computing device 804, the document server 802, and/or a publication area for the card such as a website and/or network location, and/or having an application 7912 published by the application publishing circuit 7904 (see, e.g. disclosure referencing FIG. 79). In certain embodiments, the card is configured to fit on the user screen. In certain embodiments, the card is configured to fit within a narrower dimension of the user screen (e.g. a mobile device in a “portrait” orientation). An example card includes thereupon one or more data fields and/or VE 7616a, such as a table, graph, chart, and/or image. In certain embodiments, the parameters displayed include a data group structured to convey the theme of information for the card, including without limitation information about a person, an entity, a project or task, a recipe, one or more elements of a row on a table, one or more elements of a chart, and/or one or more elements of a graph. A card may include titles, logos, disclaimers, data source information, contact information, and/or any other selected information. The described examples for a card are non-limiting illustrative examples.

In certain embodiments, the extracted data generation circuit 820 accesses contextual information (e.g. location in the document 806 that user is working with; rules set by the user, a document template, and/or an administrator; a current time of day and/or calendar date; recent operations performed by the user; a user role, title, or user-indicated information about the user; the type of data within the user indicated value; and/or a section or section type of the document 806 within with the user is working). Example and non-limiting data views 822 may include live data (e.g. data updated in real-time and/or with a short refresh period), linked data (e.g. links or references to other data, which may be updated periodically, based on system performance, and/or upon user request), flat data (e.g. data copied into the data view 822 at generation time which is not linked to the originating data), and/or may include indications of the status of the data (age, refresh time, live, etc.). In certain embodiments, the data view 822 may be provided as an addition to the document 806—for example a first table column includes a data field (e.g. a name, job title, project name, project status, etc.) and a second table column is populated with the data view 822 including structured data relative to the first table column. Additionally or alternatively, the data view 822 including the structured representation of data may be volatile (e.g. it disappears when the user changes the focus), provided in a non-volatile manner separate from the document 806, generated into a new section of the document 806, and/or the user may receive a prompt to specify an action to be performed with the structured representation of data (e.g. copy to a clipboard, paste in an e-mail, save to a file, and/or place it in the document 806).

A number of procedures for performing certain operations to extract data from a document are described following. Operations are illustrative and non-limiting, and may be re-ordered, divided, and/or combined in any manner to perform similar functions, as will be understood to one of skill in the art having the benefit of the disclosures herein. In certain embodiments, one or more operations may be performed by components of a system such as the system 800.

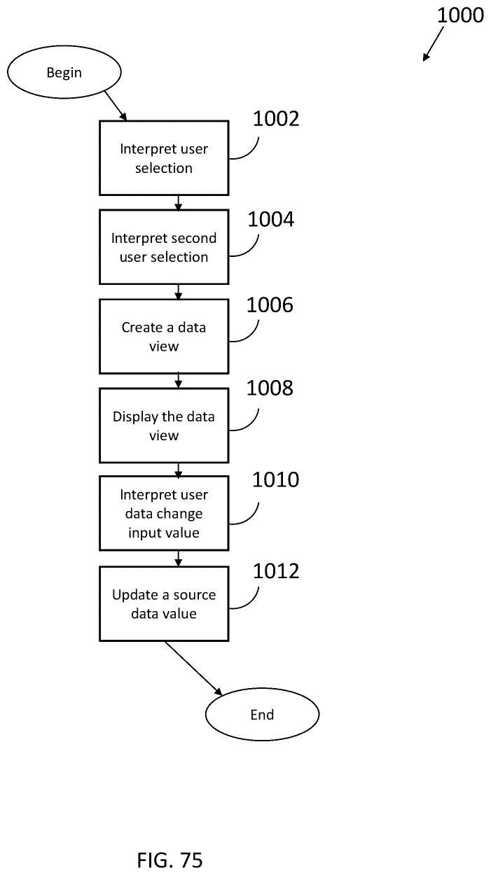

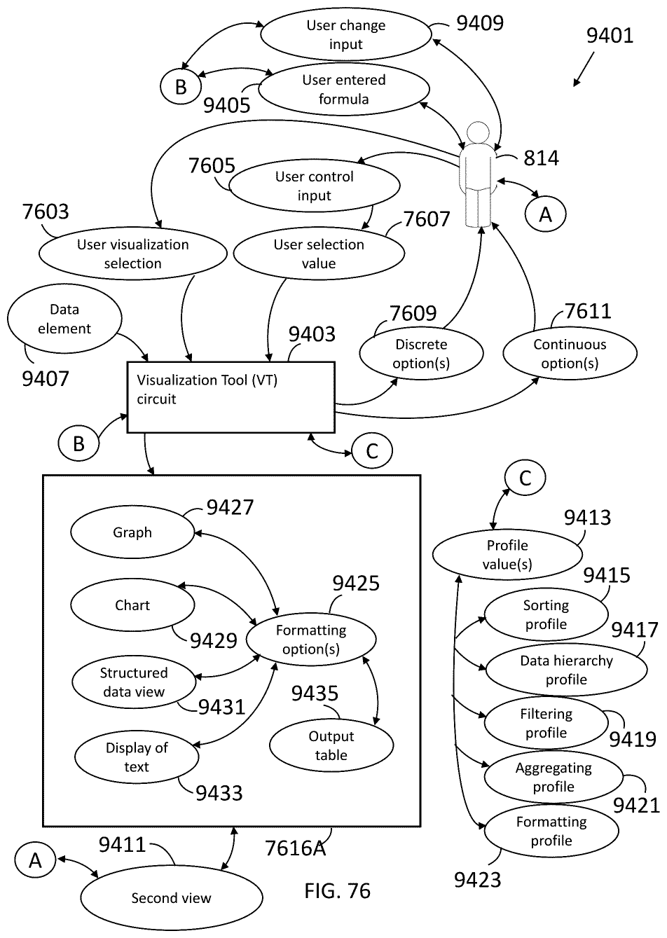

Referencing FIG. 75, an example procedure 1000 includes an operation 1002 to interpret a user selection including at least one data value, an operation 1004 to interpret a second user selection including an extract value, and an operation 1006 to create a data view in response to the user selection. The example procedure 1000 further includes an operation 1008 to display at least a portion of the data view in response to the extract value. In certain embodiments the procedure 1000 includes performing the operation 1002 by receiving a user-entered keyword, determining a data value selected by the user, determining a tag value selected by the user, and/or determining a selected range value in response to the user selection. Example and non-limiting data values include a table column, a table row, a style tag, an arbitrary tag (e.g. an identifier for a data selection within the document, with or without an inherent meaning to the identifier), a linked data value, a data reference value, and/or a data record.

In certain embodiments, the data value includes an inferred data value, and the operation 1002 further includes determining the inferred data value. Example and non-limiting operations to determine the inferred data value include determining the inferred data value in response to a document type value, determining the inferred data value in response to a document location value, determining the inferred data value in response to a predefined data association value, determining the inferred data value in response to a prior user operation, determining the inferred data value in response to a user selected data association value and/or a default data association value, and/or determining the inferred data value in response to a priority value associated with each one of a number of related data values. An example operation 1002 further includes determining the inferred data value in response to a predefined association value, and determining the predefined association value in response to a template data association value and/or a user selected data association value. An example operation 1002 further includes prompting a user with a number of data association values, and determining the inferred data value in response to the user selected association value and/or a default data association value.

An example procedure 1000 further includes the operation 1004 further including determining a document extract location value and/or an extracted data type value. An example procedure 1000 further includes the operation 1006 including an operation such as: creating a table of extracted data, creating a formatted display of extracted data, creating a structured data view of extracted data, creating an aggregated data view of extracted data, and/or creating a list of extracted data. In certain further embodiments, the extracted data includes data corresponding to the user selection, linked data determined in response to the user selection, referenced data determined in response to the user selection, and/or portions thereof. In certain embodiments, the operation 1006 further includes creating the data view by determining the portion of the data corresponding to the user selection, linked data determined in response to the user selection, referenced data determined in response to the user selection further in response to an extraction context parameter. An example procedure 1000 further includes the operation 1006 further including determining the extraction context parameter by performing at least one operation such as: interpreting a user interaction history with a document, interpreting a user context selection, determining the extraction context parameter in response to a document type value, a document location value, and/or a prior user operation, and/or determining the extraction context parameter in response to a template data association value and/or a user selected data association value. An example procedure 1000 further includes the operation 1006 further including prompting a user with a number of extraction context parameter values, and determining the extraction context parameter in response to a user selected extraction context parameter value and/or a default extraction context parameter value. An example procedure 1000 further includes the operation 1006 further including determining the extraction context parameter value in response to the second user selection.

The example procedure 1000 further includes an operation 1010 to interpret a user data change input value, where the user data change input value includes a change to the displayed portion of the data view. The example procedure 1000 further includes an operation 1012 to update a source data including the data value, where the updating is in response to the user data change input value. An example procedure 1000 further includes the created data view being a structured data view, and/or the source data being unstructured data.

Referencing FIG. 66, an example system 6600 includes a first computing device 6602 communicatively coupled to a second computing device 6604.

The example system 6600 includes the first computing device 6602 including a document server 6606 that communicates a first operation log 6608 to the second computing device 6604, where the first operation log 6608 includes one or more sequential operations defining operations to create a first document. For example, and without limitation, the first operation log 6608 includes instructions such as inserting text into a document, formatting one or more aspects of the document, adding breaks to the document, and referencing data external to the document or related to other portions of the document. The first operation log 6608 includes sequential operations such that, if the sequential operations are executed, the first document would be created. In certain embodiments, the first computing device 6602 communicates the first operation log 6608 to the second computing device 6604 by communicating a relevant or selected portion of the first operation log 6608 to the second computing device 6604. For example, the first computing device 6602 may communicate only portions of the first operation log 6608 that affect pages 1-10 of a document, where a user associated with the second computing device 6604 has communicated that only pages 1-10 are requested. Any other operations to select portions of interest of a document, relevant subject matter within a document, or the like, and to thereby communicate relevant portions of the first operation log 6608 are contemplated herein. In certain embodiments, the first operation log 6608 is included as a portion of a more complete operation log (not shown). In certain embodiments, the first computing device 6602 updates the first operation log 6608 consistent with information from a more complete operation log upon access or request to relevant portions of a document, and the updated first operation log 6608 is seamlessly incorporated with other operations herein as the “first operation log 6608.”

The example system 6600 includes a second computing device 6604 that performs operations to create a first document view 6610 in response to the first operation log 6608. For example, the second computing device 6604 performs all or a portion of the operations in the first operation log 6608, and creates a first document view 6610 providing a representation of the result of the operations in the first operation log 6608. The first document view 6610 includes portions of a document for viewing (e.g. a page or section currently accessed by a user in communication with the second computing device 6604), printing, editing, or similar operations by the user. An example second computing device 6604 includes a user interface 6612 to a user, allowing for display to the user (e.g. through output to a screen, by providing a text or alert, providing a report, providing stored data, and/or any other type of display to the user), and further allowing for input from the user (e.g. via network communication to a user device, keyboard and/or mouse input, voice input, biometric input, and/or camera input). The described examples of the user interface 6612 are non-limiting, and any type of user interface 6612 is contemplated herein.

The example second computing device 6604 further performs operations to receive a user document change input value 6614, and to create a local operation log 6616 in response to the first operation log 6608 and the user document change input value 6614. For example, the second computing device 6604 may append the first operation log 6608 with operations created to reflect the user document change input value 6614, such that the local operation log 6616 reflects a document consistent with the edits made by, and displayed to, the user associated with the second computing device 6604. An example local operation log 6616 includes at least one sequential operation defining operations to create a second document, such as the document consistent with the edits made by, and displayed to, the user associated with the second computing device 6604. In certain embodiments, the second computing device 6604 updates the first document view 6610 in response to the user document change input value 6614, for example to display the document as edited by the user. An example second computing device 6604 further communicates a change value 6618 for the first operation log 6608 to the first computing device 6602 in response to the first operation log 6608 and the local operation log 6616—for example to communicate additional changes made by the user associated with the second computing device 6604 after the receipt of the first operation log 6608 from the first computing device 6602. The timing for communicating the change value 6618 to the first computing device 6602 is selectable and/or determinable in real time, and the timing selected in certain embodiments depends upon the communication speed between the first and second computing devices 6602, 6604, the performance of the first and/or second computing devices 6602, 6604, the rate of change of the local operation log 6616 by the user associated with the second computing device 6604, a number of other users associated with separate computing devices that are simultaneously accessing and/or changing a document reflected by the first operation log 6608, the availability of communication between the first and second computing devices 6602, 6604, and/or user preferences provided during the creation of a document reflected by the first operation log 6608 and/or during an editing or accessing session of the document reflected by the first operation log 6608.

In certain further embodiments, a system 6600 includes the first computing device 6602 further communicatively coupled to a third computing device 6620, where the document server 6606 further communicates the first operation log 6608 to the third computing device 6620. The example third computing device 6620 creates a second document view 6622 in response to the first operation log 6608, where the second document view 6622 includes content generated using at least a portion of the first operation log 6608. The operation log 6608 or portion thereof as provided to the third computing device 6620 may differ from the operation log 6608 or portion thereof as provided to the second computing device 6604—for example a user associated with the third computing device 6620 may be accessing a different portion of a document reflected by the first operation log 6608. However, the first operation log 6608 provided to the third computing device 6620 is consistent with the first operation log 6608 provided to the second computing device 6604, at least before updates are provided to the first operation log 6608 in response to user edits at various computing devices. The example third computing device 6620 further receives a second user document change input value 6624, and creates a second local operation log 6626 in response to the first operation log 6608 and the second user document change input value 6624. The example second local operation log 6626 includes at least one sequential operation defining operations to create a third document, such as the document consistent with the edits made by, and displayed to, the user associated with the third computing device 6620. The example third computing device 6620 further communicates a second change value 6628 for the first operation log 6608 to the first computing device 6602 in response to the first operation log 6608 and the second local operation log 6626.

An example system 6600 further includes an arbitration circuit 6630 that constructs a second operation log 6632 in response to the first operation log 6608, the change value 6618, and the second change value 6628. The example system 6600 includes the arbitration circuit 6630 provided on the second computing device 6604, although the arbitration circuit 6630 may be provided on any device in the system 6600, and/or may be distributed across more than one device. The provision of the arbitration circuit 6630 on the second computing device 6604 allows for conflict management for changes to the operation log 6608 to be managed at the client level (e.g. where the second computing device 6604 is a client device to the first computing device 6602), allowing for more responsive conflict resolution for the user associated with the second computing device 6604. In certain embodiments, for example with a thinner client, conflict resolution may be moved partially or completely up to the first computing device 6602. Additionally or alternatively, more than one client device, and/or each client device (e.g. the second computing device 6604 and the third computing device 6620) may include an arbitration circuit 6630 and/or portions of the arbitration circuit 6630.

In certain embodiments, the local operation log 6616 includes a first record of operations which, if implemented on a document, would provide a document having edits consistent with the user document change input value 6614, and the second local operation log 6626 includes a second record of operations which, if implemented on a document, would provide a document having edits consistent with the second user document change input value. In the example, the third computing device 6620 communicates the second change value 6628 to the first computing device 6602, which makes the second change value 6628 available to the arbitration circuit 6630. In the example, the changes in the second local operation log 6626 are made available to the arbitration circuit 6630 via the communication of the second change value 6628. In certain embodiments, the second local operation log 6626 is communicated directly to the arbitration circuit 6630.

An example arbitration circuit 6630 applies non-conflicting operations of the local operation log 6616 and the second local operation log 6626, and further resolves conflicting operations of the local operation log 6616 and the second local operation log 6626 to construct the second operation log 6632. In certain embodiments, the second operation log 6632 is passed to the first computing device 6602, allowing the first computing device 6602 to update the operation log 6608 to include operations from both of the second computing device 6604 and the third computing device 6620. In certain embodiments, a combined change value (not shown) is constructed and passed to the first computing device 6602, and/or the second operation log 6632 includes only changes relative to the operation log 6608, to allow for a reduced set of information to be passed to the first computing device 6602 and to update the operation log 6608 to include operations from both of the second computing device 6602 and the third computing device 6620.

In certain embodiments, during editing and viewing of the document from users associated with the second computing device 6604 and the third computing device 6620, changes are allowed in an “optimistic” collaboration—allowing for responsive editing to the document under the assumption that conflicting operations will not be created, and/or that conflicting operations can be resolved. Periodically and/or episodically, conflicts which may be present are resolved according to the operations of one or more arbitration circuits 6630.

An example arbitration circuit 6630 resolves conflicting operations of the local operation log 6616 and the second local operation log 6626 utilizing one or more operations described herein. An example arbitration circuit 6630 applies individual operations from the local operation log 6616 and/or the second local operation log 6626 by prioritizing operations according to a time stamp of each operation—for example a first wins or a last wins prioritization. An example arbitration circuit 6630 applies individual operations from the local operation log 6616 and/or the second local operation log 6626 by prioritizing operations according to a time stamp of the operation log 6616, 6626—for example when the corresponding operation log 6616, 6626 was created, last saved, first lists an edit, and/or last lists an edit. In certain embodiments, the time stamp of the operation log 6616, 6626 provides an indication of when a user first accessed a document, first edited a document, last accessed a document, and/or last edited a document. Accordingly, the arbitration circuit 6630 can apply a selected prioritization for operations in each operation log 6616, 6626 according to predetermined priority selections. An example arbitration circuit 6630 prioritizes operations according to a priority associated with the second computing device 6604, the third computing device 6620, and/or a priority associated with a user of one of the computing devices 6604, 6620. For example, the arbitration circuit 6630 may look at user login information, and determine whether a user has higher priority than another user, and assign higher priority to changes from the operation log 6616, 6626 provided by the computing device 6604, 6620 associated with the higher priority user. The prioritization of a user and/or a computing device 6604, 6620 may vary according to the section of the document wherein the user and/or computing device 6604, 6620 is viewing and/or editing—for example a user associated with a finance role may have a higher priority in one area of the document, and a user associated with an engineering role may have a higher priority in a second area of the document. An example arbitration circuit 6630 resolves conflicting operations of the operation log 6616 and the second local operation log 6626 utilizing a time of communication of the operations to the first computing device 6602—for example a “first come first serve” prioritization may assign the higher priority for conflicting edits to the first of the computing devices 6604, 6620 to provide one of the conflicting edits, where an alternative prioritization may assign the higher priority for conflicting edits to the last of the computing devices 6604, 6620 to provide one of the conflicting edits. One of skill in the art, having the benefit of the disclosure herein, will recognize that the type of document involved, the workflow of the group that may be working on the document, the hierarchy of the organization, the type of information in the document, and other considerations known to that person of skill in the art contemplating a particular embodiment of the arbitration circuit 6630 will affect the type and implementation of the prioritization utilized.

An example arbitration circuit 6630 further resolves conflicting operations of the local operation log 6616 and the second local operation log 6626 according to a type of the conflicting operations (e.g. operations of one type—such as deletions—may receive different prioritization rules than operations of a different type—such as adding a section). Additionally or alternatively, prioritization rules may be selected according to an aspect of the data, for example payroll data, personnel data, and/or flagged data, may receive distinct prioritization rules. An example arbitration circuit 6630 applies individual operations in a priority selected according to which computing device 6604, 6620 and/or associated user with the computing device 6604, 6620 and also which region of a document would be affected by the conflicting operations. An example arbitration circuit 6630 applies individual operations in a priority selected according to a performance characteristic for a computing device, for example providing a higher priority to a more responsive or more capable second or third computing device 6604, 6620, and/or providing a higher priority to a less responsive or capable second or third computing device 6604, 6620. An example arbitration circuit 6630 applies individual operations in a priority selected in response to a conflict management difficulty value—for example if utilizing a change from the local operation log 6616 results in a lower amount of conflict for a greater number of users than utilizing a change from the second local operation log 6626, the change from the local operation log 6616 may be deemed to be a lower conflict management difficulty value. Example and non-limiting considerations for determining a conflict management difficulty include a type of operations of the change (e.g. adding, deleting, inserting elements, linking data and/or calculations, etc.), a number of users affected by a change and/or a number of local operation logs 6616, 6626 in conflict with the change, and an amount of time to re-insert a change if the change is not applied by the system (e.g. the change is an otherwise lower priority conflict change and not applied—how long would it take a user to re-enter). In certain embodiments, an arbitration circuit 6630 applies individual operations in a priority selected according to a number of operations represented in the corresponding operation log 6616, 6626, a document editing time corresponding to the operation log 6616, 6626 for the computing device 6604, 6620, and/or according to a change amount and/or a rate of change of a reference region of a document that would be affected by the conflicting operations. A change amount may be measured by a quantitative amount of the change (e.g. characters, keystrokes, and/or processor operations to effect the change) to the original operation log 6608, an amount of document output change (e.g. a 3-keystroke insertion of a table adding 4 printed pages to the document may be a bigger change than a typed paragraph), and/or a relative amount of change compared to other operation logs 6616, 6626 present in the system 6600. A rate of change amount may be measured according to edit time of the particular user and/or calendar time (e.g. the document section has been changing three times a day relative to another section changing once per week), according to any measure of change amount, and further may depend upon the document portion experiencing the change (e.g. an expected section to update annually may be deemed to be changing quickly if updated twice in a week).

An example arbitration circuit 6630 additionally or alternatively resolves conflicting operations of the corresponding operation logs 6616, 6626 according to a number of computing devices that are currently accessing a reference region of a document that would be affected by at least one of the conflicting operations, a number of computing devices that have recently (e.g. within the last hour, last day, last week, last month, and/or last year depending on the context of the document and relevant data) accessed the reference region of a document affected, that are currently editing the reference region of the document affected, and/or that have recently edited the reference region of the document affected. In certain embodiments, resolving the conflict includes applying a higher priority one of the conflicting changes, and discarding a lower priority one of the conflicting changes. Additionally or alternatively, resolving the conflict can include applying both changes, for example with one set of changes marked relative to the conflict (e.g. shown, but in strikethrough), rejecting a lower priority one of the changes with a notification to the user that entered the rejected change, and/or creating a local copy of a document with the rejected change saved in the local copy. Depending upon the context of the document and the data involved, priority evaluation of conflicting changes can be applied in response to the criteria in either direction—for example many users of a given document section can indicate changes to that section get a higher priority (e.g. to keep the document updated as quickly as possible and ensure users are seeing a timely copy), or to get a lower priority (e.g. allowing users to make more responsive changes rather than requiring high overhead communications to keep all local operation logs 6616, 6626 in sync). In certain embodiments, the priority criteria can be selected or affected by a user selection—for example the user makes a selection to ensure that the changes they are about to make are prioritized (e.g. in preparation of a final version of a document before a significant even such as a presentation or regulatory filing), or to affect the prioritization criteria.

In certain embodiments, the arbitration circuit 6630 updates the change value 6618 to an updated change value 6634 in response to the prioritization of conflicting operation logs 6616, 6626, and the updating of the second operation log 6632, and communicates the updated change value 6634 to the first computing device 6602. In certain embodiments, the first computing device 6602 determines a snapshot 6636 in response to the updated change value 6634. A snapshot 6636 includes sequential operation(s) that define a second sequential operation or operations which, if executed, results in an equivalent document to the first document created by the operation log 6608, and/or created by the second operation log 6632 (e.g. reflecting conflict resolved changes to the operation log 6608 by users associated with computing devices 6604, 6620 in the system 6600). In certain embodiments, when a snapshot 6636 reflects conflict resolved information and is an update to the operation log 6608, the operation log 6608 may be updated with (or replaced with) the snapshot 6636. In certain embodiments, the updating of the operation log 6608 may include version control with previous versions of the operation log 6608 saved, and/or the operation log 6608 simply replaced with the snapshot 6636. In certain embodiments, the first computing device 6602 provides the snapshot 6636 and/or portions thereof as the operation log 6608.

An example snapshot 6636 includes: second sequential operations that have fewer process operations than the first sequential operations of the operation log 6608 and/or second operation log 6632; second sequential operations that have fewer logical operations than the first sequential operations of the operation log 6608 and/or second operation log 6632; second sequential operations having a simplified description of operations than the first sequential operations of the operation log 6608 and/or second operation log 6632; and/or second sequential operations having lumped operations relative to the first sequential operations of the operation log 6608 and/or second operation log 6632. In certain embodiments, the snapshot 6636 includes object data having characteristics selected to create a document consistent with the operation log 6608 and/or the second operation log 6632. For example, an example snapshot 6636 includes one or more tables, and/or additional or alternative objects, having characteristics such that the collection of one or more objects creates a document consistent with the operation log and/or the second operation log 6632. In a further example, the snapshot 6636 does not include operations, such as descriptions of operations from a user to create a document, but includes only objects and characteristics for those objects. In certain embodiments, the snapshot 6636 includes objects and characteristics for those objects, plus second sequential operations, such that implantation of the objects plus the second sequential operations creates a document consistent with the operation log 6608 and/or the second operation log 6632. In certain embodiments, a resource utilization to create a document from the snapshot 6636 is reduced relative to a resource utilization to create the document from the operation log 6608 and/or second operation log 6632, where the resource utilization includes a parameter such as: a total number of processing operations, a memory utilization (e.g. random-access memory utilization, although any type of memory is contemplated herein), and/or an intermediate memory utilization (e.g. a memory size required during execution of the operation log 6608, second operation log 6632, and/or snapshot 6636; for example to create resultant arrays, query results, and the like during operations). Example and non-limiting object characteristics include object dimensioning, data related to the objects (stored within, linked to, referenced to, and/or calculated within), calculations and/or queries associated with the objects, object formatting, and/or object sequencing and position. In certain embodiments, the entire state of a document, reflective of the operation log 6608 and/or the second operation log 6632, can be stored in object descriptions with corresponding object characteristics. In certain embodiments, the entire state of a document alternatively or additionally includes one or more operations, such as the second sequential operations. In certain embodiments, one or more “undo” operations may be lost in creating the snapshot 6636, for example as multiple operations having a specified sequence are lumped into a simplified description of equivalent operations with sequencing lost. In certain embodiments, “undo” operations as a whole, and/or as relating to specific computing devices 6604, 6620 and/or specific users associated with a computing device in the system 6600 may be preserved. In certain embodiments, a user selection to preserve “undo” capability with relation to their operations may provide for preservation of their sequenced operations.

In certain embodiments, the first computing device 6602 determines a snapshot 6636 at selected times, such as but not limited to: upon receiving the communicated change value 6618 from the second computing device 6604, and where determining the snapshot 6636 includes updating the snapshot 6636 to reflect operations from the communicated change value 6618; upon a lapse of a predetermined time period (calendar time, access time, and/or editing time); a lapse of a predetermined time period since a last communication of the change value 6618; upon a request from the second computing device 6604 to update the snapshot 6636; upon an initial operation to open a document; upon an operation to close a document; upon a determination that a predetermined efficiency threshold is exceeded by determining the snapshot 6636 (e.g. an estimated number of operations of the processor or number of operation commands can be reduced, upon certain types of operations that tend to yield high efficiency in a snapshot 6636 such as repeated keys, filtering and/or sorting of data, etc.); upon an operation to save a document; upon an operation to save a document as a new document; upon a request to access a document related to the first operation log 6608 from an additional computing device beyond the computing devices already accessing the document; upon a change value 6618 exceeding a predetermined amount of change; upon a change value 6618 directed to a predetermined categorical change (e.g. a change of from a selected list of change types occurs); upon a loss of communication with the second computing device 6604; upon a reestablishment of communication with the second computing device 6604; upon an operation to print at least a portion of a document related to the first operation log 6608; upon an operation to publish at least a portion of a document related to the first operation log 6608; and/or upon a determination that determining and communicating the snapshot 6636 will not interfere with an operation of the second computing device 6604 on a document related to the first operation log 6608 (e.g. the second computing device 6604 is idle and/or outside certain hours of operation).

An example first computing device 6602 determines the snapshot 6636 by determining a provisional snapshot 6638, and determines whether the provisional snapshot 6638 is compatible with the second operation log 6616. In response to determining the provisional snapshot 6638 is compatible with the second operation log 6616, the example first computing device 6602 over-writes the snapshot 6636 with the provisional snapshot 6638.

In certain embodiments, a snapshot 6636 is created at an earlier point in an edited history of the document, for example with less than all of the operations in: the operation log 6608, the second operation log 6632, the local operation log 6616, the second local operation log 6626, the change value 6618, the second change value 6628, and/or the updated change value 6634 applied. For example, a snapshot 6636 event may occur indicating that a snapshot 6636 is to be taken and/or is requested, where it is not desirable that all of the operations in the system 6600 (e.g. the operations log 6608 plus any operations reflected in the second operation log 6632, local operation log 6616, the second local operation log 6626, the change value 6618, the second change value 6628, and/or the updated change value 6634) be applied. In certain embodiments, a user may desire to walk back some edits made and not have those edits stored in the snapshot 6636. Additionally or alternatively, the arbitration circuit 6630 may determine that one or more edits are conflicting operations that cannot be resolved, or a user may indicate that a proposed or impending operation to resolve a conflict should not be applied. In certain embodiments, it may be desirable to restore the document to an earlier state, where a previous snapshot 6636 having that earlier state is not available (e.g. some desired edits have been made since the last snapshot 6636). In certain embodiments, the first computing device 6602 determines operations within the operations log 6608 consistent with the condition indicating that not all operations are to be applied, and creates a snapshot 6636 in response to the partial operations log 6608. In certain embodiments, the first computing device 6602 determines one or more operations in the system 6600 (e.g. the operations log 6608, the second operation log 6632, the second local operation log 6626, the change value 6618, the second change value 6628, and/or the updated change value 6634) that are consistent with the condition indicating that not all operations are to be applied (e.g. operations that do not apply undesired user edits), and creates the snapshot 6636 in response to those consistent conditions, while discarding or otherwise preserving separately from the snapshot 6636 those operations that are not consistent with the condition indicating that not all operations are to be applied. In certain embodiments, the operation log 6608 may be “walked back” (e.g. returned to a previous state) utilizing the provisional snapshot 6638, a user “undo” operation, and/or through operations of the arbitration circuit 6630 resolving conflicting operations. Additionally or alternatively, the operation log 6608 may be “walked back” via removal of certain operations in the creation of the snapshot 6636 at an earlier point in the edited history of the document.

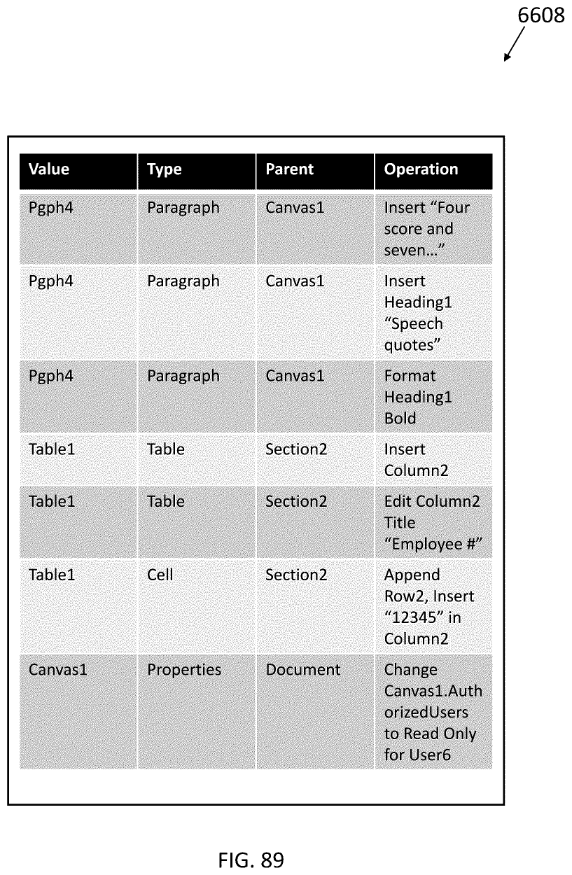

Referencing FIG. 89, an example first operation log 6608 is depicted schematically. The example operation log 6608 includes sufficient information to uniquely identify operations defining at least part of the document. The example operation log 6608 describes an identifier for the object of the edits (e.g., the “Value” column, which may be a reference name or other object identifier), and/or a position within the object hierarchy of the document (e.g., the “Parent” column, which may be a reference name or other object identifier). In certain embodiments, the Value may be sufficient to uniquely identify objects, and a Parent value may not be necessary. In certain embodiments, multiple layers of hierarchy may be provided, sufficient to uniquely identify operations in the operation log 6608. The example operation log 6608 further includes a Type value, such as a type of object subject to the operation, and/or an Operation value describing the operation performed (e.g., an insertion, addition, deletion, etc.). The example Operation Log 6608 includes operations such as insertions of text or values, formatting operations, addition or editing of columns and/or rows, and/or changes to object properties or metadata (e.g., a permissions change to a section of the document for a user). The illustrative organization of the operation log 6608, including the organization of the operation log 6608 as a table, is a non-limiting example, and any organization of operations that provides for an unambiguous operation location is contemplated herein. An example operation log 6608 can document operations at any resolution desired or selected—for example a user entry of a text sequence may be stored as individual operations of each character, as an entire line of text, and/or with each word entry utilized as a separate entry on the operation log 6608. The selection of the resolution affects utilization and resource consumption of the operation log 6608, for example an “undo” operation that references the operation log 6608 may operate to remove character-by-character if the operation log 6608 stores character-wise operations. However, the storage of high resolution operations may consume greater resources in memory utilization (e.g., to store the individual operations in the operation log 6608). Additionally or alternatively, an “undo” operation can be configured to undo only a selected portion of an operation from the operation log 6608, for example by parsing an operation into an applied and unapplied portion (and further creating a separate operation on the operation log 6608 reflecting the applied portion of the operation).

An example document may be constructed from the operation log 6608, from the snapshot 6636, and/or from the snapshot 6636 updated by the operation log 6608. An example snapshot 6636 includes operations in an operation log 6608 format, which may be a copy of the operation log 6608 and/or a sequence of operations configured to provide for the same resulting output but consolidated for efficient operation, reduced memory usage, and/or to reduce the size of the operation log 6608. An example system includes the operation log 6608 having a higher resolution of operations (e.g., character-wise, word-wise, and/or sentence-wise) than operations in the snapshot 6636 (e.g., word-wise, sentence-wise, and/or paragraph-wise).

In certain embodiments, certain data aspects related to the document may be stored outside the operation log 6608 and/or the snapshot 6636. In certain embodiments, certain data aspects are stored locally for a specific user and/or a specific client computing device. An example system includes one or more temporary and/or local values, such as a control object state (e.g., a slider bar value, a user preference, etc.), and the state of those objects may be deleted upon the user exiting the document, stored locally for the user and/or device in a manner inaccessible to other users of the document (e.g., outside the operation log 6608 and/or snapshot 6636), and/or stored in a manner accessible to other users of the document (e.g., within the operation log 6608, snapshot 6636, and/or other data structure accessible to users accessing the document) and/or as a part of the document. In certain embodiments, data aspects associated with the document that may be deleted or stored locally for a particular user and/or device may be termed local data, temporary data, cached data, and/or volatile data. The particular implementations for data aspects associated with the document described herein are non-limiting examples.

A number of procedures for performing certain operations to produce, communicate, and/or update an operation log 6608, 6616, 6626, 6632 are described following. Operations are illustrative and non-limiting, and may be re-ordered, divided, and/or combined in any manner to perform similar functions, as will be understood to one of skill in the art having the benefit of the disclosures herein. In certain embodiments, one or more operations may be performed by components of a system such as the system 6600.

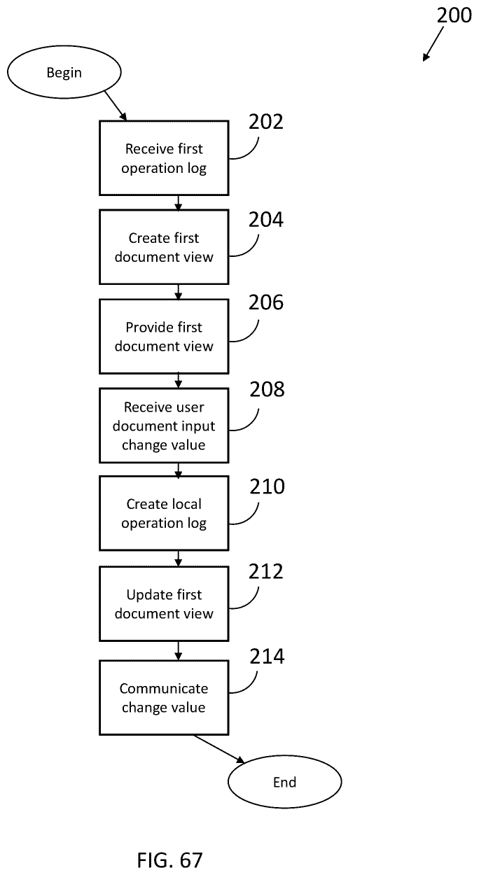

Referencing FIG. 67, a schematically depicted example procedure 200 includes an operation 202 to receive a first operation log from a first computing device, where the first operation log includes at least one first sequential operation defining operations to create a first document, an operation 204 to create a first document view in response to the first operation log, where the document view includes content generated using at least a portion of the first operation log, and an operation 206 to provide the first document to a display device. The example procedure 200 further includes an operation 208 to receive a user document change input value, and an operation 210 to create a local operation log in response to the first operation log and the user document change input value, where the local operation log includes at least one sequential operation defining operations to create a second document. The example procedure 200 further includes an operation 212 to update the first document view in response to the user document change input value, and an operation 214 to communicate a change value for the first operation log to the first computing device in response to the first operation log and the local operation log.

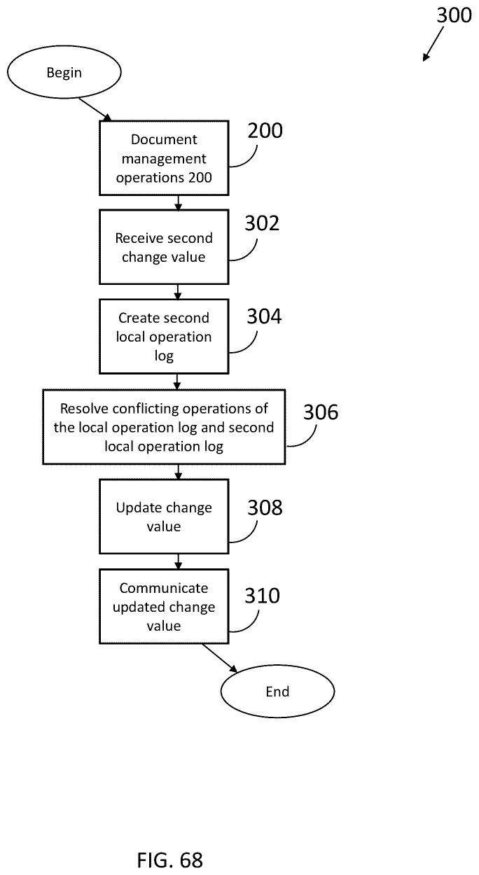

Referencing FIG. 68, a schematically depicted example procedure 300 includes one or more operations of procedure 200. The example procedure 300 further includes an operation 302 to receive a second change value from the first computing device, where the second change value includes at least one sequential operation to add to the first operation log, and defines operations to create a third document, and an operation 304 to create a second local operation log in response to the first operation log and the second change value. An example operation 304 includes creating the local operation log by creating a first record of operations which, if implemented on a document, would provide a document having edits consistent with the user document change input value, and where creating the second local operation log includes creating a second record of operations which, if implemented on a document, would provide a document having edits consistent with the second user document change input value.

The example procedure 300 includes the operation 304 to create the second local operation log by applying non-conflicting operations of the local operation log and the second local operation log. The example procedure 300 further includes an operation 306 to resolve conflicting operations of the local operation log and the second local operation log, where the operation 304 to create the second local operation log includes the resolved conflicts from operation 306. Example and non-limiting operations 306 to resolve conflicting operations of the local operation log and the second local operation log include performing one or more operations such as: applying individual operations in a priority selected according to a time stamp corresponding to each operation; applying operations in a priority selected according to a time stamp of the local operation log and second local operation log; applying operations in a priority selected according to an associated priority of at least one of a second computing device receiving the user document change input value and a third computing device providing the second change value; applying operations in a priority selected according to an associated priority of at least one of a user associated with a second computing device receiving the user document change input value or a user associated with a third computing device providing the second change value; and/or applying operations in a priority selected according to a time of communication of the operations to the first computing device. Additional or alternative example and non-limiting operations 306 to resolve conflicting operations of the local operation log and the second local operation log include performing one or more operations such as: applying individual operations in a priority selected according to a type of at least one of the conflicting operations and/or applying individual operations in a priority selected according to a relationship such as: a priority relationship between at least one of a second computing device, a third computing device, and a user associated with one of the second and third computing devices; a priority selected according to a reference region of a document that would be affected by at least one of the conflicting operations; a priority selected in response to a performance characteristic of at least one of the second and third computing devices; a priority selected in response to an indicated importance value corresponding to at least one of the conflicting operations; and/or a priority selected in response to a conflict management difficulty value. Additional or alternative example and non-limiting operations 306 to resolve conflicting operations of the local operation log and the second local operation log include applying individual operations in a priority selected according to one or more of: a number of operations represented in at least one of the local operation log and the second local operation log; a document editing time corresponding to at least one of the second computing device and the third computing device; and/or one of a change amount and a change rate of a reference region of a document that would be affected by at least one of the conflicting operations. Additional or alternative example and non-limiting operations 306 to resolve conflicting operations of the local operation log and the second local operation log include applying individual operations in a priority selected according to computing devices having one or more characteristics such as: are currently accessing a reference region of a document that would be affected by at least one of the conflicting operations; have recently accessed a reference region of a document that would be affected by at least one of the conflicting operations; are currently editing a reference region of a document that would be affected by at least one of the conflicting operations; and/or have recently edited a reference region of a document that would be affected by at least one of the conflicting operations.

An example procedure 300 includes the operation 306 at least partially performed on a first computing device, a second computing device, and/or a third computing device. An example procedure 300 includes the operation 306 to resolve the conflict at least partially performed on the second computing device, where the first computing device communicates the second change value to the second computing device (e.g. through a third computing device and/or document server). The example procedure 300 includes the operation 308 to update change value and the operation 310 to communicate the updated change value.

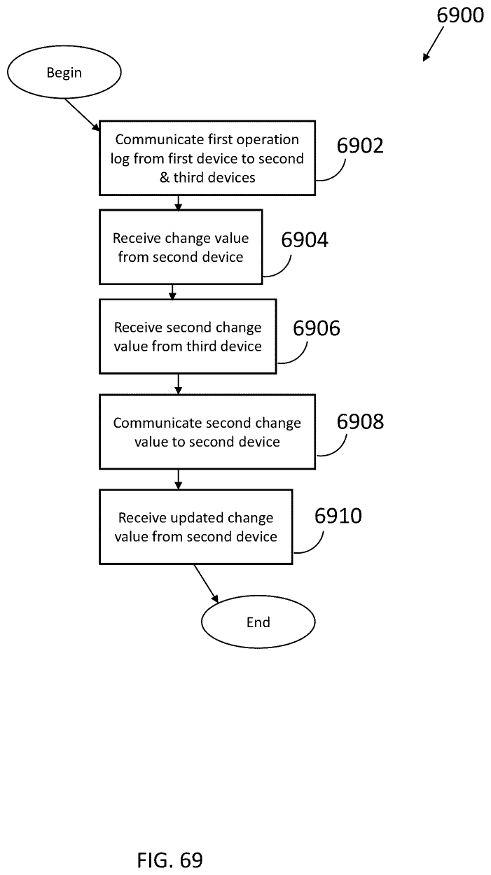

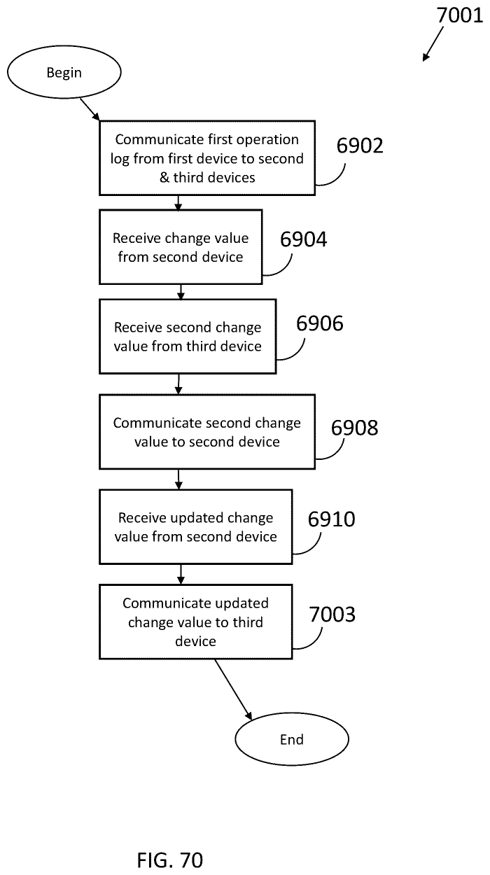

Referencing FIG. 69, a schematically depicted example procedure 6900 includes an operation 6902 to communicate a first operation log, for example from a first computing device to a second computing device and a third computing device, where the first operation log includes at least one first sequential operation defining operations to create a first document. The example procedure 6900 further includes an operation 6904 to receive a change value for the first operation log from the second computing device, where the change value includes at least one sequential operation defining operations to create a second document including changes relative to the first operation log, and an operation 6906 to receive a second change value for the first operation log from the third computing device, where the second change value includes at least one sequential operation defining operations to create a third document including changes relative to the first operation log. The example procedure 6900 further includes an operation 6908 to communicate the second change value to the second computing device, and an operation 6910 to receive an updated change value from the second computing device, where the updated change value includes a conflicts resolving change value (e.g. a change value based upon resolved conflicts) between the change value and the second change value. Referencing FIG. 70, a schematically depicted example procedure 7001 further includes an operation 7003 to communicate the updated change value to the third computing device. For example, a first operation log is partially or completely passed from a document server to each of a client computing device and a second client computing device. A first user in communication with the client computing devices makes a number of changes to a displayed text (e.g. a local copy of the document, from the perspective of the first user), and a second user in communication with the second client computing device makes a number of changes to a displayed text (e.g. a local copy of the document, from the perspective of the second user. The client computing device determines a first change value in response to operations from the first user, and the second client computing device determines a second change value in response to operations from the second user. An example arbitration circuit, which may be incorporated wholly or partially within the client computing device, the second client computing device, the document server, and/or elsewhere, determines an updated change value from the first change value and the second change value—for example the updated change value reflects all non-conflicting operations of the user and second user, and/or reflects operations resolved according to any change conflict resolution principles described throughout the present disclosure. In certain embodiments, the arbitration circuit produces the updated change value locally (e.g. at one of the client computing device and/or second client computing device), and passes the updated change value to the document server and/or another one of the client computing devices. When the client devices have updated local operation logs from the updated change value, the client devices have synchronized the local views of the document. In certain embodiments, the document server (which may additionally or alternatively be one of the client computing devices) receives the updated change value, passes it to client device(s) (e.g. each client device currently accessing the document), and updates the common server operation log (e.g. operation log 6608) in response to the client device(s) accepting the updated change value.

In certain embodiments, a procedure includes determining a snapshot, for example updating the operation log 6608 with a confirmed updated change value. It can be seen that the updated snapshot creates a document equivalent to the document created by the operation log 6608 with the confirmed updated change value applied, for example the document as initially provided to client device(s) and with edits from user(s) applied. The creation of a snapshot allows for management of document data and efficiency, for example by periodically grouping information and calculations into a more efficient form (e.g. less data, fewer processor operations, better sorting such as improved sort order, application of data compression, etc.) than an operation sequence as entered by a user. An example procedure further includes providing the snapshot as the operation log 6608 (e.g. to a client computing device accessing the document).

Example operations include determining a snapshot, where the snapshot includes at least one sequential operation defining at least one second sequential operation, wherein the at least one second sequential operation, if executed, results in an equivalent document to the first document (for example—operations of the operation log plus operations of the updated change value from operation 7003). In certain embodiments, the procedure 7001 includes providing the snapshot as the first operation log. Example operations to determine the snapshot include providing the snapshot in response to at least one event such as: the first computing device receiving the communicated change value, where the determining the snapshot further includes updating the snapshot to reflect operations from the communicated change value; a lapse of a predetermined time period; a lapse of a predetermined time period since a last communication of the change value; a request from a second computing device; an initial operation to open a document; an operation to close a document; a determination that a predetermined efficiency threshold is exceeded by determining the snapshot; an operation to save a document; an operation to save a document as a new document; a request to access a document related to the first operation log from another computing device; a change value exceeding a predetermined amount of change; a change value directed to a predetermined categorical change; a loss of communication between the first computing device and a second computing device; a reestablishment of communication between the first computing device and a second computing device; an operation to print at least a portion of a document related to the first operation log; an operation to publish at least a portion of a document related to the first operation log; and/or a determination that determining and communicating the snapshot will not interfere with an operation of a second computing device on a document related to the first operation log.

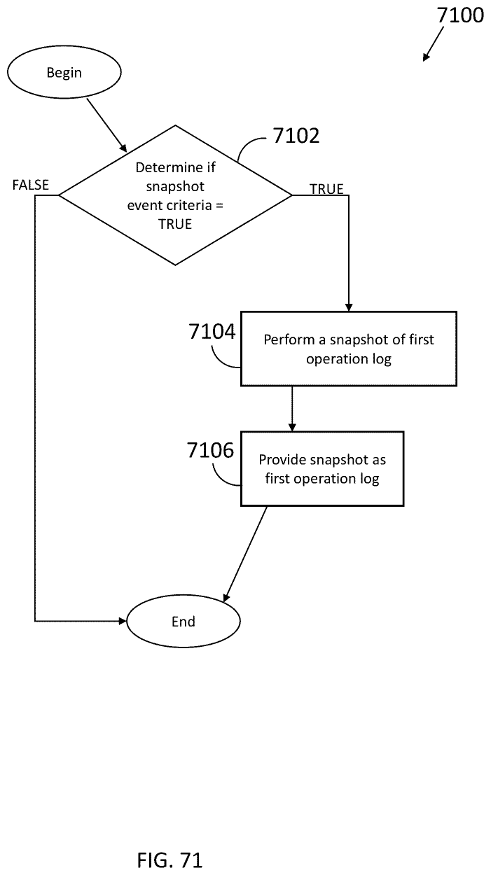

Referencing FIG. 71, a schematically depicted example procedure 7100 includes an operation 7102 to determine if a snapshot event criteria is true—for example whether the operating conditions of the system, local operation log(s), current updated change values, and/or an elapsed time has passed, such that determination of an updated snapshot is warranted. The example procedure 7100 includes an operation 7104 to perform or determine a snapshot of the operational log. Example and non-limiting operations to perform the snapshot include: determining a second sequential operation that includes fewer processor operations than the first sequential operation; determining a second sequential operation including fewer logical operations than the first sequential operation; determining the second sequential operation comprising a simplified description of operations than the first sequential operation; determining the second sequential operation comprising lumped operations relative to the first sequential operation; and/or appending or otherwise combining operations of the confirmed updated change value into the operation log. In the provided examples, the first sequential operation is the state of the document before the snapshot, for example the operational log or previous version of the snapshot, plus the confirmed updated change value, and the second sequential operation is the updated snapshot, or the updated operational log after combination with the confirmed updated change value. The example procedure 7100 further includes an operation 7106 to provide the snapshot as the operational log.

Example and non-limiting operations 7104 to determine if a snapshot event has occurred include: the first computing device receiving the communicated change value, wherein the determining the snapshot further comprises updating the snapshot to reflect operations from the communicated change value; a lapse of a predetermined time period; a lapse of a predetermined time period since a last communication of the change value; a request from a second computing device; an initial operation to open a document; an operation to close a document; a determination that a predetermined efficiency threshold is exceeded (e.g. an estimated or modeled improvement of processor operations, memory utilization, document size, and/or number or type of logical operations) by determining the snapshot; an operation to save a document; an operation to save a document as a new document; a request to access a document related to the first operation log from another computing device; a change value exceeding a predetermined amount of change (e.g. a number of operations, an editing time value, and/or operations of a specified type present in the change value); a change value directed to a predetermined categorical change (e.g. inclusion of a sort, filter, data reference, and/or insertion of a table, graph, chart, etc.); a loss of communication between the first computing device and a second computing device; a reestablishment of communication between the first computing device and a second computing device; an operation to print at least a portion of a document related to the first operation log; an operation to publish at least a portion of a document related to the first operation log; and/or a determination that determining and communicating the snapshot will not interfere with an operation of a second computing device on a document related to the first operation log.

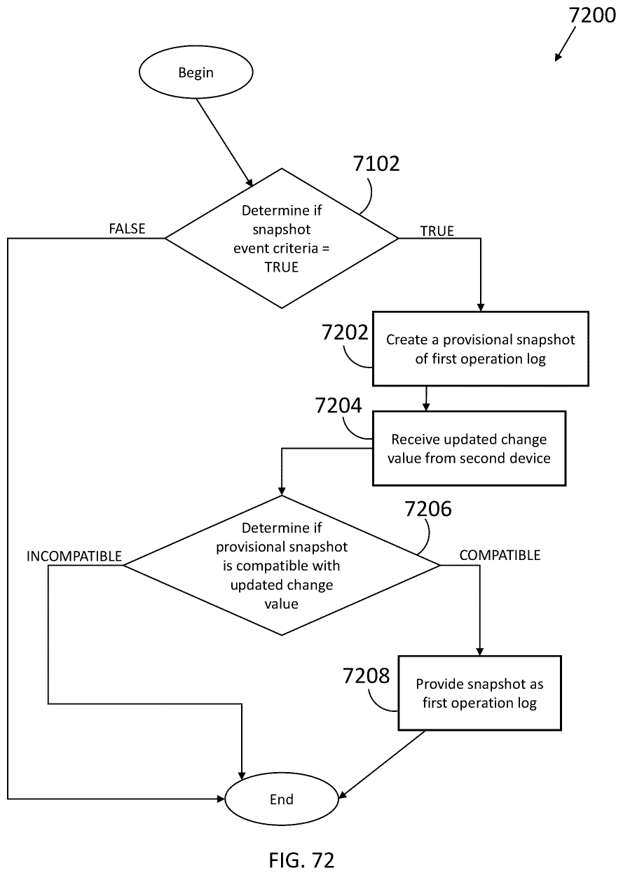

Referencing FIG. 72, a schematically depicted example procedure 7200 includes an operation 7202 to determine a provisional snapshot, an operation 7204 to receive an updated change value from the second computing device, and an operation 7206 to determine if the provisional snapshot is compatible with the updated change value. In response to the operation 7206 determining the provisional snapshot is compatible with the updated change value, the procedure 7200 includes an operation 7208 to provide the operation log as the provisional snapshot, for example to over-write the snapshot in response to the provisional snapshot, and/or to update the operation log in response to the provisional snapshot.

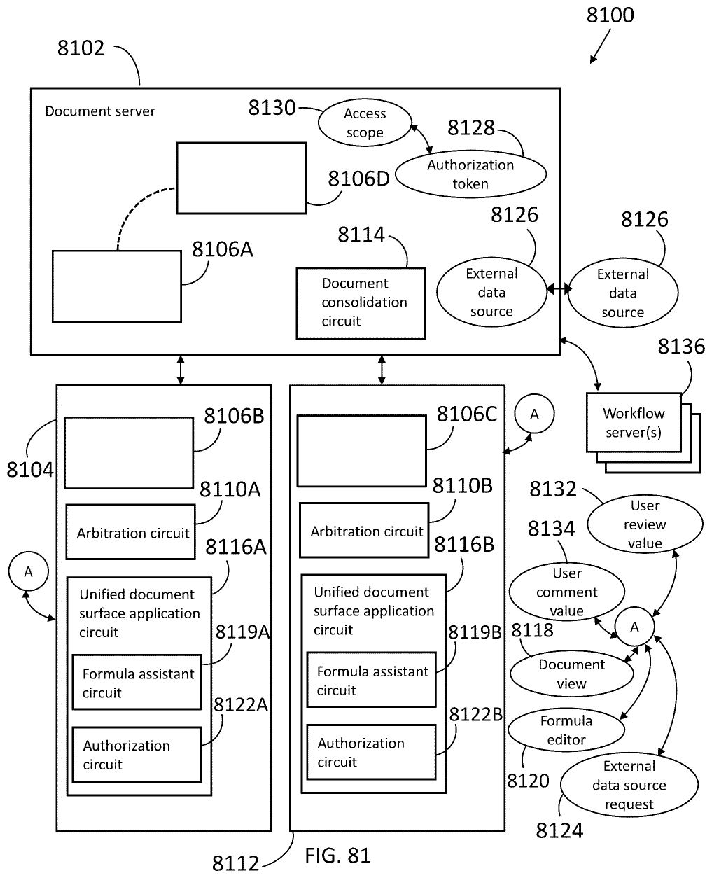

Referencing FIG. 81, an example system 8100 includes a document server 8102 communicatively coupled to at least one client computing device 8104. The example system 8100 further includes a document 8106. The example document 8106 includes a document 8106A on the document server, a document 8106B on a first client computing device 8104, and a document 8106C on a second client computing device 8112. The documents 8106A, 8106B, 8106C may include portions of the document 8106, all of the document 8106, and/or may comprise a logical grouping of elements that collectively form the document 8106. In certain embodiments, the documents 8106A, 8106B, 8106C may be the same document 8106 and/or be consistent with each other, and/or may intermittently and/or continuously have variances, such as local and/or user-specific variables, views, and/or edits that have not yet been synchronized therebetween. Additionally or alternatively, an updated document 8106D is an example document 8106—for example where the updated document 8106D is created in response to synchronization and/or optimization operations.

An example system 8100 further includes one or more workflow servers 8136. Example and non-limiting workflow servers 8136 include one or more computing devices having processing resources, associated memory, and/or communications to the document server 8102. In certain embodiments, the document server 8102 allocates one or more operations of any systems and/or procedures herein to be performed at least partially on a workflow server 8136. In certain embodiments, the document server 8102 allocates supporting operations to a workflow server 8136—for example where operations requested according to multiple users and/or for multiple documents include certain common aspects (e.g., downloading bulk information from an external data source 8126, indexing and/or querying operations to a large data set at least partially shared between documents, etc)—where the specific operations performed by the workflow server 8136 are either direct operations and/or procedures as described in the present disclosure, and/or where specific operations performed by the workflow server 8136 are a superset of operations (e.g., shared between a number of documents and/or user operations), precursor operations, preparatory operations (e.g., to support utilization of an external data source 8126 added to the system 8100, which may or may not be specifically utilized by a document at the time preparatory operations are performed) such as downloading, indexing, sorting, and/or filtering data from an external data source 8126, and/or form a portion of one or more operations or procedures according to the present disclosure. In certain embodiments, the document server 8102 brings one or more additional workflow servers 8136 online to support operations currently being performed. In certain embodiments, the document server 8102 balances operations and/or procedures herein across the document server 8102, one or more workflow servers 8136, and/or client devices according to the current workload of the system 8100, desired responsiveness of client devices, current selections by a user (e.g., requesting that a processing, memory, or communication burden on a client device be reduced), a current type of client device in use (e.g., a powerful client device such as a workstation, a light client device such as a laptop, and/or a thin client device such as a mobile device, tablet, mobile phone, etc.), a nature of operations or procedures currently being performed (e.g., high utilization operations such as nested queries, indexing, etc.), and/or a connectivity of one or more devices in the system 8100. The described operations to balance workloads across devices of the system 8100 are non-limiting examples.

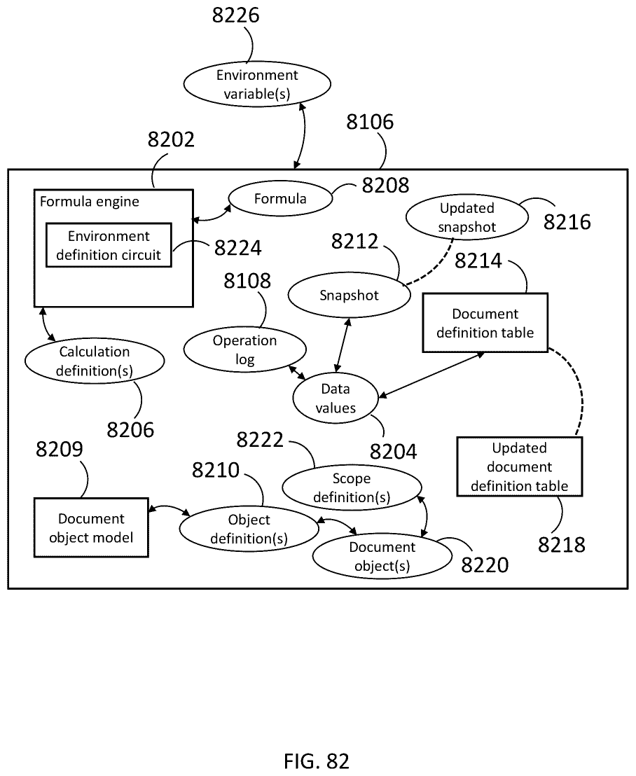

Referencing FIG. 82, an example document 8106 includes an operation log 8108, where the operation log 8108 includes a record of sequential operations defining operations to create data values 8204 of the document 8106. For example, as a user edits a document, the operations to implement the edits are stored on the operation log 8108. Each computing device accessing the document 8106, for example the document server 8102 and one or more client computing devices 8104, 8112, may have a version of the operation log 8108, and/or a local copy of the operation log 8108. In certain embodiments, the client computing devices 8104, 8112 and/or the document server 8102 include arbitration circuits 8110A, 8110B that coordinate updates between the operation logs 8108 to ensure that applied edits are consistent. The data values 8204 of the document 8106 include, without limitation, text flows, data entries, and/or formula entries in the document 8106. In certain embodiments, data values 8204 of the document 8106 are stored, additionally or alternatively, in one or more tables (e.g., a document definition table 8214) representing the data values 8204 and/or layout of the document 8106. An example system 8100 includes a table representing data values 8204 in the document 8106, and an operation log 8108 including edits since the last version of the table. Additionally or alternatively, the table representing the data values 8204 may be updated, and appropriate elements of the operation log 8108 removed to ensure the application of the operation log 8108 to the current state of the table provides the document 8106 consistent with the current state of the document 8106. Additionally or alternatively, a system 8100 includes creating a snapshot 8212—for example a consolidated operation log 8108 and/or table representing data values 8204. Example operations to create a snapshot 8212 include providing operations that produce equivalent operations to the operation log 8108 prior to the creation of the snapshot 8212, and may further include consolidating operations, providing operations that utilize fewer system resources (e.g., processing cycles, memory utilization, and/or communication bandwidth between devices 8104, 8112). In certain embodiments, the snapshot 8212 is produced after synchronizing operation logs 8108. In certain embodiments, for example where a client computing device 8104, 8112 accesses the document 8106, the snapshot 8212 is provided as the operation log 8108, and/or in conjunction with the operation log 8108 (e.g., where the operation log 8108 includes additional operations occurring after the creation of the snapshot 8212).

The example system 8100 includes a formula engine 8202, which may be a part of the document 8106 and/or provided separately from the document 8106. In certain embodiments, the formula engine 8202 is provided as a part of a unified document surface application circuit 8116—for example a first instance of the unified document surface application circuit 8116A on the first client computing device 8104 and a second instance of the unified document surface application circuit 8116B on the second client computing device 8112. The example formula engine 8202 determines a calculation definition 8206 in response to at least one formula 8208 of the document 8106. A calculation definition 8206, as used herein, includes operations to determine formulas, look-up values, reference values, and the like within the document 8106. An example calculation definition 8206 includes pseudo-code, dependency descriptions, invalidation descriptions, operations to be performed to resolve queries, references, and/or formulas, and any other operations performed to implement the document and provide visible results of the document to a user. In certain embodiments, the calculation definition includes requirements for operations for an executable model. Additionally or alternatively, the calculation definition is implemented in code, scripts, and/or relationship information between data values within the document, and/or includes instructions implementable in code, scripts, or the like. In certain embodiments, any information that at least incrementally informs a formula, query, and/or reference set, or other aspects of the document, toward building executable code to perform the operations of the formulas, queries, and/or reference look-ups is contemplated within the meaning of a calculation definition as used herein.

In certain embodiments, the formula 8208 is provided as a part of the data values 8204 of the document 8106, and/or the formula 8208 is provided on the operation log 8108. The example system 8100 includes a document object model 8209, where the document object model 8209 includes an object definition 8210 corresponding to each of a number of objects 8220 in the document 8220. The example document object model 8209 is depicted on the document 8106, but may additionally or alternatively be provided as a part of a unified document surface application circuit 8116, and/or provided by the document server 8102—for example when a client computing device 8104, 8112 accesses the document 8106. In certain embodiments, the document object model 8209 is updated in real time, for example with the addition of applicable objects 8220 into a document 8106, and/or as a part of an update of the system 8100. An example document object model 8209 includes object definitions 8210 for utilized objects 8220 in the document 8106, for all possible objects that are utilizable in the document 8106, and/or for a predetermined set of possible objects, where additional object definitions 8210 are available upon utilization and/or request. Example object definitions 8210 include a hierarchy of objects in a document 8106, properties, methods, and/or events available to objects, modifications to objects for the particular system 8100 and/or implemented by a user, inheritance of properties between objects, new object classes created by a user, administrator, document template, or the like.

An example document 8106 is at least partially positioned on at least one of the document server 8102 and a first client computing device 8104. An example system 8100 includes a first version of the document 8106A positioned on the document server 8102, a second version of the document 8106B positioned on the first client computing device 8104, and where the first client computing device 8104 includes the arbitration circuit 8110A that synchronizes the first version of the document 8106A and the second version of the document 8106B, thereby creating an updated document 8106D. An example system 8100 further includes a second client computing device 8112, where a third version of the document 8106C is positioned on the second client computing device 8112, and where the arbitration circuit(s) 8110A, 8110B are further structured to synchronize the first version of the document 8106A, the second version of the document 8106B, and the third version of the document 8106C, thereby creating the updated document 8106D. In certain embodiments, the document 8106 includes the snapshot 8212 and/or a document definition table 8214, where the snapshot 8212 and/or the document definition table 8214, combined with the operations of the operation log 8108, provide a definition of data values 8204 of the document 8106.

An example system 8100 includes the document 8106 further including the snapshot 8212 and/or the document definition table 8214, where the document server 8102 further includes a document consolidation circuit 8114 that updates the snapshot 8212 and/or the document definition table 8214. Example and non-limiting operations of the document consolidation circuit 8114 include any operations of the systems and procedures of the portion of the disclosure referencing FIGS. 66 through 72 and FIG. 81. An example updated snapshot 8216 includes sequential operations defining at least one second sequential operation, wherein the at least one second sequential operation, if executed, results in a consolidated document 8106 equivalent to the document 8106 before updating the snapshot 8212. An example and non-limiting updated snapshot 8216 includes at least one of: the second sequential operation including fewer processor operations than the first sequential operation; the second sequential operation including fewer logical operations than the first sequential operation; the second sequential operation including a simplified description of operations than the first sequential operation; and/or the second sequential operation comprising lumped operations relative to the first sequential operation. An example document consolidation circuit 8114 further clears the operation log 8108 and/or reduces operations in the operation log 8108 in response to the updated snapshot 8216—for example moving certain operations from the operation log 8108 to the updated snapshot 8216, and leaving other operations in the operation log 8108. Example and non-limiting considerations for determining to leave operations in the operation log 8108 include leaving un-synchronized and/or conflicting operations (e.g., between a number of users and/or client computing devices) in the operation log 8108, moving only a portion of the operations to reduce a computation time of the updated snapshot 8216, and/or leaving certain types of operations in the operation log 8108 and moving other types of operations to the updated snapshot 8216.

An example system 8100 includes the document 8106 further including the document definition table 8214, and where the document server 8102 further includes the document consolidation circuit 8114 updating the document definition table 8214, where the updated document definition table 8218 includes the document definition table 8214 having at least a portion of the first sequential operation(s) applied thereto. For example, certain operations of the operation log 8108 may be applied to create the updated document definition table 8218, and certain other operations of the operation log 8108 may be left in the operation log 8108 and/or moved to an updated snapshot 8216. In certain embodiments, the snapshot 8212 and/or updated snapshot 8216 includes the document definition table 8214 and/or the updated document definition table 8218. In certain embodiments, multiple versions of the operation log 8108, snapshot 8212, and/or document definition table 8214 may be stored in the system 8100, for example allowing recovery of previous versions or states of the document 8106 and/or any document objects 8220 therein, allowing for queries to previous versions or states of the document 8106 and/or any document objects 8220 therein, and/or allowing for change tracking and/or version control of the document 8106. An example system 8100 further includes the document consolidation circuit 8114 performing at least one of clearing the operation log 8108 and reducing the operation log 8108 in response to the updated document definition table. Example and non-limiting considerations for determining to leave operations in the operation log 8108 include leaving un-synchronized and/or conflicting operations (e.g., between a number of users and/or client computing devices) in the operation log 8108, updating the document definition table 8214 to move only a portion of the operations to reduce a computation time of the updated document definition table 8218, and/or leaving certain types of operations in the operation log 8108 and applying other types of operations to the updated document definition table 8218.

In certain embodiments, the document object model 8209 includes a hierarchical object structure, and further includes objects 8220 of the document associated consistent with the document object model 8209. An example hierarchical object structure includes, in descending order, a document object (e.g., an object at the document 8106 level), a canvas object, a section object, and/or a table object. In certain embodiments, objects can be ordered in any parent-child relationship of objects. An example document object model 8209 further includes the names (e.g., reference names, display names, primary key, and/or reference identifying information), and/or further includes associations and relationships between document objects 8220. In certain embodiments, the document object model 8209 is included on, in whole or part, the operation log 8108, the snapshot 8212, and/or the document definition table 8214. In certain embodiments, instances of document objects 8220, consistent with the document object model 8209 and/or modified by a user, administrator, and/or rules such as in document template rules, are stored on, in whole or part, the operation log 8108, the snapshot 8212, and/or the document definition table 8214. Referencing FIG. 82, an example document object model 8209 is depicted illustrating example relationships between document objects 8220 in an example document 8106. An example hierarchical object structure further includes objects such as: a range object (e.g., allowing for referencing of grouped data values 8204 or objects 8220 such as portions of a text flow, cells within a table, and/or a group of tables), a text object, a line object (e.g., a sentence, line of text, formula or portion of a formula, etc.), a span object (e.g., a sentence, a paragraph, text in a table cell, etc.) and/or a tag object (e.g., allowing for automatic and/or selected labeling of features or objects 8220, providing the ability to reference them together—such as bold text, pivot table, and/or an arbitrary reference such as “Tag1”).

An example system 8100 includes the hierarchical object structure further providing a scope definition 8222 corresponding to each of the objects 8220 of the document. An example scope definition 8222 includes a data scope value (e.g., providing for local variables, global variables, and/or selected scope variables such as “canvas”, “sheet”, “table”, or the like); a referencing scope value (e.g., providing for reference name uniqueness scoping, such as table names, canvas names, sheet names, tag names, and/or any other object names; where names can be display names, reference names, primary keys, and/or another identifier for an object); a formula scope value (e.g., providing for selected scope of formula reach, reference ability, and/or uniqueness enforcement); a scope depiction value (e.g., defining how scope values are communicated, displayed, and/or provided to the user); and a scope configurability value (e.g., defining rules by which the user, administrator, and/or any system 8100 component can change, update, and/or vary any scope value or scope definition 8222 in the document 8106). In certain embodiments, the scope definitions 8222 are accessible to the user (e.g., in a system table) and/or may be constrained or amendable by the user, an administrator, any component of the system 8100, and/or may be amended in response to operations of the user (e.g., where a user enters a locally non-unique table name, an example system 8100 updates the scope definition 8222 to provide a unique identifier for the tables such as a primary key, and updates the scope definition 8222 to allow for the operations by the user). In another example, the scope definitions 8222 are enforced, operations to enforce the scope definitions 8222 include prompting a user in response to an invalid entry, applying a change to the user invalid entry (e.g., adding a character such as a sequential numeric character to a user entry that would otherwise not be compliant with the scope definition 8222).

An example formula engine 8202 further includes an environment definition circuit 8224 that interprets at least one environment variable 8226, and the first client computing device 8104 includes a unified document surface application circuit 8116A that, at least selectively, provides a document view 8118 including the at least one environment variable 8226. Example and non-limiting environment variables 8226 include a user location value, an offset user document access indicator (e.g., a notification to the user that another user is accessing the document; a display operation on the document when another user is editing the document at the display location or another location; and/or a list of at least some of the users currently accessing the document); a user focus value (e.g., an object identifier, document location, and/or current operation being performed by the user); and/or a system time value (e.g., a time of day, calendar date, etc.). In certain embodiments, the environment variable 8226 is accessible to the system 8100, for example to determine contextual information about the user for performing certain operations described throughout the present disclosure, and/or to provide the environment variable 8226 and/or information determined in response to the environment variable 8226 to the user—such as in completing formulas, suggesting reference values, and/or displaying options to the user in any context. An example unified document surface application circuit 8116A further includes a formula assistant circuit 8119A that exposes the environment variable(s) to a formula editor 8120. An example system 8100 includes a user interacting with a formula editor 8120—for example making an intentional selection to open the formula editor 8120 and/or performing an operation where the formula editor 8120 is contextually opened for the user—and wherein the formula assistant circuit 8119A exposes the environment variable(s) 8226 to the formula editor 8120 to make the environment variable(s) 8226 available for display—such as: options for completing an entry by the user; as all or a part of an available property, method, event, or the like for an object 8220; and/or as a reference value accessible to the user.

An example system 8100 further includes the unified document surface application circuit 8116A, 8116B further including an authorization circuit 8122A, 8122B that interprets an external data source request 8124, and provides an access to an external data source 8126 in response to the external data source request 8124. In certain embodiments, the authorization circuit 8122A, 8122B prompts a user for authorization information (e.g., a username, login ID, password, etc.) and/or accesses authorization information accessible to the document, system, a client computing device, the document server, or the like. Accordingly, the user can access external data sources 8126 according to available permissions specific to the user, entered into a document for use during a project, according to a subscription where the subscription information is entered into the document, document server, client computing device, or otherwise within or accessible to the system. An example authorization circuit 8122A, 8122B further stores an authorization token 8128 corresponding to the external data source 8126 in the document 8106, where the authorization token 8128 includes at least one access value such as: an access type (e.g., read operations, edit operations, write operations, and/or delete operations); an access scope 8130 (e.g., accessible portions of the external data source 8126, including differential access types according to the portion of the external data source 8126); an access duration (e.g., a session duration of access, applicable calendar time of access, allowed access times for operations to access the external data source 8126 and/or portions thereof, including differential times for certain access types and/or portions of the external data source 8126); and/or expiration values for the authorization token); and/or an access reauthorization time value (e.g., a time to prompt the user for reauthorization, an expiration time for a session, subscription, or the like, and/or expiration values for the authorization token). An example authorization circuit 8122A, 8122B provides access to a second user in response to the authorization token and the access scope. It can be seen that the operations of the authorization circuit 8122 provide for convenient authorization of access to external data sources 8126 for one or more users of the document, while providing for security and scheduled access to the external data source 8126. Additionally or alternatively, an administrator, document owner, and/or a user can extend access if permitted to other users of the document in a scheduled manner. Additionally or alternatively, a user does not need to know the details of accessing the external data source 8126, such as calling and engaging APIs for the external data source 8126. The example authorization circuit 8122 provides for a configurable front-end for the user to access external data sources 8126 having only limited information to provide authorization, such as login information to the external data source 8126, to the document 8106, and/or as determined according to information about the user (e.g., role, employee identification, user identification, associated project authorizations, etc.) accessible to the system 8100. Example and non-limiting external data sources 8126 include any external data source, external source data, and/or source data described throughout the present disclosure.

An example system 8100 further includes the unified document surface application circuit 8116 interpreting a user comment value 8134, and providing a document view 8118 including the user comment value 8134. An example unified document surface application circuit 8116 interprets a user review value 8132, and provides a table view of at least one user comment value 8134 in response to the user review value 8132. For example, one or more users collaborating on a document 8106 provide user comment values 8134 to the document 8106, and a user enters the user review value 8132 to provide a display of comments, to flag or highlight comments, and/or to provide a display of comments having a specific tag, from specific users, related to a particular project, and/or provided to selected document sections and/or objects. An example document object model 8209 further includes a comment object type, where the unified document surface application circuit 8116 is further structured to associate the user comment value 8134 with the comment object type. An example system 8100 allows for utilization of the comment object type to rapidly access comments, reference comments (e.g., in a formula 8208, report, compilation into a table, etc.), manipulate or amend comments, aggregate comments (e.g., by including user comments according to the comment object type in a pivot table), and/or to relate comments to objects within the document. Additionally or alternatively, an example system 8100 provides for notifications and/or alerts in response to the entry of a user comment value 8134, including notifications and/or alerts as described throughout the present disclosure.

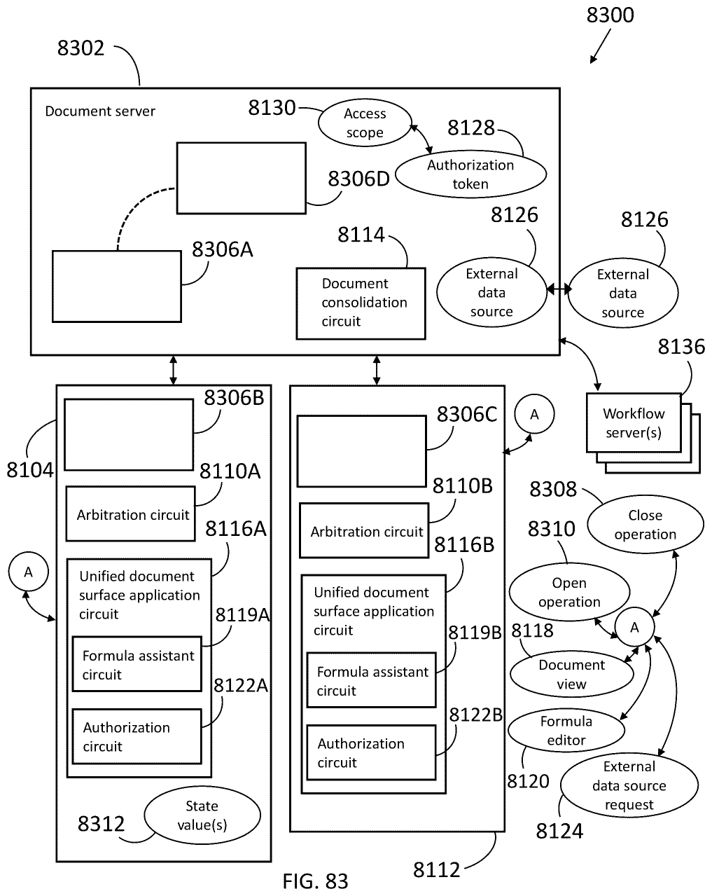

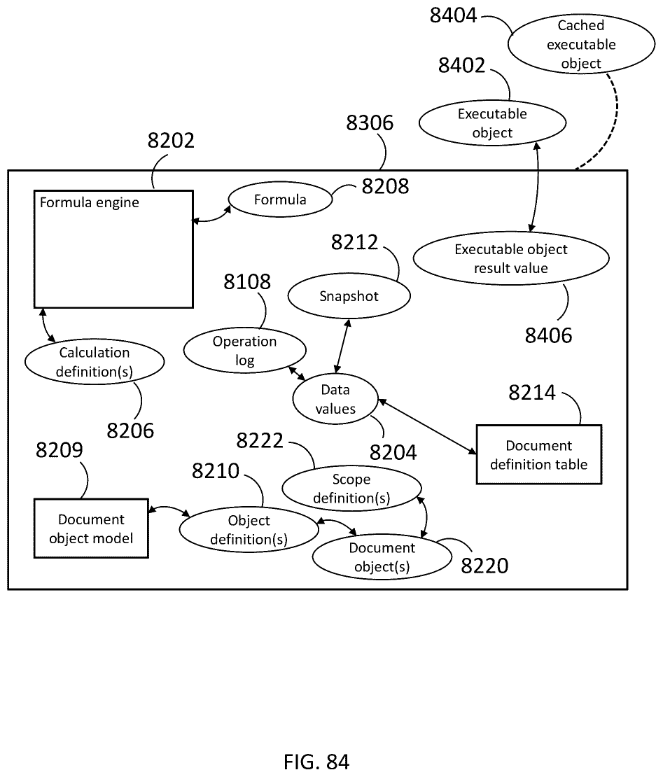

Referencing FIG. 83, an example system 8300 includes a document server 8302 communicatively coupled to at least one client computing device 8104, 8112, and a document 8306 including an operation log 8108, where the operation log 8108 includes at least one first sequential operation defining operations to create data values 8204 of the document. The example system 8300 further includes a formula engine 8202, where the formula engine 8202 determines a calculation definition 8206 in response to at least one formula 8208 of the document 8106, and where the formula engine 8202 generates an executable object 8402 (e.g. reference FIG. 84) in response to the calculation definition 8206. In certain embodiments, the document 8306 includes the executable object 8402, and/or the executable object 8402 is stored on the document server 8302 and/or a client device 8104, 8112 and accessible at run-time in relation to the document 8306. The example system 8300 includes the document 8306 at least partially positioned on the document server 8302 and/or a first client computing device 8104. In certain embodiments, the document 8306 includes the executable object 8402 during run-time operations of the document server 8302 and/or a client device 8104, 8112.

An example formula engine 8202 further deletes the executable object 8402 in response to a close operation 8308 of the document 8306 on the client computing device 8104—for example in a system 8300 where the executable object 8402 is created at run-time for the document 8306. An example formula engine 8202 further generates the executable object 8402 in response to an open operation 8310 of the document 8306 on the client computing device 8104—for example in a system 8300 where the executable object 8402 is created at run-time for the document 8306. In certain embodiments, the formula engine 8202 further caches the executable object 8402 in response to a close operation of the document 8306 on the first client computing device 8104—for example to save the executable object 8402 for potential re-use during a later run-time operation of the unified document surface application circuit 8116 on the document 8306. An example formula engine 8202 further accesses the cached executable object 8404 in response to an operation of the document 8306 on the client computing device 8104, and/or the formula engine 8202 verifies the cached executable object 8404 in response to the open operation of the document 8306 on the client computing device 8104. The verification of the cached executable object 8404 includes determining whether edits to the document have occurred since the cached executable object 8404 was created, and whether the edits made allow for the utilization of all or a portion of the cached executable object 8404. The executable object 8402 may generate or otherwise be in communication with an executable object result value 8406.

In certain embodiments, the executable object 8402 is an execution instruction to implement operations of the document 8306, including queries, reference values, calculations, and the like. The executable object 8402 may be implemented as a script operating within an environment on the client computing device 8104, 8112, such as a JavaScript object operating in a browser or other executing environment, although any scripting language or element, any computing language, and/or any executing environment, are contemplated herein. In certain embodiments, the executable object 8402 is determined from the data values 8204 in the document 8306, such as described in the operation log 8108, snapshot 8212, and/or document definition table 8214. The inclusion of the executable object 8402 on a client device 8104, 8112 provides for a responsive document access experience for the user, as well as the full power of features available to the user even where the user may be working offline or with intermittent connectivity. However, it will be understood that the provision of the executable object 8402 on the client device may tax the resources of certain client devices, and/or provide for a longer open time of a document having a large number of formulas, queries, and other active elements implemented through the executable object 8402. Accordingly, in certain embodiments, certain aspects, or all aspects, of the executable object 8402 may be provided by the document server 8302 and/or stored on the document server 8302. Certain considerations for the generation, position in the system, and/or storage of the executable object 8402 include the type of client device, the resources of the client device, a preference expressed by the user, and/or observed response times of the client device accessing the document, editing the document, and/or opening the document.

In certain embodiments, the creation of the execution object 8402 is described as the hydration of one or more aspects of the document 8306. For example, a formula 8208 within the document that specifies a query, but where the executable object 8402 does not yet include operations to perform the query, may be an “unhydrated” formula 8208. After the executable object 8402 is updated to include operations to perform the query, the formula 8208 may be a “hydrated” formula 8208—for example even where the operations of the query have not yet been performed and the returned values have not yet been determined or updated. The utilization of terminology such as “hydrated” is a non-limiting illustration, and any terminology, and/or any systems, methods, or procedures implementing described operations herein, without reference to any particular terminology, are contemplated for example embodiments.

An example system 8300 includes a second client computing device 8112, where the document 8306 is further positioned on the document server 8302 (document 8306A, 8306D), the first client computing device 8104 (document 8306B), and/or the second client computing device 8112 (document 8306C). The example system 8300 includes a first executable object 8402 stored on the first client computing device 8104, and a second executable object stored 8402 stored on the second client computing device 8112. It can be seen that the same document 8306 may have separate executable objects 8402 stored on separate devices accessing the document 8306—for example to reflect context variables within formulas, queries, etc. that differ between devices (e.g., current user, system time, user location, user focus location, predicted second user focus location, etc.), to reflect differential edits on the client devices 8104, 8112 that have not yet been synchronized or reconciled, and/or to reflect local settings of objects within a document (e.g., controls, run-time selections, and/or other volatile settings that are local to the client device 8104, 8112, the user, and/or are cleared upon a close operation of the document 8306).

An example executable object 8402 includes instructions which, upon execution, cause the document server 8302, a client computing device 8104, 8112, and/or a workflow server 8136 to perform operations in response to the calculation definition 8206 (e.g., operations to calculate formulas, look up reference values, and/or perform queries). Example executable objects 8402 include, without limitation: an executable instruction object; a script object; a javascript object; and/or a Perl object. An executable object 8402 may be operated within an application environment (e.g., as a script), and/or may include assembly code, compiled code, or other executable elements. The example system 8300 includes workflow server(s) in communication with the document server 8302, and where the executable object 8402 further includes instructions which, upon execution, cause at least one of the document server 8302, the client computing device 8104, 8112, and/or a workflow server 8136 to perform operations to provide a result value in response to the calculation definition. For example and without limitation, result values include filtered table values, sorted table values, query results, formula results, and/or objects created in response to a formula, control setting, and/or object configuration and/or selection values. An example client computing device 8104, 8112 includes a unified document surface application circuit 8116 that provides a document view 8118 in response to the data values 8204 of the document and the result value of the executable object 8402. An example unified document surface application circuit 8116 provides the document view 8118 in response to a current user location or focus within the document 8306, such as displaying the result values within the observable region of the document 8306 by the user. An example document 8306 further includes a document object model 8209, where the document object model 8209 includes an object definition 8210 corresponding to each of a number of objects 8220 in the document 8306, and where the executable object 8402 further references the document object model 8209.

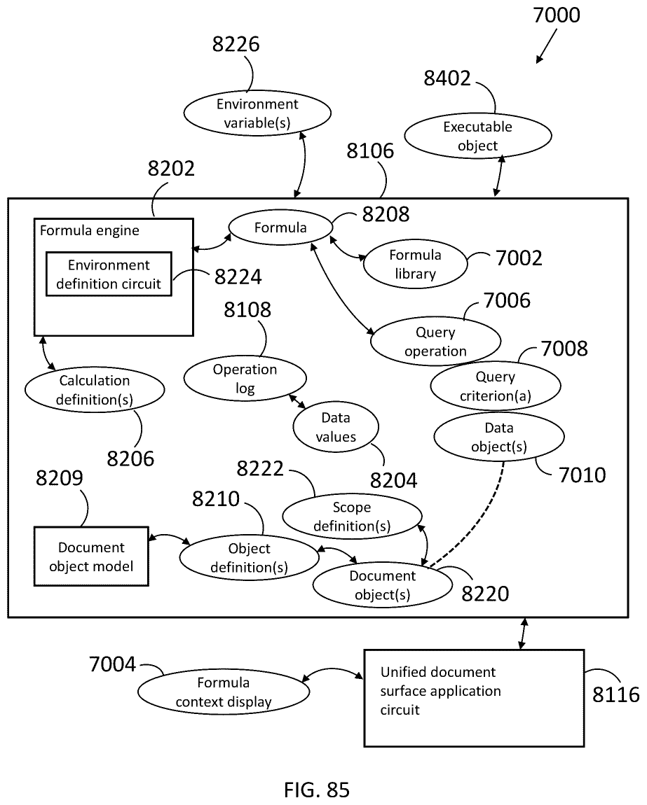

Referencing FIG. 85, an example system 7000, for example utilizable in any of the systems described in the present disclosure, includes an executable object 8402 having a resource utilization value. Example and non-limiting resource utilization values include a number of calculations, a number of processor cycle executions, a memory utilization (e.g. maximum memory utilized, RAM utilized, page file or virtual memory utilization, and/or a trajectory of memory utilization over the execution cycle of the executable object 8402), and/or a communication bandwidth utilization (e.g., communications between a document server 8102 and a client computing device 8104, 8112, between the document server 8102 and a workflow server 8136, and/or communications between the document server 8102 and an external data source 8126).

An example formula engine 8202 analyzes instructions of the executable object 8402, and updates the executable object 8402 with a resource reduced executable object 8402. The resource reduced executable object 8402 includes instructions which, upon execution, cause the document server 8102, the client computing device 8104, 8112, and/or the workflow server 8136 to perform operations to provide the result value(s), and includes a reduced execution resource value that includes a lower resource utilization value than the resource utilization value. For example, the formula engine 8202 includes operations to reduce query calculation efforts, to reduce memory utilization, and/or to reduce a communication value such as an external communication value (e.g., communications to the document server 8102 and/or to an external data source 8126). Example and non-limiting reduced executable objects include an indexing operation (e.g., reducing calculations required to complete a query), a sort order operation (e.g., changing a sort order and/or applying a sort to a table object, one or more table columns, etc.), and/or a filter order operation (e.g., applying a more restrictive filter before a less restrictive filter, and/or applying a filter before a sort in a series of operations). In certain embodiments, an order of one or more operations, for example determined according to an invalidation graph, is applied to provide the reduced executable object. In certain embodiments, the order of operations and/or adjustments to operations to result in reduced resources include consideration of the actual data values in the document 8106. For example, at a first point in time where the document 8106 includes a first state of the data values, application of “FilterA” then “FilterB” may result in a reduced resource utilization. In a continuing example, at a second point in time where the document 8106 includes a second state of the data values, application of “FilterB” then “FilterA” may result in a reduced resource utilization. Previously known database optimization routines utilize best practice techniques and estimates of which order of operations will result in an optimal resource utilization, but the optimization routine does not have visibility to the actual data, and accordingly cannot adjust the operations in real-time in response to the data. Additionally or alternatively, resource utilization priorities in a system 8100 may result in a resource utilization that is reduced according to the resource utilization priorities (e.g., to minimize processor usage of a client computing device 8104, 8112, communication bandwidth between devices in the system 8100, and/or memory utilization capped by a client computing device 8104, 8112) but that consumes more resources in another dimension that is not a priority (e.g., memory utilization of a document server 8102 and/or workflow server 8136, communication bandwidth between a document server 8102 and the workflow server 8136). Additionally, resource utilization priorities in the system 8100 may vary during run-time, for example where a user has a mobile device with a low battery, is currently presenting an aspect of a document 8106 to an audience, and/or is under a time constraint for editing and response time is paramount. Previously known database optimization routines cannot respond to the resource utilization priorities expressed in the system 8100 at run-time.

An example system 8100 includes the document server 8102 dividing operations of the executable object 8402 between at least two of the document server 8102, a client computing device 8104, 8112, and/or a workflow server 8136. For example, the document server 8102 can determine current workloads in the system to support document access, and/or predicted workloads in the system (e.g., based on a number of users logged in, operations of those users, and/or historical usage trajectories for users and/or based on time of day, etc.). The example document server 8102 further divides operations in response to a parameter such as: a client computing device resource parameter; contextual information; a current workload of the first client computing device; a current workload of the document server; and/or a current workload of the at least one workflow server. Contextual information includes any contextual information described throughout the present disclosure, including at least response values of the user (e.g., user operations indicating that the user desires a more responsive experience, including an explicit priority request, multiple and/or repeated entries for operations, and/or determined response times relative to a threshold response time for nominal acceptable system response to the user); operations currently being performed by the user; information about the user location; and/or detection of other resources operated on a client computing device 8104, 8112 that are competing for client computing device resources. An example divided operation of the executable object 8402 further includes a query execution operation. An example client device 8104, 8112 includes a unified document surface application circuit 8116 that provides a document view 8118 in response to the query execution operation. For example, the document server 8102 shifts all or portions of the query execution operation to a workflow server 8136, and the unified document surface application circuit 8116 displays relevant portions of results from the query execution operation (e.g., portions visible to the user based on the user location within the document 8106) in the document view 8118.

An example system 8100 includes at least one data value 8204 being a run-time object, for example an object having a data value 8204 that exists during run-time of the document 8106, but that is not stored in the operation log 8108, the snapshot 8212, and/or the document definition table 8214. In certain embodiments, a run-time object is termed a “volatile” object, however the terminology of run-time objects is not limiting to the present disclosure. In certain embodiments, the run-time object includes a state value 8312—for example a value indicating a certain state of the run-time object. Example and non-limiting state values include: a default value; a contextually determined value; and/or a user selected value. An example unified document surface application circuit 8116 stores the state value separate from the document 8106 in response to a close operation of the document 8106. For example, a run-time object includes a state value that is created during run-time, and ordinarily deleted upon the closing of the document. In certain embodiments, example and non-limiting run-time objects include: a selection of a filter or view, a setting of a control, a current state of an open dialog box, a current location within the document, and/or a setting of a control in the document. In certain embodiments, the unified document surface application circuit 8116 stores a state value of the run-time object upon closure of the document 8106, and applies one or more of the stored state values upon an opening of the document 8106. In certain embodiments, the types of state values to be stored are determined according to user preferences, selections, prompts, and/or rules applied by a document owner, user, administrator, and/or a document template. In certain embodiments, a stored state value is specific to a user and/or to a particular client computing device 8104, 8112: for example a first user opens a document and a first value of a control (e.g., a slider tool) is applied for that first user, and a second user opens a document and a second value of the control is applied for that second user. Accordingly, users are able to maintain views, control settings, and other volatile parameters specific to their own access to the document. An example unified document surface application circuit 8116 does not apply one or more stored state values—including, for example, where a control having a stored state value is no longer present within the document 8106 or has been modified to accept different setting values.

The example unified document surface application circuit 8116 further updates the state value with the stored state value in response to an open operation of the document 8106. An example stored state value includes a user specific value. An example run-time object includes a control, such as: a switch control; a multi-state switch control; a multi-picker control; an option list picker control; a dropdown picker control; a numeric slider control; a date slider control; a time slider control; a map picker control; a text box control; a validated text box control; a structured text box control; a card layout control; a drawing shape control; a media visual control; a table renderer control; a chart control; and a shape set control. An example switch control accepts a binary state value for the control—for example a checkbox, button, or the like. An example multi-state switch control provides for a number of options and returns a single value from the control (e.g., a radio button, a virtual dial, etc.). An example multi-picker control provides a number of options, and returns a selected number of options (e.g., up to three) and/or up to all of the options. The number of options selectable on a multi-picker control may itself be selectable and/or configurable. An example numeric slider control provides for a convenient graphical interface such as a slider bar, with a continuous or discrete numeric return from the slider control. The limits of the numeric slider control (e.g. minimum and/or maximum) and/or the resolution of the numeric slider control may be selectable and/or configurable. An example data slider control and/or time slider control provides for a convenient graphical interface, with a time-based return value such as an hour, minute, and/or calendar date return. The range displayed, units, and/or resolution of the data slider control may be selectable and/or configurable. An example map picker control provides a convenient interface to a map region and returns a selection from the map region (e.g., a location, a feature, a bounded region, etc.) and can return the value by quantitative location (e.g., latitude and longitude), qualitative location (e.g., within one of a number of specified regions), and/or with a feature name and/or feature information (e.g., a card generated in response to the feature selected). Example text box controls includes a control that accepts a string of text, a control that includes validation (e.g., applied criteria for the text that must be met for a valid return), and/or a structured text box (e.g., formatted for phone number entry, addressing, etc.), and/or combinations of these. An example card layout control provides a card output having a number of controls positioned to provide a predetermined layout for the user. An example drawing shape control provides a default shape to the user (e.g., a line, rectangle, circle, etc.) and returns a value in response to the shape as adjusted by the user, such as a line length and position, position of vertices, a color value, an area of the shape, and the like. An example a media visual control includes an image and/or media display (e.g., YouTube, HTML, a URL result, etc.) configurable by the user. An example a table renderer control provides a linked table, a list, a card layout, and/or other configurably rendered object (e.g., to allow the user to rapidly prototype a table, lookup a value, etc.). An example chart control includes a selection of configured chart objects, and/or control entries to link aspects of the chart to referenceable areas of the document 8106. An example shape set control includes a control allowing the user to construct a visualization element, for example utilizing preconfigured elements of other controls listed herein and/or visualization elements present in the document and/or available in a visualization element library, and can include combinations of any controls described throughout the present disclosure. In certain embodiments, properties and/or state values of a control are volatile elements. Additionally or alternatively, any property and/or state value of a control may be a formula and/or set by a formula, and/or may be stored in the operation log 8108, the snapshot 8212, and/or the document definition table 8214.

An example procedure includes an operation to provide a document including an operation log, where the operation log includes at least one first sequential operation, and an operation to construct the document in response to the operation log. The example procedure further includes an operation to determine a calculation definition in response to at least one formula of the document, to provide an object definition corresponding to each of a plurality of objects in the document, and to synchronize a first version of the document on a first client computing device with a second version of the document on a second computing device. An example operation to synchronize includes creating an updated document. An example procedure includes a third version of the document on a third second client computing device, and an operation to synchronize the first version of the document, the second version of the document, and the third version of the document. An example procedure includes an operation to provide at least one of a snapshot or a document definition table, where the at least one of the snapshot or the document definition table, combined with the at least one first sequential operation, provide a definition of data values of the document.

An example document includes the snapshot, and a procedure includes updating the snapshot, where the updating includes defining at least one second sequential operation, and where the at least one second sequential operation, if executed, results in a consolidated document equivalent to the document before the updating the snapshot. An example updated snapshot comprises at least one of: the second sequential operation comprising fewer processor operations than the first sequential operation; the second sequential operation comprising fewer logical operations than the first sequential operation; the second sequential operation comprising a simplified description of operations than the first sequential operation; and the second sequential operation comprising lumped operations relative to the first sequential operation.

An example procedure further includes an operation to perform one of clearing the operation log and reducing the operation log in response to the updated snapshot. An example document includes the document definition table, and a procedure includes updating the document definition table, where the updating includes defining an updated document definition table having at least a portion of the first sequential operation applied thereto. An example procedure includes performing at least one of clearing the operation log and reducing the operation log in response to the updated document definition table.

An example procedure includes an operation to interpret at least one environment variable, and to selectively provide a document view including the at least one environment variable. Example and non-limiting environment variable(s) include at least one value such as: a user location value; an offset user document access indicator; a user focus value; and a system time value. An example procedure includes an operation to expose the at least one environment variable to a formula editor.

An example procedure includes an operation to interpret an external data source request, and to provide an access to an external data source in response to the external data source request. An example procedure further includes an operation to store an authorization token corresponding to the external data source in the document, where the authorization token includes at least one access value selected from the access values such as: an access type; an access scope; an access duration; and an access reauthorization time value. An example procedure further includes an operation to provide an access to a second user in response to the authorization token and the access scope.

An example procedure includes an operation to interpret a user comment value, and to provide a document view comprising the user comment value. An example procedure further includes an operation to interpret a user review value, and to provide a table view of at least one user comment value in response to the user review value.

Referencing FIG. 85, an example system 7000 includes a document 8106 including an operation log 8108, where the operation log 8108 includes sequential operation(s) defining operations to create data values 8204 of the document 8106. The example system 7000 further includes a document object model 8209, where the document object model 8209 includes an object definition 8210 corresponding to each of a number of objects 8220 in the document 8106. The document 8106 is at least partially positioned on a document server and/or client computing device. For example, without limitation, the system 7000 is utilizable in any system described throughout the present disclosure having a document server and a client computing device, or a first computing device and a second computing device. An example client computing device includes a unified document surface application circuit 8116 that interprets a user formula value 8208, and updates the data values 8204 of the document in response to the user formula value 8208. The example system 7000 further includes a formula engine 8202, positioned within the document 8106 in the example, but additionally or alternatively positioned, without limitation, on a document server, client computing device, and/or unified document surface application circuit 8116. The example formula engine 8202 determines a calculation definition 8206 in response to the user formula value 8208 and the document object model 8209. An example unified document surface application circuit 8116 further validates the user formula value 8208 in response to a formula library 7002.

An example formula engine 8202 further generates an executable object 8402 in response to the calculation definition 8206, wherein the executable object 8402 includes instructions which, upon execution, cause at least one of the document server, a client computing device, and/or a workflow server to perform operations in response to the calculation definition 8206. An example system 7000 includes the instructions of the executable object 8402 performing a column-wise operation on a table object in response to the formula value 8208 including a table column reference.

An example user formula value 8208 includes a query operation 7006 having at least one query criterion 7008 and at least one data object 7010—for example one or more of the document objects 8220. In certain embodiments, the data object(s) 7010 include external data, volatile information, and/or other objects which may not be document objects 8220. An example query criterion 7008 includes a time value corresponding to the at least one data object 7010, and the formula engine 8202 further determines the calculation definition 8206 utilizing a state of the at least one data object 7010 determined in response to the time value. For example, a query operation 7006 can be constructed to query a table object against the state of the table object at some historical condition, such as “3 days ago,” against a previous version of the document 8106, and the like.

An example system 7000 includes the unified document surface application circuit 8116 further validating the user formula value 8208 by performing at least one operation such as: correcting a user syntax; correcting a user formula name; correcting a user formula reference; and/or prompting a user for a correction of any of the foregoing. An example unified document surface application circuit 8116 further provides a formula context display 7004, where the formula context display 7004 includes at least one formula name, and further includes an argument representation and/or a description value corresponding to each of the at least one formula name. An example unified document surface application circuit 8116 further provides the formula context display 7004 as a table object, for example as a table displayed next to a current user entry location for reference by the user. An example unified document surface application circuit 8116 further determines the at least one formula name in response to at least one of: a character sequence entered by the user, or contextual information. Without limitation, any operations to preview, look-up, and/or autocomplete an entry for a user throughout the present disclosure are contemplated for inclusion in the determination and display of the formula context display. An example formula context display 7004 includes at least one reference value. Example and non-limiting reference values include: an object name for one of the objects 8220 in the document; an object reference for one of the objects 8220 in the document; a tag for an object 8220 in the document; a range reference for a range in the document; and/or an external data source 8126 reference.

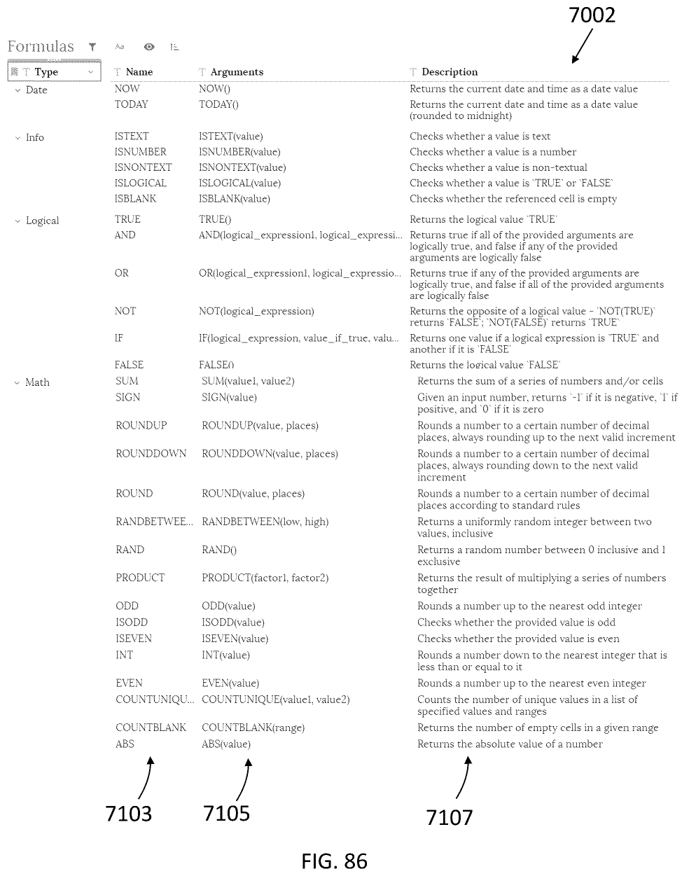

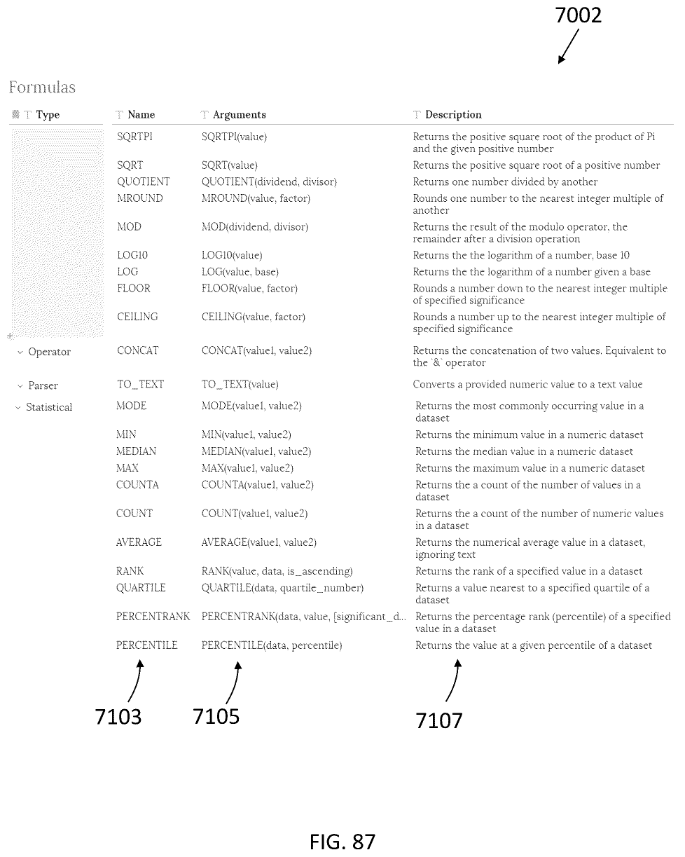

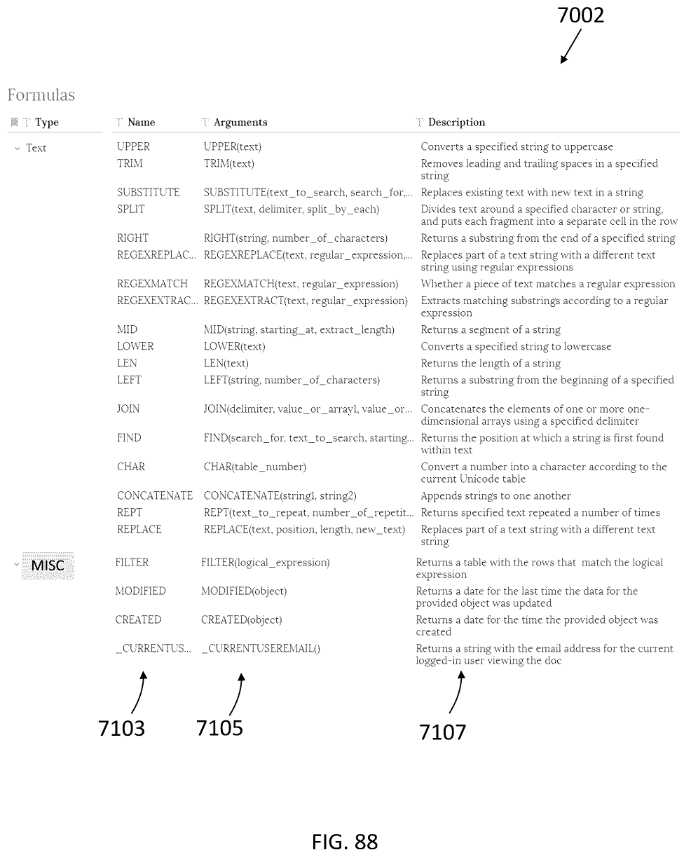

Referencing FIGS. 86 through 88, a non-limiting example of a formula library 7002 is depicted schematically. The formula library 7002 includes a formula name 7103, a formula syntax and/or arguments definition 7105, and/or a formula description 7107. In certain embodiments, a formula library 7002 such as depicted is utilized by the unified document surface application circuit 8116 to verify a formula value 8208, correct syntax for the user, and/or to provide the formula context display 7004. The depicted formula options in the example formula library 7002 are non-limiting illustrations, and any formulas may be utilized in a system, including user-defined, administrator-defined, and/or document template provided rules.

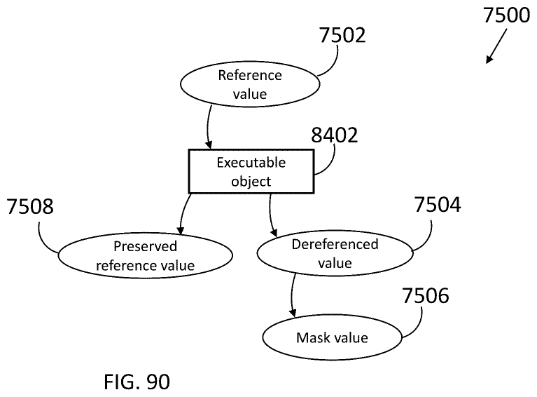

Referencing FIG. 90, an example illustration 7500 includes a reference value 7502 (e.g., from a user formula value), where the reference value includes a value such as: an object name for one of the objects in the document; an object reference for one of the objects in the document; a tag for an object in the document; a range reference for a range in the document; and an external data source reference. An example executable object 8402 includes instructions to perform an operation to dereference the reference value 7502 (e.g., to determine a value at the referenced location, a value that a pointer is pointing to, and/or a value from a formula referenced by the reference value 7502), thereby determining a dereferenced value 7504. An example unified document surface application circuit 8116 provides the dereferenced value 7504 as a mask value 7506. For example, a user enters a reference value 7502 as a formula in a table cell, the executable object 8402 determines the dereferenced value 7504 for the formula, and the unified document surface application circuit 8116 displays the dereferenced value 7504 for the table cell to the user. However, in certain embodiments, the actual value for the table cell may be the reference value 7502. Additionally or alternatively, the actual value for the table cell may be the dereferenced value 7504, and/or the unified document surface application circuit 8116 may preserve the reference value 7502, generating a preserved reference value 7508. Example operations to preserve the reference value include, without limitation: saving the reference value 7502 in an offset table column from corresponding ones of the dereferenced values; saving the reference value 7502 in at least one hidden table cell; saving the reference value 7502 in a system table; saving the reference value 7502 in at least one selectively viewable table cell; saving the reference value 7502 in a formula entry location; and/or saving the reference value 7502 on a document object including the dereferenced value 7504.

Referencing FIG. 76, an example apparatus 9401 includes a VT circuit 9403 that determines the VE 7616A in response to a user entered formula 9405. In certain embodiments, the user entered formula 9405 may be any type of formula, and further may include references to any tags, identifiers, object names, or the like anywhere within the data element 9407, the document 806, and/or the source data 830. Additionally or alternatively, the user entered formula 9405 may be commenced with a menu selection, a toolbar selection, a button selection, and/or entry of specific characters or character sequences. A user entered formula 9405 may be displayed directly, an output or result of the formula may be displayed, and/or the user entered formula 9405 may be hidden completely. The display options for the user entered formula 9405 may vary with the operations of the user 814, for example and without limitation the user entered formula 9405 may be: displayed in a first manner when selected (e.g., allowing the user to edit the formula) and in a second manner when not selected (e.g., displaying an output of the formula and/or hiding the formula); and/or displayed in a first manner during editing of the data element 9407 and/or document 806, and displayed in a second manner for printing, publishing, or other output operations of the data element 9407 and/or document 806. In certain further embodiments, the VT circuit 9403 further determines at least one profile value 9413 in response to the user entered formula 9405. Example and non-limiting profile values 9413 include a sorting profile 9415, a data hierarchy profile 9417, a filtering profile 9419, an aggregating profile 9421, and a formatting profile 9423. The example VT circuit 9403 further determines the VE 7616A in response to the profile value 9413.

An example VT circuit 9403 further determines the user visualization selection 7603 in response to a user control input 7605. Example and non-limiting user control inputs 7605 to determine the user visualization selection 7603 include a user selection value 7607 such as one or more discrete options 7609 and/or one or more continuous options 7611.

An example VT circuit 9403 further interpolates between a plurality of format options 9425 for a graph 9427, a chart 9429, a structured data view 9431, and/or a display of text 9433. For example, linking, referencing, and/or selection of multiple format or display options or elements may create more than one applicable format option 9425 for a given aspect of the VE 7616A. The example VT circuit 9403 determines a format or display option or element in such a situation by any one or more of the following operations: interpolate between two applicable formatting options (e.g., —one linked display option indicates that a value of 10 is a color blue, a second linked display option indicates that a value of 20 is a color yellow, and the VT circuit 9403 determines the value 15 will be formatted green in response to the linked display options); select a closest one of the applicable formatting options based on data values; provide for a weighted average of formatting options (e.g., where more than two applicable formatting options are available); provide for a higher priority one of the options (e.g., look at the available options, and determine which has a higher priority according to the nature of the underlying data, a recency of the source of the formatting options, a user role or title that created the source of the formatting options, and/or a relevancy factor for the source of the formatting options to the current document, data, document section, or the like that the user is working with); and/or rules applicable to the formatting option selection such as a template or user-entered rule. The relevancy factor may be determined in response to, without limitation: the type of data the user is currently working with relative to the type of data associated with the format or display options or elements; a description of the data values indicating a level of match (e.g., current data values are closer to one data set than a second data set); a heading, tag, or title in one or more data sets having a match; a count of a matching number of columns, data series, or other data similarity indications (e.g., column titles, date ranges, etc.); and/or a prompt and user selection to determine which of the formats or display options is most relevant.

In certain embodiments, an example VT circuit 9403 applies a gradient formatting option 9425 to one or more aspects of the second view 9411. For example, the VT circuit 9403 determines boundary values each associated with a formatting option 9425 (e.g., a minimum and maximum value, each having an associated color), and applies gradations of the formatting option 9425 for values between the boundaries. The gradations may be applied according to the values between (e.g., a value close to one of the boundaries includes a formatting option 9425 having a value close to the boundary formatting option 9425), applied in order (e.g., selected steps between boundary options in data sorted order, regardless of the specific relationship of values to the boundary values, where the selected steps may be linear (e.g., equal size steps) or another relationship such as logarithmic, exponential, or the like). In certain embodiments, boundary values and formatting options 9425 may be selected automatically (e.g., from the highest and/or lowest values), selected by a user, updated in real time (e.g., boundaries change as data updates change the highest and/or lowest values), and/or fixed or updated periodically or in a user selected fashion. In certain embodiments, gradation formatting options 9425 may be extrapolated outside the boundary values, capped or limited at the boundary value formatting options 9425 for values that are outside the boundary values, and/or a distinct formatting option (e.g., a different color, a default color, etc.) may be applied for values that are outside the boundary values. In certain embodiments, where values are outside the boundary values, the user may be prompted for an action (e.g., treatment type such as extrapolation, capping, applying a distinct format, and/or moving the boundary out to a new limit), and/or automatic action may be taken (e.g., according to defaults, rules defined by a user, template, and/or administrator, according to a data type (e.g., font colors capped at the boundaries, while font sizes are extrapolated)) outside the boundary values. In certain embodiments, more than one gradation may be applied to a data element 9407, for example both a font size and a font color may have gradations. The described examples of a gradient formatting option 9425 and operations related thereto, are non-limiting examples for purposes of illustration. Without limitation, examples of gradation formatting options 9425 include font colors, font sizes, line thickness values, highlighting and/or background colors, line colors, chart colors, and/or data grouping values (e.g., a data set grouped by graduated time frames such as days near a first boundary and years near a second boundary). One of skill in the art, having the benefit of the disclosure herein and knowledge ordinarily available contemplating a particular system, can readily determine gradient formatting options 9425 and related operations thereto. Example and non-limiting considerations to determine gradient formatting options 9425 and related operations thereto include the type of data element 9407, the type of document 806, characteristics of the user 814, purpose of the second view 9411, the type of formatting utilized for the gradient formatting option 9425, and/or the size and/or variability within a graduated data set (either by design or as observed based on real-time data).

An example VE 7616A includes a graph 9427 and/or a chart 9429, and the VT circuit 9403 further adjusts the second view 9411 in response to a user change input 9409. For example, a user 814 may adjust a graph 9427 or a chart 9429, such as by moving a data point, bar, column, line, etc. on the graph 9427 or chart 9429, changing a format of a point or data series on the graph 9427 or chart 9429, changes a linked inheritance to the graph 9427 and/or chart 9429 (e.g., change a reference “format like the 2009 annual report” to a reference “format like the 2011 annual report”, where the reference herein is described schematically). The VT circuit 9403 further adjusts the second view 9411 in response to the user change input 9409—for example applying a formatting or display change to other elements of the graph 9427 or chart 9429 that were not directly changed by the user based on the user change input 9409; updating formatting options and the display of the graph 9427 and/or chart 9429 in response to the linked inheritance change; and/or updating a display of an output table 9435 (e.g., source data for the graph 9427 and/or chart 9429, and/or a report generated in response to the graph 9427 and/or chart 9429) based on the user change input 9409 (e.g., user drags a data point from a value of 1250 to a value of 1275 on the chart, and the corresponding value on the table is changed) where a portion of the table is displayed to the user and accordingly the second view 9411 is updated. In certain embodiments, the VT circuit 9403 may prompt the user to confirm the adjusting of the second view 9411 in response to the user change input 9409. An example user change input 9409 includes a user interaction with a graphical element of the one of the graph 9427 or the chart 9429.

An example VE 7616A includes an output table 9435 and/or a structured data view 9431, and the VT circuit 9403 further adjusts the second view 9411 in response to a user change input 9409. Example and non-limiting structured data views 9431 include: a table providing a view of one or more data elements; a pivot table providing aggregated views of one or more data elements; a summary generated to provide information of one or more data elements (the summary may include multiple summary aspects such as sums, averages, interpolations and/or extrapolations, trends, and/or may include prose, graphs, tables, charts, and combinations of these); a selected data display of any one or more of the preceding (e.g., a card with selected information, a generated document with selected information, and/or a section of the document 806 with selected information).

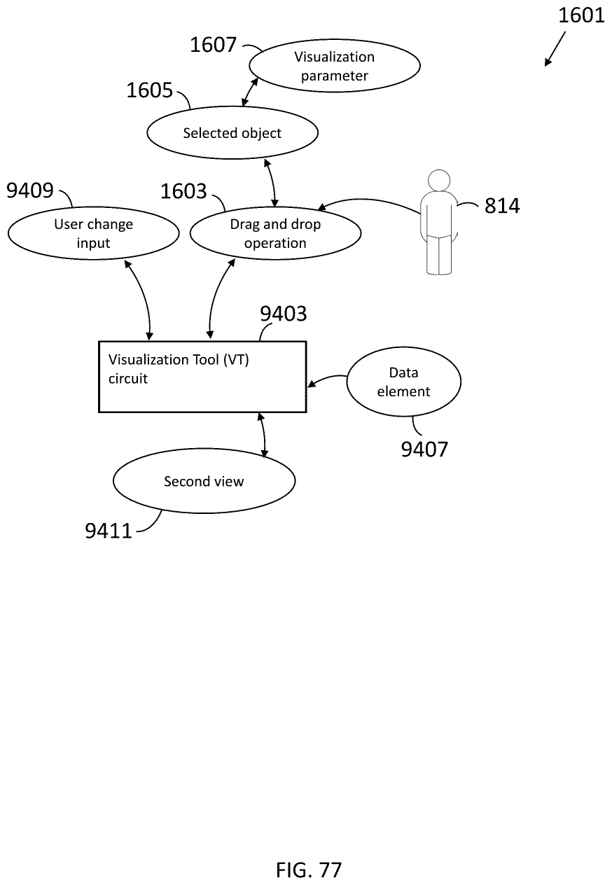

Referencing FIG. 77, an example apparatus 1601 includes a VT circuit 9403 that determines the user change input 9409 in response to a drag-and-drop operation 1603. A drag-and-drop operation 1603 as used herein should be understood broadly. A drag-and-drop operation 1603 includes, without limitation: dragging an object, a data value, and/or portions thereof from a first location to a second location (e.g., utilizing a mouse, touch screen, or other user input device); referencing an object, a data value, and/or portions thereof at a first location, and referencing a second location; dragging an object, a data value, and/or portions thereof onto a second object, data value, and/or portions thereof; and/or referencing an object, a data value, and/or portions thereof, and referencing a second object, data value, and/or portions thereof, thereby completing the drag-and-drop operation 1603.

An example VT circuit 9403 further adjusts the second view 9411 by re-sorting at least a portion of the second view 9411—for example sorting a table in response to a sorting of an associated table, where the associating is provided at least partially by the drag-and-drop operation 1603. An example VT circuit 9403 changes a hierarchy of at least a portion of the second view 9411—for example providing a first table created with a first hierarchy (e.g., a first primary table and a second secondary table, wherein the hierarchy indicates a primacy of the data organization, column headings, aggregation categories, etc.), and through a drag-and-drop operation 1603 switching to a second table created with a second hierarchy (e.g., switching the primary and secondary to the first table being secondary, and the second table being primary). An example VT circuit 9403 adjusts the second view 9411 by filtering at least a portion of the second view 9411—for example applying a filtering criteria from a first object to a target object in response to the drag-and-drop operation 1603. An example VT circuit 9403 adjusts the second view 9411 by aggregating data including at least a portion of the second view 9411—for example by creating a pivot table, selecting aggregating categories, and/or creating a related aggregation set (e.g., utilizing the same aggregation criteria, utilizing a parallel aggregation criteria) from a first object to a target object in response to the drag-and-drop operation 1603. An example VT circuit 9403 adjusts the second view 9411 by inheriting a format from a portion of the data element 9407 and applying the inherited format to at least a portion of the second view 9411—for example the user 814 drags a first object to a target object (or the target object to the first object), and the VT circuit 9403 applies one or more formatting aspects of the first object to the target object in response to the drag-and-drop operation 1603. The applied formatting aspects may be according to a selection, rule, or template setting (e.g., apply font settings), applicable formatting settings that are common between the first object and the target object. The first object and the target object may be of the same or distinct types. The updates of any sorting, formatting, aggregating, hierarchy changes, and the like, includes, in certain embodiments, applying aspects of the first object which are applicable to the target object, and/or analogizing aspects of the first object to target object (e.g., a chart dragged onto a table may allow for updating of certain aspects applicable to both, and other aspects that may be analogized such as table column headings changed to match category headings from the chart, etc.).

An example VT circuit 9403 adjusts the second view 9411 by inheriting a visualization parameter 1607 from an object 1605 selected in the drag-and-drop operation 1603, and applying the inherited visualization parameter 1607 to at least a portion of the second view 9411. A visualization parameter 1607 can include any aspect of an object that results in a potential change to the view (e.g., first view, second view 9411), such as a format option, a sorting option, a filtering option, an aggregating option, and/or an object type selection (e.g., table, structured data, chart, graph, text, etc.). Example and non-limiting objects 1605 include a data value, a graph, a chart, a table, a table row, and/or a table column. Example and non-limiting visualization parameters 1607 include a sorting description, a filtering description, a formatting description, an aggregation description, and/or a display value description.

A number of procedures for performing certain operations to change a view (e.g., first view, second view 9411) of a data element 9407 are described following. Operations are illustrative and non-limiting, and may be re-ordered, divided, and/or combined in any manner to perform similar functions, as will be understood to one of skill in the art having the benefit of the disclosures herein. In certain embodiments, one or more operations may be performed by components of a system, such as the systems described herein.

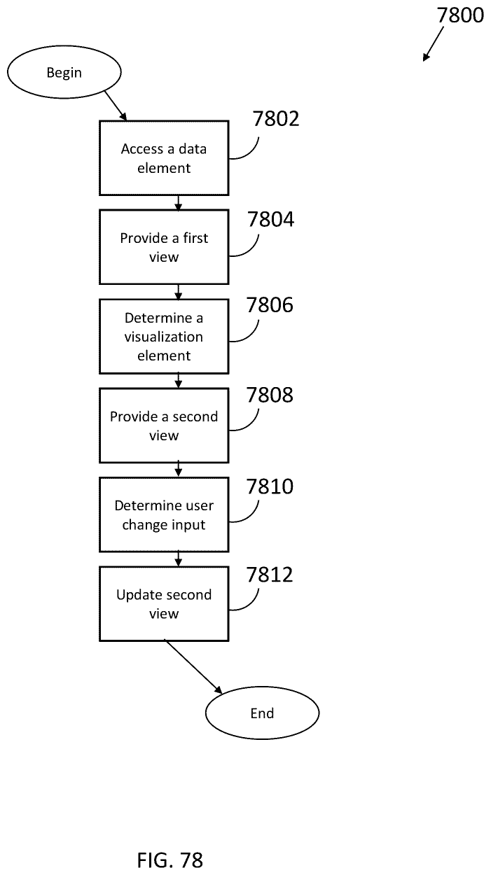

Referencing FIG. 78, an example procedure 7800 includes an operation 7802 to access a data element, and an operation 7804 to provide a first view in response to the data element, where the first view comprising at least a portion of the data element. The example procedure 7800 further includes an operation 7806 to determine a visualization element (VE) in response to the data element, and further in response to a user visualization selection and/or a user context value. The example procedure 7800 further includes an operation 7808 to provide a second view in response to the VE and the data element. Referencing FIG. 78, the example procedure 7800 further includes an operation 7810 to interpret a user change input, and an operation 7812 to update one of the first view 6610, the second view 9411, and/or a data element 9407 in response to the user change input. An example procedure 7800 further includes the VE being one of a graph or a chart, and adjusting the second view in response to the user change input. An example procedure 7800 includes the user change input being a user interaction with a graphical element of the graph and/or chart. An example procedure 7800 includes the VE being an output table and/or a structured data view, and the operation 7812 to update or adjust the second view in response to the user change input. An example procedure 7800 includes the operation 7812 further including adjusting or updating the data element 9407 in response to the user change input. An example procedure 7800 further includes the user change input being a drag-and-drop operation.

An example procedure 7800 includes the operation 7812 to adjust the second view being an operation such as: re-sorting at least a portion of the second view; changing a hierarchy of at least a portion of the second view; filtering at least a portion of the second view; aggregating data comprising at least a portion of the second view; inheriting a format from a portion of the data element and applying the inherited format to at least a portion of the second view; and/or inheriting a format from an object selected in the drag-and-drop operation and applying the inherited format to at least a portion of the second view. An example operation 7812 to adjust the second view includes inheriting a visualization parameter from an object selected in a drag-and-drop operation and applying the inherited visualization parameter to at least a portion of the second view. Example and non-limiting objects selected in the drag-and-drop operation include: a data value, a graph, a chart, a table, a table row, and/or a table column. Example and non-limiting visualization parameters include: a sorting description, a filtering description, a formatting description, an aggregation description, and/or a display value description.

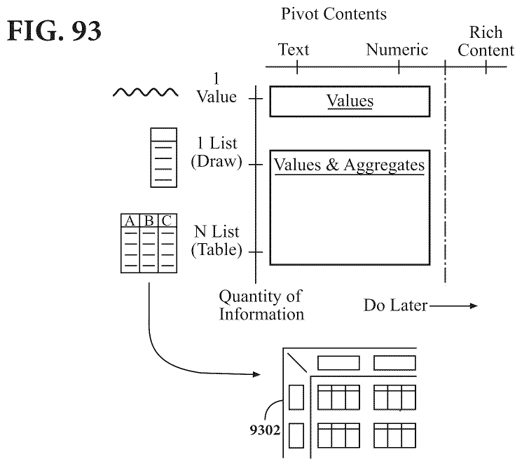

Referencing FIG. 93, an aggregated table view 9302 is depicted on a tab of a document for ease of selection, publication, or other manipulation by a user 814. The aggregated table view 9302 can be depicted as a single value (e.g., “Values”). Where the aggregated data result is a single list of values, the aggregated table view can be depicted as a list (or array) of values (e.g., “Values and aggregates”). Where the aggregated data result is a number of lists of values, the aggregated table view can be depicted as a table of N lists (e.g. “N lists” depicting columns A, B, C, etc.). Additionally or alternatively, where the aggregated data result is a number of lists, or other two-dimensional information, the aggregated data view can be depicted as a two-dimensional table of associated data sets grouped according to the at least two grouping criteria (e.g. depiction of aggregated data view 9302). Where two or more dimensions result from the aggregation, grouping can additionally or alternatively include additional data grouping depictions, such as nested lists, shapes, colors, or alternative formatting to depict additional grouping dimensions, and/or density or transparency adjustments to depict additional grouping dimensions. Additionally or alternatively, grouping order (e.g. priority of two separate grouping dimensions) can be readily adjusted by the user—for example dragging a horizontal grouping category to a member of the vertical grouping category, which in certain embodiments a table aggregation circuit interprets as an operation to switch the grouping priority of the horizontal and vertical grouping categories. In certain embodiments, operations to change grouping priorities and/or dimensions are stored in the operation log as operations to implement the grouping priorities and/or dimensions reflected in the document and the respective objects affected. For example, the referenced objects, relationships, and associations are stored as entries editing the aggregated table view 9302 to implement the grouping priorities and/or dimensions. Additionally or alternatively, change operations executed by the user are stored in the operation log (e.g., an original state of the operation log includes operations to implement the pre-change grouping priorities and/or dimensions, and an updated state of the operation log includes operations to change the grouping priorities and/or dimensions). In certain embodiments, change operations are stored at a first time (e.g., after initial edits to preserve undo functionality), and reduced to operations to implement the final state at a second time (e.g., upon generating a snapshot, saving the document, etc., to reduce memory utilization and/or document calculation time).

It can be seen that grouping results may be depicted as single data values, lists of data values, and/or associated rows of data within each grouping (e.g. a “table in a table” depiction

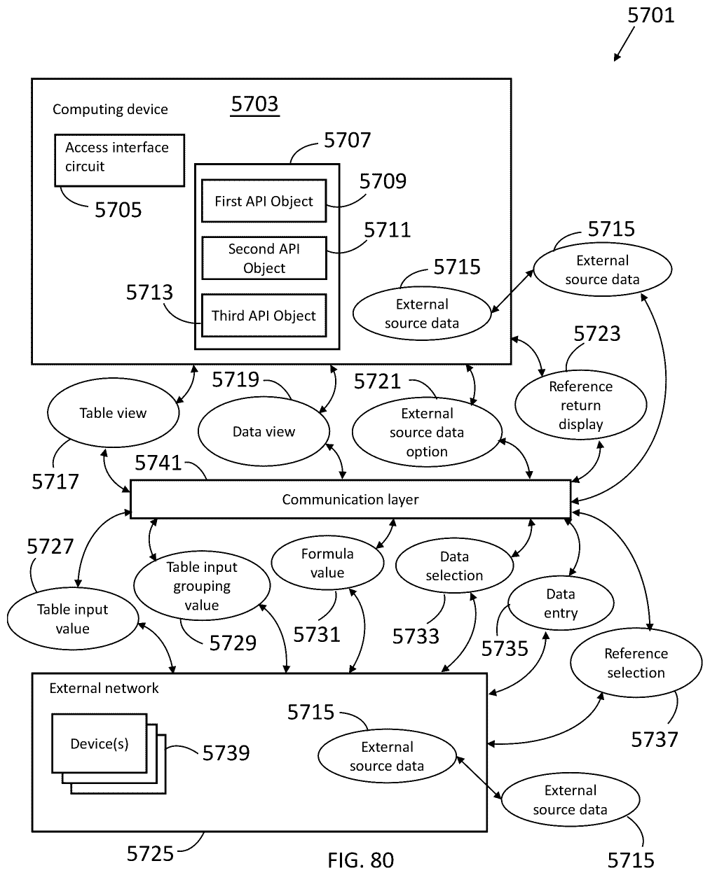

Referencing FIG. 80, an example system 5701 includes a communication layer 5741 that provides access between a computing device 5703 and an external network 5725. The communication layer 5741 includes any communication devices, protocols, and/or components to provide for communications between the computing device 5703 and the external network 5725. An example system 5701 includes the computing device 5703 as a server providing access to one or more API objects 5707 to the external network 5725. For example, the computing device 5703 may be a web server, a cloud server, and/or a network server, and the communication layer 5741 may be an internet link, intranet, extranet, wide area network, and/or may further include wireless communication devices. In a further example, the external network 5725 includes one or more devices 5739 that access the computing device 5703 to interface with the API object(s) 5707 to perform certain operations implementing one or more aspects of systems and operations described in the present disclosure. Additionally or alternatively, a communication layer 5741 may be a communication layer between devices within a network, for example the computing device 5703 providing access to the API object(s) 5707 to other devices 5739 on the network. Additionally or alternatively, the computing device 5703 includes an application and/or virtual device operating within a same device 5739 operating the external application accessing the API object(s) 5707, for example a first application on a device 5739 accessing the API object(s) 5707 operating within a second application on the device 5739. In a further example, the communication layer 5741 includes an operating system, processor bus, and/or other communication layer within one or more of the devices 5739.

An example computing device 5703 includes the one or more API objects 5707, and an access interface circuit 5705 that exposes one or more of the API objects 5707 to the communication layer 5741. Additionally or alternatively, exposure of the API objects 5707 includes features to provide a subscription service, and login and/or authentication information. Subscription services may provide access to selected API objects 5707 and/or selected external source data 5715 features and/or data sources. For example, access to the computing device 5703 may include access to a selected menu of API objects 5707 and/or a menu of external source data 5715 options. Example and non-limiting external source data 5715 include any data sources such as websites, website databases, databases, cloud databases, data within a file and/or document, and/or data provided by a data service at any location and/or via any access method. In certain embodiments, “external” source data 5715 is external relative to an application running on a device 5739, relative to the computing device 5703, and/or relative to the system 5701. In certain embodiments, the external source data 5715 includes data on the external network 5725, on the computing device 5703, accessible to the computing device 5703, accessible to the external network 5725, and/or accessible to the communication layer 5741. Any descriptions of source data and/or external source data described throughout the present disclosure are additionally or alternatively contemplated as examples of external source data 5715.

An example first API object 5709 includes an API object configured to interpret a table input value 5727, where the table input value 5727 includes a number of table data values, to determine a table organization value in response to the table data values, where the table organization value includes at least one value such as: a column naming scheme; a sorting scheme; a filtering scheme; an aggregation scheme; and/or a formatting scheme. The example first API object 5709 is further configured to determine a table view 5717 in response to the table organization value, and to provide the table view 5717 to the communication layer. An example system further includes the access interface circuit 5705 further receiving the table input value 5727 over the communication layer 5741. In certain embodiments, the first API object 5709 is further configured to interpret a formula value 5731, where the formula value 5731 does not include a row reference, to update the table organization value in response to the formula value 5731, and to update the table view 5717 in response to the updated table organization value. An example first API object 5709 is further configured to update the table organization value by applying the formula value 5731 to an entire column of the table data values.

An example first API object 5709 is further configured to interpret a table grouping input value 5729 associated with the table data values, where the table data values include a number of categories and a number of associated data sets corresponding to the number of categories, and to determine an aggregation value in response to the table grouping input value, where the aggregation value corresponds to at least one of the number of categories. The example first API object 5709 is further configured to update the table view in response to the aggregation value. In certain embodiments, the system 5701 includes the access interface circuit further receiving the table grouping input value 5729 over the communication layer 5741.

An example first API object 5709 is further configured to determine an aggregation scheme, where the aggregation scheme includes at least one scheme such as: qualitative aggregation of associated data sets according to at least one of the categories; quantitative aggregation of associated data sets according to at least one of the categories; and/or binned aggregation of associated data sets according to at least one of the categories; and to determine the aggregation value in response to the aggregation scheme. Example and non-limiting table input grouping values include at least one value such as: a selection of a dedicated aggregation input element; a drag operation to a table supercell; a drag operation of a table supercell; a drag operation including an element of a first table and an element of a second table; a menu interface element selection; and/or a selection of a context triggered element.

An example system 5701 includes a second API object 5711 configured to interpret a data selection 5733 including at least one data value, where the data selection 5733 includes at least one of a reference or a link to an external source data 5715. The example second API object 5711 is further configured to create a data view 5719 in response to the data selection 5733. An example system 5701 further includes the access interface circuit 5705 further receiving the data selection 5733 over the communication layer 5741, and providing the data view 5719 to the communication layer 5741. An example second API object 5711 is further configured to interpret a data entry 5735, to provide an external source data option 5721 in response to the data entry 5735, and to update at least a portion of the data view 5719 in response to the external source data option 5721. An example system 5701 further includes the access interface circuit 5705 further receiving the data entry 5735 over the communication layer 5741.

In certain embodiments, the second API object 5711 is further configured to interpret a data entry 5735 including an edit of the at least one data value, and to update the external source data 5715 to update the external source data 5715 in response to the data entry 5735. In certain embodiments, the second API object 5711 is further configured to query the external source data 5715 and to provide an update of the data view 5719 in response to the query. In certain embodiments, the second API object 5711 is further configured to perform the query operation in response to at least one of: an update time expiration; a notification from an external device hosting the external source data 5715; a change in a second data value having a dependency on the external source data 5715; a change in an object having a dependency on the external source data 5715; a creation of a second data value having a dependency on the external source data 5715 and/or a creation of an object having a dependency on the external source data 5715; and/or a request to provide a continuous update of the at least one data value.

An example system 5701 further includes a third API object 5713 configured to interpret a reference selection 5737, to determine a reference return value in response to the reference selection 5737, and to determine a reference return display 5723 in response to the reference return value. An example access interface circuit 5705 is further configured to receive the reference selection 5737 over the communication layer 5741, and to provide the reference return display 5723 to the communication layer 5741. An example third API object 5713 is further configured to determine the reference return value in response to at least one of: responsive information within a document (e.g. a document accessed by an application operating on a device 5739), or responsive information within an external source data 5715. Example and non-limiting external source data 5715 includes a data source such as: a website, a database external to a document, a cloud storage location, a second identified document, and/or a network location.

It can be seen that the described systems and API objects provide for a platform to receive commands from a distinct application, and return results utilizing capabilities described throughout the present disclosure.

In embodiments, according to the methods and systems of the present disclosure, an autocompletion functionality may be provided (referred to herein as “autocomplete”). Suggestions within autocomplete may be determined using a combination of a current formula in use, the cursor location within that formula, which, for example, may determine the text portion of the formula to be the subject of an autocomplete usage, and the parsing context (e.g., what type of formula column, canvas, filter, etc.) of that formula. When generating autocomplete suggestions a user may navigate down the tree, picking an appropriate “child” based on the current cursor location. Each node may have an option to return a set of autocomplete options if a sufficiently complete view of a formula is obtained, or the algorithm may continue to recurse down.

In embodiments, according to the methods and systems of the present disclosure, a number of custom data types may be created, utilized, and/or understandable to the system to determine suggested reference values, candidate entries, and/or autocomplete entries (e.g., for a reference and/or formula value) are described following, without limitation to any aspect described in the present disclosure. Further example operations to provide reference values, candidate For example, as a user enters data, the data entry may be classified (e.g., estimated, and/or provisionally assigned) as a particular type of data. Each formula (e.g. from a formula library) defined may have annotations to define the data type of its return type, as well as the expected data types of each of its parameters. As dynamic calculations complete, the calculation results may also be classified as a particular type of data. These classifications may be stored, for example, in histograms for each column, so that they may be used in the future to determine the type for an entire column (e.g., where a column accepts multiple data types, and/or is assigned a principle data type).

In embodiments, when a formula is converted to an abstract syntax tree (AST), according to the methods and systems of the present disclosure, each node (or part) of the formula with an expected return type may be decorated. This expectation may start at the root of a tree and be pushed down. Some formula types, including but not limited to, filters and conditional formats, may have an expected return type of a boolean expression. Functions within a formula may have a series of argument nodes, where each may be comprised of their own expression tree. The root of these trees may have an expected return type set based at least in part on the expected type for that particular formula parameter, and this may propagate down the tree. Operators may have similar behaviors and, by analogy, function like formulas with, for example, two parameters. In an example, the “%” (modulo) operator may expect that its parameters would be numeric.

In embodiments, formula suggestions may start with a global list of known formulas. This list may be first narrowed by removing formulas that do not have at least one alias that matches the given text that a user wants to complete. Further narrowing of the list may be attempted by identifying a set of best matches and, if the user is completing an empty string, only the best matches may be returned, otherwise the best matches may be ranked above other matches. To determine best match suggestions, the expected return type of the given node may be evaluated, and the type of any value being chained into the formula if one is present.

An example operation to consider a formula as a “best match” includes, without limitation: the formula is not marked as a low priority formula; there is a known expected return type, and the formula has a possible return value assignable to the known expected return type; a chain node associated with the formula includes a known type, where a) the formula expects a parameter, b) the best match expected type of the chained parameter is not excluded from a match (optional); c) the type of the chain node is assignable to the best match expected type of the chained parameter. A best match expected type of a chain node parameter may be expected to be an array of the parameter's defined type if the parameter is a variable argument, otherwise it may be the type defined by the parameter.

An example operation includes a user attempting to complete a block of text, where the user looks across the entire current context stack for references that can match the current search text. If a user is looking for only the best suggestions and an expected return type is known, these results may be filtered to only references that contain a data type that is assignable to the expected return type, such as according to selections by the user, rules in the document (e.g., by the user, and administrator, and/or document template).

When appropriate, values may be suggested (e.g., as candidate entries, auto-complete enabled entries, and/or suggested values) that are present within another object. Values may be dynamically looked up in that object and a histogram generated so the values can be ranked based on, for example, frequency from highest to lowest. When analyzing the AST, a number of scenarios may be evaluated to trigger a specific class of suggestions. The order in which the conditions of heuristics are checked may be important to generate a full experience, as conditions may not be mutually exclusive. Below are a few non-limiting examples:

### Boolean Expression Extension

Condition: A boolean expression is expected, a complete boolean expression is present, and the cursor is one space after the boolean expression.

Suggestion: Logical operators.

### Start of Grid Expression

Condition: A grid parser is the context and nothing has been typed.

Suggestion: Set of columns in the grid parser context.

### Grid Expression Start of Extension

Condition: A grid parser is the context after a logical operator and nothing has been typed.

Suggestion: Set of columns in the grid parser context.

### Local Grid Context Start of Boolean Expression

Condition: A local grid is the context and an empty parameter is the context with an expected type of boolean expression.

Suggestion: Set of columns in the local grid context.

### Extend Table

Condition: An unchained table reference is present with an expected return type that is not a table or grid.

Suggestions: Show reference and formula suggestions.

Extend this Document

Condition: An unchained document reference is present with an expected return type that is not a document.

Suggestions: Show reference and formula suggestions.

### Canvas Start

Condition: Nothing has been typed and a canvas parsing context is the present state.

Suggestions: Tables, controls, and views in the document with the ones in the current canvas are ranked first.

### Reference Boolean Expression Extension

Condition: A column or variable reference is present when a boolean expression is expected.

Suggestions: Equality operators, also isBlank and isNotBlank if a trailing space is not present, and comparison operators if the reference contained data type is assignable to numeric or dateTime.

### CurrentValue Boolean Expression

Condition: A missing parameter context is present and a boolean expression is expected, and there is a local context of a column or thisRow.

Suggestion: Suggest the CurrentValue keyword.

### Right Hand Side Operator Comparison to Reference

Condition: A right-hand side of a comparison is present where the left-hand side has a resolved reference.

Suggestion: Aggregate the following suggestions:

If a current input is an empty string, and a local grid context is present, return RowColumnReferences for the local grid context. Else all reference options that match in the current context.

If the left-hand side data is of the type date time, suggest common date comparison suggestions.

Suggest value suggestions present in the left-hand side reference, but drop this suggestion if the only value match is an exact match.

If there is some text present, include any formula matches.

### Unknown Literal

Condition: Fallback for node with unknown return type.

Suggestion: Return reference and formula matches.

In certain embodiments, autocomplete operations include autocompletion of any reference value, external data request, and/or formula entry value. Example and non-limiting autocomplete operations include: providing a list of candidate entries for a current user entry value that are consistent with the user entry value entered, which may be a partial or a complete value (hereinafter, “candidate entries”); providing previews for one or more candidate entries, where previews include one or more of contextual information related to the candidate entry (e.g., offset column data for a table, a related table column heading, a related table name, and/or a related object name, heading, or value) and/or a result set for one or more candidate entries if selected (e.g., a result of a formula resulting from the candidate entry; one or more rows of a sorting and/or filtering operation as a result of the candidate entry; and/or a depiction of a resulting object such as a graph, chart, and/or image as a result of the candidate entry); a card depicting relevant information to the candidate entry. Additionally or alternatively, candidate entries are prioritized according to contextual information. Additionally or alternatively, previews for one or more candidate entries are provided as a tooltip and/or at the request of the user to provide additional information for candidate entries. Additionally or alternatively, a listing of candidate entries is updated in response to the user adding to the current user entry value (e.g., the candidate entry list is updated in real time as the user types). Additionally or alternatively, a notification is provided to the user that additional candidate entries beyond those listed are available in the system. Additionally or alternatively, one or more candidate entries are determined according to a document model of objects, including object reference names stored in a document model, an operation log, a system table, and/or document metadata, and/or further in response to available events and/or methods available for objects related to the candidate entries and/or related to the user entry value. In certain embodiments, a formatting is applied to the user selection of the candidate entries. In certain embodiments, a single candidate entry is supplied to the user for autocomplete operations.

An example system 8100 may include a unified document surface application circuit 8119A, 8119B further including an authorization circuit 8122A, 8122B that interprets an external data source request 8124, and provides an access to an external data source 8126 in response to the external data source request 8124. In an example, an employee may wish to perform a CRM function by obtaining regional sales data for Product X from each of a plurality of third party databases, such as retail stores, third party data warehouses and the like. An organization may place limits on which employees may access such data, and an authorization circuit may review permissions and perform authentication to ensure that a party wishing to view, for example, a particular type of data or data source is authorized to do so. The authorization circuit 8122A, 8122B may prompt a user for authorization information (e.g., a username, login ID, password, etc.) and/or accesses authorization information accessible to the document, system, a client computing device, the document server, or the like. Accordingly, the user may access external data sources 8126 according to available permissions specific to the user, entered into a document for use during a project, according to a subscription where the subscription information is entered into the document, document server, client computing device, or otherwise within or accessible to the system. An example authorization circuit 8122A, 8122B may further store an authorization token corresponding to the external data source 8126 in the document 8106, where the authorization token may include at least one access value such as: an access type (e.g., read operations, edit operations, write operations, and/or delete operations); an access scope (e.g., accessible portions of the external data source 8126, including differential access types according to the portion of the external data source 8126); an access duration (e.g., a session duration of access, applicable calendar time of access, allowed access times for operations to access the external data source 8126 and/or portions thereof, including differential times for certain access types and/or portions of the external data source 8126); and/or expiration values for the authorization token); and/or an access reauthorization time value (e.g., a time to prompt the user for reauthorization, an expiration time for a session, subscription, or the like, and/or expiration values for the authorization token). For example, a user may have a stored permission, such as a token, indicating that they may access External Data Source 1 and 2 but not 3. Upon an attempt to access External Source 1, the user may be able to import data, create an action link to the external data source, as described herein, and/or populate a table within the unified document surface with data from External Data Source 1. Continuing the example, if this user is in a work group with shared responsibilities and a shared workspace, a document server 8102 may allocate supporting operations to a workflow server 8136—for example where operations requested according to multiple users and/or for multiple documents include certain common aspects (e.g., downloading bulk information from External Data Source 1, indexing and/or querying operations to a large data set at least partially shared between documents, and so forth). In embodiments, the specific operations performed by the workflow server 8136 may be direct operations and/or procedures as described in the present disclosure, and/or where specific operations performed by the workflow server 8136 are a superset of operations (e.g., shared between a number of documents and/or user operations), precursor operations, and/or preparatory operations, for example to support utilization of an external data source 8126 that is added to the system 8100.

In embodiments, an administrator, document owner, and/or an authorized user, such as a manager, may extend access to a data source and/or the unified document surface, if permitted to other users of the document. For example, a user in need of using data from External Data Source 1 in order to analyze regional sales trends as part of an organization's CRM program does not necessarily need to know the details of accessing the external data source 8126, such as calling and engaging APIs for the external data source 8126. The authorization circuit 8122 may provide for a configurable front-end for the user to access external data sources 8126, including within linked tables within the unified document surface, as described herein, while having only limited information to provide authorization, such as login information to the external data source 8126, to the document 8106, and/or as determined according to information about the user. For example, a plurality of employees that are tasked with tracking regional sales may interact with a unified document surface in which there are tables that are linked to external data sources, including via active links. As the data changes (e.g., additional sales are recorded at a retail organization), the linked tables within the unified document surface may automatically update to indicate the new information. Alternatively, the data may be periodically updated in the linked tables, updated at the user's request, or according to some other schedule or rule. The authorization required to access this data may be unknown to the user, because it is implicit to that user's interaction and permissions with the unified document surface and the tables therein. Thus, external data sets, such as a web page or database external to the document surface, may be periodically and/or continuously updated by operation of the document server that pulls in the updated data and updates corresponding elements of the document, such as linked tables, that utilize the external data set.

In another embodiment, a user may wish to track potential sales leads using the system 8100. As a starting point, the user may use a unified document surface to create a table or plurality of tables that may include action links to external data sources, such as websites (e.g., LinkedIn or Wikipedia), networks (American Purchasing Society), distributed databases (job banks), or some other data source. As described herein, linked tables may be updated within the document as changes are registered at the external data sources. Alternatively, the document may also contain tables containing data that are static or that only receive periodic data updates. For example, a CRM professional may be in the habit of updating, on a quarterly basis, a table listing purchasing executives' names and contact information. In a second table, or in a second region of the table in which the purchasing executives' data are recorded, the user may also update external data, such as SEC filings for the companies at which the purchasing executive are employed, for example indicating the quarterly loss or profit of the division with which the purchasing executives are associated. Continuing the example, a table, or tables, within the document may periodically update the parties that have contacted the user via an email account, recording data such as name, title, address, company of employment, time of email, and so forth. Once this data is within the document, or made available to the user through the linked tables of the document, the user may be able to create different views of the data, such as pivot tables, as described herein, to explore various relationships among the data. For example, a particular view of interest to the user might be a listing of 1) purchasing executives with a particular title (e.g., “Purchasing Director”), 2) from a company for which an SEC quarterly report within the last quarter indicated a company profit, increasing margins, notice of expansion, or some other type of positive financial information, and 3) at least one record of email contact with the user. This view/table may be titled (“Promising Leads”), stored (including stored as a template to be periodically run to refresh the data presented), and pushed to a client device for viewing.

In certain embodiments, a CRM document template may include external data structured within linked tables in a manner suited to a given user's CRM needs permissions and history with a document, for example as recorded in an operations log that is associated with the document surface in which the user is tracking data. Access, views of data, and the data presented within a linked table within the document surface may be based at least in part on a particular sales team and the individuals included on the team, or a certain set of products, retailers, or some other criterion of interest in a CRM system.

Real estate can be a fast-moving, competitive industry in which timely access to data is important. A typical home buying experience can be exasperating when one must go to multiple data sources, web search to web search, to research real estate that is on the market, in your preferred neighborhood, in your price range, within your acceptable commuting range, and so on. In addition to the data regarding the properties themselves, there is a significant number of realtors to choose from, data about realtors, historical data regarding their sales, the percentage of asking price they were able to bargain for, number of deals closed, etc. To be adequately informed, a participant in the real estate market needs real time access to data regarding the real estate market, inventory, sales, realtors, notification when events of interest occur (e.g., new home listed in preferred neighborhood), and comparison shopping to know what fair market value is of homes, but also realtor's commissions, given their sales records.

In embodiments, the system 8100, as described herein, may be used to create a unified document surface in which there are linked tables that have external data links to data sources outside of the system 8100. The data sources may include websites containing home listings, valuation databases, such as tax assessor's offices, third party valuation services, crime databases, education websites rating school districts, quality of life indices, or some other type of data. The conventional means of accessing such data is now often sequential web searching, government office visits, meetings with realtors, and so forth. Each may have their own manner of allowing access to data, and rules regarding which data may be retrieved.

In a preferred embodiment of the present disclosure, with linked tables within a unified document surface, a user may be able to extract external data, using the method and systems as described herein, and populate a table, series of tables, or embedded tables, with the types of data of most relevance to the user and in the format that is most actionable for that user's particular intended use of the data. For example, a real estate website may allow connectivity through API functionality. A real estate firm may regularly post its sales by neighborhood and price on its website, all data which may be scraped and populated with a table. And the user herself may have certain data criteria she wants to record and track, such as cost of property taxes, age of home that is acceptable and so on. Using the external data features of the system 8100 as described herein, the user may be able to construct a table or plurality of tables that retrieve and refresh such real estate data on a regular basis, rather than the user having to individually visit websites, construct traditional spreadsheet summaries of key metrics and the like.

Continuing the example, once the linked tables are functional within the unified document surface, the user may employ formulas and rules to sort, pivot, aggregate and perform other analyses. For example, using the @reference functionality, as described herein, the user may be able to query across these plurality of data sources and data types to pull all data that relates to a four bedroom house (“@four bedroom”), or financing status (@foreclosure), or location (@78705), and so forth. A pivot table may be able to produce a listing of all homes listed for sale in a given zip code that also appear in a publicly available crime statistics database indicating no burglary within the last 24 months.

In embodiments, a user may set notifications and alerts based on data within the table(s), or that is updated to a table(s). For example, a user may have tables within a document that are linked to external data sources that provide data related to location, price, schools, crime, lot size, and manually entered personal data regarding the approximate distance from places of interest, such as family and friend's houses, or a favorite park. Formulas, as described herein, may be used to construct a notification rule regarding the intersection or presence of meaningful data, such as “within 1 mile of Zilker Park, sidewalks in neighborhood, under price $X, no burglaries” and so on. This data may also be viewed in conjunction with other data, such as realtor data indicating realtors who have worked as a buyer's agent in the zip code of interest, and obtained a sale for their buyer at X % below the list price, and within the last 12 months.

In embodiments, once there is a match across all these factors, derived from a plurality of datasets, within a view of the data, such as a pivot table, as described herein, the system 8100 may generate a notification for the user. A notification may, in one embodiment, take the form of an alert that is sent to a client device, such as a mobile phone that is associated with the user, or that the user indicated within the unified document surface was the appropriate contact for an alert. An alert may be sent over the Internet, cellular network, WiFi, near-field communication, beacon, or some other means. Upon receipt of the alert, the client device, such as a smart phone may receive instructions to activate, such as out of a “sleep mode.” The activation may be coupled with an audio, visual, tactile, or some other type of indication of activity occurring on the client device. Upon activation, the client device may act on instructions received from the system to connect with the document in which the table data is present, and that is the source of the notification/alert. The document may present the user a view of the intersection of data that was the cause of the alert (e.g., good home, right neighborhood, quality realtor contact with proven sales record in the neighborhood). In another embodiment, the client device, such as a smart phone, may present the phone number of the realtor identified in the linked table view, and ask the user if they would like to place the call before the opportunity to buy the home passes.

In embodiments, the system 8100 may be used to track human resources functionalities, including but not limited to the tracking of prospects, the scheduling of job interviews, follow-up interviews, recruiting events, job fairs, contact information, history of employment, or some other type of data related to human resources and recruiting. Human resource representatives or others may use a unified document surface to create tables, linked tables, and other resources, as described herein, to track personnel data, to keep track of important documentation, including but not limited to resumes, or other documents.

Because the system 8100 is collaborative, and the documents created in the system may be utilized by multiple parties, and the unified document surface may allow multiple parties to comment, review, and evaluate potential recruits, without having to coordinate the passing of a review form or other standardized means of tracking recruiting activities. Functionalities such as the @reference function, as described herein, may allow human resources representatives or others to more efficiently search and find needed information regarding prospects or other information.

The external data capabilities of the system 8100 may also enable other data sources outside of an organization to contribute to the overall picture of a recruit. For example, background data, prior employment, data from websites such social network sites, like LinkedIn, or some other type of data may be incorporated into tables, including linked tables, as described herein and refreshed periodically or automatically when a given data source, such as a website is updated with new information. In this way, the system 8100 may be used not just to track current parties that are undergoing an interview process, but also used to search for and evaluate potential parties to contact for potential employment.

In certain embodiments, operations to determine a list of candidate entries and/or to provide an autocompleted entry can be applied to any text, formula, and/or data entry in a document. Example and non-limiting classes of information for candidate entries and/or autocompleted entries include: column names; column values; corrections to apparent error values in a math operation, a reference, a parsing value, syntax, and/or a formula; a value for a reference precedent and/or dependent; and/or tag parameters. Example and non-limiting previews include: help text; an impact of an entry (e.g., highlight cells that are changed by a current entry); results of a current entry; and/or write-through results for a current entry (e.g., where a source value is updated by a change in a referencing value).

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

While only a few embodiments of the present disclosure have been shown and described, it will be obvious to those skilled in the art that many changes and modifications may be made thereunto without departing from the conceptual framework and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions, and the like. The processor may be or may include a signal processor, digital processor, embedded processor, microprocessor, or any variant such as a co-processor (math co-processor, graphic co-processor, communication co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions, and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions, or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code, and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client, and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of a program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

In embodiments, one or more of the controllers, circuits, systems, data collectors, storage systems, network elements, or the like as described throughout this disclosure may be embodied in or on an integrated circuit, such as an analog, digital, or mixed signal circuit, such as a microprocessor, a programmable logic controller, an application-specific integrated circuit, a field programmable gate array, or other circuit, such as embodied on one or more chips disposed on one or more circuit boards, such as to provide in hardware (with potentially accelerated speed, energy performance, input-output performance, or the like) one or more of the functions described herein. This may include setting up circuits with up to billions of logic gates, flip-flops, multiplexers, and other circuits in a small space, facilitating high speed processing, low power dissipation, and reduced manufacturing cost compared with board-level integration. In embodiments, a digital IC, typically a microprocessor, digital signal processor, microcontroller, or the like may use Boolean algebra to process digital signals to embody complex logic, such as involved in the circuits, controllers, and other systems described herein. In embodiments, a data collector, an expert system, a storage system, or the like may be embodied as a digital integrated circuit (“IC”), such as a logic IC, memory chip, interface IC (e.g., a level shifter, a serializer, a deserializer, and the like), a power management IC and/or a programmable device; an analog integrated circuit, such as a linear IC, RF IC, or the like, or a mixed signal IC, such as a data acquisition IC (including A/D converters, D/A converter, digital potentiometers) and/or a clock/timing IC.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be configured for use with any kind of private, community, or hybrid cloud computing network or cloud computing environment, including those which involve features of software as a service (“SaaS”), platform as a service (“PaaS”), and/or infrastructure as a service (“IaaS”).

The methods, program codes, and instructions described herein and elsewhere may be implemented on a cellular network having multiple cells. The cellular network may either be frequency division multiple access (“FDMA”) network or code division multiple access (“CDMA”) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (“RAM”); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the Figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

What is claimed is:

1. A system, comprising:
a document serving circuit structured to access a document data, the document data comprising data for a unified document surface, and to provide at least a portion of the document data to a client serving circuit;
the client serving circuit structured to implement a unified document surface interface in response to the at least a portion of the document data;
the client serving circuit further structured to implement an extension creation interface, and to provide a pack implementation value to the document serving circuit in response to user interactions with the extension creation interface; and
wherein the document serving circuit is further structured to determine a pack definition value in response to the pack implementation value.

2. The system of claim 1, wherein the pack implementation value comprises an access authorization value, and wherein the pack definition value comprises an access authorization description.

3. The system of claim 1, wherein the document serving circuit is further structured to expose a pack to a workspace in response to the pack definition value.

4. The system of claim 3, further comprising a second client serving circuit structured to access the pack, to implement an extension utilization interface, and to incorporate at least a portion of the pack into a second document in response to user interactions with the extension utilization interface, wherein the second document is associated with the workspace.

5. The system of claim 2, wherein the document serving circuit is further structured to expose a pack to a workspace in response to the pack definition value.

6. The system of claim 5, further comprising a second client serving circuit structured to access the pack, to implement an extension utilization interface, and to incorporate at least a portion of the pack into a second document in response to user interactions with the extension utilization interface, wherein the second document is associated with the workspace.

7. The system of claim 6, wherein the document serving circuit is further structured to isolate the access authorization description from the second client serving circuit.

8. The system of claim 7, wherein the pack comprises at least one of a service or an external data value, and wherein the access authorization description comprises authorization information for access to the at least one of the service or the external data value.

9. The system of claim 1, wherein the pack definition value comprises a formula.

10. The system of claim 1, wherein the pack definition value comprises an external data access value.

11. The system of claim 1, wherein the pack definition value comprises at least one of: a formula; an action; a format; or a table.

12. The system of claim 1, wherein the pack implementation value comprises an arbitrary code component.

13. The system of claim 12, wherein the document serving circuit is further structured to determine the pack definition value by isolating operations of the arbitrary code component from at least one of the client serving circuit or the document serving circuit.

14. The system of claim 13, wherein the document serving circuit is further structured to determine the pack implementation value by operating a virtual machine to execute the arbitrary code component.

15. The system of claim 14, wherein the document serving circuit is further structured to determine the pack definition value by operating the virtual machine on a workflow serving circuit.

16. The system of claim 15, wherein the document serving circuit is further structured to create a dedicated instance of the virtual machine for the arbitrary code component.

17. The system of claim 1, wherein the document serving circuit is further structured to perform, in response to determining an update to the pack implementation value comprises an incompatibility risk, at least one operation selected from the operations consisting of:
providing an incompatibility warning value to a client device;
providing an update option value to a second client serving circuit accessing a document utilizing a pack exposed to a workspace in response to the pack definition value; or
providing an update delay value to a second client serving circuit accessing a document utilizing a pack exposed to a workspace in response to the pack definition value.

18. The system of claim 5, wherein the access authorization description comprises an authorization type for each one of a service or an external data access of the pack.

19. The system of claim 18, wherein the document serving circuit is further structured to require authorization information for the service or the external data access from a second user of a second document utilizing the pack in response to the authorization type comprising a user authorization type.

20. The system of claim 19, wherein the document serving circuit is further structured to access the service or the external data access using separate credentials from the required authorization information.

21. The system of claim 19, wherein the document serving circuit is further structured to provide access to the service or the external data access to the second user of the second document utilizing the pack in response to the authorization type comprising a system authorization type.

22. The system of claim 1, wherein the document serving circuit is further structured to perform a validation of the pack definition value, and to create a pack in response to the pack definition value and the validation.

23. The system of claim 1, wherein the document serving circuit is further structured to perform a validation of the pack definition value, and to provide a notification to the extension creation interface in response to the validation indicating a pack error.

24. The system of claim 23, wherein the pack error comprises at least one error selected from the errors consisting of: a formula error, an authorization error, or a code operation error.

25. The system of claim 1, wherein the extension creation interface further comprises an assistance interface.

26. The system of claim 25, wherein the assistance interface further comprises at least one of:
a tooltip associated with at least one of: a component of the extension creation interface, a formula command, or a text value;
a description value associated with at least one of: a component of the extension creation interface, a formula command, or a text value; or
a code example associated with at least one of: a component of the extension creation interface, a formula command, or a text value.

27. The system of claim 10, wherein the extension creation interface is configured to limit access to the external data access value to a defined external data component of the extension creation interface.

28. A system, comprising:
a document serving circuit structured to access a document data, the document data comprising data for a unified document surface, and to provide at least a portion of the document data to a client serving circuit;
the client serving circuit structured to:
implement a unified document surface interface in response to the at least a portion of the document data;
access a pack list comprising a plurality of exposed packs, each comprising a capability extension created in response to a corresponding pack definition value;
implement a pack addition interface in response to the pack list; and
install at least a portion of a pack of the plurality of exposed packs, into a document comprising at least a portion of the document data, in response to user interactions with the pack addition interface.

29. The system of claim 28, wherein the user interactions comprise a drag and drop operation of the pack to the document.

30. The system of claim 28, wherein the pack comprises at least one of: a formula; an action; a format; a table; a unified document surface interface formula; a code based formula; a third party formula; a column formula; a text flow; an arbitrary code component; or a template.

31. The system of claim 28, wherein the pack comprises one of a service or an external data access value.

32. The system of claim 31, wherein the one of the service or the external data access value comprises an authorized service or external data access value.

33. The system of claim 32, wherein the authorized service or external data access value comprises a system authorized service or external data access value, where the document serving circuit provides access to the service or external data access value without further authorization operations from a user of the unified document surface interface.

34. The system of claim 33, wherein the document serving circuit isolates authorization information for the authorized service or external data access value from a client device displaying the document.

35. The system of claim 34, wherein the authorized service or external data access value comprises a user authorized service or external data access value, where the document serving circuit provides access to the authorized service or external data access value in response to authorization credentials supplied by a user of the unified document surface interface.

36. The system of claim 35, wherein the document serving circuit accesses the authorized service or external data access value using distinct credentials from the authorization credentials supplied by the user of the unified document surface interface.

37. The system of claim 28, wherein the document serving circuit commands execution of operations of the pack on at least one of a separate workflow server or a virtual machine.

38. The system of claim 28, wherein the corresponding pack definition value comprises an update implementation value, and wherein the document serving circuit updates the document in response to an update of the pack and the update implementation value.

39. The system of claim 38, wherein the update implementation value comprises at least one value selected from the values consisting of: an immediate update value; a timed update value; or an update notification value.

40. The system of claim 38, wherein the document serving circuit is further structured to determine an update type value, and to update the document further in response to the update type value.

41. The system of claim 38, wherein the pack comprises a versioned object, and wherein the document serving circuit updates the document further in response to a version of the exposed pack and a version of the installed pack in the document.

42. The system of claim 28, wherein the document serving circuit is further structured to determine a pack execution log in response to operations of the document using the pack, and to expose at least a portion of the pack execution log to an author of the pack.

43. The system of claim 42, wherein the pack execution log comprises at least one log information element selected from:
a number of documents having the pack installed;
a number of execution events of components of the pack;
an execution time of execution events of components of the pack;
a number of service or data access events of components of the pack.
